(19) United States
(12) Patent Application Publication
(10) Pub. No.: US 2024/0415045 A1
(43) Pub. Date: Dec. 19, 2024

(54) SIDE TILT COUNTERACTING SYSTEM AND STEERING SYSTEM FOR AGRICULTURAL APPARATUSES

(71) Applicant: HONEY BEE MANUFACTURING LTD., Frontier (CA)

(72) Inventors: Glenn Raymond HONEY, Bracken (CA); Lee Glenn HARPER, Shaunavon (CA)

(21) Appl. No.: 18/209,370

(22) Filed: Jun. 13, 2023

(51) Int. Cl. A01B 69/00; A01B 33/16

(52) U.S. Cl. CPC A01B 69/004; A01B 33/16

(57) ABSTRACT

Orientation signals from a ground surface orientation sensor are received at a control system. The signals are indicative of a side tilt angle of a sideways sloped ground surface. Based on the signals the control system, the control system causes a side tilt counteracting mechanism to operate to counteract the sideways acting force acting an agricultural apparatus associated with the side tilt angle. A steerable wheel of an agricultural apparatus is pivotable about a steering axis, and an actuation system is operable to adjust a steering angle of the steerable wheel about the steering axis. The steering angle of the steerable wheel may produce a steering direction that counteracts the side force acting on the tillage apparatus.

### TECHNICAL FIELD

This invention relates to agricultural apparatuses, including methods, systems, and apparatuses for facilitating tilling and seeding.

### BACKGROUND

Farmers use a variety of agricultural apparatuses including implements in order to prepare and treat the ground, for example placing seeds within the soil material. An agricultural apparatus may be driven/pushed/pulled over a field to be prepared for seeding and/or seeded and may include a tillage apparatus. Some tillage apparatuses may incorporate seeding apparatuses in order to be able to both till the soil material and plant the seeds at the same time. Tillage apparatuses typically have a plurality of engagement members mounted on a frame, with the ground engagement members being configured and positioned for preparing the soil material for seeding. The ground engagement members may engage with the ground to dig, stir, or overturn the soil material to a desired depth. must be carried out over an area of ground that has an uneven surface and/or has sloped surface areas.

Tilling the ground accurately and relatively consistently to a desired tillage depth when preparing the ground for seeding is important for several reasons. For example, it is typically important to till the ground to a relatively precise depth to provide a proper bed depth for placement of plant/crop seeds. Additionally, when placing seeds within the soil material it is important that the seeds be placed accurately within the soil material at a desired depth. Placing seeds either at either a too shallow depth or too deep within the soil material can impact upon the seeds ability to transform into a desired healthy crop plant.

Tilling and seeding the ground accurately and in consistently transversely spaced, longitudinally extending rows can also be important to ensure that plants do not become overcrowded and compete with each other for resources during growth. For example, it is important that the plurality of ground engagers on the agricultural implement are sufficiently and accurately spaced and do not shift transversely relative to each other during operation, which may result in unevenly transverse spaced rows. Furthermore, it is desirable for the agricultural implement to remain substantially in alignment with the apparatus that is driving/pushing/pulling the tillage/seeder apparatus without laterally shifting into a skewed or skidding orientation. It can be particularly challenging to achieve this on contoured or uneven ground that can cause the agricultural implement to shift, for example due to unbalanced forces operating upon some of the plurality of ground engagers and/or the force of gravity acting on an apparatus that is on transversely sloped terrain. Such shifting may result in inconsistent row spacing and variations in the depth of tilling or seeding. Additionally, shifting may leave some areas of the ground untilled and/or unseeded, rendering it unproductive and more prone to weeds, threatening crop yields.

Providing agricultural apparatuses/implements that can consistently and precisely till and/or seed ground surfaces that may be uneven and/or includes slopes, whilst maintaining a precise tilling depth, and seeding depth, and row spacing has been challenging.

Accordingly, improved agricultural apparatuses are desirable.

### SUMMARY

In an aspect of the disclosure, there is provided a method for counteracting a sideways force acting of an agricultural apparatus moving on a sideways sloped ground surface, the agricultural apparatus comprising a frame and a plurality of support units supporting the frame for movement on the ground surface, wherein the method comprises: (a) receiving at a control system, orientation signals from a ground surface orientation sensor, the orientation signals indicative of a side tilt angle of the sideways sloped ground surface; (b) based on the orientation signals received by the control system, causing the control system to determine whether to cause a side tilt counteracting mechanism to operate to counteract the sideways acting force acting on the agricultural apparatus associated with the side tilt angle.

In another aspect of the disclosure, there is provided a method for counteracting a sideways force acting of an agricultural apparatus moving on a sideways sloped ground surface, the agricultural apparatus comprising a frame and a plurality of support units supporting the frame for movement on the ground surface, wherein the method comprises: (a) receiving at a control system, orientation signals from a ground surface orientation sensor, the orientation signals indicative of a side tilt angle of the sideways sloped ground surface; (b) based on the orientation signals received by the control system, causing the control system to cause a side tilt counteracting mechanism to operate to counteract the sideways acting force acting on the agricultural apparatus associated with the side tilt angle.

In another aspect of the disclosure, there is provided a method for compensating for sideways force acting of an agricultural apparatus moving on a sideways sloped ground surface, the agricultural apparatus comprising: a frame and a plurality of support units supporting the frame for movement on the ground surface, the plurality of support units comprising at least one wheeled support unit comprising at least one steerable wheel mounted for rotation about a wheel axis, the steerable wheel operable to contact the ground surface, the steerable wheel being rotatable and steerable about a generally vertical steering axis; a steering angle adjustment system operable to adjust a steering angle of the at least one steerable wheel about the steering axis; wherein the method comprises operating the steering angle adjustment system to adjust the steering angle of the steerable wheel about the steering axis, such that the steerable wheel is oriented in an angled direction that is generally in an uphill direction that is generally in an opposite direction to a sideways downhill slope direction of the ground surface.

In another aspect of the disclosure, there is provided a method for compensating for a sideways force acting of an agricultural apparatus moving on a sideways sloped ground surface, the agricultural apparatus comprising: a frame and a plurality of support units supporting the frame for movement on the ground surface, the plurality of support units comprising at least one wheeled support unit comprising at least one steerable wheel mounted for rotation about a wheel axis, the at least one steerable wheel operable to contact the ground surface; the steerable wheel of the at least one wheeled support unit of the plurality of wheeled support units being rotatable and steerable about a generally vertical steering axis; a steering angle adjustment system operable to adjust the angular position of the steerable wheel about the steering axis; wherein the method comprises: receiving at a control system, at least one orientation signal from a ground surface orientation sensor, the at least one orientation signal indicative of a side tilt angle of the sideways sloped ground surface; receiving at the control system a wheel steering angle signal from a steering angle rotation sensor, the at steering angle signal indicative of an actual steering angle of the steerable wheel; based on the orientation signal, causing the control system to calculate a target steering angle; based on the wheel steering angle signal, causing the control system to identify the actual steering angle of the steerable wheel; causing the control system to generate signals to the steering angle adjustment system to adjust the actual steering angle of the steerable wheel towards the target steering angle.

In another aspect of the disclosure, there is provided a method for compensating for sideways force acting of an agricultural apparatus moving on a sideways sloped ground surface, the agricultural apparatus comprising: (a) a frame and a plurality of support units supporting the frame for movement on the ground surface, the plurality of support units; (b) a plurality of front ground engagers and a plurality of rear ground engagers mounted on the frame, each of the plurality of front and rear ground engagers operable for engaging beneath the ground surface, wherein at least one of a depth of engagement beneath the ground surface of the front ground engagers and (ii) a depth of engagement below the ground surface of the rear ground engagers can be adjusted; (c) a depth adjustment system that is operable to adjust at least one of a depth of engagement of the front ground engagers below the ground surface and a depth of engagement of the rear ground engagers beneath the ground surface; and wherein the method comprises: (i) propelling the agricultural implement in a direction of travel; (ii) receiving at a control system, orientation signals from a ground surface orientation sensor, the orientation signals indicative of a side tilt angle of the sideways sloped ground surface; (iii) based on the orientation signals received by the control system, causing the control system to operate the depth adjustment system to cause the side tilt counteracting system to adjust at least one of: (i) a depth of engagement below the ground surface of the front ground engagers and (ii) a depth of engagement below the ground surface of the rear ground engagers, to produce a side force operable to counteract the side force acting on the tillage apparatus associated with the side tilt angle.

In another aspect of the disclosure, there is provided a method for compensating for sideways force acting of an agricultural apparatus located on a transversely side sloped ground surface, the agricultural apparatus comprising a frame and a plurality of wheeled support units, each of the plurality of wheeled support units having at least one wheel mounted for rotation about a wheel axis and the at least one wheel operable to contact the ground surface, the wheel of at least one wheeled support unit of the plurality of wheeled support units being rotatable about a generally vertical steering axis; wherein the method comprises: receiving at a control system at least one wheel steering angle rotation signal from a wheel steering angle rotational sensor, the at least one wheel steering angle rotation signal representative of a steering angle of the wheel about the steering axis; receiving at the control system, at least one frame orientation signal from a frame orientation sensor, the at least one frame orientation signal representative of a side tilt angle of the frame; based on the frame orientation signal and the at least one wheel steering angle rotation signal received by the control system, causing the control system to determine whether to activate a side tilt counteracting mechanism to counteract the sideways force acting on the agricultural apparatus associated with the side tilt angle; based on the frame orientation signal and the at least one wheel rotational signal received by the control system, the control system determines whether to activate the side tilt counteracting system to generate the side force operable to counteract the sideways force acting on the agricultural apparatus associated with the side tilt angle.

In another aspect of the disclosure, there is provided a system comprising: an agricultural apparatus comprising a frame supported by a plurality of support units operable to support the frame for movement on a ground surface; a control system; an orientation sensor operable to provide to the control system an orientation signal indicative of a side tilt angle of the ground surface upon which the frame is supported; wherein the control system is operable is operable to determine if the side tilt angle is above a threshold angle, and in response to determining that the side tilt angle is above the threshold angle, to generate and send control signals to operate a side tilt counteracting system to counteract the sideways force on the agricultural apparatus associated with the side tilt angle.

In another aspect of the disclosure, there is provided a system comprising: an agricultural apparatus comprising a frame supported by a plurality of support units operable to support the frame for movement on a ground surface; a control system; an orientation sensor operable to provide to the control system an orientation signal indicative of a side tilt angle of the ground surface upon which the frame is supported; wherein the control system is operable is operable to, based on the side tilt angle, generate and send control signals to operate a side tilt counteracting system to counteract the sideways force on the agricultural apparatus associated with the side tilt angle.

In another aspect of the disclosure, there is provided an agricultural apparatus comprising: a frame; at least one wheeled support unit supporting the frame, the at least one wheeled support unit comprising at least one wheel mounted for rotation about a wheel axis, the at least one wheel operable to contact the ground surface, the at least one wheel operable to rotate about a generally vertical steering axis, the at least one wheeled support unit operable to support the frame on a ground surface; an actuation system operable to adjust a steering angle of the at least one wheel about the steering axis.

In another aspect of the disclosure, there is provided an agricultural system comprising: (1) a tillage apparatus comprising a frame; at least one wheeled support unit connected to the frame, the at least one wheeled support unit comprising at least one wheel operable to rotate about a steering axis; a tillage apparatus actuation system operable to adjust a steering angle of the at least one wheel about the steering axis. (2) a seed cart interconnected to said tillage apparatus, said seed cart comprising a frame; at least plurality of wheeled support units connected to the frame, each of the plurality of wheeled support units comprising at least one wheel operable to rotate about a steering axis; a seed cart actuation system operable to adjust a steering angle of at least one wheeled support unit of the plurality of wheeled support units about its respective steering axis.

### BRIEF DESCRIPTION OF THE DRAWINGS

In drawings which illustrate embodiments of the invention,

FIG. 1 is a perspective view of a frame section of an agricultural implement according to an example embodiment of the present disclosure;

FIG. 1A is a top plan view of the agricultural implement of FIG. 1;

FIG. 1B is a top plan view of the agricultural implement of FIG. 2, with additional components indicated;

FIG. 1C is an enlarged rear perspective view of another portion of the agricultural implement shown in FIG. 1

FIG. 1D is an enlarged rear view of another portion of the agricultural implement shown in FIG. 1;

FIG. 1E is an enlarged view of a region of FIG. 1E;

FIG. 2A is a perspective view of a frame section of the agricultural implement of FIG. 1;

FIG. 2B is a top plan view of the frame section of FIG. 2A with the rear wheeled support units in a first position;

FIG. 2C is another top plan view of the frame section of FIG. 2A, with the rear wheeled support units in a second position and some components omitted for clarity;

FIG. 2D is another top plan view of the frame section of FIG. 2A, with the rear wheeled support units in a third position and some components omitted for clarity;

FIG. 2E is a rear view of the frame section of FIG. 2A;

FIG. 2F is another rear view of the frame section of FIG. 2A, with the rear wheeled support units in the second position and with some components omitted for clarity;

FIG. 2G is rear perspective view of a portion of the frame section of FIG. 2A;

FIG. 2H is a schematic view of the layout of a hydraulic fluid system for controlling the upward and downward movement of height adjustment cylinders associated with rear wheeled support units of the agricultural implement of FIG. 1;

FIG. 2I is bottom perspective view of a portion of the frame section of FIG. 2A;

FIG. 2J is a enlarged view of a portion of the frame section of FIG. 2I;

FIGS. 3A, 3B and 3C is a top plan, front perspective and rear perspective views of a steerable rear wheeled assembly of the agricultural implement of FIG. 1;

FIG. 4A is an enlarged front perspective view of FIG. 2A, showing a front wheeled support unit;

FIG. 4B is an enlarged view of a region of FIG. 4B;

FIG. 4C is a side view of the frame section of FIG. 2A;

FIG. 4D is a schematic view of part of the frame section of FIG. 4C shown in a generally level orientation;

FIG. 4E is a schematic view of the part of the frame section of FIG. 4D shown in a side tilted orientation;

FIGS. 5A and 5B are front perspective and rear perspective and front perspective views of a left-side rear wheeled support unit of the steerable rear wheeled assembly of FIGS. 3A-C;

FIGS. 5C and 5D are exploded front perspective views of the left-side rear wheeled support unit of FIGS. 5A-B;

FIG. 5E is an exploded rear perspective view of the left-side rear wheeled support unit of FIGS. 5A-B;

FIG. 5F is a perspective view of a component of the left-side rear wheeled support unit of FIGS. 5A-B;

FIG. 5G is a perspective view of another component of the left-side rear wheeled support unit of FIGS. 5A-B;

FIG. 5H is a side view of the left-side rear wheeled support unit of FIGS. 5A-B;

FIGS. 6A and 6B are front perspective and rear perspective views of a walking beam of the left-side rear wheeled support unit of FIGS. 5A-B;

FIG. 6C is a front perspective view of a walking beam of the left-side rear wheeled support unit of FIGS. 5A-B with a lower pivot pin installed;

FIG. 6D is a partial cross-sectional view of the walking beam of FIGS. 6A to 6B.

FIGS. 7A and 7B are front perspective and rear perspective views of a pivot pin assembly of the left-side rear wheeled support unit of FIGS. 5A-B;

FIG. 7C is a front perspective view of the pivot pin assembly of FIGS. 7A-B with some components omitted;

FIG. 7D is a front perspective view of the pivot pin assembly of FIGS. 7A-B with some components omitted;

FIG. 7E is a perspective view of an upper pivot pin of the pivot pin assembly of FIGS. 7A-B;

FIGS. 8A and 8B are front perspective and rear perspective views of a steering hub of the left-side rear wheeled support unit of FIGS. 5A-B;

FIGS. 9A and 9B are enlarged views of the of the left-side rear wheeled support unit of FIGS. 5A-B;

FIG. 9C is a top plan view of the left-side rear wheeled support unit of FIGS. 5A-B, orientated in a first position;

FIG. 9D is a top plan view of the left-side rear wheeled support unit of FIGS. 5A-B, orientated in a second position;

FIG. 9E is a top plan view of the left-side rear wheeled support unit of FIGS. 5A-B, orientated in a third position;

FIGS. 10A and 10B are rear perspective and front perspective and front perspective views of a right-side rear wheeled support unit of the steerable rear wheeled assembly of FIGS. 3A-C;

FIG. 10C is a top plan view of the right-side rear wheeled support unit of FIGS. 10A-B, orientated in a first position;

FIG. 10D is a top plan view of the right-side rear wheeled support unit of FIGS. 10A-B, orientated in a second position;

FIG. 10E is a top plan view of the right-side rear wheeled support unit of FIGS. 10A-B, orientated in a third position;

FIG. 11A is a schematic view of a control system for a steerable rear wheeled assembly of the present disclosure with the hydraulic pistons in a first position;

FIG. 11B is a schematic view of a control system for a steerable rear wheeled assembly of the present disclosure with the hydraulic pistons in a second position;

FIG. 11C is a schematic view of a control system for a steerable rear wheeled assembly of the present disclosure with the hydraulic pistons in a third position;

FIG. 12 is a flowchart of a process for controlling a steerable rear wheeled assembly of the present disclosure during operation;

FIGS. 13A and 13B are rear and top plan view of the agricultural implement shown in FIG. 1 during a first mode of operation;

FIGS. 14A and 14B are rear and top plan view of the agricultural implement shown in FIG. 1 during a second mode of operation;

FIGS. 15A and 15B are rear and top plan view of the agricultural implement shown in FIG. 1 during a third mode of operation;

FIG. 16 is a perspective view of an air seed cart according to an example embodiment of the present disclosure;

FIG. 16A is a perspective view of a steering assembly of the air seed cart of FIG. 16;

FIGS. 16B and 16C are top and bottom plan views of the steering assembly of FIG. 16A;

FIGS. 16D and 16E are side and rear views of the steering assembly of FIG. 16A;

FIGS. 17A-C are front, rear and bottom perspective views of a portion of the steering assembly of FIG. 16A, with some components removed for clarity;

FIG. 17D is a perspective view of a portion of the steering assembly of FIG. 16A;

FIG. 18 is a perspective view of the left-side wheeled support unit of the steering assembly of FIG. 16A;

FIG. 19 is a perspective view of the right-side wheeled support unit of the steering assembly of FIG. 16A;

FIG. 20 is a schematic view of a control system for the steering assembly of the FIG. 16A;

FIG. 21 is a flowchart of a process for controlling the steering assembly of the FIG. 16A;

FIG. 22 is a top plan view of the agricultural implement shown in FIG. 1 and the air seed cart of FIG. 16 during a first mode of operation;

FIG. 23 is a top plan view of the agricultural implement shown in FIG. 1 and the air seed cart of FIG. 16 during a second mode of operation.

FIG. 24 is a top plan view of the agricultural implement shown in FIG. 1 and the air seed cart of FIG. 16 during a third mode of operation;

FIG. 25 is a top plan view of the agricultural implement shown in FIG. 1 and the air seed cart of FIG. 16 during a fourth mode of operation;

FIG. 26 is a top plan view of the agricultural implement shown in FIG. 1 and the air seed cart of FIG. 16 during a fifth mode of operation;

FIG. 27 is a perspective view of a tillage apparatus and a propulsion unit according to another embodiment;

FIG. 27A is a side view of a portion of the apparatus of FIG. 27;

FIG. 27B is a top plan view of the apparatus of FIG. 27 with apparatus aligned with a direction of travel;

FIG. 27C is a top plan view of the apparatus of FIG. 27 with apparatus having drifted/skidded so it is not aligned with a direction of travel;

FIG. 27D is a view of a portion of an apparatus similar to the apparatus of FIG. 27A;

FIG. 28 is an enlarged perspective view of a part of the portion shown in FIG. 27A of the apparatus of FIG. 27;

FIG. 29 is an enlarged side view of a part of the portion shown in FIG. 27A of the apparatus of FIG. 27;

FIG. 30 is an enlarged side view of a part of the portion shown in FIG. 27A of the apparatus of FIG. 27;

FIG. 31 is an enlarged side view of a part of the apparatus portion shown in FIG. 27A of the apparatus of FIG. 27;

FIG. 32 is an enlarged perspective view of a rear wheeled support unit part of the apparatus portion shown in FIG. 27A;

FIG. 33 is a schematic view of a control system for the tillage apparatus illustrated in FIG. 27; and

FIG. 34 is a flowchart of a process for controlling the pitch control system of FIG. 33.

### DETAILED DESCRIPTION

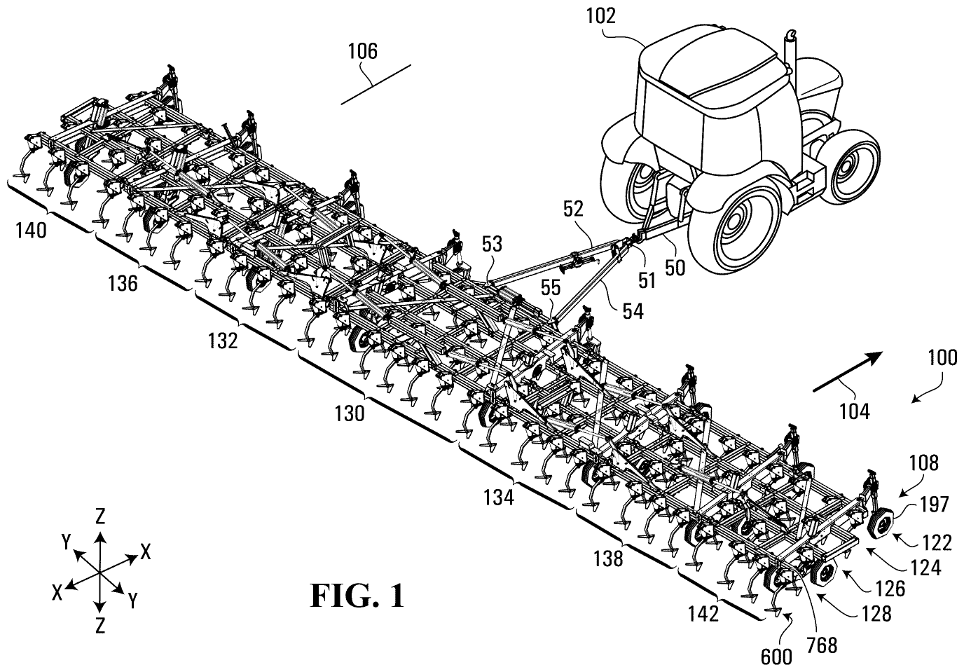

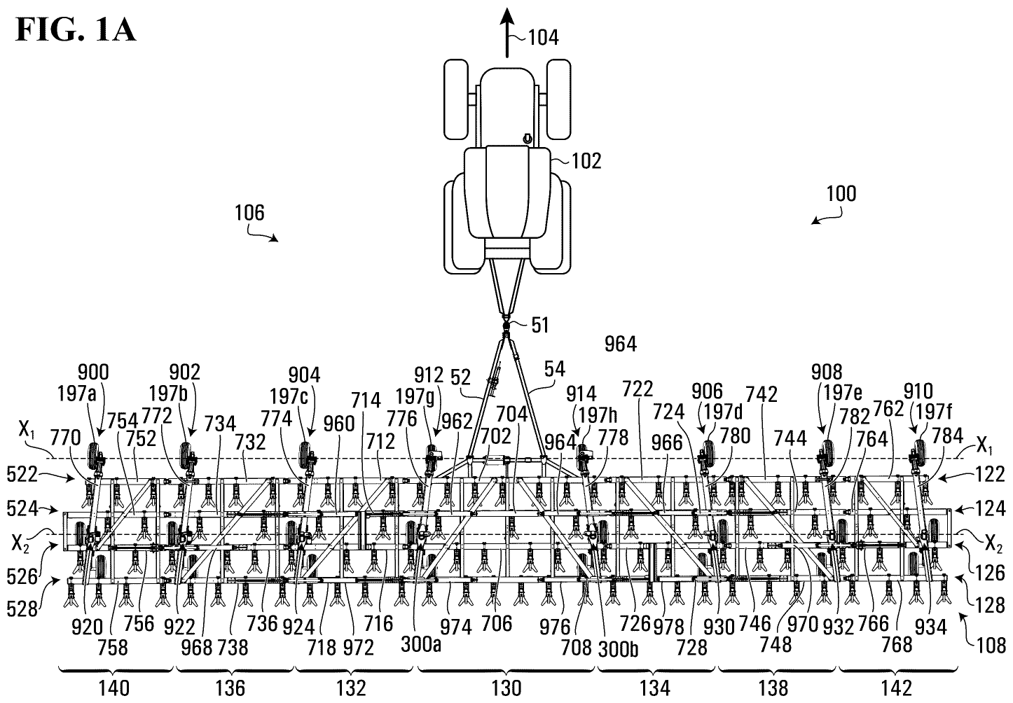

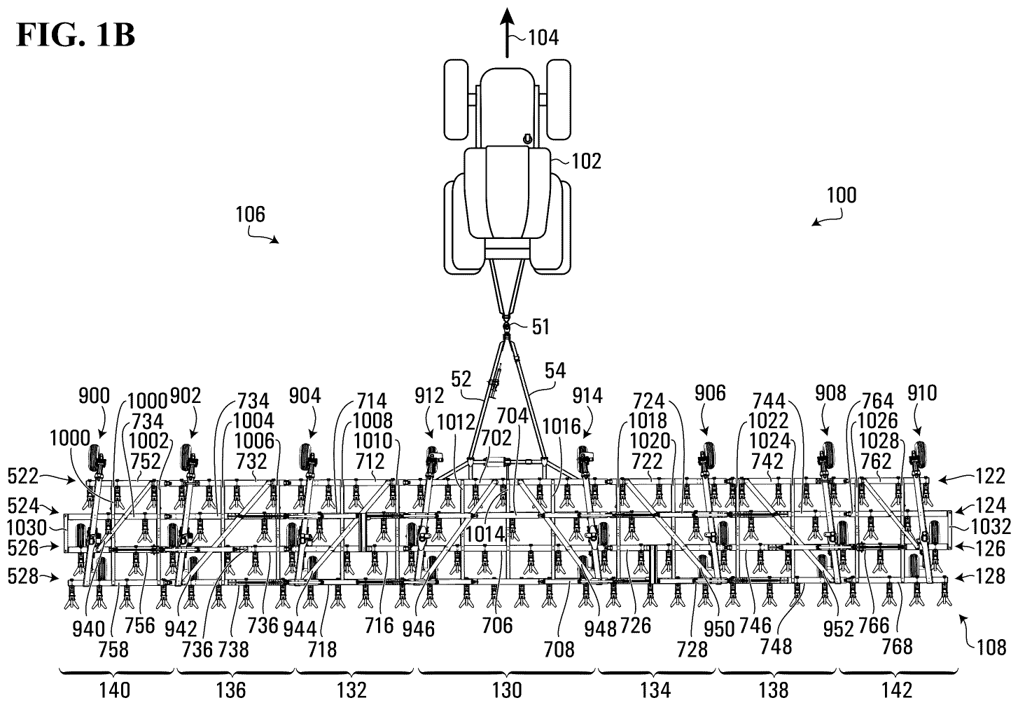

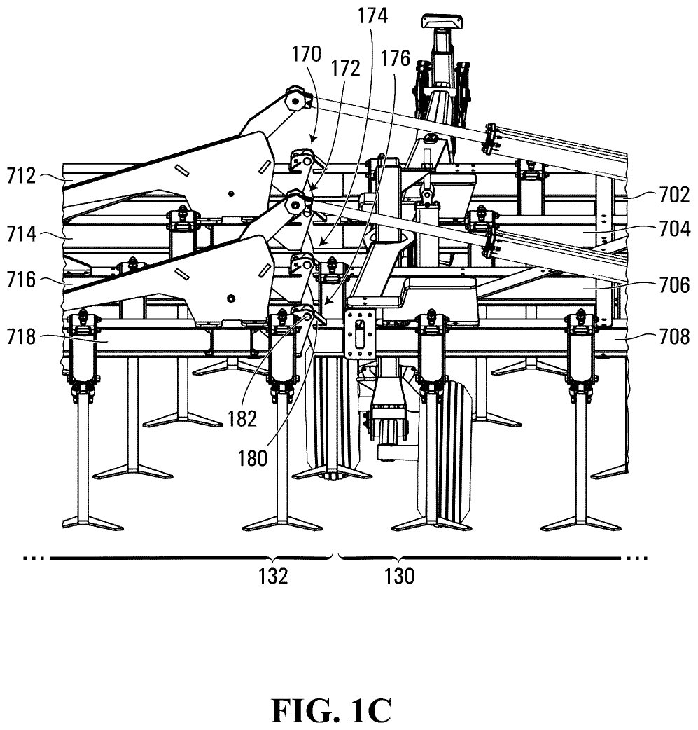

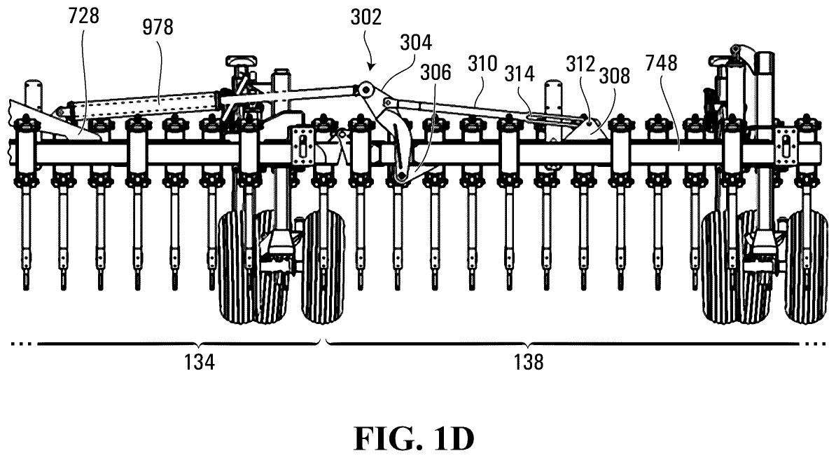

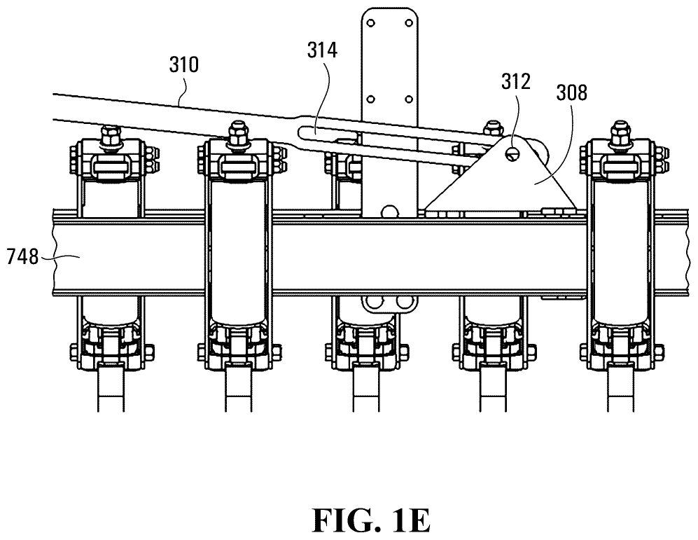

Referring FIGS. 1 and 1A, an agricultural implement 100 in accordance with one example embodiment of the present disclosure is shown. Agricultural implement 100 may generally be any type of agricultural implement for treating and/or preparing ground surface 106, including tilling and seeding operations. In the example embodiment shown in FIG. 1, agricultural implement 100 may be a tillage apparatus which may be pulled behind a propulsion unit 102 in a direction of travel denoted by arrow 104 across a ground surface 106. Agricultural implement 100 may be interconnected to another mobile agricultural apparatus such as a cart, such as an air seed cart (not shown in FIG. 1) for use in storing and distributing seed and/or fertilizer. In operation, as agricultural implement 100 moves across ground surface 106, a plurality of ground engagers may engage with and/or condition the surface 106 as it is moved in the direction of travel. One of the plurality of ground engagers is denoted at 600 in FIG. 1 for exemplary purposes. In some embodiments, mobile agricultural apparatus such as an air seed cart (not shown) may be moved with (e.g. towed behind) agricultural implement 100 and be operable and configured to supply and distribute seeds and/or fertilizer through a network of tubing (not shown) to the prepared surface 106 after treatment by the ground engagers. In some embodiments, seeds may be delivered through tubing to the ground engagers themselves, and the ground engagers may be configured to deliver seeds to a correct depth/position within the soil material as the agricultural implement moves across the ground surface 106. In other embodiments, seeds may be delivered through tubing to separate seeding devices that are positioned adjacent to the ground engagers and these separate seeding devices may be configured to deliver seeds to a correct depth/position within the soil material as the agricultural implement 100 moves across the ground surface 106. In various embodiments agricultural implement 100 may include ground engagers such as disks, chisel plows, seed drills, harrow tines, openers, packers as well as other ground engaging tools or devices or any combination thereof.

Propulsion unit 102 may be a known type of tractor, which may be configured and adapted to pull agricultural implement 100 via a rearwardly positioned tow hitch 50 on propulsion unit 102. In some embodiments, tow hitch 50 may be operable to be moved/pivot upwards and downwards to a limited extent, at the rearward end of two hitch 50, relative to propulsion unit 102. In some embodiments, tow hitch 50 may be configured to pivot/move in a transverse direction (direction Y in FIG. 1) to a limited extent at the rearward end of tow hitch 50 relative to the propulsion unit 102. In other embodiments, tow hitch 50 may, at least during operation, be fixed in space relative to propulsion unit 102. In some embodiments, the movement/pivoting motion of tow hitch 50 may actively powered./controlled/steered/moved by a control system of propulsion unit 102. In some embodiments, the height of the rearward end of tow hitch 50 relative to the ground surface may be adjustable by operation of actuators controlled from the propulsion unit.

### Implement Tow Hitch Connection to Propulsion Unit—Range of Motion

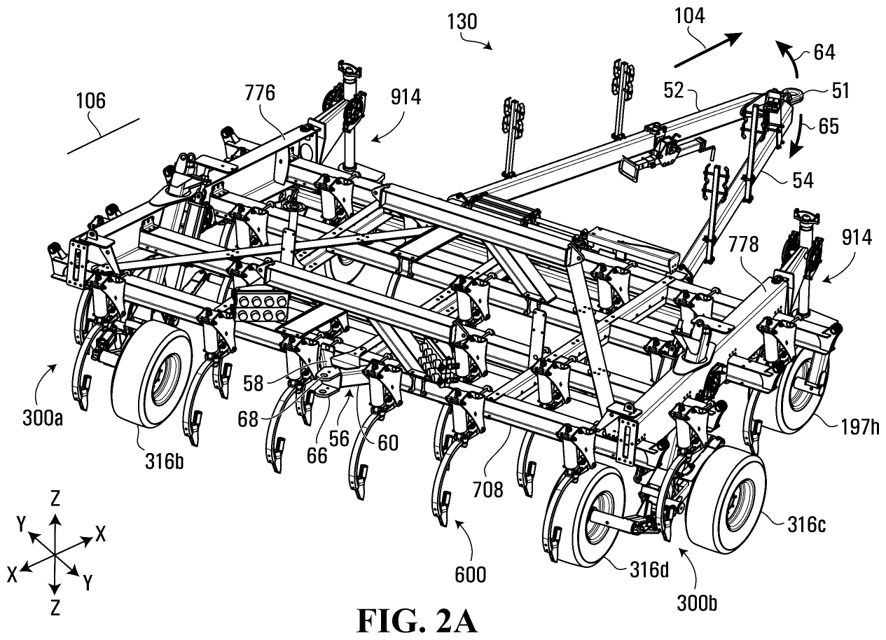

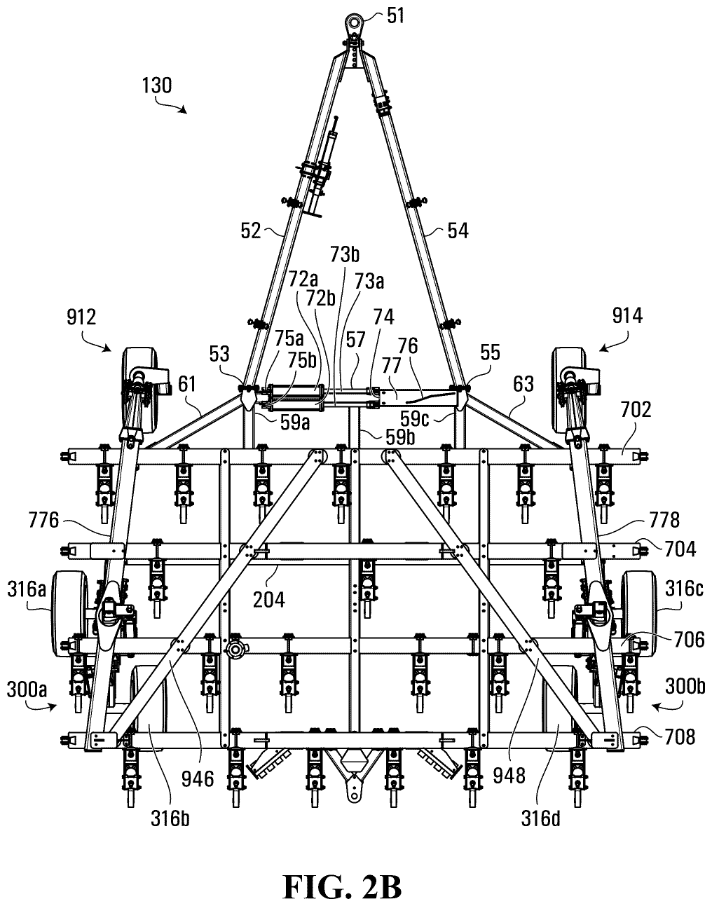

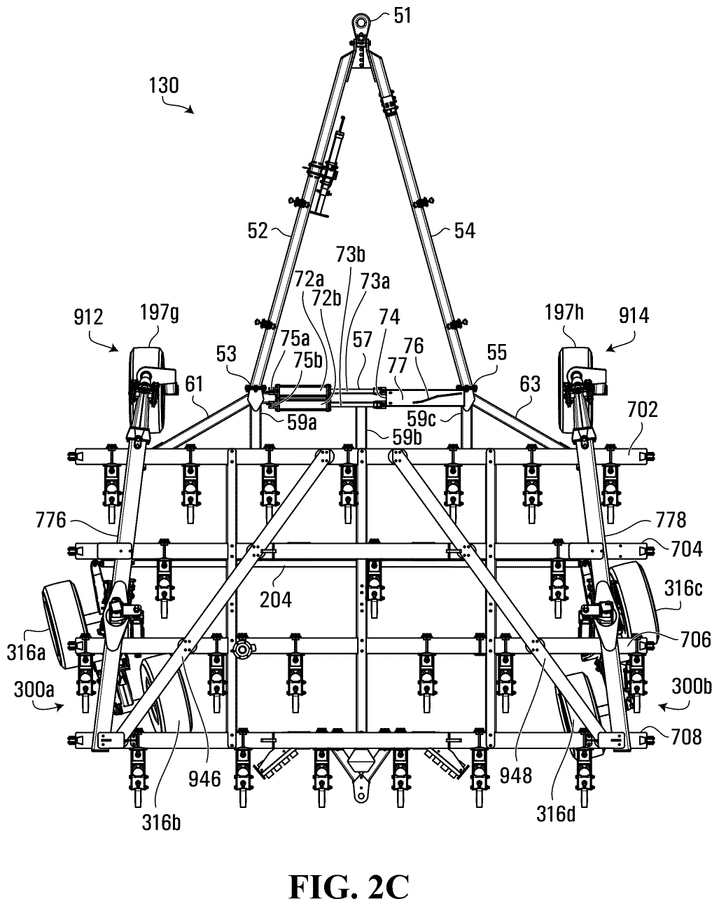

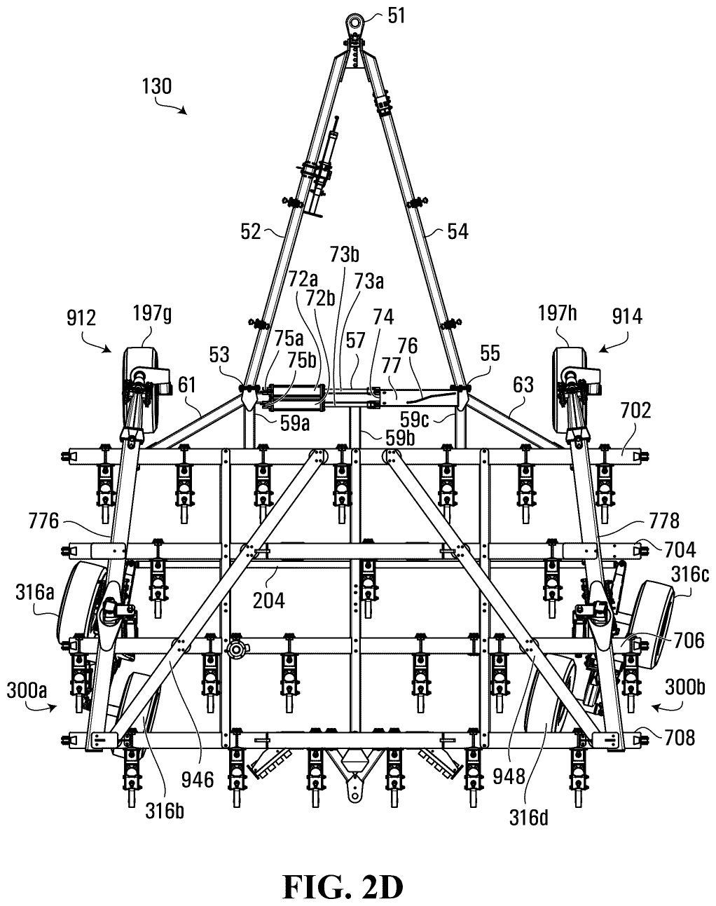

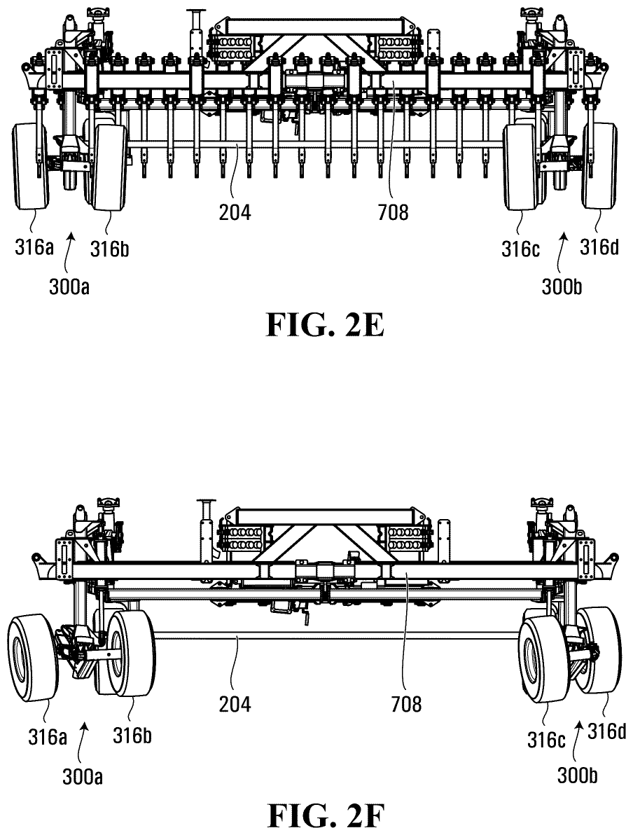

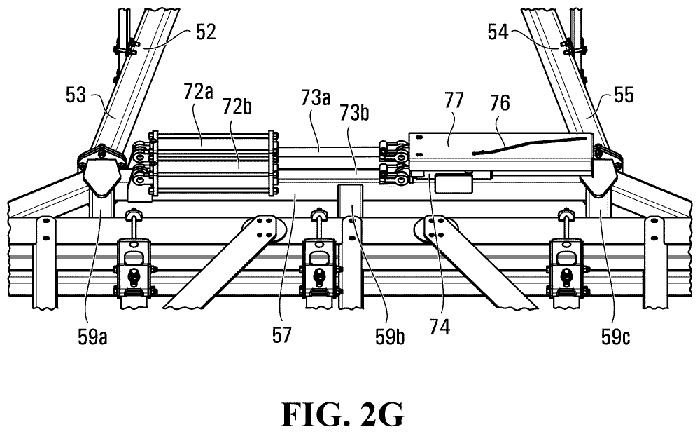

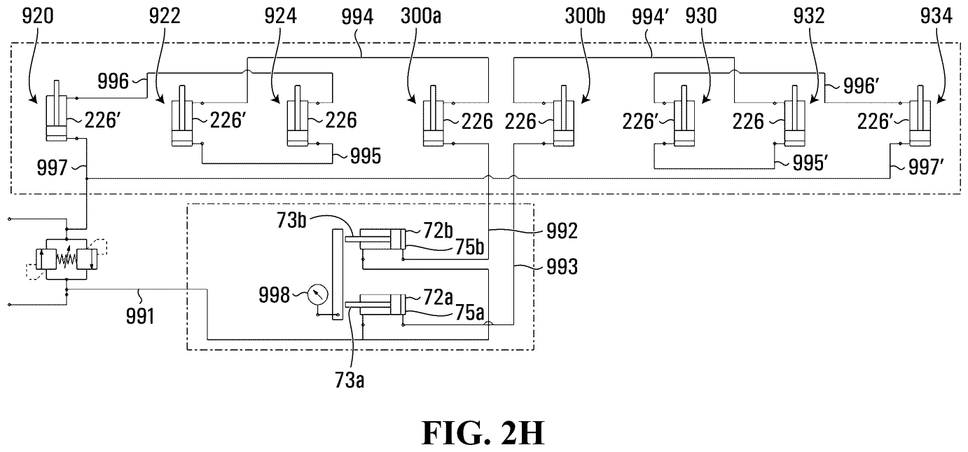

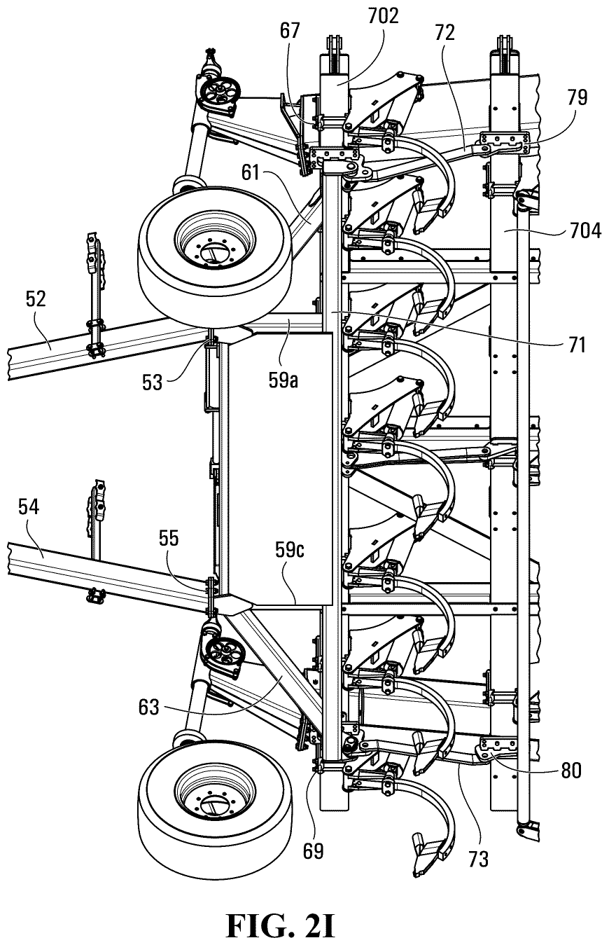

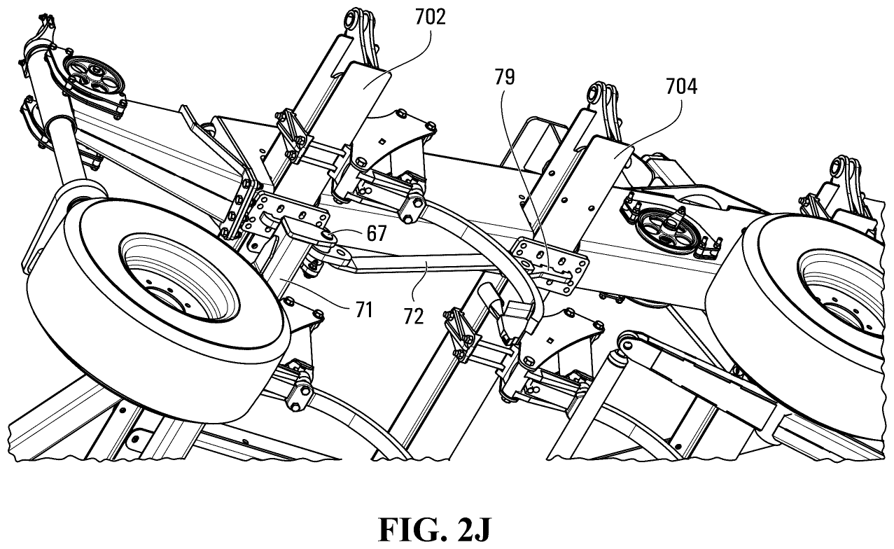

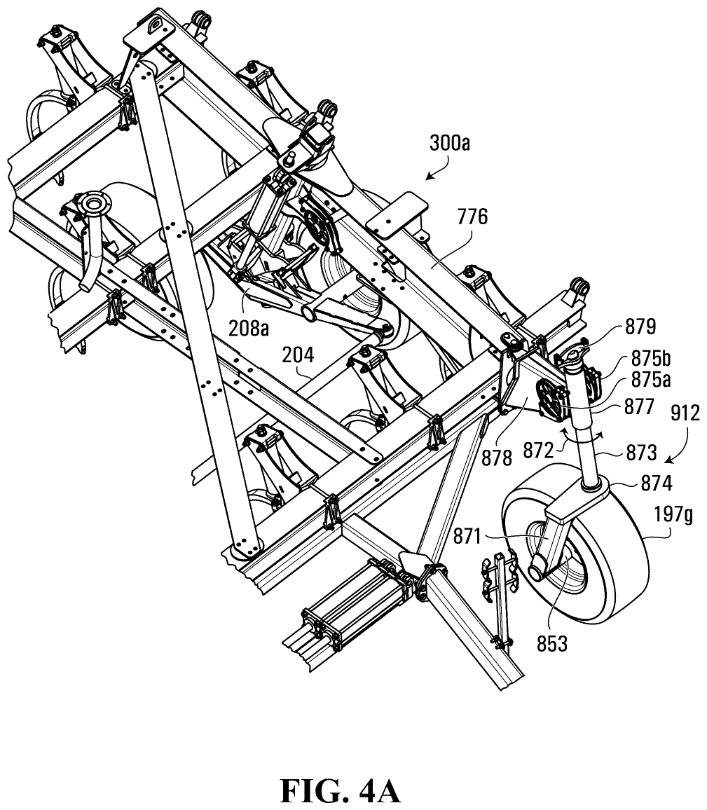

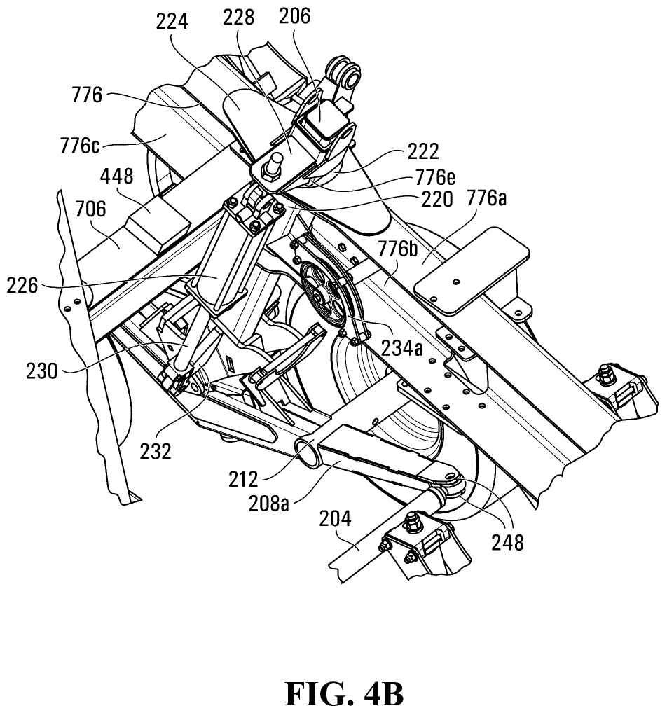

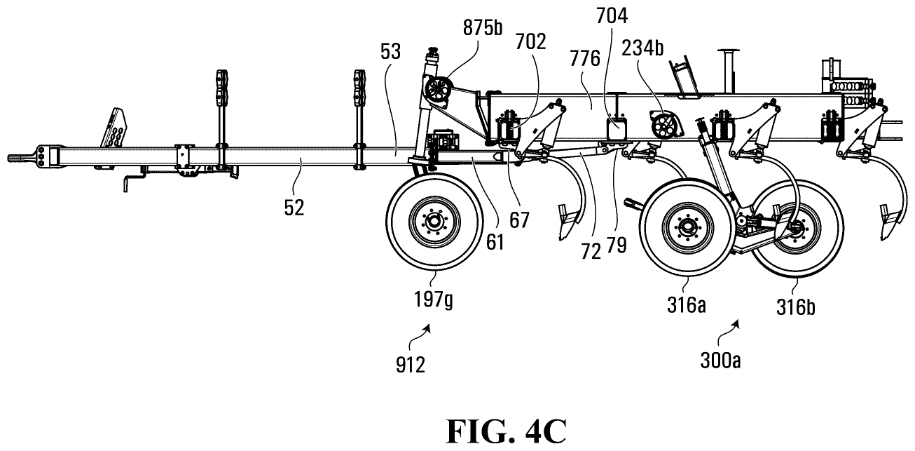

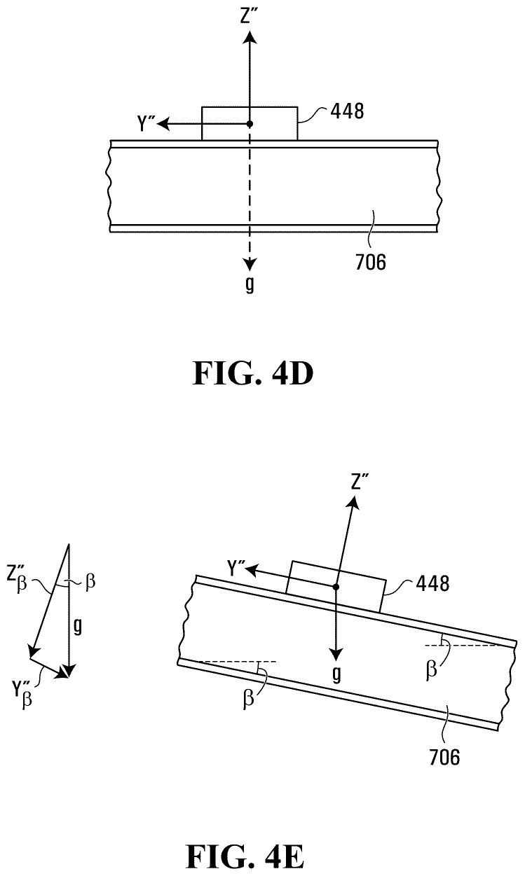

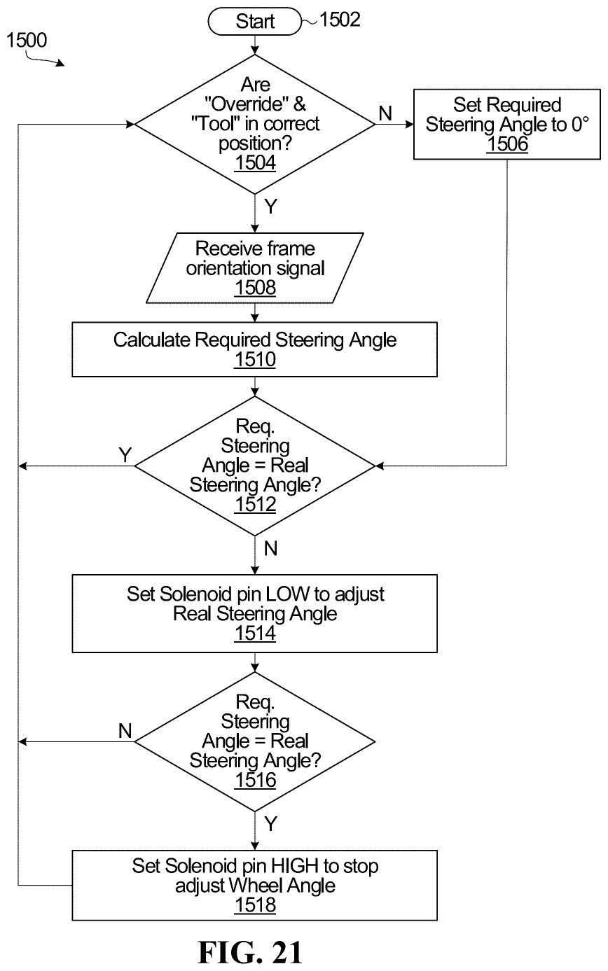

Tow hitch 50 can be connected to a receiver 51 of agricultural implement 100, shown in greater detail in FIG. 1A at the forward distal end region of towing members 52 and 54 of agricultural implement 100. The connection between receiver 51 and tow hitch 50 may be a pintle/ring type connection that may allow for some limited degree of vertical translation movement of the receiver ring relative to the pintle, and also allow some degree of rotation/pivoting movement of the ring (and tow members 52, 54 secured thereto), about vertical, transverse and longitudinal axes passing through the connection between receiver 51 and tow hitch 50. Towing members 52 and 54 may be rigidly connected (such as through bolting) at their respective rearwards ends 53 and 55 to a transversely orientated member 57 (FIG. 2B). With reference to FIGS. 2G, 2I and 2J, member 57 may in turn be rigidly affixed to a transversely orientated member 71 via longitudinally orientated members 59a, 59b, 59c and diagonally orientated members 61, 63 (FIG. 2B). Member 71 may generally be positioned parallel to and below transverse member 702 and be pivotally interconnected to member 702 via respective hinges 67, 69 (FIGS. 21 and 2J). As shown in FIG. 4C, a pair of support arms 72, 73 may also extend from the rear of member 71 and be pivotally interconnected to the lower face of transverse member 704 by respective hinges 79, 80. Hinges 67, 69 are oriented to provide pivoting movement of towing members 52, 54 at their rearward ends relative to transversely oriented member 702 about a common transverse axis passing through hinges 67, 69.

Through this arrangement, the forwards ends (i.e. at receiver 51) of members 52 and 54 may be able to move up and down to some limited degree on the pintle, and also members 52, 54, are able to rotate/pivot to a limited extent about a transverse axis (direction Y) through the pintle/ring connection, in an arc, in the directions indicated by arrows 64 and 65 in FIG. 2A. The members 52 and 54 are also able to rotate/pivot horizontally to a fairly significant extent, about a vertical axis (direction Z in FIG. 2A) at such a pintle/ring connection. Furthermore, the rearward ends 53, 55 may pivot to some extent relative to transverse member 702 about a transverse axis (direction Y in FIG. 2A) passing through hinges 67, 69 respectively, typically in the range of about 20 degrees in an upwards direction and about 45 degrees in a downwards direction, about a transverse axis.

Thus, the connection between tow hitch 50 and receiver 51 is typically not a rigid connection, but may be a loosely coupled connection such as a ring and pintle hook connection.

Towing members 52, 54 may be closed or open channeled beam members that may be made from a suitably hard and strong material such as a steel such as by way of example a suitable structural steel. In some applications, A36 mild steel, which is considered a structural steel with a yield strength of about 60K psi, may be employed. Stronger structural steels with higher yield strengths (e.g. 80-100K psi) may be employed in other embodiments, depending upon expected operational and design loads.

In various embodiments, propulsion unit 102 may be another vehicle capable of moving agricultural implement 100 and may include a propulsion unit operable to move agricultural implement 100 from one operational location to another operational location, such as a truck. In some embodiments, propulsion unit 102 may be integrated with agricultural implement 100.

### Implement Frame Support and Height Adjustment

Referring to FIGS. 1 and 1A, agricultural implement 100 may include a frame 108 (FIG. 1) also known as a support frame) that includes a plurality of components. Frame 108 may be adapted to be supported for movement on the ground surface 106 by a plurality of frame support units (FIG. 1) such as a plurality of front (or forward) wheeled support units 900, 902, 904, 906, 908, 910, 912, 914 (with wheels 197 generally aligned along a forward transverse wheel axis X1 for implement 100 to traverse in the direction of travel indicated by arrow 104 [FIG. 1A]) and a plurality of rear wheeled support units 300a, 300b, 920, 922, 924, 930, 932, 934 each having one, two or more wheels 197 (that typically include round rubber compound tires (or tires made of other materials that provide a suitable frictional contact with a terrain surface) mounted on round strong metallic rims and are operable for free rotation about a generally transversely oriented wheel axis of rotation on respective axles 212, 216.

Mounted on a wheel hub/axle for free rotation about a generally transversely oriented wheel axis of rotation. The wheels 197 of the front wheeled support units and the rear wheeled support units may be of substantially the same diameter and may for example be in the range of 30 to 32 inches in diameter in various embodiments. The rear wheeled support units may be generally aligned along a rearward transverse wheel axis X2. This will allow the agricultural implement to be relatively easily moved across a ground surface 106 (FIG. 1) during operation. Both front wheeled support units 900, 902, 904, 906, 908, 910, 912, 914 and rear wheeled support units 300a, 300b, 920, 922, 924, 930, 932, 934 may be variable height wheeled support units relative to frame 108. For example, one or both sets of rear and front wheeled support units may be associated with and interconnected to various hydraulic cylinders controlled by a pressurized hydraulic fluid supply and control system to permit the height of the frame 108 relative wheels 197 and relative to the ground surface to be adjusted. An example of such an arrangement that provides for height adjustment of both front and rear wheeled support units is disclosed in U.S. Pat. No. 11,122,725 B2 the entire contents of which is hereby incorporated herein by reference. As will be referenced further hereinafter, in some embodiments, some of the hydraulic cylinders of the rear wheeled units rear wheeled support units 300a, 300b, 920, 922, 924, 930, 932, 934 may be variable height wheeled support units relative to frame 108 in which the height of frame 108 is raised by extension of the piston rods of the hydraulic cylinders, while others of the hydraulic cylinders of the rear wheeled units rear wheeled support units may be provided with linkages such that retraction of the piston rods of those hydraulic cylinders results in the raising of the height of the frame 108.

### Flexible Implement Frame May Be Braced For Working Loads

Referring again to FIGS. 1 and 1A, frame 108 (which may be constructed in a manner like that disclosed in U.S. Pat. No. 11,122,725 B2) may include rows 122, 124, 126, and 128 of transversely oriented (in direction Y in FIG. 1) and longitudinally spaced structural transverse members interconnected to a plurality of generally longitudinally oriented (generally in the direction X in FIG. 1) and transversely spaced structural longitudinal members 770, 772, 774, 776, 778, 780, 782 and 784. The rows of transverse members 122, 124, 126, 128 may support a plurality of rows of ground engagers. For example, rows of ground engagers 522, 524, 526, 528 may be coupled to each of the rows of transverse members 122, 124, 126, 128 respectively. Longitudinal members 770, 772, 774, 776, 778, 780, 782 and 784 may be orientated at a small angle (for example in the range of 5 to 10 degrees) in relation to a longitudinal axis (in the X direction in FIG. 1), such that the front ends of the longitudinal members are closer to the center of frame 108 than their rear ends. In a specific embodiment, longitudinal members 770, 772, 774, 776, 778, 780, 782 and 784 are orientated 7 degrees from a longitudinal axis (in the X direction in FIG. 1). This may be beneficial in preventing each of the frame sections 130, 132, 134, 136, 138, 140, 142 of frame 108 from trapezoid deformation (collapsing) when subjected to loads, particularly during operation. Further, the angled orientation of longitudinal members 770, 772, 774, 776, 778, 780, 782 and 784 assist in transversely spacing wheels 197 of front wheeled support units 900, 902, 904, 906, 908, 910, 912, 914 and wheels of rear wheeled support units 300a, 300b, 920, 922, 924, 930, 932, 934 from one another, as described above. Additionally, this angling of longitudinal members 770, 772, 774, 776, 778, 780, 782 and 784 may allow optimal spacing of the ground engagers 600 on frame 108, such that multiple wheels 197 do not pass over the same area of ground surface 106, whilst providing the ability to position ground engagers 600 in different rows that will enable full coverage of the surface area beneath the frame 108. This angling of longitudinal members 770, 772, 774, 776, 778, 780, 782 and 784 may also assist in providing sufficient space for the range of motion of the wheels 197 of the front and rear wheeled supports.

Each of the structural transverse and longitudinal frame members described above may be an open channel member that has a substantial amount of flexibility (particularly as compared to a closed channel member of comparable wall thickness dimensions and made from a comparable material) when, in operation, it is subjected to a twisting force about a longitudinal axis (in the X direction) of the member. Each of the structural transverse and longitudinal members may include a web portion and may have at least one flange defining at least one open recess/channel along a length of the open member. The open transverse and longitudinal members may be “wide flange” members which have flanges that have a greater thickness than the thickness of the connecting central web. For example, the flanges may have a thickness of about ¼ inch which the central web may have a thickness of about 3/16 inch.

Frame 108 may comprise a plurality of frame sections such as a central frame section 130, left and right inner frame sections 132 and 134, left-center and right-center frame sections 136 and 138 and left and right outer frame sections 140 and 142. The transverse members in rows 122, 124, 126, and 128 and the longitudinal members 770-784 may be made from one or more suitable materials such as a structural steel like A36 mild steel.

Inwardly positioned, central section, right and left side wheeled support units 912, 914 may be mounted to main inner open longitudinal members 776 and 778 respectively to support central section 130 of frame 108. Front wheeled supports 912, 914 may act in conjunction with right and left side rear wheeled support units 300a, 300b to substantially provide support on the ground surface 106 (FIG. 1) for central frame section 130, and also for left and right inner frame sections 132 and 134, left-center and right-center frame sections 136 and 138 and left and right outer frame sections 140 and 142 of frame 108 when those sections on either side of central section 130 have been pivoted to an elevated transport mode. Right and left front wheeled supports 912, 914 of frame 108 may be a swivel caster wheel configuration (such as for example as disclosed in U.S. patent application Ser. No. 17/349,204 filed on Jun. 16, 2021 and published as United States patent publication no. US 2022/0400595 on Dec. 22, 2022 (the entire contents of which are hereby incorporated herein by reference) and may be mounted to longitudinal frame members 776, 778 respectively to allow for substantially 360-degree free revolving rotation about a generally vertical steering axis of their respective wheels 316a, 316b, to allow the agricultural implement to be maneuvered in relatively tight turns when in a transport configuration. For these swivel caster assemblies there may be a horizontal offset distance between the horizontal axis of rotation of the wheel and the corresponding vertical steering axis of rotation (also known as the rake angle). Additionally, or alternatively, swivel caster assemblies may be provided for front wheeled support units 912, 914 in which there is a “caster angle” that provides an angular displacement of the steering axis, from a vertical axis in the X direction, such that the axis of rotation of the steering axis is angled downwardly to intersect the ground surface in front of the contact location of the wheel 197 on the ground surface 106 when the implement is moving forwards.

For outward frame sections 132-142, swivel caster assemblies may be also provided for the outward frame sections, front wheeled units 900-910 (also referred to as forward outward wheeled support units). Front wheeled supports 900-910 may (also as disclosed in United States Patent publication no. US 2022/0400595 on Dec. 22, 2022) be configured to provide limited rotation of their respective wheels 197a-f about their respective steering axes. In both types of swivel caster assemblies, so long as the intersection location of the wheel/tire on the ground surface is behind where the axis of rotation of the steering axis intersects the ground, during forward movement of implement 100, the wheels will always rotate to be oriented in the same direction.

It should be noted that given the level of weight carried by rear wheeled support units 300a, 300b, 920, 922, 924, 930, 932, 934, and to provide enhanced lateral stability, such wheeled support units may be double wheel units having two wheels 197 mounted transversely spaced and which may be aligned with each other on a common transverse wheel axis.

Agricultural implement 100 may be configured such that none of the wheels 197 of rear wheeled units will follow/track on the same path of movement as any other of the wheels 197 of the rear wheel units (i.e. there is not overlap in a Y axis direction of the path of any wheel 197 in the rear wheeled units). Also, in some embodiments, none of the wheels 197a-h of front wheeled support units 900, 902, 904, 906, 908, 910, 912, 914 are positioned at the same transverse location along a transverse axis in the Y direction as any of the wheels 197 of the rear wheeled support units 300a, 300b, 920, 922, 924, 930, 932, 934 (i.e. all or most of the front wheeled unit wheels are positioned at different locations in a Y-axis direction of FIG. 1 than the Y-axis direction locations of any of the wheels 197 of the rear wheeled units). Thus, none of the wheels 197 of rear wheeled units will follow/track on the same path of movement as any of the wheels 197a-h of the front wheeled units 900, 902, 904, 906, 908, 910, 912, 914. This may minimize/reduce repetitive compaction of the ground on surface 106 caused by multiple wheels passing over the same area of surface 106.

With reference to FIG. 1A, frame 108 may include open transverse members 702, 712, 722, 732, 742, 752 and 762 in front row 122, open transverse members 704, 714, 724, 734, 744, 754 and 764 in middle row 124, open transverse members 706, 716, 726, 736, 746, 756 and 766 in middle row 126, and open transverse members 708, 718, 728, 738, 748, 758 and 768 in rear row 128. The above-described open transverse members may generally be H-section beams (or H-section beam members) including a generally vertically oriented, longitudinally extending central web portion inter-connected or integrally formed with longitudinally extending, upper right and left side flanges, and lower left and right flanges. Such a member may be configured to be substantially equally flexible when subjected to twisting forces/torques in both rotational directions about an axis in the Y direction along its length.

Frame 108 of agricultural implement 100 may also include longitudinally oriented main row supporting open longitudinal members 770, 772, 774, 776, 778, 780, 782 and 784 which fixedly connect with transverse members in rows 122, 124, 126, and 128 of transverse members. For example, the longitudinal member 770 is fixedly connected to the open members 752-758, longitudinal member 772 is fixedly connected to transverse members 732-738, longitudinal members 776 and 778 are fixedly connected to transverse members 702-708, longitudinal member 780 is fixedly connected to transverse members 722-728, and longitudinal member 784 is fixedly connected to transverse members 762-768. In the embodiment shown, the open members 770-784 have generally C-shaped cross sections and may have their channels directed inwardly towards the center of frame 108.

Frame 108 may include pivotal connectors between each of the transversely adjacent frame sections 130/132; 132/136; 136/140; 130/134; 134/138; 138/142; that permit the adjacent frame sections to be pivoted relative to each other about axes oriented in a longitudinal direction X (FIG. 1). For example, pivotal connectors may be positioned in each row between the central frame section 130 and the left and right inner frame sections 132 and 134, between the left and right inner frame sections 132 and 134 and the left-center and right-center outer frame sections 136 and 138 and between the left-center and right-center outer frame sections 136 and 138 and the left and right outer frame sections 140 and 142. Each of the pivotal connectors may facilitate a pivotal connection between adjacent transverse open members such that the adjacent open members are operable to pivot to orientations generally parallel to a contour of the surface 106 when the agricultural implement 100 is moved across the ground surface 106.

Referring now to FIG. 1C, a rear perspective view of a representative portion of the central frame section 130 and a portion of the left inner frame section 132 of frame 108 is shown. Central frame section 130 of frame 108 includes transverse members 702, 704, 706, and 708. The left inner frame section 132 includes transverse members 712, 714, 716, and 718 which are pivotally connected to transverse members 702, 704, 706, and 708 via pivotal connectors 170, 172, 174, and 176 respectively. By way of example, the pivotal connector 176 includes first and second connector portions 180 and 182 which are welded to the open members 708 and 718 respectively, and pivotally inter-connected to facilitate a pivotal connection between the open members. Each of the pivotal connectors 170, 172, and 174 may each include generally similar features to that of the pivotal connector 176. This allows rotational torsion of the members to be transferred across the pivot connection.

Referring to FIG. 1B, frame 108 may also include longitudinally oriented, supplementary row supporting longitudinal members 1000, 1002, 1004, 1006, 1008, 1010, 1012, 1014, 1016, 1018, 1020, 1022, 1024, 1026 and 1028 which also fixedly connect the transverse rows 122, 124, 126 and 128 of transverse members. For example, longitudinal members 1000 and 1002 are connected to the transverse members 752, 754, 756, 758, longitudinal members 1008 and 1010 are fixedly connected to the transverse members 712, 714, 716, 718, longitudinal members 1012, 1014 and 1016 are fixedly connected to the transverse members 702, 704, 706, 708 and longitudinal members 1022, 1024 are fixedly connected to the transverse members 742, 744, 746, 748. Longitudinal members 1000-1028 may be formed from upper and lower generally L-shaped sections, with their vertical sections affixed together to form a generally C-shaped cross section.

Supplementary row supporting longitudinal members 1000, 1002, 1004, 1006, 1008, 1010, 1012, 1014, 1016, 1018, 1020, 1022, 1024, 1026 and 1028 may have vertical heights which are approximately the same as the vertical heights of the transverse members in transverse rows 122, 124, 126 and 128. However, the vertical heights (and widths) of longitudinal members 770-784 may be greater in size than the corresponding heights/widths of supporting longitudinal members 1000, 1002, 1004, 1006, 1008, 1010, 1012, 1014, 1016, 1018, 1020, 1022, 1024, 1026 and 1028 and of the transverse members in transverse rows 122, 124, 126 and 128. This may facilitate the rear wheeled support units 300a, 300b, 920, 922, 924, 930, 932, 934 being mounted to the open members through aligned openings in the upper and lower horizontal flanges of these members and the connection of front wheeled supports 900, 902, 904, 906, 908, 910, 912 and 914 to longitudinal members 770-784.

Referring again to FIG. 1B, frame 108 may also include open member diagonal load distribution members 940, 942, 944, 946, 948, 950, 952 and 954. The open member load distribution member 940 is fixedly connected to transverse members 752, 754 and 756, the open member load distribution member 942 is fixedly connected to transverse members 732, 734, 736 and 738, the open member load distribution member 942 is fixedly connected to the open members 712, 714, 716 and 718, the open member load distribution members 946 and 948 are fixedly connected to the open members 702, 704, 706 and 708, the open member load distribution member 950 is fixedly connected to the open members 722, 724, 726 and 728, the open member load distribution member 952 is fixedly connected to the open members 742, 744, 746 and 748, and the open member load distribution member 954 is fixedly connected to the open members 762, 764 and 766 In various embodiments, each of the open member load distribution members 940, 942, 944, 946, 948, 950, 952 and 954 may extend at an angle to the open members to which they are connected.

Each of the diagonal open member load distribution members 940, 942, 944, 946, 948, 950, 952 and 954 extends at an angle of between about 30 and 70 degrees relative to the open member to which they are connected. In the embodiment shown, the angle may be about 45 degrees. The load distribution members extending at angles to the open members in the rows 122, 124, 126, and 128 may facilitate lateral rigidity in the frame 108, reducing trapezoidal forces on the main frame assembly.

In the embodiment shown in FIG. 1B, open member load distribution members 940, 942, 944, 946, 948, 950, 952 and 954 may be formed from flat rectangular sections affixed to the top surfaces of structural open members in rows 122, 124, 126, 128 and row supporting members 1000, 1002, 1004, 1006, 1008, 1010, 1012, 1014, 1016, 1018, 1020, 1022, 1024, 1026 and 1028. For example, open member load distribution member 942 is affixed to the top surface of open members 732, 734, 736, 738 and row supporting member 1004.

Open member load distribution members 940, 942, 944, 946, 948, 950, 952 and 954 assist in distributing forces acting on the top flanges of each of the rows 122, 124, 126, and 128 of open members. The use of the open member load distribution members 940, 942, 944, 946, 948, 950, 952 and 954 prevents each of the frame sections 130, 132, 134, 136, 138, 140, 142 from trapezoid deformation (i.e. deforming/collapsing) under heavy loading, while at the same time allowing the frame sections to flex while the agricultural implement is operating over uneven ground surface 106.

The connections between the various longitudinal members, transverse members, and load distributions members may be made by various known techniques including welding, nut and bolt or rivet connections. In an embodiment, the connections between members are made by two-piece fasteners such as structural lock bolts.

Examples of a frame construction including connections between the various longitudinal members, transverse members, and load distribution members suitable for frame 108 is also disclosed in U.S. Pat. No. 11,122,725 B2.

### Implement Articulations and Operating Adjustments

The frame 108 of agricultural implement 100 may also include shorter end members 1030 and 1032 (FIG. 1B). Member 1030 is fixedly connected to the outer ends of open members 754 and 756 and member 1032 is fixedly connected to the outer ends of open members 764 and 766. The members 1030 and 1032 may have C-shaped cross sections.

Referring to FIGS. 1 and 1A, in various embodiments the agricultural implement 100 may include actuators 960, 962, 964, 966, 968, 970, 972, 974, 976 and 978 which are configured to stow and deploy portions of the agricultural implement 100 to reduce the width of the agricultural implement during transport, for example. Actuators may be hydraulic cylinders with actuating piston arms controlled by a hydraulic fluid supply system. When actuators 960, 962, 964, 966, 968, 970, 972, 974, 976 and 978 are in a fully retracted configuration, implement 100 may be held in a transport mode (or stowed configuration) in which frame sections 132, 134, 136, 138, 140, 142 may be folded up in a manner such that they are all supported by central frame section 130 and in which the overall transverse width of implement 100 is significantly reduced. In the transport mode, central frame section 130 may be the only frame section that is in contact with the ground surface 106, and may be capable of being moved on the ground surface supported by its front wheeled support units 912, 914 and rear support units 300a, 300b. As front wheeled support units 912, 914 are caster wheels that are fully 360 degrees rotatable about their generally vertical steering axis (as described further hereinafter), central frame section 130 may be relatively easily moved in a path that has tight turns. In the transport mode, frame sections 132, 134, 136, 138, 140, 142 may be supported only by central frame section 130 and move with central frame section 130. During tillage operations, the actuators may be fully extended (or deployed configuration, as shown in FIG. 1) and the frame sections may be able to freely rotate/pivot, about a longitudinal pivot axis relative to each other through the pivotal connectors, such as pivotal connectors 170, 172, 174, and 176) described above, as apparatus 100 is pulled across the ground surface 106. Thus, the frame sections may be operationally disengaged from the hydraulic cylinder pivot actuation mechanism to allow adjacent frame sections to freely pivot/float (or mechanically float) relative to each other as the apparatus 100 moves across an uneven ground surface.

The mechanical float of adjacent frame sections may be realized through a series of bell crank and scotch yoke mechanisms as known to those skilled in the art. A representative bell crank mechanism 302 is depicted in FIGS. 1D and 1E which is operable between adjacent frame sections 134 and 138. Actuator 978 may have its actuating body portion (e.g. hydraulic cylinder portion) pivotally connected at an inward end to open member 728 of frame section 134 and may have an actuating member (e.g. hydraulic piston rod) that is pivotally connected at an outward end to an arm of bell crank 304. Bell crank 304 may have a lower arm portion that is pivotally connected at a lower end to open member 748 of frame section 138 through lower bracket 306. Bell crank 304 is also pivotally connected to frame section 138 at upper bracket 308 through a wing link 310 having pivotal pin in slot connection 312 with bracket 308. Movement of pivotal pin connection 312 in the slotted end 314 on the outward end of wing link 310 may allow a degree of free pivotal movement of frame section 138 relative to frame section 134. For example, frame section 138 may be able to freely pivot in a vertical direction (Z direction in FIG. 1) relative to frame section 134 up to about 10 degrees in a downward/clockwise angular direction and up to about 40 degrees in an upwards/counter-clockwise direction without requiring extension or contraction of the actuating member (e.g. piston rod) of actuator 978. The degree of pivotal movement may be adjusted and fine-tuned through selecting different locations for each of the pivotal connections described on bell crank 304 and frame 108.

Each of the actuators 960, 962, 964, 966, 968, 970, 972, 974, 976 and 978 may have a corresponding bell crank mechanism as described above. As such, during movement of agricultural implement 100 over uneven terrain, through operation of each bell crank mechanism, each adjacent frame sections of frame 108 may be able to mechanically float (i.e. move in a vertical direction relative to one another) to a limited extent through their respective bell crank mechanisms without extension or contraction of respective actuators 960, 962, 964, 966, 968, 970, 972, 974, 976 and 978.

In the embodiment shown, actuator 968 is coupled to the open members 736 and 756 and configured to retract to pivot the outer left section 140 of the frame 108 about the pivotal connectors between the outer left section 140 and the left-center section 136.

The actuator 960 is coupled to the open members 714 and 734 and the actuator 972 is coupled to the open members 718 and 738. In operation, the actuators 960 and 972 may be retracted from the configuration shown in FIG. 1A to rotate the left-center section 136 upwards relative to the left-inner section 132 of the frame 108.

The actuator 962 is coupled to the open members 714 and 704 and the actuator 974 is coupled to the open members 718 and 708 (FIG. 1C). In operation, the actuators 962 and 974 may be retracted from the configuration shown in FIG. 1A to rotate the left-inner section 132 upwards relative to the central section 130 of the frame 108. The actuators 964, 966, 970, 976 and 978 may be generally similar to the actuators 960, 962, 968, 972 and 974 and are operable to rotate the right outer section 142, right-center section 138 and right inner section 134 of frame 108 inwards in a similar manner.

In various embodiments, the actuators 960, 962, 964, 966, 968, 970, 976 and 978 may be interconnected to a hydraulic fluid supply system controlled with electronic activated valves. Actuators 964, 966, 970, 976 and 978 may be retracted generally simultaneously with the actuators 960, 962, 968, 972 and 974, to rotate the right outer section 142, right-center section 138 and right inner section 134 inwards as the left outer section 140, left-center section 136 and left inner section 132 are rotated inwards. In various embodiments, the actuators 960-966 may be actuators which are configured to lift and hold substantial weight, such as, for example hydraulic actuators.

With reference to FIG. 2A, fixedly attached to open channel transverse member 708 in row 128 of transverse open members may be a rear towing hitch 56. Rear hitch towing 56 may be affixed to transverse member 708 through diagonally oriented towing members 58, 60. Extending from the rear of members 58, 60 are upper and lower hitch plates 66 and 68 respectively, which are configured to attach and tow additional farming implements or tools to agricultural implement 100 such as a seed cart, a roller and/or a compactor.

### Front Wheeled Vertical Load Support Units

With reference to FIG. 2C, affixed to the front end of open members 776, 778, may be respectively, representative front wheeled support units 912, 914 having respectively wheels 197g, 197h. Shown also in greater detail in FIG. 4A, representative front wheeled support 912, which may be constructed in the substantially the same manner to front wheeled support 914, may include a single caster wheel 197g (that may typically include a round rubber compound tire mounted on a round strong metallic rim) supported at one lower end of leg member 871, which may be attached to an axle/hub mechanism 853 in such a known manner, as to allow for free rotation of the wheel about a generally horizontal wheel rotation axis of axle/hub 853.

Leg member 871 may be generally rectangular in cross section and tubular and may be fixedly connected at a top end portion to an outer end of a horizontal pivot arm 874. The inner end of pivot arm 874 may be fixedly secured to cylindrical freely rotatable support post 873 (rotatable about its own longitudinal—generally vertical axis). Post 873 may be received within cylindrical tubular support 877 and configured for axial movement relative to supporting hollow cylindrical tubular support 877. Post 873 along with pivot arm 874 may also be freely rotatable 360 degrees in each rotational direction, about a longitudinal steering axis of tubular support 877, as indicated by arrows 872 in FIG. 4A.

Tubular support 877 may have an end cap 879 affixed to the upper end and may be mounted to a forward end portion of a mounting block (mount) 878. End cap 879 may permit post 873 to rotate in relation to end cap 879, while end cap 879 retains its rotational position relative to frame section 130. In some embodiments a cable (not shown in FIG. 4A) may extend over end cap 879 and pass-through cable guides 875a, 875b on opposite transverse sides of tubular support 877 the rearward ends of which may be fixedly secured for example to steering hub 208a of rear support unit 300a as will be described below.

Leg member 871, pivot arm 874, support post 873 and cylindrical tubular support 877 may all be made from suitably strong materials such as suitable steel materials.

### Rear Wheeled Vertical Load Support Units

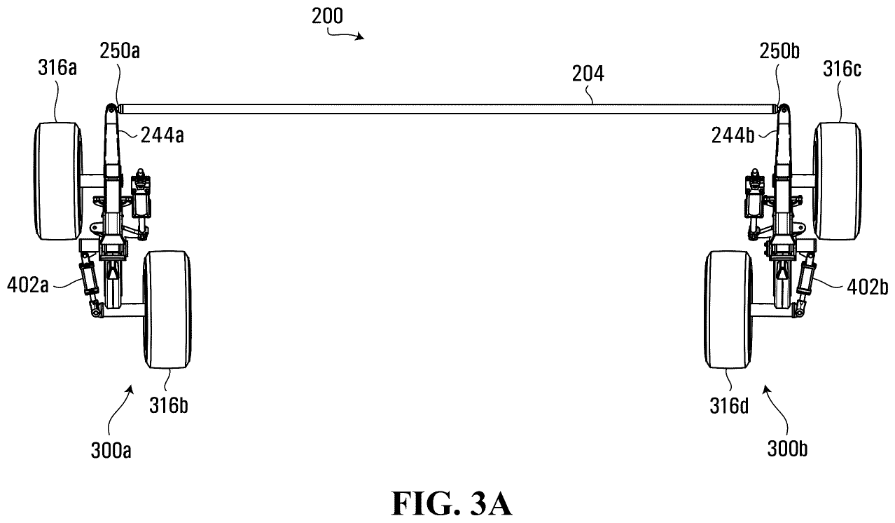

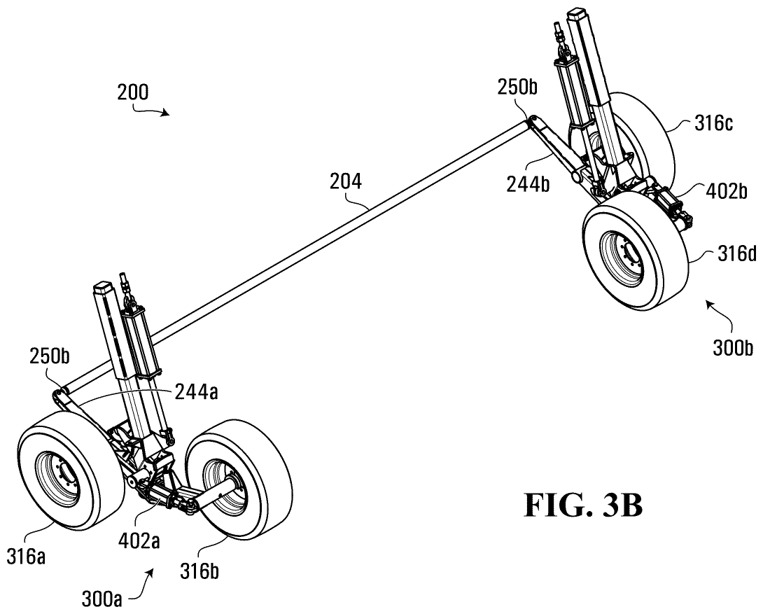

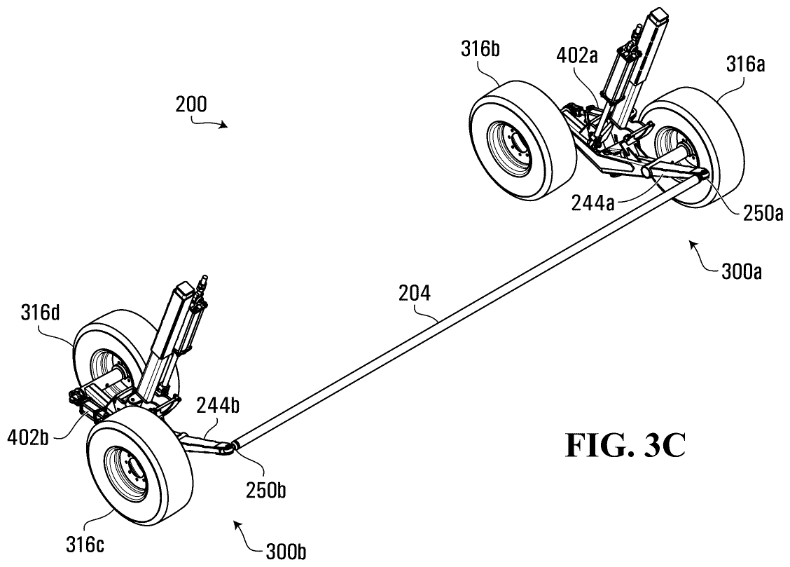

With reference to FIGS. 2A-F, central frame section 130 is depicted in greater detail and may include steerable central frame, left-side and right-side, rear wheeled support units 300a, 300b, which may be transversely, pivotally and operationally interconnected by a track rod 204, to form a steerable rear wheeled assembly 200, shown in isolation in FIGS. 3A-3C. As described herein, steerable rear wheeled assembly 200 (along with hydraulic cylinders 402a, 402b and directional valve 434) may comprise at least part of a side tilt/slope counteracting mechanism.

In various other embodiments, only one of the rear wheeled support units, or more than two of the rear wheeled support units, may be steerable either independently, or in dependence upon other rear wheeled support units.

Track rod 204 may be an elongated and extending bar made from a suitably strong material such as for example a bar with a cross sectional area in the range of about 1-2 inches and made from a steel, such as A36 steel. As will be explained in greater detail, steerable rear wheeled assembly 200 may be configured such that such that steerable wheels 316a, 316b, and steerable wheels 316c, 316d of respective rear wheeled support units 300a, 300b are each rotatable about a respective generally vertically orientated (generally in the X direction) steering axis, in order to prevent or correct and/or counter-act side-shift/sliding of agricultural implement 100 relative to propulsion unit 102 during operation and maintain longitudinal axis alignment between agricultural implement 100 and propulsion unit 102

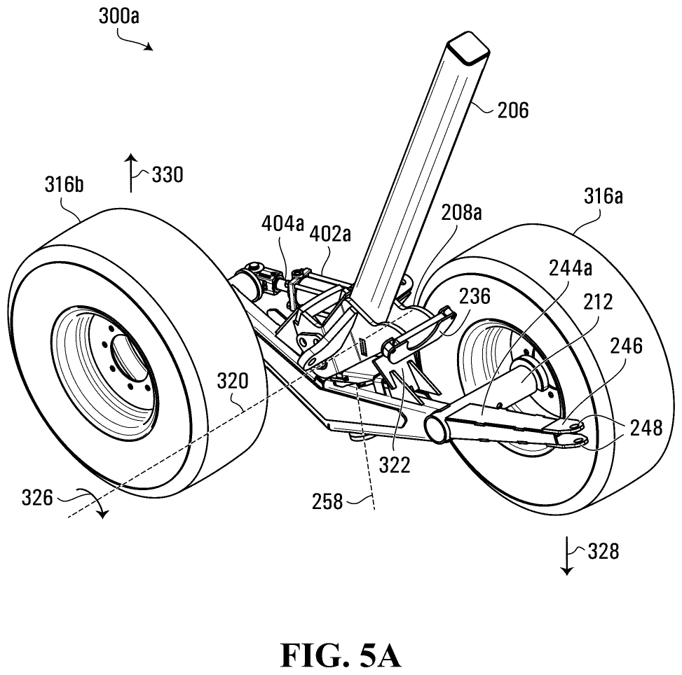

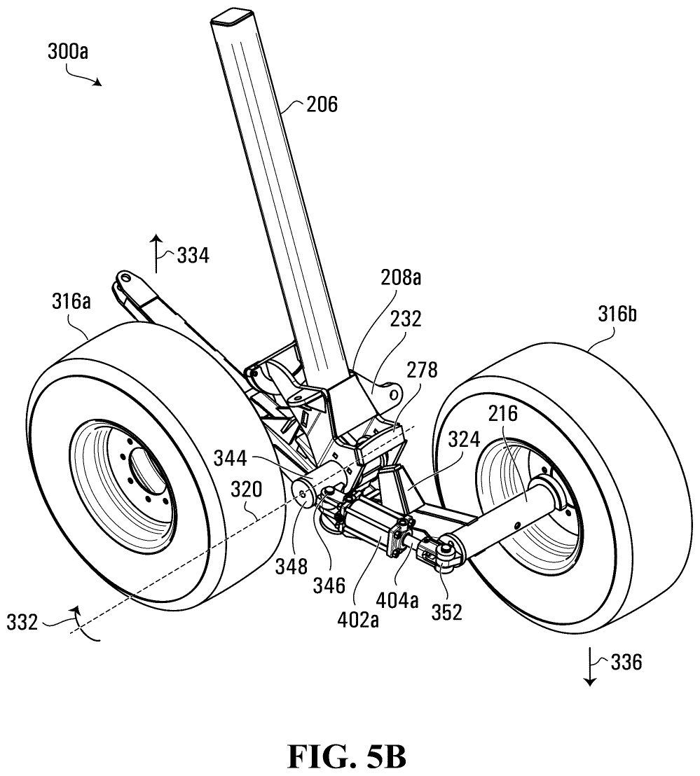

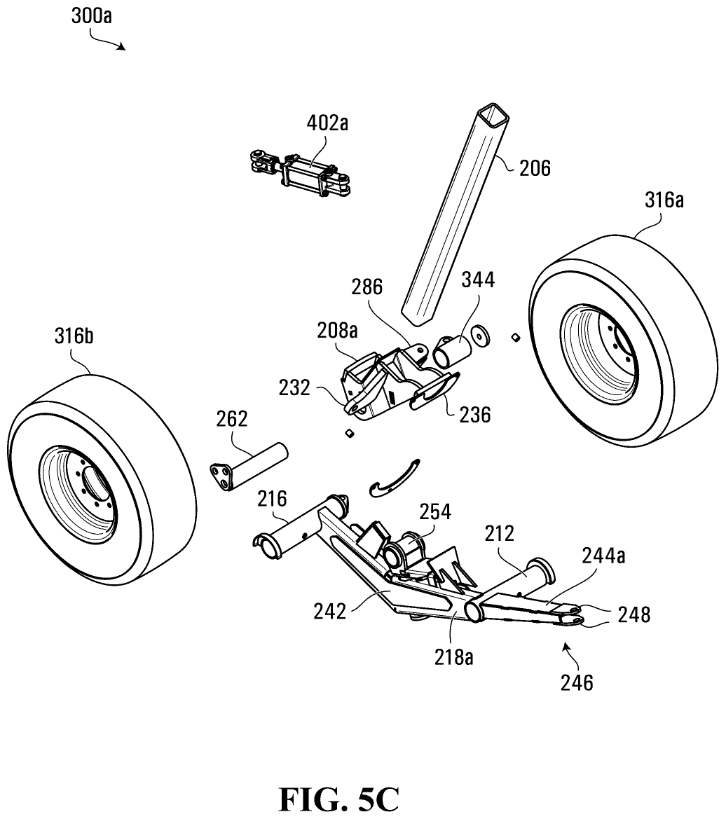

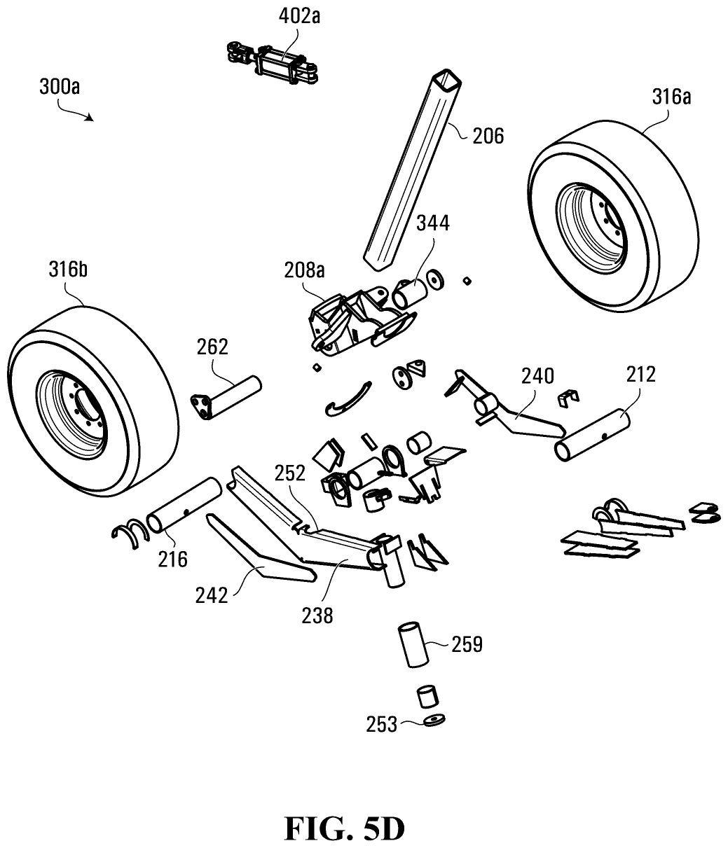

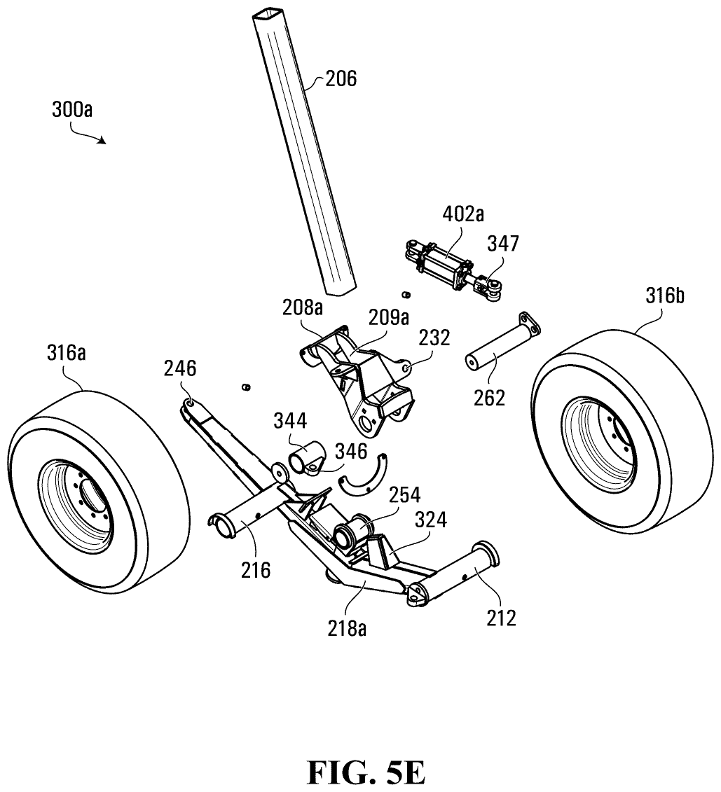

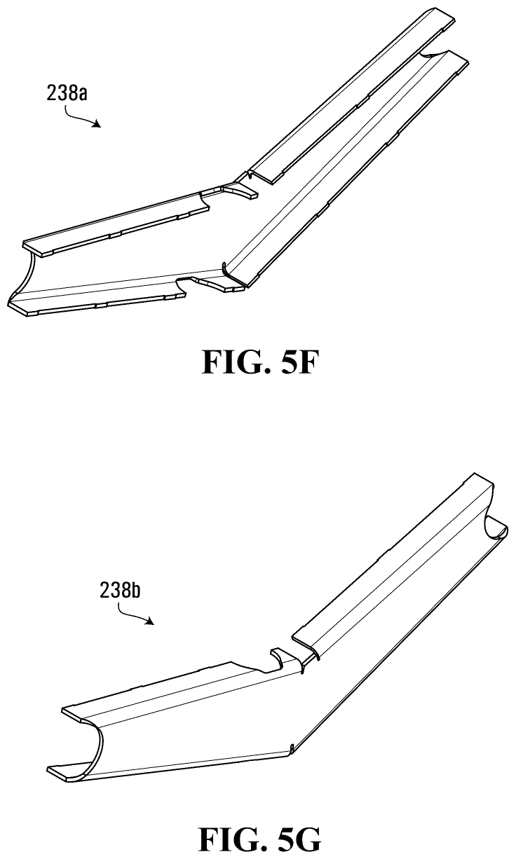

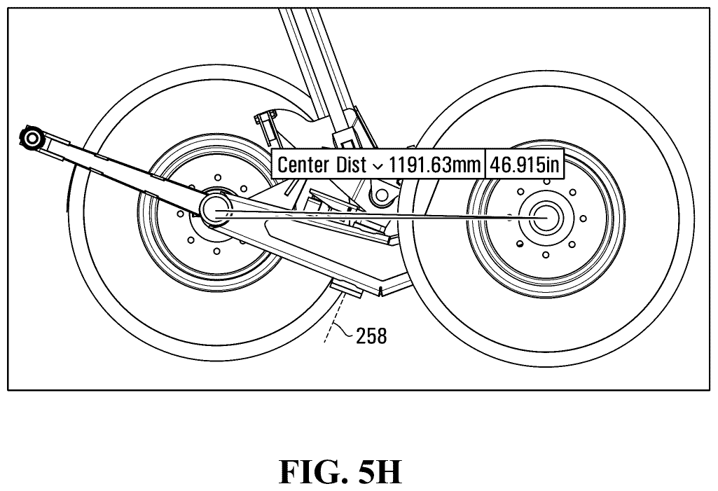

Left and right rear wheeled support units 300a, 300b may be constructed in substantially the same manner but some components of left-side support unit 300a may be configured as left-hand oriented components whereas some components of right-side support unit 300b may be configured as right-hand oriented components. Left side support unit 300a is depicted in isolation in FIGS. 5A-5E and may generally include a generally tubular leg member 206, made from a suitably strong material such as A36 steel, which is received within a generally vertically and upward oriented opening 209a (FIG. 5E) of a steering hub 208a. Steering hub 208a may also be made from a suitably strong material such as A36 steel.

Tubular leg member 206 may be fixedly secured within opening 209a of steering hub 208a such as by welding.

Left side wheeled support unit 300a may also include left-side front wheel 316a mounted on a transversely oriented front wheel axle 212 and right-side rear wheel 316b mounted on a transversely oriented rear wheel axle 216. Axles 212 and 216 will be made from a suitably strong material such as C1045CR steel. Wheels 316a, 316b may typically include round rubber compound tires (or tires made of other materials that provide a suitable frictional contact with a terrain surface) mounted on round strong metallic rims and are operable for free rotation about a generally transversely oriented wheel axis of rotation on respective axles 212, 216.

Front wheel axle 212 and rear wheel axle and 216 may be interconnected by a longitudinally oriented walking beam 218a such that wheels 316a and 316b are transversely and longitudinally spaced from each other. Walking beam 218a may be made from a suitably strong material such as A36 steel. As will be explained in greater detail below, walking beam 218a may be pivotally connected to steering hub 208a and operable to rotate about separate horizontal and vertical axes relative to steering hub 208a and tubular leg 206. Similarly, walking beam 218b may be pivotally connected to a corresponding steering hub 208 and operable to rotate about separate horizontal and vertical axes relative to steering hub 208b and its respective tubular leg 206.

With reference to FIG. 4B, leg member 206 may be generally rectangular in cross section and tubular and may be configured for axial movement relative to a hollow tubular support 220. Tubular support 220 may extend through an opening in lower flange 776c of open member 776, through the channel of open member 776 next to web 776b and through an opening 776e in upper flange 776a of open member 776. Tubular support 220 may be welded to lower flange 776c of open member 776 to provide a rigid connection. However, the connection between upper flange 776a and tubular support 220 may not be fixed (eg. it may be considered a “floating” or movable connection), such that there is a limited/restricted amount of horizontal movement/twisting of tubular support 220 relative to upper flange 776a, although vertical movement is substantially prevented (e.g. through the fixed connection at lower flange 776c). A control ring 222 may be positioned over opening 776e of upper flange 776a and may be fixedly attached (such as by welding) to tubular support 220. Control ring 222 may be held within support plate 224 (FIG. 4B). Support plate 224 may be secured such as by welding, to the upper surface of upper flange 776a and lay flat thereon. Control ring 222 may be configured to guide and support tubular support 220 at the required angle. Tubular support 220 may thus be constrained in its movement horizontally and rotationally, to move with control ring 222. However, upper flange 776a can twist to some extent relative to tubular support 220.

As shown in FIG. 4B, a one-way acting hydraulic cylinder device 226 associated with rear wheeled support unit 300a may be interposed and interconnected between open member 776 and steering hub 208a. Hydraulic cylinder 226 may have an upper piston cylinder end interconnected to bracket 228 which is fixedly secured to the upper end of tubular support 220, such as by welding. Hydraulic cylinder 226 may have an extendible piston rod 230 and the end of piston rod 230 may be connected to steering hub 208a through bracket 232 which projects transversely from steering hub 208a (FIG. 5A). The operation of hydraulic cylinder 226 may be controlled by an actuator (which may be controlled manually or by a controller). The control of control valves in a hydraulic fluid circuit/system can control the flow of pressurized hydraulic fluid to and from hydraulic cylinder 226. By extending piston rod 230 of hydraulic cylinder 226, the distance between wheel steering hub 208a (and therefore wheels 316a, 316b) and open member 776 may be increased, and by retracting piston rod 230, the distance between steering hub 208a and open member 776 may be decreased, thus permitting adjustment of the height of the frame member 776 relative to the steering hub 208a. its wheels and the ground surface upon which they are supported.

The one-way acting hydraulic cylinder device 226 associated with rear wheeled support unit 300b may be interposed and interconnected between open member 776 and a corresponding steering hub and operate in the same manner as hydraulic cylinder device 226 of rear wheeled support unit 300a.

As will be referenced later in connection with FIG. 2H, it should be noted that one-way acting hydraulic cylinder devices 226 associated with rear wheeled support units 924 and 930 may also be interposed and interconnected between open members and a corresponding member/component of the wheel unit and operate in the same manner as hydraulic cylinder device 226 of rear wheeled support unit 300a to raise and lower the frame 108 relative to those rear wheeled support units 924 and 930. One-way acting hydraulic cylinder devices 226′ associated with rear wheeled support units 920, 922, 932 and 934 may also be interposed and interconnected between open members of frame 108 and a corresponding member/component of the rear wheeled support unit, but be provided with mechanical linkages that cause them to operate in an opposite manner to hydraulic cylinder device 226 of rear wheeled support unit 300a to raise and lower the frame relative to those wheel units.

For such hydraulic cylinders 226′, by extending piston rod of a hydraulic cylinder 226′, the distance between wheels and the open frame member may be decreased, and by retracting the piston rod of a hydraulic cylinder 226′, the distance between wheels and the open frame member may be increased, thus permitting adjustment of the height of the frame member of frame 108 relative to their respective rear wheels and the ground surface upon which they are supported.

The height of frame 108 relative to each of the front wheel units may be adjusted in unison with the adjustment of the frame relative to the rear wheel units, such as with a mechanical linkage that operationally links the movement of the frame 108 relative to the rear wheeled support units, such as rear wheeled support unit 300a. For example, secured to opposed sides of web portion 776b of open member 776 may be a pair of pulley devices 234a, 234b (FIGS. 4B and 4C). One or more cables (not shown) may be secured around an arcuate cable guide 236 (see FIG. 5A) which may be fixedly mounted to steering hub 208a of rear wheeled support unit 300a. The cable may extend around arcuate cable guide 236 of steering hub 208a upwards on both sides to transversely opposed rearward pulley devices 234a, 234b and then follow curved paths around pulley devices 234a, 234b on opposite sides of web 776b of open member 776 and extend to a pair of corresponding opposed forward pulley devices 875a, 875b associated with front wheeled support 912 (see FIGS. 4A and 4B). Thus, the operation of hydraulic cylinder 226 and the length of its piston rod 230 that is extended, can control the height of frame 108 where left-side support unit 300a is connected thereto relative to ground surface 106.

The configuration of the apparatus including the total length of the cable can be selected to ensure that frame 108 at that location can be positioned at a desired horizontal orientation and lowered upwards and downwards while at that selected orientation. Furthermore, by adjusting the length of the cable that extends between cable guides 875a, 875b over end cap 879 with a cable adjustment mechanism the relative vertical position of post 873 relative to tubular support 877 (and front region of frame 108) can be adjusted and set to a desired vertical position. By providing functionally interconnected hydraulic cylinder arrangements associated for each of rear wheeled support units 300a, 300b, 920, 922, 924, 930, 932, 934 and their respective front wheeled support units 900, 902, 904, 906, 908, 910, 912, 914, the entire position and orientation of vertical height of frame 108 above ground surface 106 can be controlled and varied by the operation of hydraulic cylinders that are controlled by actuators—which can be controlled by manually by an operator and/or by a controller.

### Combined Hydraulic Flow Divider and Height Sensor

In an embodiment, the height of the entire frame 108 relative to and generally above all rear wheeled support units 300a, 300b, 920, 922, 924, 930, 932, 934 may be controlled by a particular arrangement of a plurality of respective fluidly interconnected hydraulic cylinders 226, 226′ that are also fluidly interconnected with a pair of mechanically and fluidly connected flow divider hydraulic cylinders 72a, 72b, configured in a manner such as is shown schematically in FIG. 2H. The height of frame 108 relative to each of the corresponding front wheel units may also be adjusted in unison with the adjustment of the frame relative to the rear wheel units, such as with a mechanical linkage that operationally links the movement of the frame 108 relative to the rear wheeled support units, as described herein. With reference to FIG. 2G, the hydraulic cylinders 226 of the left and right side rear wheeled support units, as well as the other hydraulic cylinders 226, 226′ of rear wheeled support units 920, 922, 924, 930, 932, 934, as well as flow divider hydraulic cylinders 72a, 72b may receive and discharge pressurized hydraulic fluid, from and to, the hydraulic fluid supply and control system of propulsion unit 102.

Affixed to transversely orientated member 57 may be flow divider hydraulic cylinders 72a, 72b. Hydraulic cylinders 72a, 72b may each have a hydraulic chamber with a reciprocally moveable piston therewithin connected to a respective piston rod 73a, 73b. The respective cap ends 75a, 75b of hydraulic cylinders 72a, 72b may both be interconnected to member 57 (such as by bolting) and each include a rod end port to receive the supply of hydraulic fluid from the hydraulic fluid supply and control system of propulsion unit 102. The piston rods 73a, 73b of cylinders 72a, 72b may be fixedly and mechanically tied together with a slide block 74 movable on a transversely extending rail, that may be affixed to transverse member 57, such that piston rods 73a, 73b, of cylinders 72a, 72b will expand/extend and retract to the same extent and at the same rate and in unison with each other to ensure equal hydraulic fluid flow into and out of cylinders 73a, 73b.

As such, cylinders 72a, 72b may act as a 50/50 flow divider for the supply of hydraulic fluid received from the hydraulic fluid supply and control system of propulsion unit 102 that is thereafter distributed to hydraulic cylinders 226, 226′.

In some embodiments, each of hydraulic cylinders 226, 226′, 73a, 73b, may have the same size chamber volumes, piston rods, same size pistons and piston rods, and have the same stroke distance. In other embodiments, it may be desirable that cylinders may have some varying dimensions such as for example some having smaller diameter cylinders with longer stroke lengths and others with relatively larger diameter cylinders with shorter stroke lengths. With cylinders being connected in series the system can be configured such that the volume of hydraulic fluid being displaced on each stroke is the same in each of the cylinders connected in series.

With reference again to FIG. 2H, the hydraulic fluid supply circuit for supplying hydraulic fluid to hydraulic cylinders 72a, 72b, 226, and 226′ is shown. Hydraulic cylinder 72a may supply hydraulic fluid to the rear wheeled support units 300a, 924, 922, 920 on the left side of implement 100 and hydraulic cylinder 72b may supply hydraulic fluid to the rear wheeled support units 300b, 930, 932, 934 on the right side of implement 100.

If it is desired to raise the frame 108 relative to the wheels of each of the rear wheeled support units 300a, 300b, 920, 922, 924, 930, 932, 934, pressurized hydraulic fluid may be supplied from the hydraulic fluid supply and control system associated with propulsion unit 102, on line 991 to the rod ends of hydraulic cylinders 72a and 72b. Since piston rods 73a, 73b, move together when the rods retract, equal amounts of pressurized hydraulic fluid will flow into the rod end ports and also equal amounts of hydraulic fluid will exit the cap end ports of hydraulic cylinders 72a, 72b.

The fluid exiting the cap end ports of each cylinder 72a, 72b may be connected via lines 992 and 993 respectively, to the hydraulic cylinders 226 of rear wheeled support units 300a, 300b. This will cause piston rod of hydraulic cylinder 226 of rear wheeled support unit 300a to expand/extend, raising frame 108 at that location on the frame to which the hydraulic cylinder is connected. Fluid exiting the rod end port of cylinder 226 of rear wheeled support unit 300a will flow through line 994 to the rod end port of cylinder 226′ of rear wheeled support unit 922 causing that rod to retract, also causing frame to be raised at that corresponding location on the frame. As a result of the retraction of rod of cylinder 226′ of rear wheeled support unit 922, fluid will flow from the cap end port of cylinder 226′ of rear wheeled support unit 922 through line 995 to the cap end port of cylinder 226 of rear wheeled support unit 924 causing that piston rod to extend, also raising frame 108 at that corresponding frame location. This also results in fluid exiting from the rod end port of cylinder 226 of rear wheeled support unit 924 through line 996 to the rod end port of cylinder 226′ of rear wheeled support unit 920. This causes the piston rod of rear wheeled support unit 920 to retract, also raising frame 108 at that corresponding frame location and also causing fluid to exit from the cap end port of cylinder 226′ of rear wheeled support unit 920, into discharge line 997, where it can be returned to the hydraulic fluid supply and control system associated with propulsion unit 102.

Similarly, fluid exiting the cap end port of cylinder 72b may be connected via line 993 to the cap end port of hydraulic cylinder 226 of rear wheeled support unit 300b. This will cause piston rod of hydraulic cylinder 226 of rear wheeled support unit 300b to extend, raising frame 108 at that corresponding frame location. Pressurized hydraulic fluid exiting the rod end port of cylinder 226 of rear wheeled support unit 300b will flow through line 994′ to the rod end of cylinder 226′ of rear wheeled support unit 932 causing that piston rod to retract, also causing frame 108 to be raised at that corresponding frame location. As a result of the retraction of rod of cylinder 226′ of rear wheeled support unit 932, pressurized hydraulic fluid will flow from the cap end port of cylinder 226′ of rear wheeled support unit 932 through line 995′ to the cap end port of cylinder 226 of rear wheeled support unit 930 causing that piston rod to extend, also raising frame 108 at that corresponding frame location. This also results in fluid exiting from the rod end port of cylinder 226 of rear wheeled support unit 930 through line 996′ to the rod end port of cylinder 226′ of rear wheeled support unit 934. This causes the piston rod of that hydraulic cylinder 226′ to retract, also raising frame 108 at that location and also causing hydraulic fluid to exit from the cap end port of cylinder 226′ of rear wheeled unit 934, into discharge line 997′, where it can be returned to the hydraulic fluid supply and control system associated with propulsion unit 102.

As described above, through the operation of each of the hydraulic cylinders 72a, 72b, 226, 226′ under the control of the hydraulic fluid supply and control system of propulsion unit 102 (e.g. by activating valves to control the flow of hydraulic fluid) the height of the entire frame 108 where the rear wheeled support units are connected thereto relative to ground surface 106 can be controlled and adjusted upwards.

It may be appreciated that in order to lower frame 108 relative to rear wheeled support units 300a, 300b, 920, 922, 924, 930, 932, 934, the weight of frame 108 can act as a driving force and cause the hydraulic fluid to be driven in the fluid circuit in the opposite direction to that described above in connection with the raising of frame 108. The force of gravity will transmit forces on the piston rods of hydraulic cylinders 226, 226′ acting in the opposite directions to that described above—such that piston rods of hydraulic cylinders 226 will retract and the piston rods of hydraulic cylinders 226′ to extend. This causes hydraulic fluid to flow in the opposite direction throughout the fluid circuit, and cause the piston rods of flow divider cylinders 72a, 72b to retract, the amount and at the same rate (as a result of the mechanical tying with slide block 74).

Thus, through the operation of each of the hydraulic cylinders 72a, 72b, 226, 226′ under the control of the hydraulic fluid supply and control system of propulsion unit 102, the height of the entire frame 108 where the rear wheeled support units are connected thereto relative to ground surface 106 can be controlled and adjusted downwards.

Slide block 74 may be slidably interconnected to member 57 such that slide block 74 will slide in a transverse direction along member 57 as cylinders 72a, 72b extend and retract, during the upwards and downwards movement of frame 108 relative to the rear wheeled units, as described above. Affixed to slide block 74, for reciprocating movement with slide block 74 (and piston rods 73a, 73b) may be a slide plate 77. A rotation sensor 998 (shown in FIG. 2H), that may be similar to steering angle rotation sensor 354a described below, and may mounted to transverse member 77, and may have a pivotable sensor arm with a pin mounted at an end of the sensor arm. The pin of the sensor arm may follow a slot 76 in plate 77 that is oriented towards the longitudinal direction from the transverse direction. As cylinders 72a, 72b expand and contract, the angle of the sensor arm will change as a result of the pin moving in slot 76. This results in the relative voltage produced by the sensor changing in relation the change in the position of the rods 73a, 73b of cylinders 72a, 72b, thus reflecting the change in height of frame 108. The sensor 998 may be in communication with a control system (such as controller 450 of control system 400 described below forming part of the hydraulic fluid supply and control system of propulsion unit 102. As such the change in the relative voltage produced by the sensor may enable the control system to determine and operate hydraulic fluid valve to provide supply of pressurized hydraulic fluid to adjust the height of the frame 108 relative the ground surface 106 as described above.

In some embodiments, the forward/aft pitch of frame 108 (i.e. the X direction of FIG. 1) may also be adjustable, as described further below. Also, as described below, in other embodiments (such as for central wheel support units used in a combination tillage/seeder apparatus), the vertical height setting of front wheels 197g, 197h relative to the frame 108 on front wheeled support units 912, 914 may be adjusted by one or more hydraulic cylinders inter-connected between the end cap and the frame and controlled by a pressurized hydraulic fluid supply and control system. The hydraulic piston(s) may be operable to raise and lower post 873 relative to frame 108, to permit the height of frame 108 relative to that front wheel 316b to be adjusted. In some embodiments, such as for a chisel plow apparatus with ground engagers, which may engage the ground surface with a greater force than a seeder apparatus, may include an apparatus to adjust the pitch of the ground engagers in the front row, which may engage the ground surface to a greater extent than the subsequent rows of ground engagers, relative to the ground engagers in the rearward rows.

### Rear Wheel Steering Arrangement

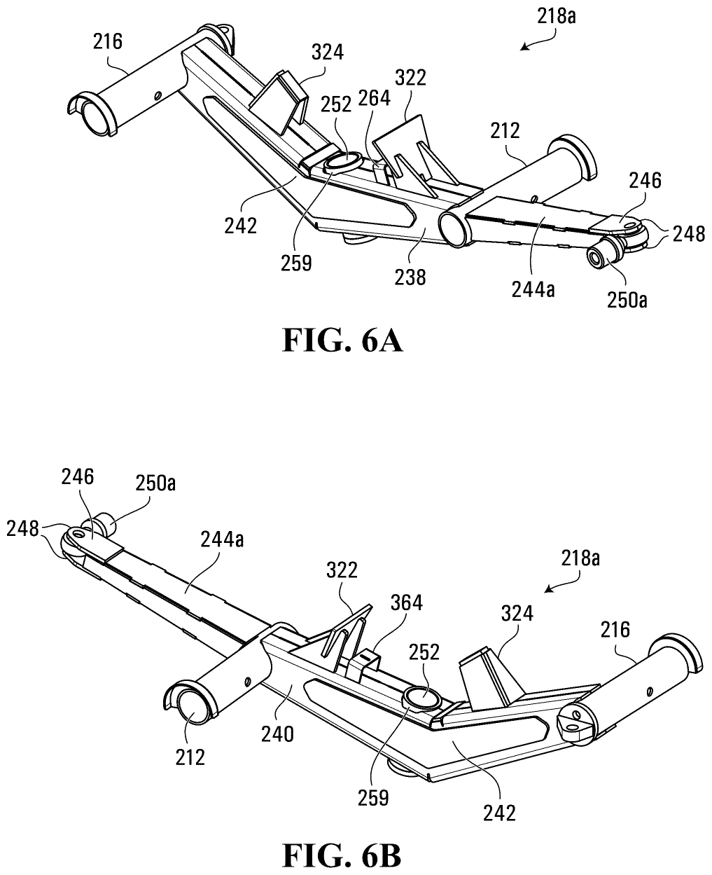

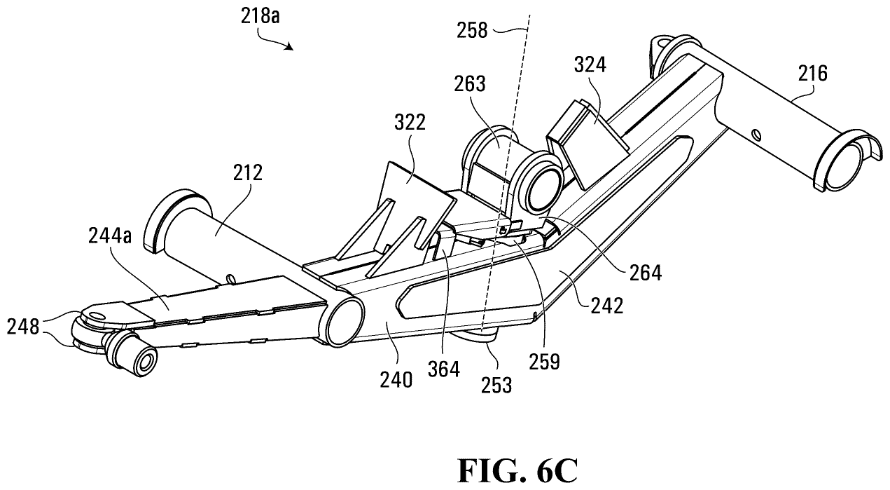

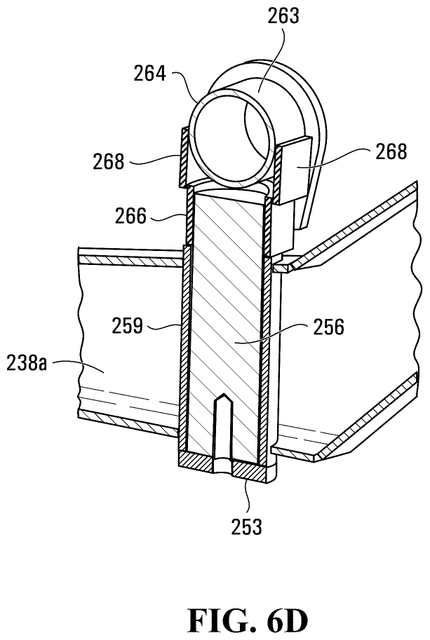

As will be evident from the present disclosure, central rear wheeled support units 300a, 300b are steerable wheeled support units with steerable wheels that can be actively steered with a steering mechanism that comprises an actuator that can adjust the steering angle of the wheels. With reference now to FIGS. 6A and 6B, walking beam 218a of left side rear wheeled support unit 300a may have a generally rectangular hollow tubular transverse and vertical cross section with a generally V-shaped longitudinal profile when viewed transversely from a side. The interior angle of the V-shape profile may be in the range of between 145 degrees and 155 degrees and may preferably be about 150 degrees.

Walking beam 218a may be formed from a generally C-channel inner portion 238 and a generally flat longitudinally and vertically extending outer plate portion 240, which may be affixed to one another by a suitable method such as welding. The rigidity and strength of walking beam 218a may be enhanced additional features on the surfaces of walking beam 218a, such as reinforcement plates 242, which may be affixed such as by welding to the outer vertical face of inner portion 238, or plates 242 may alternatively be formed as in integral part of inner portion 238.

In an embodiment, walking beam 218a may be formed from two generally C-shaped portions, such as a first portion 238a shown in FIG. 5F and a second portion 238b shown in FIG. 5G which is essentially a mirror image of first portion 238a. First and second portions 238a and 238b be mated and welded together to form a single box weldment for walking beam 218a.

At the approximate longitudinal mid-point of walking beam 218a, there may be cylindrical tube 259 that may be welded into an opening in walking beam 218a and having a vertical extending opening 252 therethrough (FIG. 6B). At or proximate a rear-end region of walking beam 218a may be affixed rear wheel axle 216. Approximately midway between vertical opening 252 and the front-end region of walking beam 218a may be affixed front wheel axle 212. As will be explained in greater detail below, through this arrangement, a transversely orientated pivot axis 320 of an upper pivot pin 262 (FIGS. 5B and 5C) may thereby be located at the approximate midpoint between front wheel axle 212 and rear wheel axle 216. In various embodiments, each axle 212, 216 may be positioned between about 40 inches and about 50 inches apart from each other. Thus, with reference to FIGS. 5B and 5H the transversely orientated pivot axis 320 is roughly centered between the two wheels. As will be explained in more detail a generally vertical steering axis 258 of a kingpin/pivot pin 256 points downwardly forward of the rear wheel to give some caster centering effect. However, the hydraulic steering mechanism as described herein, will be configured and operable to override the caster centering effect on the wheels.

Axles 212 and 216 may be affixed to walking beam 218a in any suitable manner such as by welding. Projecting from the front side of front wheel axle 212 may be a pivot bar connector 244a which may have a generally rectangular cross-sectional profile, extending forwards in alignment with the longitudinal axis of walking beam 218a. Pivot bar connector 244a narrows in a forward direction and terminates at pivot bar linkage 246, which includes a pair of vertically spaced arms 248 configured to receive eyebolt 250a on the left end of track rod 204 (FIG. 6A).

At the approximate longitudinal mid-point of walking beam 218a, there may be located a generally vertical upwards oriented opening 252 therethrough (FIG. 6B), which may be configured to receive the lower end of a generally vertically oriented pivot pin/kingpin 256 of a pivot pin assembly 254 therewithin and permit pivoting rotation of walking beam 218a about the shaft longitudinal axis of pivot pin 256 (FIG. 6C).

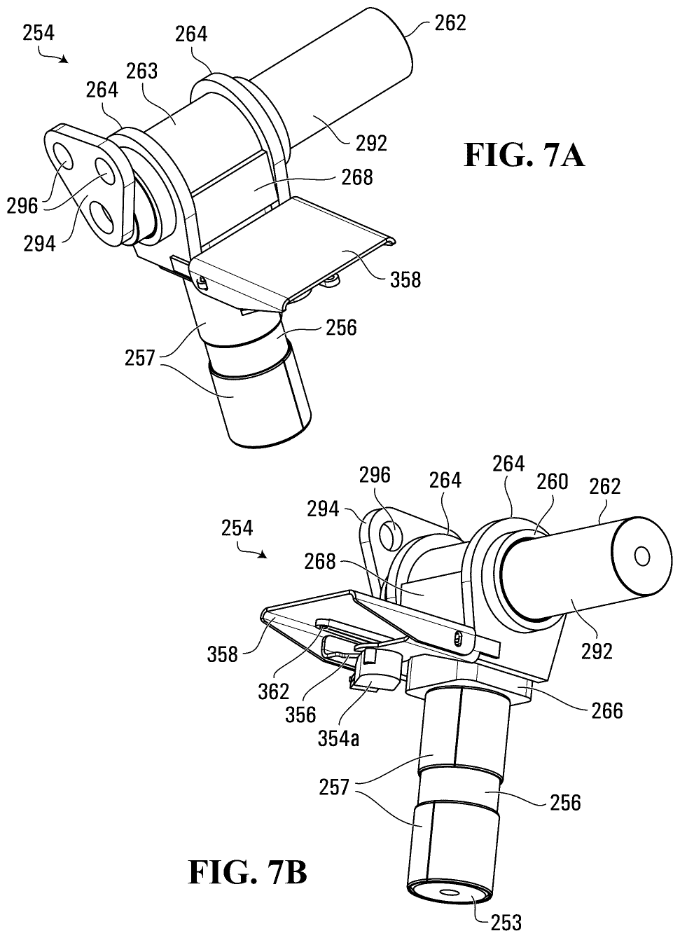

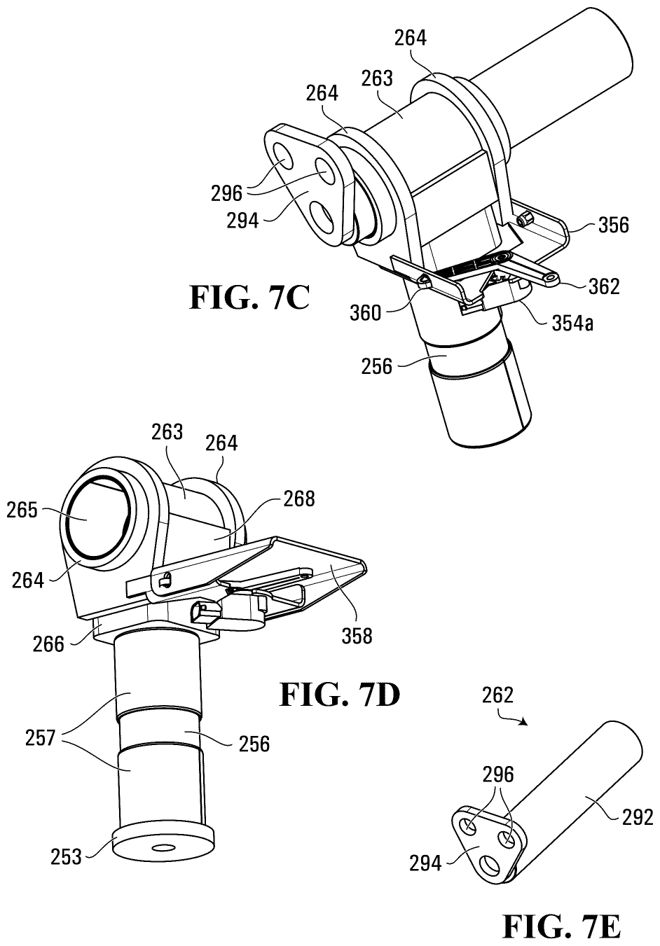

Shown in greater detail in FIGS. 7A to 7E, pivot pin assembly 254 is operable to allow walking beam 218a to move about separate vertical/generally vertical, and horizontal/generally horizontal axes of rotation. Pivot pin assembly 254 may include lower pivot pin/kingpin 256 configured to be received within cylindrical opening 252 of walking beam 218a. A pair of bushings 257, may be disposed between lower pivot pin 256 to reduce friction and wear between lower pivot pin 256 and the inner surface of opening 252 in walking beam 218. Bushings 257 may be made from a suitable material such as lubricated bronze. Walking beam 218a is able to pivot about/relative to pivot pin assembly 254 via lower pivot pin 256 about generally vertically orientated steering axis 258 shown in FIG. 5A. Pivot pin 256 may be retained in opening 252 of tube 259 by a cap 253 (FIG. 6D) configured to bolt to the lower end of pivot pin 256. Cap 253 may have an outer diameter that greater than the inner diameter of cylindrical opening 252 in tube 259 such that, once cap 253 is installed, pivot pin 256 may not be retracted vertically from opening 252 (for example of wheels 316a, 316b were raised above the ground surface).

At the upper end of pivot pin assembly 254, an opening 260 (FIG. 7B) is configured for a generally horizontally oriented upper pivot pin 262 to be received therethrough to allow for pivotal movement of pivot pin assembly 254 relative to upper pivot pin 262 about the shaft axis of upper pivot pin 262. Opening 260 may be formed from a transversely oriented tubular member 263, with a pair of fixedly connected vertically orientated end plates 264 positioned at opposed ends of tubular member 263 (FIG. 7D). End plates 264 may each include a pair of circular openings 265, aligned with the openings at opposed ends of tubular member 263.

End plates 264 may be secured to the upper end of lower pivot pin 256 by base 266 and side walls 268 (FIG. 7D), which may be joined to each other and lower pivot pin 256 by methods such as by welding. As will be explained further below, opening 260 functions to locate upper pivot pin 262 and provide a rotational bearing surface for upper pivot pin 262.

Upper pivot pin 262 is shown in greater detail in FIG. 7E and may include shaft 292 with an end plate 294 fixedly attached to shaft 292 by a method such as welding. End plate 294 may be generally triangular shaped with a pair of spaced apart openings 296 therethrough that are axially aligned with the axis of shaft 292.

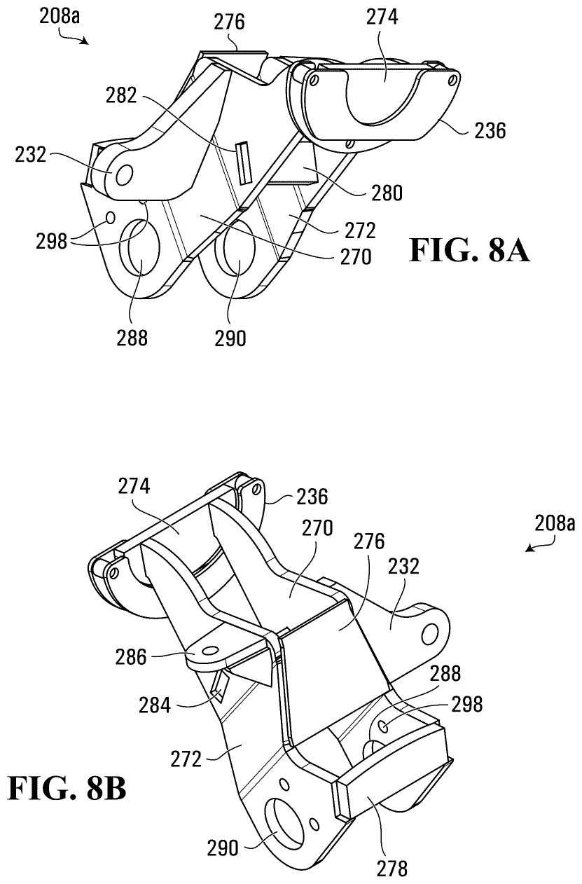

Turning to FIGS. 8A and 8B, steering hub 208a is depicted in isolation and may include a pair of vertically and longitudinally extending support struts 270 and 272, the upper front edges of which are fixedly interconnected (such as by welding) by a transversely extending support plate 274 forming part of arcuate cable guide 236 (as referenced above). In a similar manner, at the rear edges of struts 270 and 272 there may be a pair of vertically and longitudinally extending angled support plates 276 and 278 which are fixedly interconnected (such as by welding). In order to provided additional strength and rigidity, steering hub 208a may also include a rectangular and transversely and vertically extending angled plate 280 (FIG. 8A) having tabs that are configured to be received in appropriately and correspondingly configured slots 282 and 284 of steering hub 208a. At the lower end of support struts 270 and 272 may be a pair of axially aligned openings 288 and 290 respectively which function to receive and locate the shaft portion 292 of upper pivot pin 262. As previously described, bracket 232 may extend longitudinally from the outer face of support strut 270 for connection to lower end of piston rod 230. Further, extending from the upper end of support strut 272 may be bracket 286 for mounting a frame height or tillage depth sensor (not shown in FIGS.).

Parts of steering hub 208a (e.g. elements 270, 272) can be made from a suitably strong material such as a cast iron or cast steel. In various embodiments, steering hub 208a is formed as a casting or a weldment made from steel pieces (such as A36 steel). Upper pivot pin 262 and lower pivot pin 256 may be made from a suitably strong and durable material and may be induction hardened chrome pins.

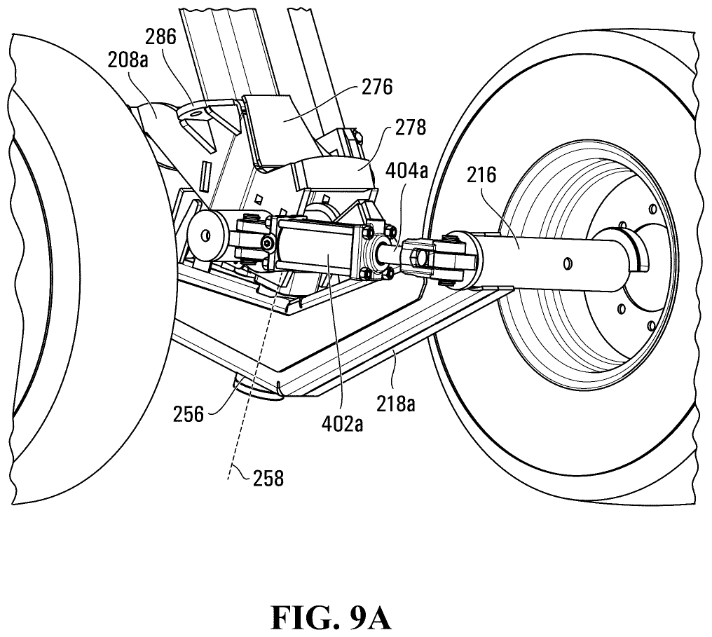

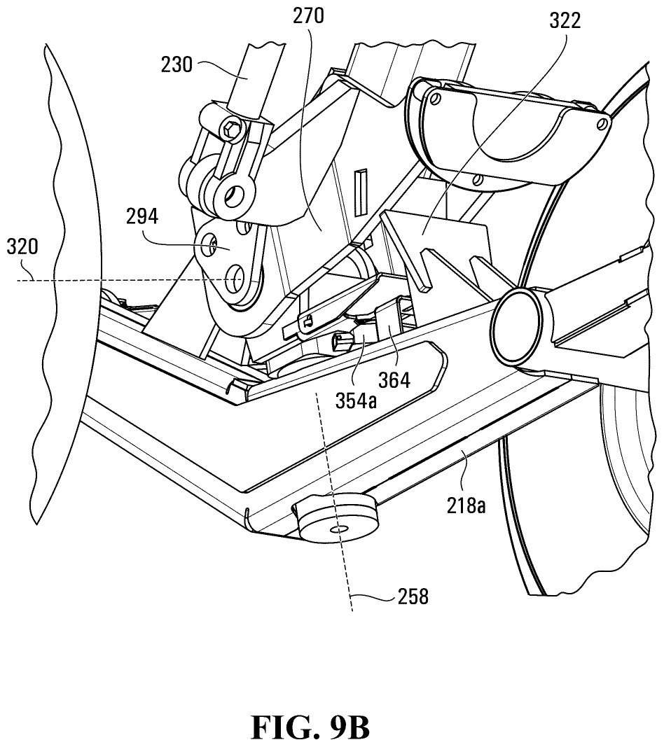

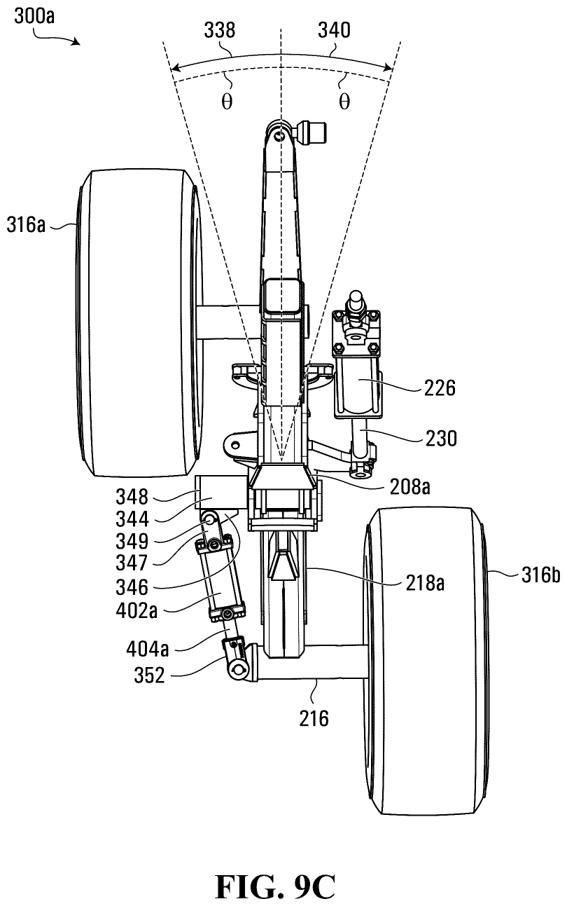

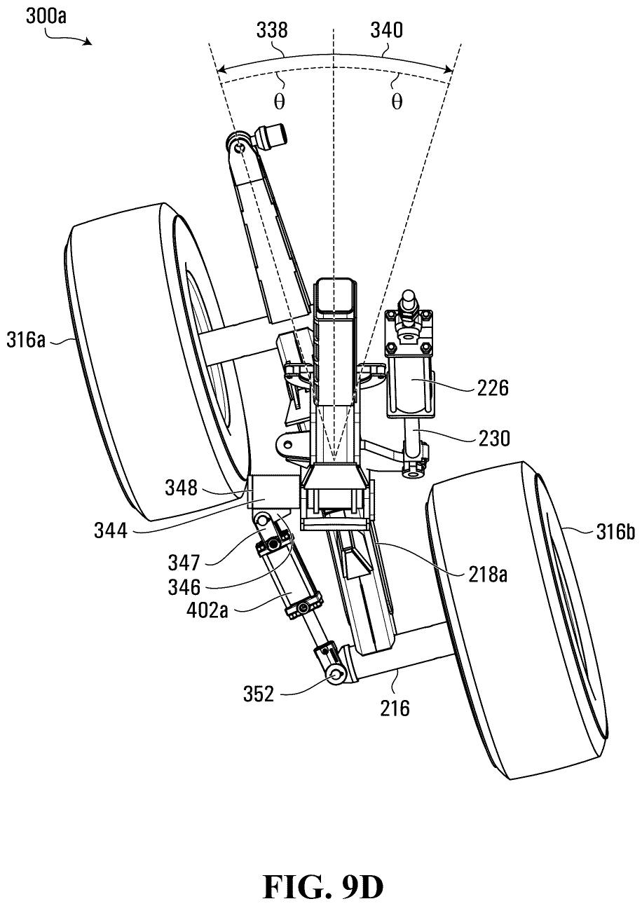

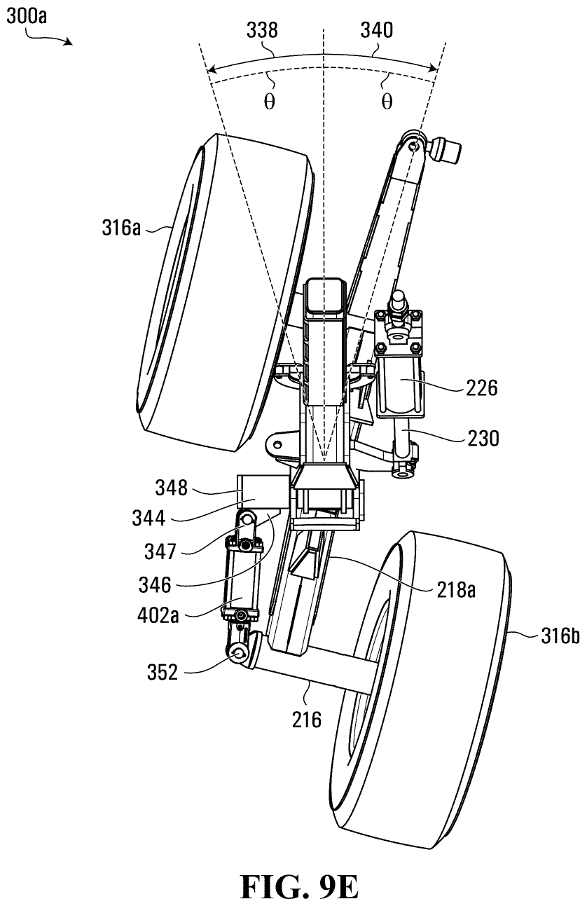

With reference in particular to FIGS. 9A-9C, the upper end of pivot pin assembly 254 including end plates 264, is received between support struts 270, 272 of steering hub 208a such that the outer edges of end plates 264 of pivot pin assembly 254 are proximal to the inner edges of struts 270 and 272 and openings 265 in endplates 264 are aligned with respective openings 288 and 290 of struts 270 and 272 (FIG. 8B).

Shaft 292 of upper pivot pin 262 is received though openings 288, 290 of support struts 270, 272 and tubular member 263. End plate 294 of upper pivot pin 262 is positioned proximal to the outer surface of support strut 270 (FIG. 9B). A pair of bolts (not shown) may be inserted though spaced apart openings 296 in end plate 294, which are aligned with corresponding openings 298 in support strut 270 (FIG. 8A) to secure upper pivot pin 262 to steering hub 208a. The bolting of pivot pin 262 to steering hub 208a prevents upper pivot pin 262 from moving out of alignment in the transverse direction and prevents upper pivot pin 262 from rotating relative to steering hub 208a. Thus, the other components of pivot pin assembly 254, which includes tubular member 263, along with fixedly connected end plates 264, and generally vertically oriented pivot pin 256 (along with walking beam 218a which is attached thereto) are free to rotate (or “rock”) relative to and about upper pivot pin 262 about the transversely orientated pivot axis 320 denoted FIGS. 5A and 5B.

As noted above, walking beam 218a, which has a tube 259 with a generally vertical upwards oriented opening 252 therethrough (FIG. 6B), which received the lower end of generally vertically oriented pivot pin 256 of a pivot pin assembly 254 therewithin and permits pivoting rotation of walking beam 218a about the longitudinal axis of pivot pin 256 (FIG. 6C).

Components of pivot pin assembly 254 (with the exception of steering angle rotation sensor 354a, which may be attached by bolts) may be formed as a weldment made from steel pieces (such as A36 steel).

As depicted in FIG. 5A, walking beam 218a may thus pivot about a first axis of rotation—axis 320—in the direction indicated by arrow 326 such that wheel 316a moves in the downwards direction indicated by arrow 328 and wheel 316b moves in the upwards direction indicated by arrow 330. As indicated by FIG. 5B, walking beam 218a may also rotate about axis 320 in the opposite direction, i.e. the direction indicated by arrow 332 such that wheel 316a moves in the upwards direction indicated by arrow 334 and wheel 316b moves in the downwards direction indicated by arrow 336. The maximum permissible angle of rotation in either direction may be restricted by a pair of stop members 322 and 324 on the upper surface of walking beam 218a (FIGS. 6A and 6B). Rotation of walking beam 218a about axis 320 in the direction indicated by arrow 326 in FIG. 5A may be limited by engagement of the upper surface of front stop member 322 with the lower front edges of support struts 270, 272. Rotation of walking beam 218a about axis 320 in the direction indicated by arrow 332 in FIG. 5B may be limited by engagement of the upper surface of rear stop member 324 with the lower surface of support plate 278 of steering hub 208a. Thus, walking beam 218a, including attached wheels 316a, 316b, along with king pin 256, base 226 and end plates 264, may be configured to pivot about pivot axis 320 upwards and downwards, up to a total maximum angle in the range of about 25 to 30 degrees and most preferably about 27 degrees.

When left-side support unit 300a is moved across surface 106 that is uneven (as when agricultural implement 100 is operated for example), walking beam 218a is operable to pivot about pivot axis 320 as described above in response to variations in the terrain of surface 106 such that wheels 316a and 316b can more closely follow the terrain of surface 106. This may allow the portion of the mass of frame 108 acting upon left side support unit 300a to be evenly distributed between wheels 316a and 316b, which may reduce wear and tear on left-side support unit 300a and may avoid maximum tire pressures for wheels 316a and 316b being exceeded. As axles 212, 216 may be positioned generally equidistant from axis pivot 320, wheels 316a, 316b may pivot the same distance, but in opposite directions.

In a similar manner to left-side support unit 300a, rear wheeled support units 300b, 920, 922, 924, 930, 932, 934 may each be configured to pivot about a corresponding horizontal pivot axis. The horizontal pivotal movement of each rear wheeled support unit when agricultural implement 100 is operating over, for example an uneven ground surface may assist in frame 108 maintaining a consistent spacing between frame 108 and ground surface 106 during operation of agricultural implement 100. This may beneficially enable ground engages in rows 522-528 to maintain reasonably consistent depth engagement of surface 106. A precise and consistent level of engagement with the surface 106 may be desirable in order to achieve a constant tillage seed depth which in turn may result in healthy crops and high yields for crops grown in the soil defining the surface 106. Precise and consistent levels of engagement may also reduce wear and tear on machines.

### Downhill Side Drift Counter-Steer System

In some situations, such as when agricultural implement is travelling across a surface that is sloped to the side (Y-direction in FIG. 1), side drift (in the Y-direction shown in FIG. 1) may occur that results in agricultural implement 100 moving into a skewed or skidding configuration, and pivot at the connection between propulsion unit 102 and agricultural implement 100, such that it is no longer in a generally square (longitudinally aligned) orientation. Side drift typically occurs when agricultural implement 100 is travelling across uneven or transversely sloped ground. For example, the weight of frame 108 due to gravity acting in a downhill direction on a transverse slide slope may result in a gravitational drift force acing upon implement 100 that causes agricultural implement 100 to drift/slide in a downhill direction relative to propulsion unit 102. The angle of the side slope, speed of the implement 100 and the grip/resistance forces between ground surface 106 and the implement 100 may contribute towards the amount of side drift. The grip/resistance forces acting against the gravitational forces, that arise between ground surface 106 and implement 100 that compensates for the forces acting to move the frame sideways, is influenced/determined by a number of factors such as the specific characteristics of the wheels 197 and associated tires of front wheeled support units 900-910 and of rear wheeled support units 300a, 300b, 920, 922, 924, 930, 932, 934, the weight of implement 100, the characteristics of the ground engagers 800, and the composition and moisture content of the material beneath ground surface 106.

A skewed or skidding orientation of implement 100, relative to propulsion unit 102 is undesirable as it may cause agricultural implement 100 to not pass over substantially the same area as propulsion unit 102, causing areas of ground surface 106 to be left unengaged. If implement 100 is being used in seeding operations, a skewed or skidding orientation may cause uneven spacing between adjacent seeded rows. This is a problem when treating on side slopes as the weight of agricultural implement 100 acting in a downhill direction may contribute to side drift. A precise and consistent level of engagement with the surface 106 may be desirable in order to achieve a constant seed depth which in turn may result in healthy crops and high yields for crops grown in the soil defining the surface 106. Precise and consistent levels of engagement may also reduce wear and tear on machines. To counteract downhill side drift of agricultural implement 100, a mechanism that compensates for the side slope forces such as side slope gravitational forces is provided such that the central rear wheeled support units 300a, 300b of steerable assembly 200 may be actively steered by having the orientation of the wheels adjusted by a steering actuation mechanism, relative to the longitudinal X direction and transverse Y direction, in order to correct/compensate for/counteract the tendency for downhill side drift of agricultural implement 100. By adjusting the direction of the steerable wheels of the rear wheeled support units 300a, 300b to steer upwards against the downhill direction of the side slope, counteracting forces against the side slope forces acting on the implement (e.g. from gravity) may result from the interaction of the steered wheels (and the tires of such wheels) with the ground surface (i.e. as the implement is pulled generally forward by the propulsion unit, there will be a component of force acting upwards against the side slope, resulting from the uphill angled direction of the wheels).

As described above, lower pivot pin 256 of pivot pin assembly 254 is received in opening 252 of walking beam 218a such that walking beam 218a is configured for horizontal rotation relative to pivot pin assembly 254 about generally vertically orientated steering axis 258 shown in FIGS. 9A and 9B. With reference to FIG. 9C, walking beam 218a may be configured and operable to rotate/pivot from a straight ahead X direction, in either a clockwise or counterclockwise direction about steering axis 258 as indicated by arrows 338 (to the position shown in FIG. 9D) and 340 (to the position shown in FIG. 9E) respectively. Rotation in either direction may be permissible to vary a steering angle θ of walking beam 218a and wheels 316a and 316b, up to a maximum steering angle θₘₐₓ relative to the longitudinal direction of frame 108 in either direction. In some embodiments the maximum steering angle θₘₐₓ, may be about 30 degrees in either of the directions indicated by arrows 338 and 340.

As shown in FIG. 9B, steering axis 258 may be tilted such that the upper end region is tilted backwards, in the range of 5-10 degrees and preferably 7.5 degrees from the vertical direction axis Z (also known as the rake angle). As such, steering axis 258 is configured such that as walking beam 218a rotates to either of the positions shown in FIGS. 9D and 9E, wheels 316a, 316b will lean from a vertical orientation towards a horizontal position, i.e. wheels 316a, 316b will move from a neutral camber orientation to a negative camber orientation to lean/face down at an angle towards surface 106 (as also seen in FIG. 2F). The negative camber when in a rotated position may increase the traction of the tires of wheels 316a, 316b as the tread of the tires, rather than the side wall remains in contact with surface 106 and also increases the lifespan of the tires by reducing scrubbing across surface 106. The negative camber angle of wheels 316a, 316b may be in the range of 5-30 degrees. Further, the caster effect caused by leaning of wheels 316a, 316b towards a horizontal position may assist in recentering wheels 316a, 316b from a rotated/pivoted position about the steering axis 258.

With reference to FIG. 9C, horizontal rotation of walking beam 218a and wheels 316a, 316b attached thereto about king pin/pivot pin 256 may be actuated and controlled by the actuation system that may include a double (two-way) acting hydraulic cylinder 402a with reciprocating piston rod 404a pivotally interconnecting transversely oriented rear wheel axle 216 and pivot pin assembly 254. Hydraulic cylinder 402a may have a front (or cap) end pivotally interconnected to sleeve 344 through a tab 346 affixed to the outer surface of sleeve 344. Sleeve 344 may be received on the end of shaft portion 292 of upper pivot pin 262 that protrudes from steering hub 208a and is able to pivot about shaft portion 292. Sleeve 344 and tab 346 may be formed as a weldment from steel pieces. Hydraulic cylinder 402a may be interconnected to tab 346 through a pivotal linkage 347, such as a clevis fastener such that cylinder 402a can rotate about a pin 349 of fastener 347 (FIG. 9C). Sleeve 344 may be generally tubular and sized to fit over the end of shaft 292 of upper pivot pin 262 projecting from opening 260 of pivot pin assembly 254 (FIG. 7B) and is retained by floating washer 348. Hydraulic cylinder 402a may have an extendible piston rod 404a and rear (or rod) end of hydraulic cylinder 402a may be connected to the end of axle 216 by a pivotal linkage 352 (such as a clevis fastener) and be able to apply an axial force F_{A} (FIG. 9C). Due to the direction of force F_{A} hydraulic cylinder 402a which has a radial component relative to the generally vertical steering axis 258, hydraulic cylinder 402a is able to apply both a clockwise and counter-clockwise torque to walking beam 218a and wheels 316a, 316b attached thereto, in order to pivot them in a clockwise and counter-clockwise direction about the generally vertical steering axis 258.

Sleeve 344 may be configured for rotational movement about pivot upper pivot pin 262 such that during vertical movement of walking beam 218a about transversely orientated pivot axis 320, hydraulic cylinder 402a will maintain the same length and wheels 316a, 316b will remain pointed in the same direction throughout the range of movement of walking beam 218a about axis 320.

In some embodiments, the actuation system, for actuation the generally horizontal rotation of walking beam 218a and wheels 316a, 316b attached thereto about king pin/pivot pin 256 may be actuated by a different of actuator than a hydraulic cylinder, such as for example an electrically powered servo drive motor mechanism.

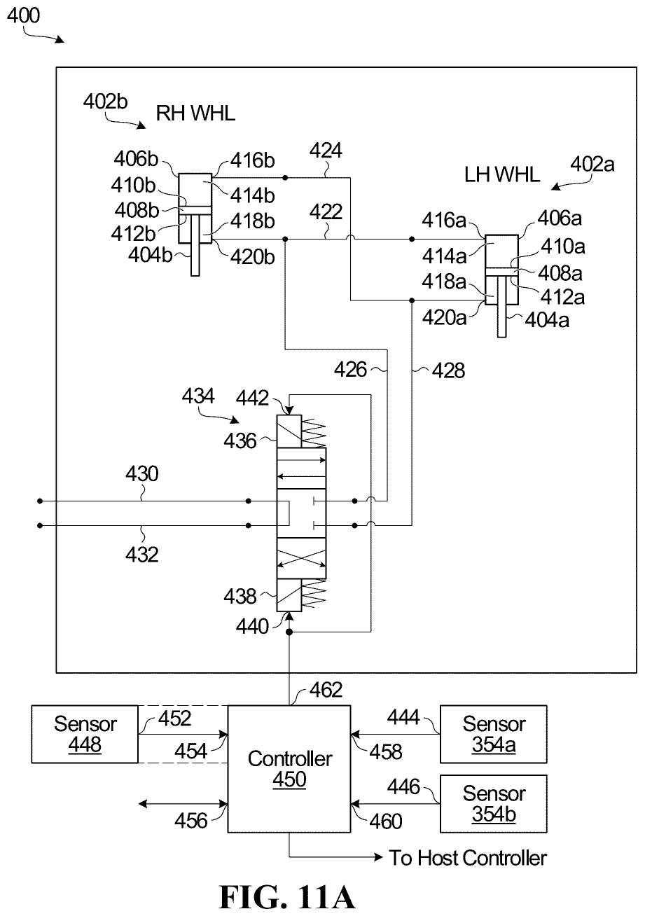

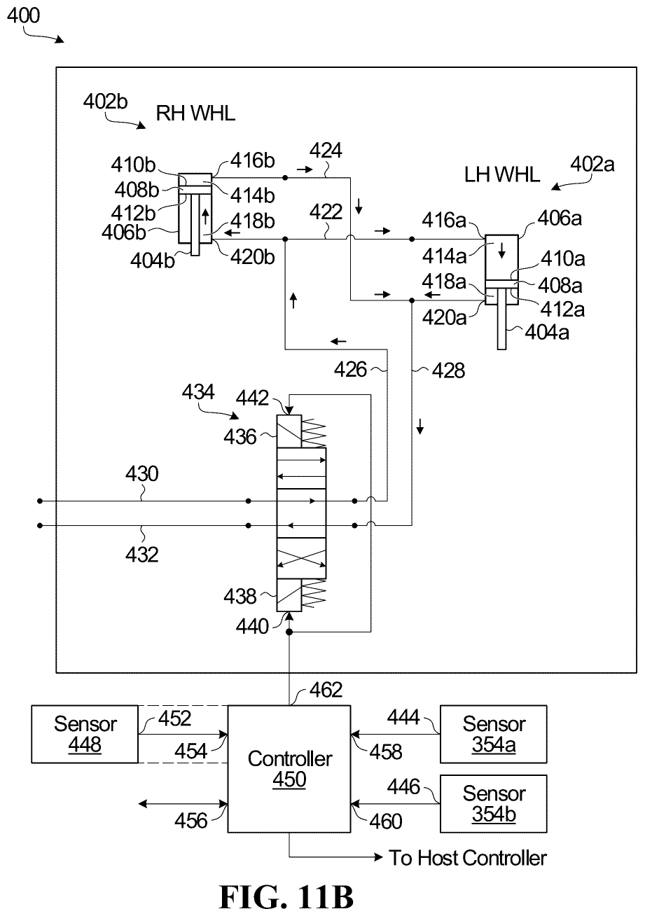

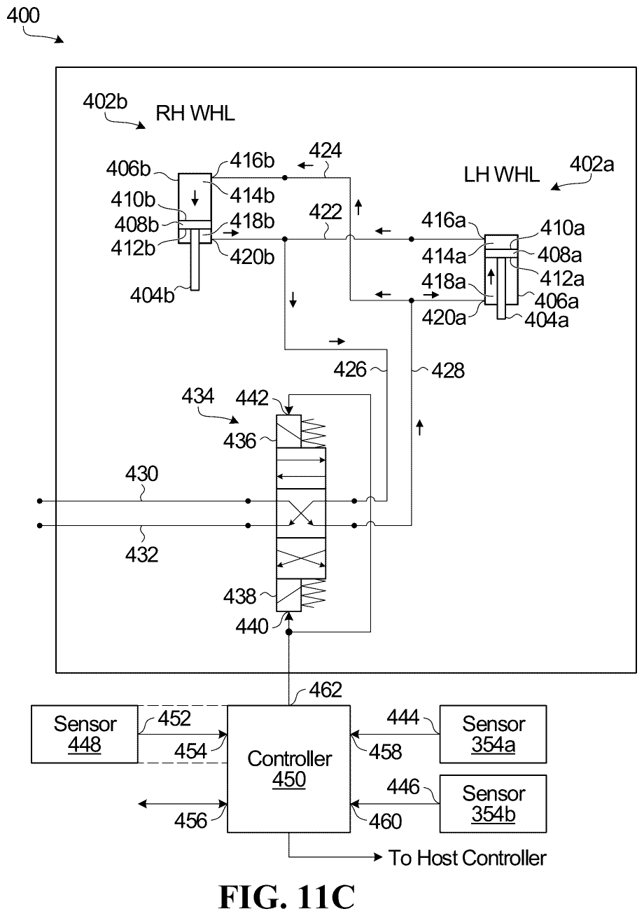

In some embodiments, the operation of the actuation system comprising at least in part hydraulic cylinder 402a (and of hydraulic cylinder 402b) may be accomplished manually by an operator (such as an operator of propulsion unit 102, who may actuate a suitable manual device (such as a control lever in the cab) to actuate and control the control valve(s) in a hydraulic fluid circuit to control the flow of pressurized fluid to and from hydraulic cylinder 402a. Additionally, or alternately, as will be outlined in greater detail below, the operation of hydraulic cylinder 402a may be controlled by a programmable computer controller such as a controller 450 (FIG. 11A), which may at least in part, operate and control the control valve(s) in a hydraulic fluid circuit to control the flow of pressurized fluid to and from hydraulic cylinder 402a. When hydraulic cylinder 402a is extended from a neutral position, the distance between upper pivot pin 262 on steering hub 208a and axle 216 of waking beam 218a may be increased, the applied force F_{A} causes walking beam 218a and wheels 316a and 316b attached thereto to rotate in the direction indicated by arrow 338 in FIG. 9C to the position shown in FIG. 9D. When hydraulic cylinder 402a is retracted from the neutral position, the distance between upper pivot pin 262 on steering hub 208a and axle 216 of walking beam 218a will decrease, with the applied force F_{A} causing walking beam 218a and wheels 316a and 316b attached thereto to rotate in the direction indicated by arrow 340 to the position shown in FIG. 9E. Thus, through control by an operator and/or controller 450 of the operation of hydraulic cylinder 402a and the distance that piston rod 404a is extended or contracted, may control the selected steering angle 316a, 316b of the wheels (and the maximum steering angle θ) of walking beam 218a and wheels 316a, 316b relative to the longitudinal direction of frame 108 in either direction. The maximum permissible angle of rotation—steering angle θₘₐₓ—in either direction will be determined at least in part, by the stroke length of hydraulic cylinder 402a and the respective physical distances and arrangements of the relevant parts inter-connected thereto.

In an example embodiment, walking beam 218a, including attached wheels 316a, 316b can rotate in either direction about vertically orientated steering axis 258 up to a maximum steering angle θₘₐₓ in the range of about 10 to 15 degrees and most preferably in the range of 13 to 14 degrees. In other embodiments, the maximum steering angle θₘₐₓ may be in the range of about 25 to 45 degrees.

Left-side rear wheeled support unit 300a may also include a wheel steering angle rotation sensor 354a (FIG. 9B) associated with pivot pin assembly 254 and configured to generate a rotation signal representing the respective rotation of walking beam 218a (and the wheels attached thereto) from a neutral—straight ahead orientation, about steering axis 258. As will be explained in greater detail below, wheel steering angle sensor 354a may provide a signal to controller 450 (FIG. 11A) to identify the wheel steering angle from the neutral straight-ahead longitudinal position over time and may also verify that a required wheel steering angle has been achieved. In an embodiment sensor 354a is a rotary position sensor, configured to produce a rotation signal representing zero degrees of rotation when walking beam 218a is the straight-ahead position. Rotation of walking beam 218a in the direction indicated by arrow 338 in FIG. 9C may result in a negative change in the rotation signal and rotation in the direction indicated by arrow 338 may result in a positive change in the rotation signal. In a specific embodiment, sensor 354a may generate a rotation voltage signal of 2.5 V in the straight-ahead position and a decrease or increase in voltage depending on the direction of rotation of walking beam 218a.

Rotation of walking beam 218a in the direction indicated by arrow 338 in FIG. 9C to the position shown in FIG. 9D may result in a rotation voltage signal of 0.5V from sensor 354a. Rotation of walking beam 218a in the direction indicated by arrow 340 in FIG. 9C to the position shown in FIG. 9E may result in a rotation voltage signal of 4.5V from sensor 354a.

Referring back to FIGS. 7A to 7C, sensor 354a may be mounted to sensor mount 356, which is in turn affixed to the lower front portion of end plates 264. A covering plate 358 (shown in FIGS. 7A and 7B and removed in FIG. 7C for clarity) may be affixed to the outer edges of sensor mount 356 and may operate to protect sensor 354a from dust and debris or inclement weather. Sensor 354a may include first arm 360, affixed to sensor mount 356 and second arm 362, affixed to a bracket 364 on the upper surface of walking beam 218a (FIG. 9B). As walking beam 218a rotates about steering axis 258, relative movement of second arm 362 to first arm 360 will cause a change in the rotation signal produced by sensor 354a. As shown in the FIGS. first and second arms 360, 362 are offset from each other, such that the ratio of movement of first and second arms 360, 362 can be adjusted for different ranges of motion for walking beam 218a.

Steering angle rotation sensor 354a may be a hard-wired sensor and wires may be run through leg member 206 to controller 450. In other embodiments, sensor 354a may be a sensor capable of wireless communication with a control system. Various other rotation sensors may be used such as inductive sensors, resistive sensors, or optical rotary encoders. In an example embodiment, sensor 354a is a 5-volt ratiometric angle sensor manufactured by Hella GmbH.

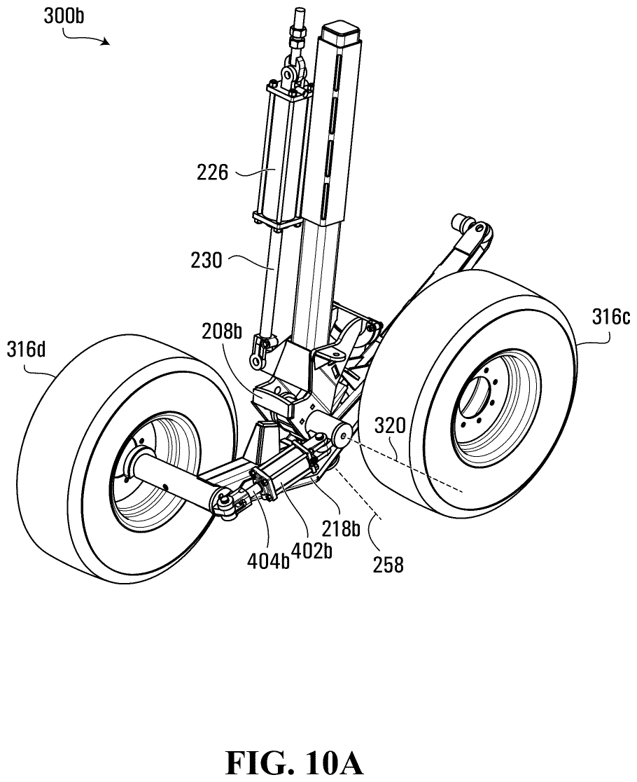

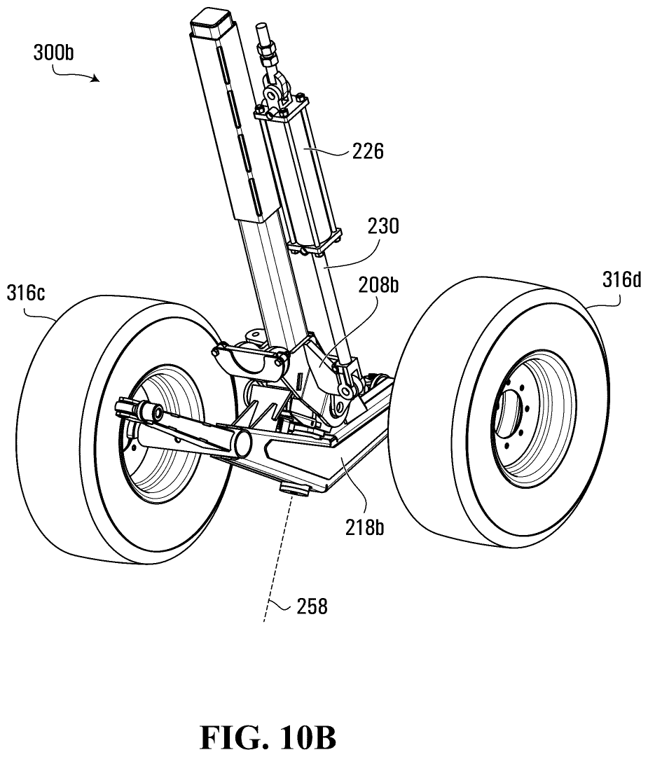

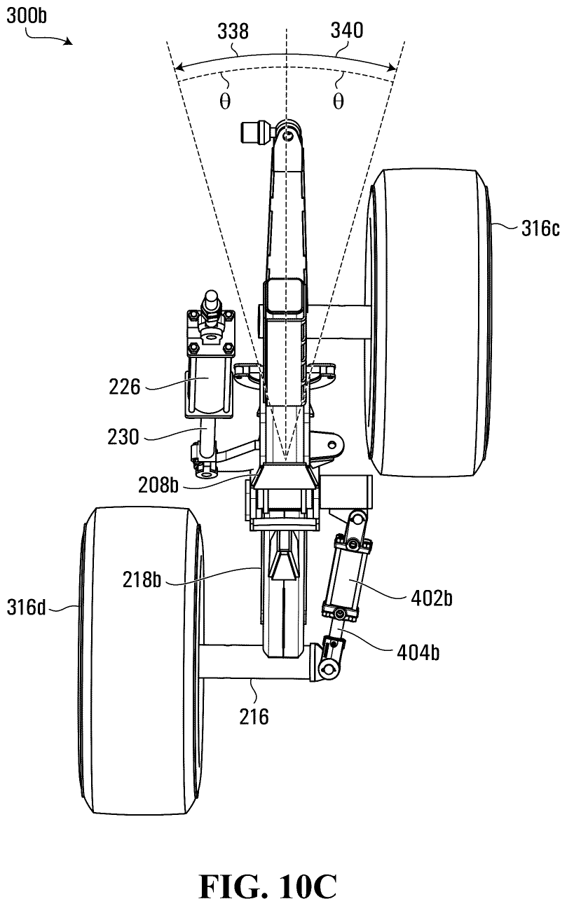

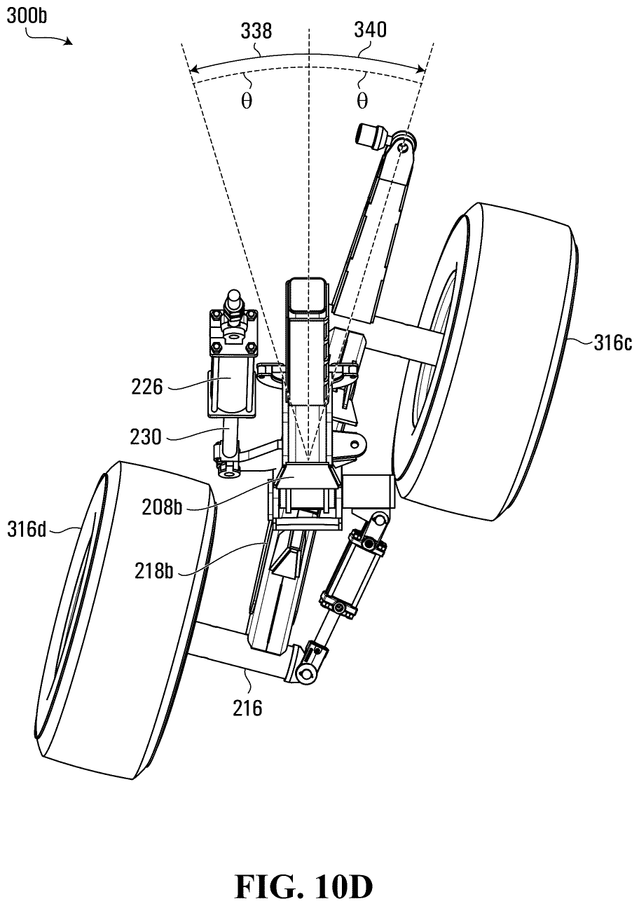

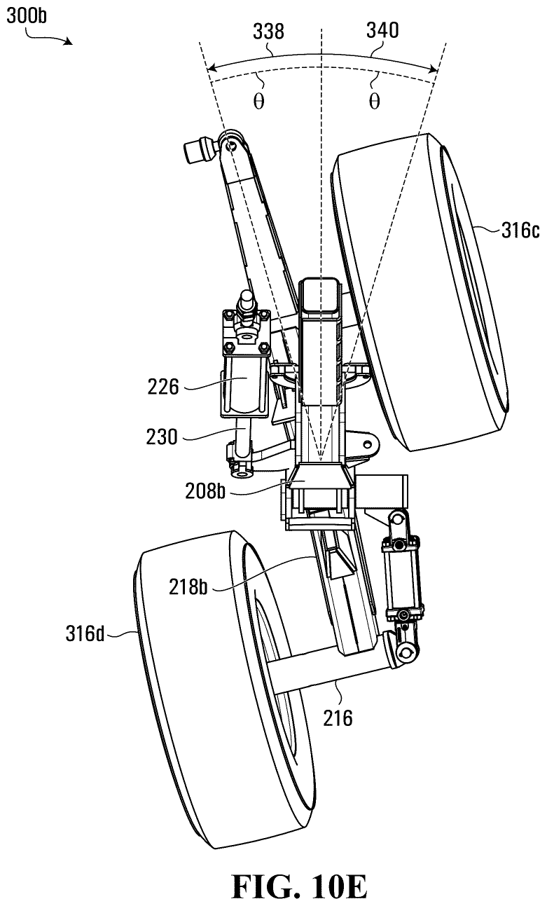

With reference to FIGS. 10A-E, right-side rear wheeled support unit 300b is depicted. The right side rear wheeled support unit 300b may be constructed in substantially the same manner to left-side rear wheeled support unit 300a, but some components may be separate right-hand components as opposed to the left-hand of left-side support unit 300a. For example, walking beam 218b of right-side support unit 300b may be constructed in a similar manner to walking beam 218a of left-side support unit 300a, but are mirror images of each other. Similar to walking beam 218a, walking beam 218b (and wheels 316c and 316d attached thereto) is also configured to rotate about a transversely orientated pivot axis 320 and a generally vertically orientated steering axis 258 as shown in FIG. 10A.

Due to the right-hand components used in right-hand support unit 300b, extension of hydraulic cylinder 402b of rear wheeled support 300b from the position shown in FIG. 10C will increase the distance between upper pivot pin 262 on steering hub 208b and axle 216 of waking beam 218b, causing walking beam 218b and wheels 316c and 316d attached thereto to rotate in the direction indicated by arrow 340 in FIG. 10C to the configuration shown in FIG. 10D. When hydraulic cylinder 402b is retracted, the distance between upper pivot pin 262 on steering hub 208b and axle 216 of walking beam 218b may be decreased, causing walking beam 218b and wheels 316c and 316d attached thereto to rotate in the direction indicated by arrow 338 in FIG. 10C to the configuration shown in FIG. 10E. Similar to left-side support 300a, the distance that piston rod 404b of hydraulic cylinder 402b is contracted will determine the steering angle θ of walking beam 208b and wheels 316c, 316d relative to frame 108 in either direction. Preferably, the maximum steering angle θₘₐₓ of left-side support unit 300a, will be similar to the maximum steering angle θₘₐₓ of right-side support unit 300b.

Similar to wheel steering angle rotation sensor 354a of left-side support unit 300a, support unit 300b may also include a wheel steering angle rotation sensor 354b, configured to provide feedback to controller 450 to verify that a desired wheel steering angle has been achieved by support unit 300b.

Referring back to FIGS. 3A to 3C, left-side and right-side support units 300a, 300b may be pivotally interconnected and mechanically tied together by track rod 204 through a pair of eyebolts 250a, 250b at opposite ends of track rod 204 to form steerable rear wheeled assembly 200. At the left end of track rod 204 (in FIG. 3A) eyebolt 250a is connected to the front end of pivot bar connector 244a of left-side support unit 300a. At the right end of track rod 204 eyebolt 250b is connected to the front end of pivot bar connector 244a of right-side support 300b. As will be explained in greater detail below, track rod 204 ensures and provides assistance so that the walking beams 218a, 218b and their corresponding pairs of wheels 316a, 316b, and wheels 316c and 316d attached thereto move in unison and undergo the same degree of rotation about their respective steering axes relative to the straight-ahead longitudinal direction, when subjected to forces created by operation of hydraulic cylinders 402a, 402b.

### Counter-Steer Control System

In a manual operator controlled steering system, an operator in propulsion unit 102 may be able to visually observe the position/movement/orientation of agricultural implement 100 relative to propulsion unit 102 and by operation of manual controls effect desired changes in the orientations/steered direction of the wheels units 300a, 300b. However, in some embodiments, manual operator control may be supplemented by or replaced by a computer based control system. This computer-based control system may be capable of controlling a side tilt counteracting mechanism as described herein, that may comprise steering assembly 200.

With reference to FIGS. 11A-C, an embodiment of a control system for steering assembly 200 (which may be part of the hydraulic fluid supply and control system of propulsion unit 102) is shown generally at 400. The hydraulic fluid supply and control system of propulsion unit 102 may, as described above, also include integrated control systems for controlling other aspects of agricultural implement 100, such as the height of rows of open members of frame 108, and/or as disclosed in U.S. Pat. No. 11,122,725 B2 as referenced above. Control system 400 may control valve 434 that controls the operation of hydraulic cylinder 402a associated with left-side support unit 300a and hydraulic cylinder 402b associated with right-side rear support unit 300b. As described above hydraulic cylinders 402a, 402b are configured to pivot the walking beams 208a, 208b and respective attached wheels of support units 300a, 300b about their generally vertically orientated steering axes 258.

Hydraulic cylinder 402a may include hydraulic chamber 406a having a reciprocally moveable piston 408a therewithin connected to piston rod 404a. Piston 408a may have upper and lower faces 410a, 412a and divides hydraulic chamber 406a into cap end chamber 414a having cap end hydraulic fluid port 416a and rod end chamber 418a having rod end hydraulic port 420a.

Similarly, hydraulic cylinder 402b is configured with hydraulic chamber 406b having a reciprocally moveable piston 408b therewithin connected to piston rod 404b. Piston 408b may have upper and lower faces 410b, 412b and divides hydraulic chamber 406b into cap end chamber 414b having cap end hydraulic fluid port 416b and rod end chamber 418b having rod end hydraulic port 420b. Hydraulic cylinders 402a and 402b may have the same size chamber volumes, piston rods, same size pistons and piston rods, and have the same stroke distance. In other embodiments, it may possibly be desirable that cylinders may have some varying dimensions such as for example some having smaller diameter cylinders with longer stroke lengths and others with relatively larger diameter cylinders with shorter stroke lengths. With cylinders being connected in series the system can be configured such that the volume of hydraulic fluid being displaced on each stroke is the same in each of the cylinders connected in series.

As shown in FIG. 11A hydraulic pistons 408a, 408b are at the approximate mid-points of respective hydraulic chambers 406a, 406b, which corresponds to the straight-ahead position/longitudinal orientation for rear wheeled assembly 200 shown in FIG. 2B.

The cap end port 416a of hydraulic cylinder 402a may be hydraulically connected to rod end port 420b of hydraulic cylinder 402b by hydraulic fluid line 422. Hydraulic fluid line 424 hydraulically connects rod end port 420a of hydraulic cylinder 402a to the cap end port 416b of hydraulic cylinder 402b. Hydraulic fluid lines 422 and 424 are connected to hydraulic fluid lines 426, 428 respectively which are in turn selectively connected to a pressurized hydraulic fluid supply line 430 and return line 432 through a directional valve 434 (shown schematically in FIG. 11A). Valve 434, which may be located on agricultural implement 100, may be coupled to a pressurized hydraulic fluid supply system (not shown) that may be mounted on propulsion unit 102—and which may include a hydraulic fluid pump and hydraulic fluid reservoir—through lines 430 and 432 such as by quick connection fittings (not shown).

As shown in FIG. 11A and described above, hydraulic cylinders 402a and 402b are connected in a cross-parallel arrangement. As such, through control of valve 434, pressurized hydraulic fluid may be selectively supplied to line 426 in order to cause cylinder 402a to expand (and its piston rod extend) whist cylinder 402b contracts (its piston rod retracts), or pressurized hydraulic fluid may be supplied to line 428 to cause cylinder 402a to contract (its piston rod retracts) whilst cylinder 402b expands (its piston rod extends).

Control of directional valve 434 may be achieved through an internal control spool that may be actuated for straight-through flow via solenoids 436 and 438 to selectively permit fluid flow from supply line 430 to line 426 and for fluid to flow back from line 428 to return line 432. Alternatively, directional control valve 434 may be actuated for cross-flow to selectively permit fluid flow from supply line 430 to line 428 and for fluid to flow back from line 426 to return line 432.

When valve 434 is actuated for straight-through flow, hydraulic fluid may flow through lines 426, 422 to cap end port 416a of hydraulic cylinder 402a and rod end port 420b of hydraulic cylinder 402b. At the same time, fluid is permitted to flow back from rod end port 420a of hydraulic cylinder 402a and cap end port 416b of hydraulic cylinder 402b, through lines 424 and 428 to return line 432. This will cause hydraulic cylinder 402a to expand in length as hydraulic fluid acts upon upper face 410a of piston 408a. At the same time, hydraulic cylinder 402b contracts in length as hydraulic fluid acts upon lower face 412b of piston 408b. As described above, this motion of opposite acting hydraulic cylinders will cause support units 300a, 300b of rear wheeled assembly 200 to move from the straight-ahead position shown in FIG. 2B to the right-turned position shown in FIG. 2D.

When valve 434 is actuated for cross-flow hydraulic fluid may flow through lines 428 and 424 to rod end port 420a of hydraulic cylinder 402a and cap end port 416b of hydraulic cylinder 402b. At the same time fluid is permitted to flow back from of end port 420a of hydraulic cylinder 402a and cap end port 416b of hydraulic cylinder 402b, through lines 422, 426 to return line 432. This will cause hydraulic cylinder 402a to contract in length as pressurized hydraulic fluid acts upon lower face 412a of piston 408a. At the same time, hydraulic cylinder 402b extends in length as pressurized hydraulic fluid acts upon upper face 410b of piston 408b. As described above, this motion of opposite acting hydraulic cylinders will cause support units 300a, 300b of rear wheeled assembly 200 to move from the straight-ahead position shown in FIG. 2B to the left-turned position shown in FIG. 2C.

For an equal hydraulic pressure is applied to opposite sides of the hydraulic piston cylinders 402a, 402b, there may be a greater force applied to upper faces 410a, 410b in comparison to lower faces 412a, 412b. This is due to the connection of piston rods 404a, 404b to pistons 408a, 408b reducing surface area for the pressurized hydraulic fluid to act upon at lower faces 412a, 412b. As cylinders 402a, 402b are connected in a cross parallel arrangement, this force imbalance could result in different degrees of rotation for each of support units 300a, 300b when hydraulic fluid at the same pressure is supplied to cylinders 402a, 402b. This is undesirable as varying steering angles between support units 300a, 300b may cause agricultural implement 100 to move further out of alignment with propulsion unit 102. This may be prevented by having rear support units 300a, 300b interconnected by track rod 204, which provides an equalization force mechanism, which may ensure that the two units will rotate the same amount despite any force imbalance acting across cylinders 402a, 402b.

The solenoids 436, 438 are responsive to the electrical control signals provided at inputs 440, 442 to cause the internal control spool to move between the straight-through flow and cross-flow configurations in order to affect a change in the orientation of the wheels of support units 300a, 300b. Valve 434 may be a “bang-bang” controlled valve. For example valve 434 may be configured and operable such that: (a) if zero volts are applied to the solenoids 436, 438 then the solenoid is not activated and valve springs ensure that the valve is positioned in the closed positions (FIG. 11A) and fluid is not permitted to flow through valve 434; (b) when 12 volts is applied producing a current of about 3 amps to either of the solenoids 436, 438 then the respective solenoid is activated and the valve is actuated for either straight-through flow (FIG. 11B, if solenoid 436 is activated) or cross-flow (FIG. 11C if solenoid 438 is activated).

If zero volts are applied to solenoids 456, 460 then the solenoids are not activated and the valve springs ensure that the valve 434 is in the closed position (FIG. 11A). This will effectively seal the hydraulic cylinders 402a, 402b from any changes in hydraulic fluid pressure, and hold their position. In this scenario, hydraulic cylinders 402a, 402b (and therefore the wheels of support units 300a, 300b) will remain fixed in the same angular orientation about steering axis 258 (which may be the straight-ahead orientation or any other selected orientation).

When 12 volts is applied to a solenoid 436 (FIG. 11A), resulting in straight through flow in valve 434, then hydraulic cylinders 402a, 402b will be operated to cause the left wheel unit 300a to move for example from the position in 9C to the position shown in FIG. 9D and the right wheel unit 300b to move from the position shown in FIG. 10C to the position in FIG. 10E. Similarly, when 12 volts is applied to solenoid 438, resulting in cross-flow through valve 434, then hydraulic cylinders 402a, 402b will be operated to cause the wheel unit to move for example the left wheel unit 300a to move for example from the position in 9C to the position shown in FIG. 9E and the right wheel unit 300b to move from the position shown in FIG. 10C to the position in FIG. 10D.

In other embodiments, valve 434 may be a proportionally controlled directional valve.

### Control System Sensors

Control system 400 may also include steering angle rotation sensor 354a, associated with left-side support unit 300a, and steering angle rotation sensor 354b, associated with right-side support unit 300b as described above. Sensors 354a, 354b have respective outputs 444, 446 (FIG. 11A) for generating rotation signals representing the rotation of the respective support units 300a, 300b as described above. In one embodiment, sensors 354a, 354b may be configured to each produce rotation signals representing a zero angular rotation when wheels 316a-d of support units 300a, 300b are orientated in the straight-ahead direction/longitudinal orientation (such as shown in FIG. 2B). Angular deviation of wheels 316a-d to one side may result in in a positive angle signal and an angular deviation to the other side may result in a negative angular signal from steering angle rotation sensors 354a, 354b.

In an embodiment, control system 400 includes a frame orientation sensor 448 having an output 452 for producing a frame orientation signal representative of the orientation of frame 108 in the X-Y-Z frame of reference of FIG. 1. The frame orientation sensor 448 is indicative of, and detects, the orientation of the frame 108, which correlates with the orientation of the ground surface upon which the frame 108 and its ground engagers are supported. Thus, frame orientation sensor 448 may also be considered a ground surface orientation sensor. As the wheels of front and rear wheeled units of implement 100 pass over a ground surface that changes in orientation, this results in a change in the orientation of the frame members of frame 108 and thus a change the orientation of the sensor 448 attached to one of these frame members. Thus, frame orientation sensor 448 may be in effect a sensor that detects the orientation of the ground surface beneath frame 108 (and changes therein), including in particular the side tilt/slope angle of the ground surface beneath the frame as it is supported on the wheels of the front and rear wheeled units.

In some embodiments, other types of sensors might possibly be utilized to detect/determine the orientation of the ground surface upon which the frame is supported, including the side tilt angle of the ground surface.

It should be noted that sensor 448 is not detecting whether frame 108 has moved out of longitudinal/transverse alignment with propulsion unit 102. Thus, sensor 448 may sense a change in the side tilt angle (and optionally the fore/aft tilt) of frame 108 before frame 108 side drifts/slides sideways and moves out of longitudinal/transverse alignment with propulsion unit 102. In an embodiment, frame orientation sensor 448 may include an accelerometer and/or gyroscopic sensor, configured to detect parameters such as the roll, downhill angle (pitch) and yaw of frame 108. Sensor 448 may be manually or automatically calibrated to read a roll angle of zero degrees when frame 108 is on flat and level ground. In some embodiments other types of sensors that detect the orientation of the frame and/or the ground surface may be employed.

Sensor 448 may be positioned in any suitable location on frame 108. For example, sensor 448 may be placed on a flat upper surface of an upper flange of open member 706 (FIG. 4B). By mounting sensor 448 on a such a surface which is level, when frame 108 is positioned on level ground, the sensor 448 may thus be easily calibrated. In an embodiment sensor 448 is a 6 DOF IMU sensor manufactured by STMicroelectronics N.V. In some embodiments sensor 448 may be an accelerometer capable of measuring vertical and horizontal acceleration (and in some embodiments being a 3-axis sensing accelerometer). Sensor 448 may measure acceleration in relation to its own frame for reference that may be defined in part its upward/downward axis Z″ and its side to side/transverse axis Y″ (see FIGS. 4D and 4E) and may be configured and operable to detect the changes in the direction of weight. If the magnitude of acceleration/weight is known along each axis Z″ and Y″, then the roll/side tilt angle of the sensor 448, and the roll/side tilt angle of frame 108 to which it is attached can be derived and this correlates with (and may be the same as) the side tilt angle of the ground surface upon which the frame 108 is supported.

In some embodiments, sensor 448 may be provided with appropriate electrical power and other wires/cables to communicate with other components of control system 400 including controller 450.

In some embodiments, frame orientation sensor 448 may take the form of a semi-conductor chip that is operationally located on the control circuit board of controller 450. In such embodiments, controller 450, with embedded frame sensor 448, may be mounted onto a flat upper surface of an upper flange of open member 706 (FIG. 4B) and may be provided with appropriate electrical power and other wires/cables to communicate with other components of control system 400. Controller 450 may also be in communication with a host controller on propulsion unit 102. Controller may be provided with appropriate electrical power and other wires/cables to communicate with other components of control system 400.

In an embodiment, sensor 448 may only measure or provide signals indicative of force/acceleration in the Z″ and Y″ directions. The acceleration measured by sensor 448 may be measured as a function of gravity, from which the roll/side tilt angle of frame 108 can be calculated by measuring the magnitude and direction of the proper acceleration as a vector quantity and thus can be used to sense the orientation of the accelerometer (and the component of the frame it is attached thereto) because of the direction of weight changes experienced by the accelerometer.

Thus, an accelerometer 448 may be operable to report values of the acceleration/force along the Z″ axis and the Y″ axis. As will be apparent, the orientation of the axes Z″ and Y″ relative to the direction of gravity may be derived from the value readings provided by the accelerometer. For example, as shown in FIG. 4D, when frame 108 is on ground that is substantially flat and level, the sensor 448 may initially measure 1G in a direction straight down to the ground surface (i.e., generally perpendicular to the ground surface in the direction of Z″). When implement 100 moves to ground that is not flat and level, for example ground that is sloped/tilted sideways downwards to the right (FIG. 4E) then sensor 448 may measure for example Z″″(beta) of 0.8G in the Z″″ direction and Y″(beta) of 0.2G in the Y″ direction. From this g-value information, control system 400 may be operable to calculate (such as from a vector diagram and for example using the Pythagorean Theorem and deriving an angle beta therefrom) to establish the roll/side tilt angle beta of frame 108.

Once the roll/side tilt angle of frame 108 has been established, a desired steering angle of the wheels of rear wheeled support units 300a and 300b can be also established. The desired steering angle of those wheels may be a function of the side tilt angle. For example, in an embodiment, the greater the side tilt angle that is determined, then the greater the desired steering angle for the wheels that is desired and sought to be established. In other embodiments, there may be only one desired steering angle of the wheels of rear wheeled support units 300a and 300b that is sought to be established. The desired steering angle of those wheels will be sought it there is any side tilt angle at all, or if there is a side tilt angle that is greater than a threshold side tilt angle.

With reference to FIGS. 11A-C, control system 400 may also include controller 450, which may receive the frame orientation signals from sensor 448 (and any other sensor signals) through input 454. The controller 450 also includes inputs 458 and 460 for receiving the rotation signals from respective outputs 444, 446 of steering angle rotation sensors 354a, 354b.

An algorithm of controller 450 may determine a required steering direction (ie. left or right from the straight-ahead direction) and the magnitude of the desired steering angle for the wheels of rear wheeled support units 300a, 300b, to prevent or at least counter drift of agricultural implement 100 based on the frame orientation signals received from sensor 448 and the side tilt/roll angle derived therefrom. In some embodiments, the required steering direction and angle may be determined using a look up table, utilizing calculated values that are stored in a database that can be accessed by the controller.

In an embodiment, the steering system may operate in a manner such that the greater the angle of side tilt of frame 108, the greater the steering angle to compensate for the greater the side tilt angle and an algorithm may be provided to calculate the desired steering angle. For an example for a calculated roll/side tilt angle of −0.2 degrees—and given that steering angle rotation sensors 354a, 354b may have a range of 0.5V to 4.5V (where 2.5V corresponds to the straight ahead position for rear wheeled support units 300a, 300b, 0.5 V corresponds to full steering to the left and 4.5 V corresponds to full steering to the right), then a target voltage value for sensors 354a, 354b may be determined by dividing the calculated roll angle by 4, followed by addition of 2.5V (to correct for 2.5V being equivalent to 0 degrees steering). In this example, for −0.2 degrees roll angle the target value for steering angle rotation sensors 354a, 354b is (−2/4)+2.5=2V (which is equivalent to a gentle turn to the left for wheeled support units 300a, 300b). This algorithm will work up to a maximum frame side tilt angle in each direction. Once a maximum measured frame side tile angle in either direction is reached and/or exceeded, the maximum steering angle will be maintained until the frame side tilt angle falls below the maximum frame side tilt angle. In some embodiments, it is possible that the maximum steering angle could be restricted by the physical arrangements of the steering components. Typically, it will be the measured frame side tilt angle which will control the maximum steering angle.

Controller 450 may then produce an appropriate valve control signal through output 462 for driving solenoid 436 or 438 to cause directional valve 434 to be completely open in the straight-through flow or cross-flow configuration to change the steering angle and direction of steerable rear wheeled assembly 200. Rotation signals from respective outputs 444, 446 of steering angle rotation sensors 354a, 354b may be used to confirm if, and when, the calculated required target voltage and (thus corresponding target steering angle) (2V in the example above) for steerable rear wheeled assembly 200 has been achieved. The orifice of valve 434 may be sized to restrict the flow of hydraulic fluid through valve 434 to prevent steerable rear wheeled assembly 200 overshooting the required steering angle, when direction valve 434 is open in the straight-through flow or cross-flow configuration. Once the actual steering voltage from steering sensors 354a, 354b reaches the desired calculated steering voltage (and thus the desired steering angle) the valve control signal may no longer be applied to solenoids 456, 460 and the valve springs will ensure that the valve 434 returns to the closed position and the steerable rear wheeled assembly will be held in the same position.

The controller 450 of control system 400 may be implemented using a microprocessor-based controller such as the Eaton HFX Family of programmable controllers (available from Eaton Corporation plc, Dublin, Ireland) or the JCA electronics Oriole controller (available from JCA Electronics Manitoba, Canada. These controllers may implement a Controller Area Network bus (CAN bus) that may act as a communications port for receiving commands from a host controller (not shown) that may form part of control system 400 and also provide inputs and outputs that may be configured to act as the output and inputs. A communications port of the controller 450 may facilitate connection to a control bus of the host propulsion unit 102 for receiving and sending control signals between the host and the tillage apparatus 100. The host propulsion unit 102 will generally include a host controller (not shown) that operates via a data bus (such as a CAN bus) for controlling the propulsion unit 102 and connected farm implements such as the tillage apparatus 100. Command signals may be received from the host controller at a communications port of controller 450 for controlling operations of the steering actuation system.

The operating/update rate of controller 450/sensor 448 may be relatively slow to ensure that the steering system is not operated in an erratic manner. For example, the frame orientation and steering angle rotation sensors may provide updated signals only once every second.

The control system may also be provided with a user adjustable gain control to increase or decrease the sensitivity of the system. It should be noted that increasing the sensitivity of the system may result in the maximum steering angle being reached a lower frame side tilt angle sooner, i.e., it may effectively decrease the maximum frame side tilt angle described above. Conversely, decreasing the sensitivity of the system may result in the maximum steering angle being reached a greater frame side tilt angle, i.e., it may effectively increase the maximum frame side tilt angle.

The system may operate in an open loop—such that there is no feedback information/data provided to controller 450 as whether the frame 108 is longitudinally and transversely aligned with the propulsion unit that is pulling it forward. When the combination of tillage apparatus 100 and propulsion unit 102 wish to make a turn together (such as at the end of a run in a field), the frame 108 can be lifted to such a height that the ground engagers are not in working positions and the steering system for rear wheeled support units 300a, 300b can be de-activated as referenced herein.

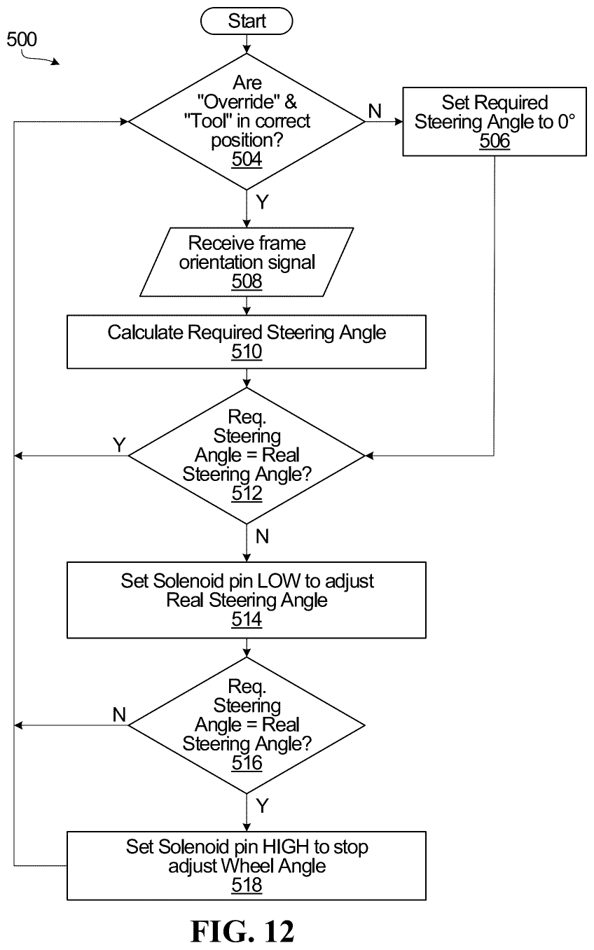

Referring to FIG. 12, a process 500 that can be executed for detecting the orientation of frame 108 of agricultural implement 100 and preventing side drift of implement 100 is shown. The process is initiated by a signal provided by a user or automated process at block 502. At block 504, controller 450 determines if the override for the system if activated and if agricultural implement 100 is in the correct configuration. A correct configuration for agricultural implement 100 would include, for example, all frame sections 130, 132, 134, 136, 138, 140, 142 of frame 108 being in the deployed configuration (as shown in FIG. 1A). The override may be a manual override operated by a user in propulsion unit 102. If the condition at block 504 is not met, for example when agricultural implement 100 is in a transport configuration, the process proceeds to block 506, where the required steering angle for rear support units 300a, 300b is set to 0 degrees.

If the condition in block 504 is met, then the process proceeds to block 508, where a frame orientation signal (as described above)—which may also be a ground surface orientation signal)—is received by controller 450 from sensor 448. At block 510, controller 450 determines, such as via an algorithm or from a look up table, a required steering direction and angle for rear support units 300a, 300b to prevent or counteract side drift of implement 100. In some cases, the required steering angle may be 0 degrees. If controller 450 determines that there is no side drift is likely to occur, i.e., for example if implement 100 is travelling on flat and level ground, the desired steering angle will be 0 degrees. In some cases controller may be configured to operate such that if the frame orientation signal corresponds with a side tilt angle that is below a certain threshold level, then the desired steering angle will be 0 degrees.

In some embodiments, the required steering direction and angle may be a predetermined value obtained from a lookup table. For example, if sensor 448 detects a roll angle of frame 108 of −10 degrees, that roll angle may, as an example, correspond to the wheels of rear support units 300a, 300b being orientated to 10 degrees in the left direction (as determined from the lookup table).

In an embodiment, when sensor 448 detects a roll angle (in either direction) of frame 108 of 8 degrees or more, the required steering angle for the wheels of rear support units 300a, 300b may correspond to the maximum steering angle of rear support units 300a, 300b and any further increase in the roll angle detected by sensor 448 will not result in any change in the required steering angle (i.e. controller 450 will determine the same required steering angle for roll angles greater than 8 degrees).

At block 512, controller 450 determines the difference between the required steering angle and the real steering angle. The real steering angle is determined from rotation signals received from steering angle rotation sensors 354a, 354b as described above. If the condition in block 512 is met, then no adjustments are necessary, and the process returns to block 504.

If the condition in block 512 is not met, at block 514 the process sends a signal to solenoids 436 and 438 in order to cause the internal control spool of valve to move to either of the straight-through flow or cross-flow configurations to control the flow of pressurized hydraulic fluid through directional valve 434 to adjust the position of pistons 408a, 408b within hydraulic cylinders 402a, 402b and thereby adjust the steering angle of support units 300a, 300b. This may be referred to as a “Low” setting for the solenoid pin. In doing so, the steerable wheels 316a, 316b, and steerable wheels 316c, 316d of respective rear wheeled support units 300a, 300b may generally be angled/pointed at least to some extent in a direction uphill—in the opposite direction to the downhill direction of the slope.

At block 516 controller 450 again determines the difference between the required steering angle and the real steering angle. If the condition at block 516 is met, the process proceeds to block 518, and the signal is no longer sent to solenoids 436 and 438 in order to stop adjustment of solenoids 436 and 438 (i.e., the signal is no longer applied to solenoids 436, 438 and the valve springs will ensure that the valve 434 returns to the closed position as described above) in order to fix the settings/position of valve 434 in order to maintain the current steering angle. This may be referred to as a “High” setting for the solenoid pins 436, 438, whereby zero volts are applied to the solenoids 436, 438 and valve springs ensure that the valve is positioned in the closed position. The process then returns to block 504.

If the condition at block 516 is not met, the process returns directly to block 504.

In some embodiments, process 500 may refresh at a rate of 1 Hz, or once per second.

Process 500 may be an open loop system, whereby the controller 450 does not receive any information on the position of frame 108 relative to propulsion unit 102. Therefore control 450 may only determine the required steering angle and direction for the wheels of rear support units 300a, 300b based on the roll angle of frame 108.

In some situations, such as when propulsion unit 102 and implement 100 are making a turn at the end of a field, frame 108 (and the associated ground engagers) may be lifted up from the ground surface. When frame 108 is lifted, at block 504 the override for the system may be automatically activated and the process proceeds to block 506, where the required steering angle for rear support units 300a, 300b is set to 0 degrees.

It should be noted that if it is desired to de-activate the steering system such that the rear wheeled support units 300a, 300b are able to move somewhat freely (albeit there will be some resistance due to the movement of fluid in the system), then the valves can be operated in such a manner that the there is no pressurized hydraulic fluid supplied by the hydraulic fluid supply and control system to the hydraulic circuit of cylinders 402a, 402b. Thus, fluid is able to freely flow into and out of cylinders 402a, 402b and pass freely though valve 474.

### Counteracting Downhill Side Drift/Side Sloping Terrain

It is desirable that implement 100 keeps a generally “square” (longitudinally and transverse aligned) orientation relative to propulsion unit 102, with frame 108 also substantially level and having its central longitudinal axis in longitudinal alignment with, and be parallel to, the central longitudinal axis of propulsion unit 102 (and maintain the open longitudinal members of frame 108 generally parallel to the direction of travel 104 in FIG. 1). However, in some situations, side drift (or side shift) in the Y-direction shown in FIG. 1 may occur that results in agricultural implement 100 moving/pivoting (or being more susceptible to moving/pivoting) into a skewed or skidding configuration, such that it is no longer in this generally longitudinal parallel axis orientation and in longitudinal/transverse alignment with propulsion unit 102 as shown in FIGS. 1A and 1B.

Agricultural implement 100 will typically have a significant overall mass/weight and the gravitational forces acting thereon is supported on the ground surface by the components that are in contact with the ground surface 106. In many embodiments, a relatively small proportion of the overall mass of agricultural implement 100 will be supported by ground engagers 600 that contact the ground surface 106. Most of the mass/weight of agricultural implement 100 will be carried by front wheeled units 900-914 and rear wheeled units 300a, 300b, 922, 924, 926, 930, 932, 934.

Typically, ground engagers 600 themselves will not provide a significant degree of force resistance to side drifting of agricultural implement 100 when agricultural implement 100 is on a side slope, which subjects agricultural implement to a sideways acting drift force.

Side drift typically occurs when agricultural implement 100 is travelling across uneven or side sloping ground. For example, the weight of frame 108 due to gravity acting in a downhill direction on a side slope may result in a sideways (e.g. generally in direction Y in FIG. 1) gravitational drift force acting upon implement 100 that causes agricultural implement 100 to drift/slide in a downhill direction relative to propulsion unit 102. The angle of the slope, speed of implement 100 and the grip/resistance forces between ground surface 106 and the implement 100 may contribute towards the amount of side drifting that occurs. Additionally, if propulsion unit 102 is pulling agricultural implement in a curved path, then there will be centrifugal forces acting and this may cause agricultural implement 100 to pivot outwardly relative to propulsion unit 102, and out of alignment.

The grip/resistance forces acting against the gravitational forces (and/or centrifugal forces), that arise between ground surface 106 and implement 100 are determined from a number of factors such as the specific characteristics of the wheels 197 and associated tires of front wheeled support units 900-910 and of rear wheeled support units 300a, 300b, 920, 922, 924, 930, 932, 934, the characteristics of the ground engagers 800, the weight of implement 100, and the composition and moisture content of the material beneath ground surface 106.

If the propulsion unit 102 has sufficient resistance to avoid sliding sideways (or not slide sideways as much) in the same direction as agricultural implement 100, then agricultural implement 100 may pivot around the pivot connection between tow hitch 50 and receiver 50 such that receiver 51 and towing members 52, 54, pivot relative to tow hitch 50, at their connection location, about a common a generally vertical axis in the direction Z (FIG. 1) such that the agricultural implement 100 and propulsion unit are no longer longitudinally aligned. If the gravitational forces acting sideways on both propulsion unit 102 and agricultural implement 100 are so great as to overcome the combined resistance to sideways movement of both propulsion unit 102 and agricultural implement 100, then it is conceivable in some situations that the entire combination of both propulsion unit 102 and agricultural implement 100 may slide sideways down the slope.

However, through operation of steering assembly 200, side drift/pivoting of agricultural implement 100 relative to propulsion unit 102 may be reduced or substantially eliminated. Therefore, the longitudinal alignment of agricultural implement 100 with propulsion unit 102 may be maintained during operation. This is especially important during seeding operations due to the importance of creating evenly spaced seed distribution will result in efficient land use and avoid overcrowding of crops.

In general, one or more rear wheeled assemblies may be steered in an uphill direction (which may be referred to as counter steering), when implement 100 encounters ground sloped either way in a transverse direction (in the Y-direction shown in FIG. 1). The severity of the slope of ground surface (such as surfaces 114 and 116) will determine the amount of the steering angle of a steerable rear wheeled assembly 200 from the straight-ahead orientation, whereby the steering angle will increase with increasing slope of the ground surface 114 due to the greater drift gravitational forces that will be acting upon implement 100.

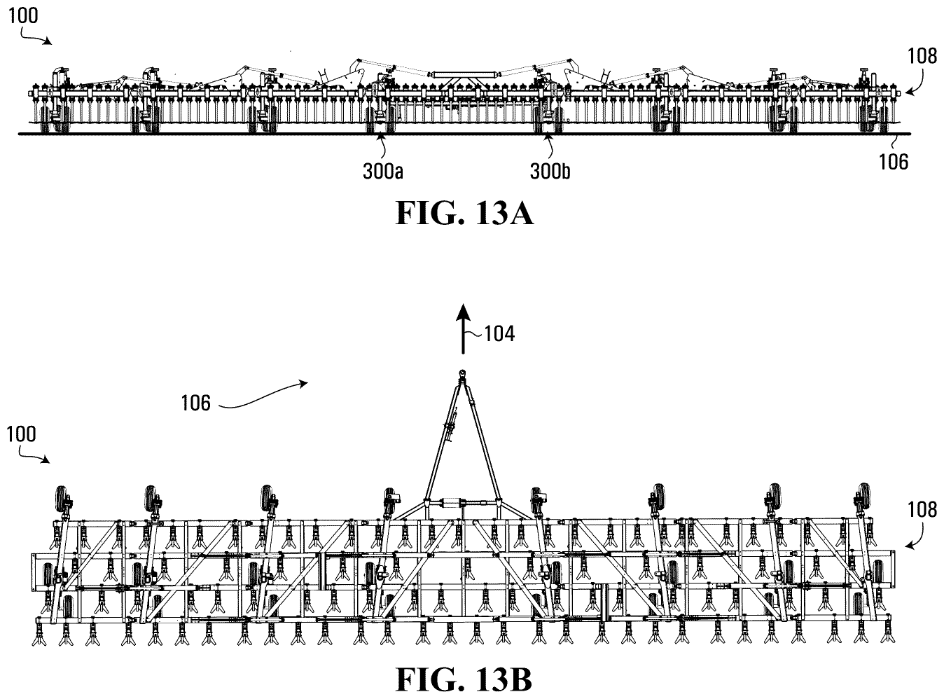

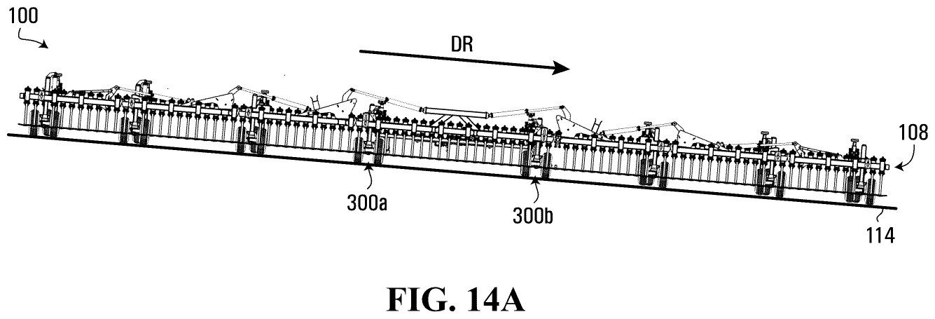

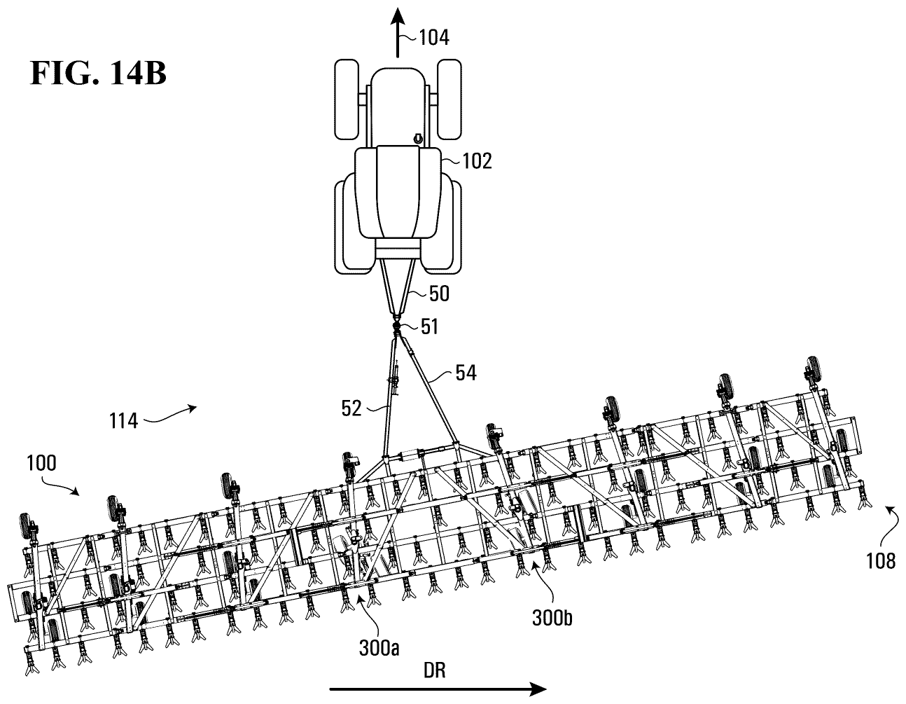

In an example embodiment, as illustrated in FIGS. 13A and 13B, agricultural implement 100 (with propulsion unit 102 omitted) may be travelling across ground surface that is substantially flat and level in a direction of travel 104. In a first scenario as depicted in FIGS. 14A and 14B, agricultural implement 100 may encounter a transition from ground surface 106 to ground surface 114, that is sloped downwards in the direction DR. As agricultural implement 100 travels in the direction 104, the weight of frame 108 and the implement 100 as a whole due to gravity will act in the direction DR, resulting in a drift force acting in the same direction that will urge implement 100 to drift in the direction DR. As shown in FIG. 14B this may result in implement 100 pivoting in an arc about tow hitch 50 such that implement 100 is no longer in alignment with propulsion apparatus 102.

However, as the ground surface transitions from surface 106 to surface 114, frame orientation sensor 448 will detect any change in roll of frame 108 (or possibly in other embodiments, a combination of changes in more than one of the pitch, roll and yaw) of frame 108 (and therefore the direction and degree of slope of the ground surface 114), generating a frame orientation signal which is received by controller 450 at input 454. Controller 450 will use the frame orientation signal (and any other data signals utilized by the control system) by employing the appropriate algorithm, to determine a required steering direction and angle for steerable rear wheeled assembly 200 that will keep implement 100 in alignment with propulsion unit 102. Through operation of hydraulic cylinders 402a, 402b, by controller 450, steerable rear wheeled assembly 200 will rotate such that wheels 316a-d are orientated in an uphill direction, as shown in FIG. 14B in order to steer implement 100 in an uphill direction to maintain alignment with propulsion unit 102.

In an embodiment, controller 450 may primarily rely of the degree of any change in the roll angle of frame 108 detected by frame orientation sensor 448 to determine the required steering direction and angle for steerable rear wheeled assembly 200. Generally speaking, as the roll angle of frame 108 increases, the required steering angle determined by controller 450 will also increase. If the roll angle of frame 108 is determined to be level (i.e. zero degrees roll) then controller 450 may determine that steerable rear wheeled assembly 200 is required to be orientated in the straight ahead position. Both the straight-ahead position of steerable rear wheeled assembly 200 and a zero-degree roll angle of frame 108 may be set by a calibration of control system 450.

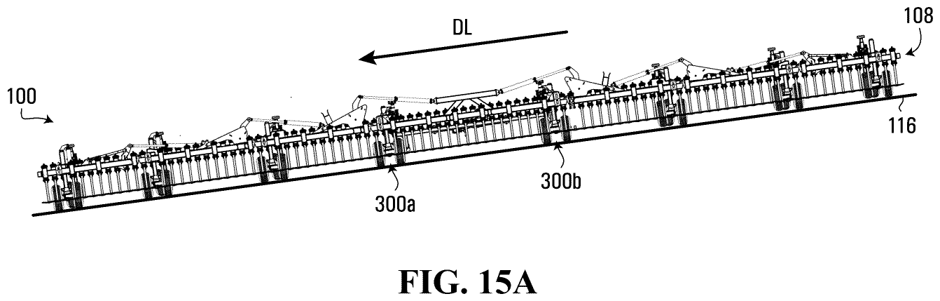

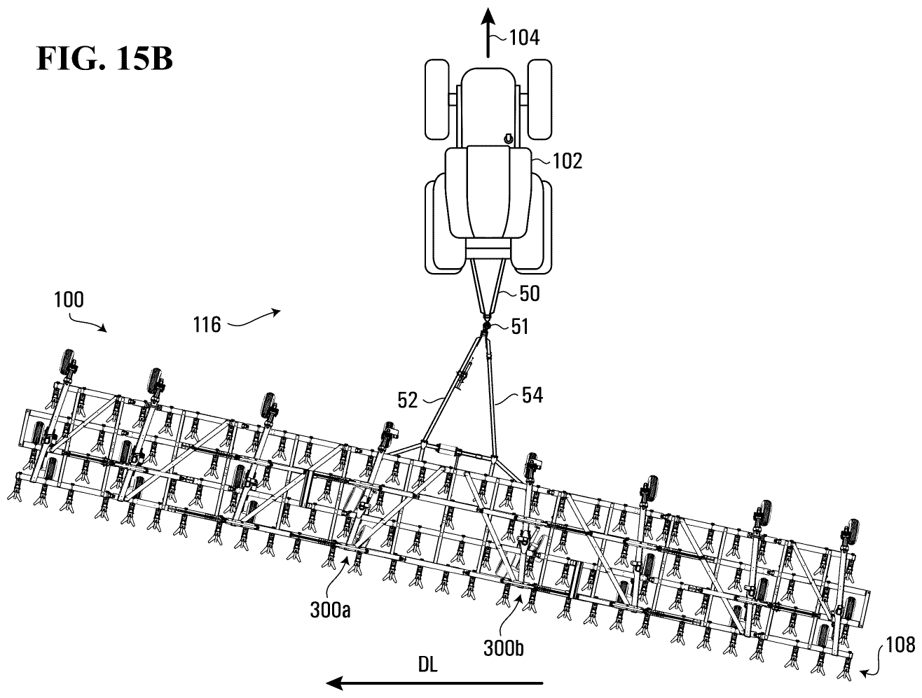

In a second scenario as depicted in FIGS. 15A and 15B, in operation agricultural implement 100 may encounter a transition from ground surface 106 to ground surface 116, that is sloped downwards in the direction DL. As agricultural implement 100 travels in the direction 104, the weight of frame 108 and the implement 100 as a whole due to gravity, will act the direction DL, resulting in a drift force acting in the same direction that will urge implement 100 to drift in the direction DL. As shown in FIG. 15B this may result in implement 100 pivoting in an arc about tow hitch 50 such that implement 100 is no longer in alignment with propulsion apparatus 102.

However, as the ground surface transitions from surface 106 (FIG. 13A) to surface 116 (FIG. 15A), frame orientation sensor 448 will detect the change in one or more of the roll, pitch and yaw of frame 108 (and associated direction and degree of slope of ground surface 116), generating a frame orientation signal which is received by controller 450 at input 454. Controller 450 will use the frame orientation signal to determine a required steering direction and angle for steerable rear wheeled assembly 200 that will keep implement 100 in alignment with propulsion unit 102. Through operation of hydraulic cylinders 402a, 402b (FIG. 3A), by controller 45 generating and sending appropriate control signals, assembly 200 will rotate such that wheels 316a-d are orientated in an uphill direction, as shown in FIG. 15B, in order to steer implement 100 in an uphill direction to maintain alignment with propulsion unit 102 and counteract the gravitational forces acting on agricultural implement 100.

As sensor 448 detects further changes in the roll of frame 108, (e.g. Change in the sideways slope of the ground surface) controller 450 will generate and send control signals adjust direction and degree of steering of steerable rear wheeled assembly 200 in order to keep implement 100 in alignment with propulsion unit 102. For example, if the severity of the slope of surfaces 114, 116 were to decrease (which would be detected through changes in the roll of frame 108 by sensor 448), controller 450 may generate and send control signals to decrease the steering angle of rear wheeled assembly 200. Conversely, if the severity of the slope of surfaces 114, 116 were to increase controller 450 may generate and send control signals to increase the steering angle of rear wheeled assembly 200 to counteract the increase in drift/sideways acting forces.

Additional factors other than the slope of the ground and the weight of implement 100 may influence the likelihood that implement 100 will experience side drift. For example, a frictional force generated between the tires of front wheeled support units 900-910, rear wheeled support units 300a, 300b, 920, 922, 924, 930, 932, 934 and ground surface 106 will provide a degree of resistance against any drift force that develops. This frictional force and may, to some extent, act against and mitigate at least a portion of the drift force. As the frictional force described above increases, then less steering input from steerable rear wheeled assembly 200 will be required as the drift force may effectively be decreased. Conversely, as the frictional force decreases, then less steering input from steerable rear wheeled assembly 200 will be required as the drift force may effectively be increased.

For example, the frictional force may vary between areas being treated by implement 100 due to variations of the moisture content or composition of the ground surface or changing weather conditions. Also, the level of resistance to side drifting movement may change due to changes in resistance imparted by the ground engagers 800. For example, if ground engagers are deeply embedded in the ground, then this may result in greater resistance to side drift than if the ground engagers are only embedded a small amount of depth into the ground. As such, it may become apparent to an operator of agricultural implement 100 that the response of controller 450 to changes in the slope of surface 106 is either too great such that assembly 200 oversteers or too little such that assembly 200 understeers, and some side drift of implement occurs. This under or oversteering may be due in part to changes in the frictional force, or due to other factors.

In embodiments, controller 450 may receive other signals from sensors indicating that the rotational orientation of the agricultural implement 100 is in alignment, or out of alignment, relative to propulsion unit 100 and may as a result of the operation of the control system algorithm, adjust the direction of steering of the steerable rear wheeled assembly 200 accordingly either to correct the orientation or maintain the proper orientation.

In embodiments an operator in propulsion unit 102 may be able to adjust the sensitivity of the response of controller 450 such for the same frame orientation signal received by controller 450, a greater or lesser required steering angle is determined. For example, if an operator observed that some side drift of implement 100 was occurring, an adjustment could be made to increase the sensitivity of the response on controller 450 such that for the same frame orientation signal received by controller 450, a greater required steering angle was determined for steerable rear wheeled assembly 200.

Furthermore, if agricultural implement 100 is used in connection and combination with a mobile agricultural apparatus such as a towed air seed cart (e.g. the air seed cart is towed behind agricultural implement 100) the weight of the air seed cart will decrease during use as seed and/or fertilizer is distributed/used up. This decrease in overall weight may decrease the magnitude of the drift force that is generated over time. Similar to as described above, an operator may decrease the sensitivity of the response of controller 450 in order to adjust for the decreasing drift force as the weight of the air seed cart decreases.

Through steering of assembly 200, side drift of agricultural implement 100 in may be reduced or substantially eliminated. Therefore, the alignment of agricultural implement 100 with propulsion unit 102 may be substantially maintained during operation.

In some embodiments, steerable rear wheeled assembly 200 could be used to intentionally move implement 100 out of alignment with propulsion unit 102 during operation. For example, this may be desirable in order to adjust the transverse (direction Y) spacing at which adjacent ground engagers 600 of implement 100 engage the ground surface. As implement 100 pivots in an arc about tow hitch 50 (such as to the orientations shown in FIGS. 14B and 15B), the transverse spacing between which the ground engagers 600 will engage the ground surface effectively decreases. This transverse spacing will decrease the more implement 100 pivots relative to propulsion unit 102. This may be beneficial as the spacing can be adjusted without the need to move any of the ground engagers 600 (which may be fixedly attached and difficult to adjust in position) on frame 108. In an embodiment, controller 450 may produce signals to adjust the steering direction and angle for steerable rear wheeled assembly 200 in order to achieve a desired orientation of implement 100 (ie. an angular rotation about tow hitch 50), which may be confirmed by a frame orientation signal (which may also be a ground surface orientation signal) that is generated by sensor 448 or any other sensor on implement 100. The desired orientation of implement 100 may be selected in order to achieve a desired spacing between adjacent ground engagers 600 engaging the ground surface. In some embodiments/situations, the steering system may be configured to be manually operated by an operator in order to manually adjust the steering direction and angle for the steerable wheel assemblies 200, with the system being configured so that an operator can manually control the operation of valve 434 to provide suitable signals to valve 434 to operate the steering actuators in a desired manner. Thus, an operator may in effect manually steer the agricultural implement 100 and adjust the position of it relative to propulsion unit, such as steering it back into or towards a square alignment with population unit 102. It should also be noted that by being able to adjust the lateral position of the agricultural implement an operator can steer the agricultural apparatus out of alignment with said propulsion unit so that the agricultural apparatus avoids contacting an obstacle that may be on the ground surface. Thus, the lateral position of the agricultural apparatus relative to the propulsion unit can be adjusted independently of the propulsion unit. Thus, when during operation, a propulsion unit is able to be manually steered to avoid an obstacle on the ground surface, the agricultural apparatus can also be separately steered to avoid the same obstacle, and its position is not entirely dependent upon the movement of the propulsion unit as it varies its travel direction.

In an embodiment, whilst it is beneficial to have steerable assembly 200 on central frame section 130 due to the greater level of weight carried by wheeled support units of frame section 130, in alternate embodiments, some or all of frame sections 132, 134, 136, 138, 140, 142 may also include steerable rear wheeled assemblies. Such additional steerable rear wheeled assemblies may be interconnected to a hydraulic fluid system such that they all steer in a synchronized fashion, or such that they operate independently from each other.

In some embodiments, such additional steerable assemblies may also be linked pivotally interconnected by one or more track rods, similar to track rod 204 such that all steerable wheeled support units on implement 100 are interconnected.

In other embodiments, left-side and right-side wheeled support units may only have one wheel.

In other embodiments some or all of the wheels of front wheel units 900, 902, 904, 906, 908, 910, 912, 914 of an agricultural implement 100 may also or alternatively be constructed like wheel unit 300a and 300b as steerable wheel units. In such embodiments, the front and rear wheels may both include steering actuators that may be controlled by a control system (similar to control system 400 such that the some or all of the wheels of front wheel units 900, 902, 904, 906, 908, 910, 912, 914 turn in the same direction and to approximately the same degree at the same time as the wheels of rear wheeled units 300a and 300b (also known as crab steering).

In some embodiments, some or all of rear wheeled support units 920, 922, 924, 930, 932, 934 may also be configured as steerable wheeled units, similar in construction and operation to rear wheeled units 300a and 300b.

By way of example, the front and/or rear wheeled units as disclosed in United States patent publication no. US 2022/0400595 A1 published on Dec. 22, 2022 (the entire contents of which are hereby incorporated herein) might be modified to provide an active steering system as disclosed herein.

In other embodiments, the steering direction and angle of left- and right-side rear wheeled support units 300a, 300b of steerable rear wheeled assembly 200 may be actuated by any other suitable actuator such as a pneumatic actuator in pneumatic communication with a pneumatic system (which may be compressed air or possibly another suitable gas). In another embodiments, rear wheeled support units 300a, 300b may be actuated by electrically powered servo drive motors.

### Trailing Agricultural Apparatus Steering System

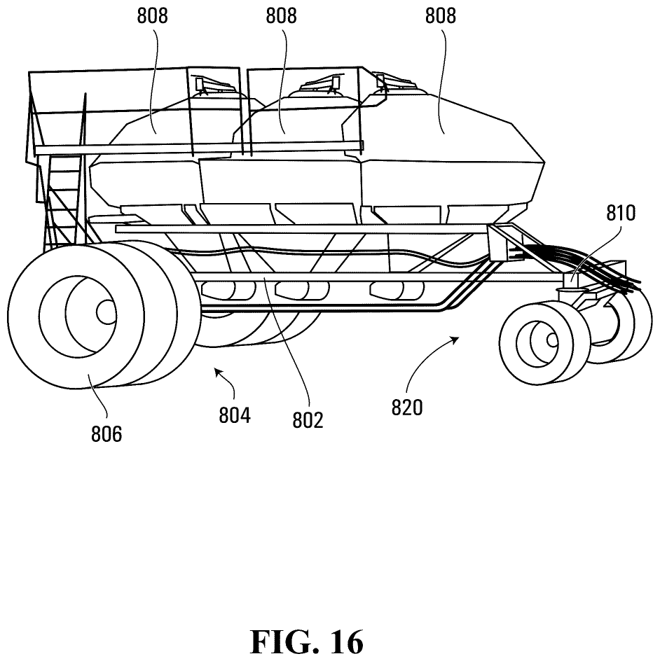

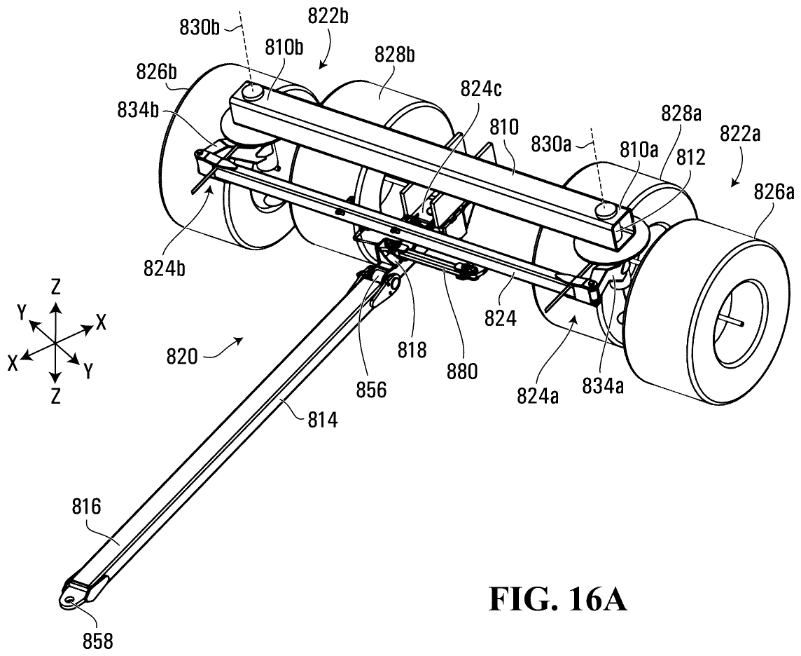

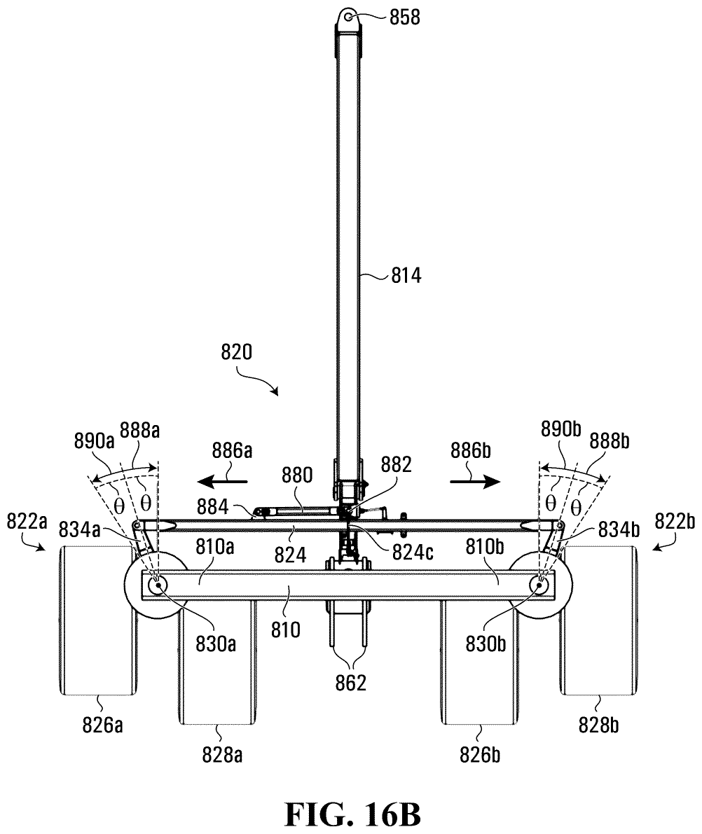

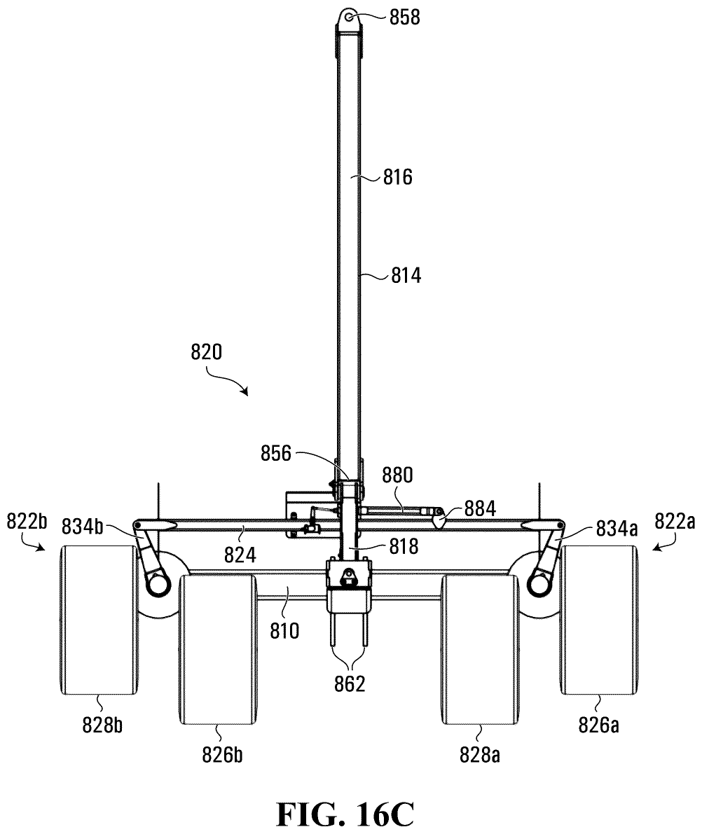

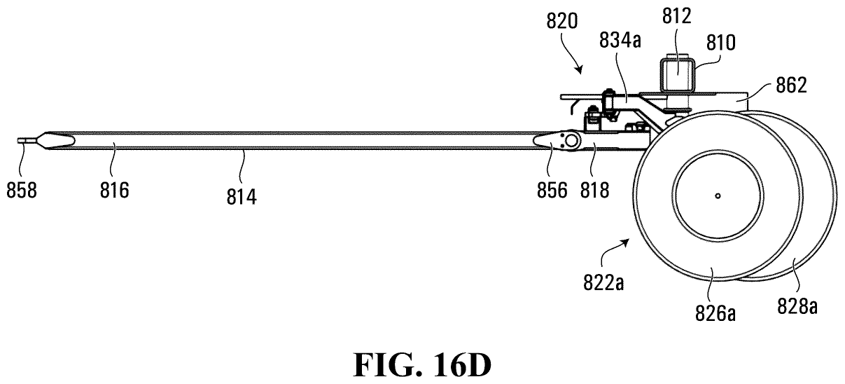

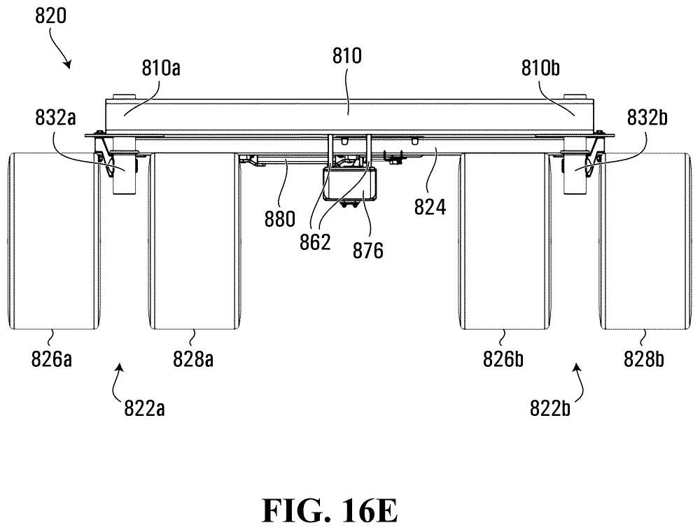

As described above, a mobile agricultural apparatus such as an air seeder/fertilizer type wheeled cart 800 (FIG. 16), may be moved in combination/conjunction with an agricultural implement such as agricultural implement 100, for storing seed and/or fertilizer (or other products) for distribution, such as to ground engagers 600 of implement 100. As is known, air seed carts may be configured for tow-between or tow-behind operation. In an example tow-between configuration, an air seed cart is positioned between propulsion unit 102 and agricultural implement 100 and seed and/or fertilizer is discharged from the rear of the air seed cart to the front of agricultural implement 100. In an example tow-behind configuration, the air seed cart is positioned behind agricultural implement 102 and seed and/or fertilizer is discharged from the front of the air seed cart to the rear of agricultural implement 100.

Connection of an air seed cart in a tow-behind configuration as opposed to a tow-between configuration may be desirable in order to place implement 100, which may have a significant overall mass, closer to propulsion unit 102. This may assist with traction of propulsion unit 102 and may also avoid a greater tendency for agricultural implement 100 to slide (such as when turning) When using a tow-between configuration, the wheels of the air seed cart may compact and/or disturb the soil of the ground surface 106 before agricultural implement 100 engages/treats surface 106, which may impact the level and consistency of surface engagement/treatment by ground engagers 600 of implement 100. Additionally, positioning an air seed cart in a tow-behind configuration will not impair the view of agricultural implement 100 from the propulsion unit 102 for an operator, as may be the case with a tow-between configuration.

Referring to FIG. 16, an embodiment of an air seed cart 800 is shown, which may be connected to agricultural implement 100 in a tow-behind an agricultural implement (such as agricultural implement 100) configuration. Air seed cart 800 may generally include a generally horizontal, transversely and longitudinally extending, frame 802. Frame 802 may include a plurality of interconnected longitudinal and transverse beam members made from suitable materials such as a suitable steel and being interconnected together such as by bolting/welding.

Frame 802 may be supported at the rear end region, by a transversely extending rear axle 804 to which may be mounted a pair of transversely spaced rear wheels 806 (which may include suitable tires such as compound rubber tires, and metallic rims) at each end of rear axle 804. Rear axle 804 may have mounted for free rotation about a generally transverse axle axis, single rear wheels 806 at each corner, although rear axle 804 may be configured with dual wheels mounted proximate each corner. Frame 802 may be supported at the front-end region by a seed cart steering assembly 820. Steering assembly 820 may include which is shown with an attached drawbar 814, in isolation in FIGS. 16A-D, having a first front-wheel pair 826a, 828a on one side, and a second front-wheel pair 826b, 828b on an opposite side, with the wheels each being mounted for free rotation about respective generally horizontal wheel axes and each of the wheels including suitable tires such as compound rubber tires, and metallic rims. As will be described in more detail below, seed cart steering assembly 820 may be configured such that such that front wheel pair 826a, 828a and front wheel pair 826b, 826b are each rotatable/pivotable about a respective generally vertically orientated steering axis, enabling the front wheel pairs to be rotated angularly clockwise and counter-clockwise from the straight ahead, longitudinal orientation, in order to prevent or correct side-shifting of seed cart 800 relative to the agricultural implement 100, propulsion unit 102, and/or other apparatus or apparatuses to which it may be interconnected.

Frame 802 may support various components required for operation of seed cart 800. These may include one or more tanks 808 and a distribution system for distributing a metered supply of seed and/or fertilizer to agricultural implement 100. The distribution system may be any suitable system which may include a network of tubing and piping that enables the communication/transfer of seed, fertilizer and/or any other product from tanks 808 for application to the soil material. For example, plant/crop seed, fertilizer and/or any other product may be supplied to ground engagers 600 of agricultural implement 100.

The front of frame 802 may include a transversely extending beam member 810 (shown in FIGS. 16 and 16B without other frame components). With reference now also to FIGS. 16C-E, seed cart 800 may include a longitudinally forward extending drawbar 814—which is interconnected to beam member 810—and which is operable for attaching seed cart 800 to a rear hitch device of agricultural implement 100. Beam member 810 and drawbar 814 may be generally square or rectangular hollow cross section and tubular structural members. For example, beam member 810 and drawbar 814 may be closed channeled beam members that may be made from a suitably hard and strong material such as a steel such as by way of example a suitable structural steel. In some applications, A36 mild steel, which is considered a structural steel with a yield strength of about 60K psi, may be employed. Stronger structural steels with higher yield strengths (e.g. 80-100K psi) may be employed in other embodiments, depending upon expected operational and design loads.

Tubing and piping may run along and/or inside drawbar 814 between seed cart 800 and agricultural implement 100 in order to transfer seed and/or fertilizer from seed cart 800 to agricultural implement 100. Other cabling and piping, such as to facilitate electrical, pneumatic and hydraulic connections between seed cart 800, implement 100 and propulsion unit 102 may also be routed along/in drawbar 814.

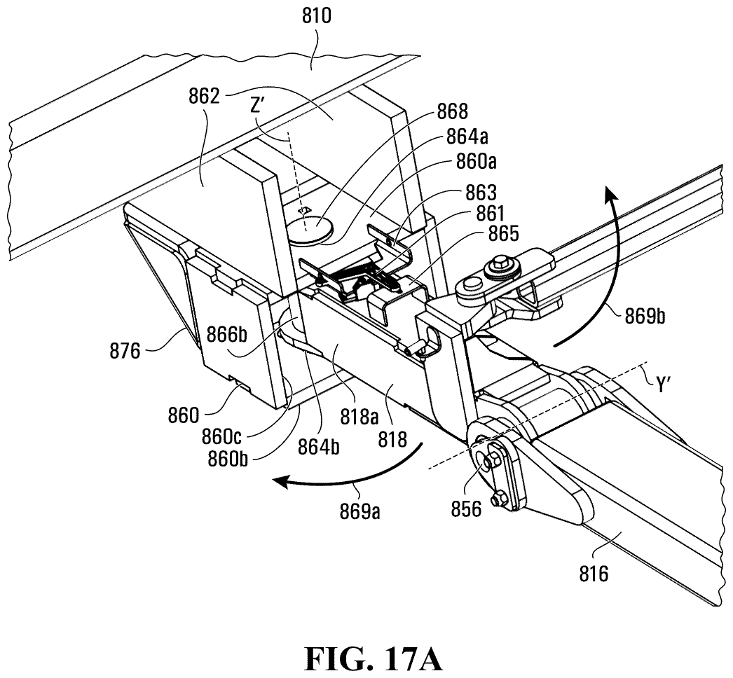

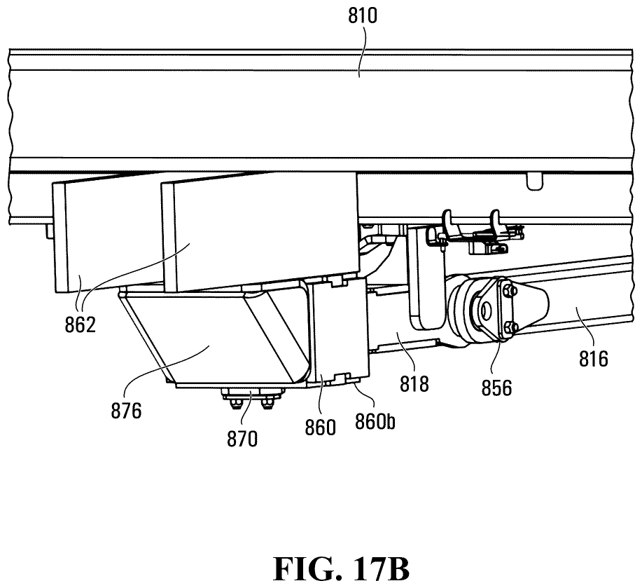

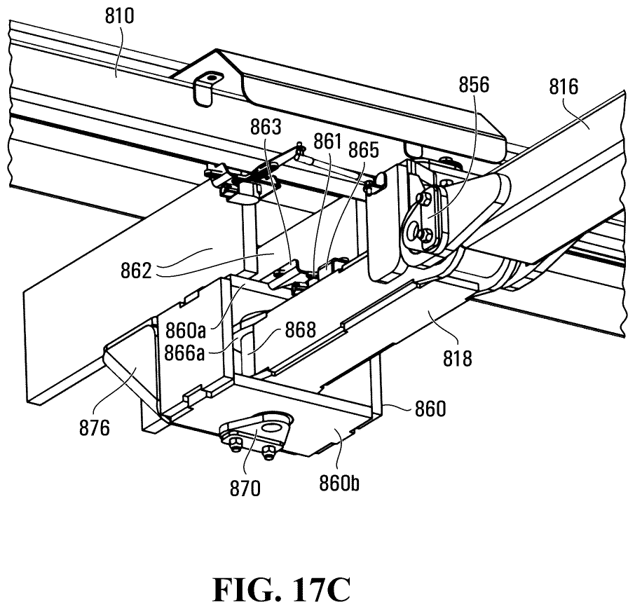

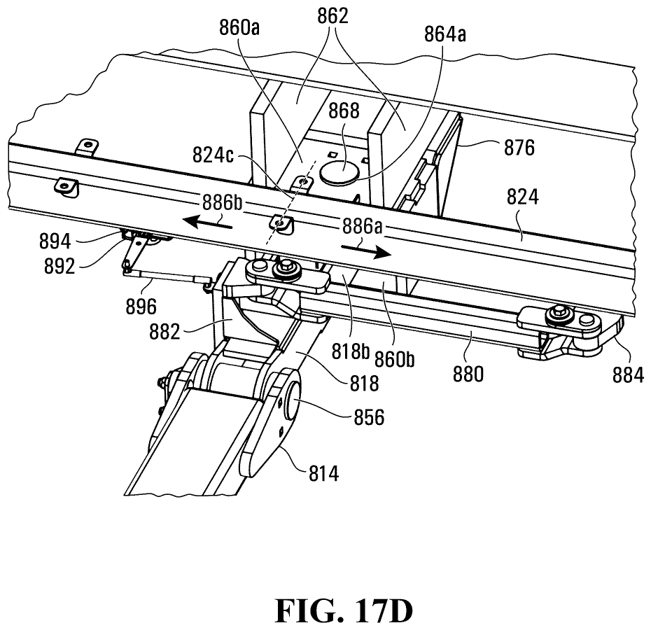

Drawbar 814 may include a longer front bar section 816 and a shorter rear bar section 818, connected by pivotal linkage 856. At the front end of front bar section 816 may be a hitch connection 858 for connecting seed cart 800 to agricultural implement 100, such as through rear towing hitch 56. By providing pivotal linkage 856, front bar section 816 (and the attached agricultural implement 100) may pivot in a generally about a transverse axis Y′ (FIG. 17A) relative to rear bar section 818 (and seed cart 800). This may beneficially reduce stress and strain on drawbar 814 when agricultural implement 100 and seed cart 800 are travelling over undulating/sloped/uneven ground.

Rear bar section 818 of drawbar 814 is shown in greater detail in FIGS. 17A-D and may be pivotally connected to frame 802 though drawbar pivot mount 860 such that frame 802 and the rest of seed cart 800 may pivot about a generally vertical axis (Z direction in FIG. 16A) relative to drawbar 814 (and the attached agricultural implement 100). The upper side of drawbar pivot mount 860 may be connected to frame 802 through a pair of vertically extending, spaced apart plates 862 which are connected at their upper ends to the lower side of transverse member 810. At the rear end of drawbar pivot mount 860, a gusset 876 may be provided to further interconnect mount 860 and plates 862 to provide additional strength and rigidity (FIG. 17B). The connections between member 810, drawbar pivot mount 860, plates 862 and gusset 876 may be made using any suitable method such as welding.

Drawbar pivot mount 860 may be generally rectangular with an opening at the front end for receiving the rear end of rear bar section 818. The upper and lower sides 860a, 860b of mount 860 each include respective openings 864a, 864b which align with corresponding upper and lower openings 866a (FIG. 17C), 866b in rear bar section 818 for receiving drawbar pivot pin 868 therethrough. Drawbar pivot pin 868 may be affixed to the lower side 860b of mount 860 by a triangular bracket 870 (FIG. 17C) such that pin 868 is fixed in position and rear bar section 818 may pivot around pin 868. As a result, rear bar section 818 may move in a pivoting movement about a generally vertical orientated pivot axis (direction Z′ in FIG. 17A) relative to seed cart 800 in the directions indicated by arrows 869a, 869b in FIG. 17A. This may beneficially reduce stress and strain on drawbar 814 when agricultural implement 100 and seed cart 800 are travelling across surface 106 and may also improve maneuverability when executing a turn. The range of motion of rear bar section 818 pivoting around pin 868 may be limited by a vertical side edge of rear bar section contacting the inner edge of mount 860. For example, when rear bar section 818 pivots in direction 869a vertical side edge 818a of rear bar section 818 will contact edge 860c of housing 860 (FIG. 17A) and when rear bar section 818 pivots in direction 869b vertical side edge 818b of rear bar section 818 will contact edge 860d of housing 860 (FIG. 17D). In some embodiments, the range of motion of rear bar section 818 may be about 45 degrees in either of the directions 869a, 869b in FIG. 17A.

A drawbar rotation sensor 861 (FIG. 17A) associated with drawbar 814 and drawbar pivot mount 860 may be configured to generate a rotation signal representing the pivoting movement of drawbar 814 about axis Z′ relative to drawbar pivot mount 860 and frame 802. Drawbar rotation sensor 861 may be mounted to sensor mount 863, which in turn is affixed to upper side 860a of drawbar pivot mount 860. Drawbar rotation sensor 861 may also be connected to bracket 865 which in turn is affixed to the upper side of rear bar section 818. As drawbar 814 and drawbar pivot mount 860 move relative to each other about pivot pin 868, this relative pivoting movement will cause a change in a voltage produced by sensor 861. For example, drawbar rotation sensor 861 may generate a rotation signal of 2.5 V when drawbar 814 is in the straight-ahead position and a decrease or increase in voltage depending on the direction of rotation of drawbar 814. In some embodiments, the voltage from drawbar rotation sensor 861 may be displayed in the cab of propulsion unit 102 to provide information to the operator on the relative orientation of drawbar 814.

With reference to FIGS. 16A-16D, seed cart steering assembly 820 may include front left- and right-side wheeled support units 822a, 822b which may be pivotally and operationally interconnected by a track rod 824. Track rod 824 may be an elongated and extending bar made from a suitably strong material such as for example a bar with a rectangular cross-sectional profile having a height of about 2 inches and a width of about 4 inches and a wall thickness of about ¼ inch and made from a steel, such as A36 steel.

Left and right front wheeled support units 822a, 822b may be constructed in a similar manner to each other but some components of left-side support unit 822a may be configured as left-hand components whereas some components of right-side support unit 822b may be configured as right-hand components. Left-side front wheeled support unit 822a may be a double wheeled unit having wheels 826a, 828a mounted transversely and longitudinally spaced from one another. Similarly, right-side front wheeled support unit 822b may have wheels 826b, 828b transversely and longitudinally spaced from one another. In other embodiments, wheels pairs 826a, 828a, and 826b, 828b may be mounted in other configurations, such as transversely spaced and longitudinally aligned. In other embodiments, left- and right-side wheeled support units 822a, 822b may be configured as singled wheeled units, each having one wheel.

As will be outlined below, wheels 826a-b and 828a-b of front wheeled support units 822a, 822b may each be configured to rotate about respective generally vertically orientated steering axes such that seed cart steering assembly 820 may correct side-shift and/or maintain a proper longitudinal orientation relative to agricultural implement 100.

Left-side wheeled support unit 822a may be pivotally mounted to end 810a of transversely extending member 810 of frame 802 such that unit 822a may pivot about a generally vertical steering axis 830a shown in FIG. 16A. Similarly, right-side wheeled support unit 822b may be pivotally mounted to an opposite end of 810b of member 810 such that wheeled support unit 822b may pivot about a generally vertical steering axis 830b shown in FIG. 16A. Through interconnecting left- and right-side wheeled support units 822a, 822b by track rod 824, wheeled support units 822a, 822b will each undergo the same degree of rotation about respective axes 830a, 830b.

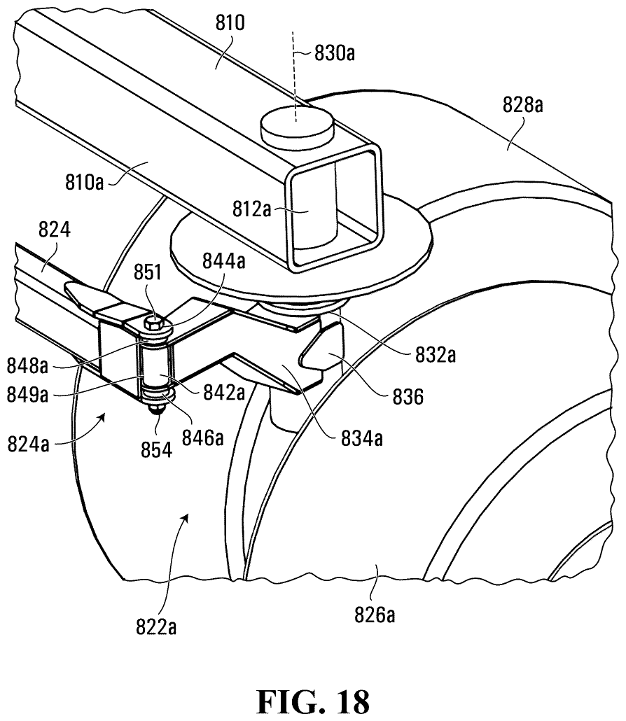

Left-side support unit 822a is depicted in more detail in FIG. 18 and may include vertically orientated kingpin 832a, the upper end of which is received in tube 812a. Tube 812a is affixed to and extends vertically though beam member 810 of frame 802 at end 810a. Kingpin 832a is operable to rotate within tube 812a about axis 830a. Wheels 826a, 828a may each be mounted on respective front and rear transversely orientated wheel axles (not shown) to allow for free rotation about a generally horizontal axis of rotation. The front and rear wheel axles may be interconnected by a wheel support beam (not shown) which may be a walking beam device, that is pivotally mounted to the lower end of kingpin 832a such that the wheel support beam, wheels 826a, 828a and their wheel axles mounted thereon, may rotate with kingpin 832a about axis 830a.

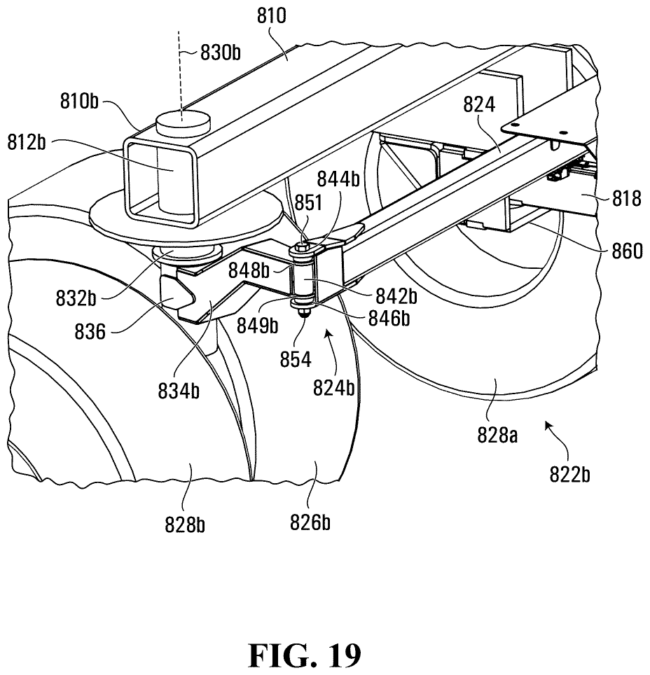

Similarly, right-side support, shown in more detail in FIG. 19, may include vertically orientated kingpin 832b that is received in tube 812b of member 810 at end 810b. Wheels 826b, 828b may each be mounted on respective front and rear transversely orientated wheel axles (not shown) to allow for free rotation about a generally horizontal axis of rotation. The front and rear wheel axles may be interconnected by a wheel support beam (not shown), such as a walking beam, that is pivotally mounted to the lower end of kingpin 832b such that wheel support beam, and the wheels 826b, 826b and their wheel axles mounted thereon, may rotate with kingpin 832b about axis 830b.

Left-side support unit 822a also includes a pivot arm 834a attached to and extending generally forwards from the front side of kingpin 832a. Similarly, right-side support unit 822b includes a pivot arm 834b attached to kingpin 832b. Pivot arms 834a, 834b may have generally rectangular cross-sections and may be attached to kingpins 832a, 832b respectively by a suitable method such as welding. A pair of gussets 836, may be affixed to either side of kingpins 832a, 832b and pivot arms 834a, 834b to provide additional strength and rigidity.

With reference to FIG. 18, pivot arm 834a may be pivotally connected to end 824a of track rod 824 though a pivotal connection which may include a vertically extending pin/bolt 851 located with sleeve 842a. This pin extends through upper and lower openings 844a, 846a in track rod 824 and upper and lower openings 848a, 849a in pivot arm 834a and is rotatable within sleeve 842. Pin 840a is secured by bolt 851 and nut 854. Similarly, pivot arm 834b may be pivotally connected to the opposite end 824b of track rod 824 (FIG. 19) through vertically extending pin (not shown) located with sleeve 842b. This pin extends through upper and lower openings 844b, 846b in track rod 824 and upper and lower openings 848b, 849b in pivot arm 834b and is rotatable within sleeve 842b and is secured by bolt 851 and nut 854.

The components of left- and right-side wheeled support units 822a, 822b can be made from suitably strong materials such as a cast iron or cast steel. Kingpins 832a, 832b and pins 840a, 840b may be made from a suitably strong and durable material and may be induction hardened chrome pins.

As can be seen in FIG. 16B, pivot arms 834a, 834b may be offset from the straight-ahead direction (x-direction in FIG. 16A) such that they are both orientated in an outwards direction when wheels 826a-b, 828a-b are orientated in the straight-ahead longitudinal direction. Pivot arms 834a, 834b may be orientated as the outwards direction shown in FIG. 16B so as to provide clearance and not interfere with other components of seed cart 800 during operation.

Turning to FIG. 17D, a two-way acting hydraulic cylinder 880 may be interposed between track rod 824 and drawbar 814. Hydraulic cylinder 880 may have an inboard end with an extendible piston rod that may pivotally interconnected to bracket 882 which is in turn secured to the upper side of rear bar section 816 of drawbar 814, such as by welding. The outboard end of hydraulic cylinder 880 is pivotally connected to drawbar 814 via bracket 884, which projects in a forward direction from drawbar 814 and is secured to the lower side of drawbar 814, such as by welding. The extendible piston rod at the inboard end of hydraulic cylinder 880 is not shown in FIG. 17D. The operation of hydraulic cylinder 880 may be controlled by an actuator and/or controller, which may control valves in a hydraulic fluid circuit to control the flow of pressurized hydraulic fluid to and from hydraulic cylinder 880.

The extendible piston rod may be moveable between a fully retracted position, where the total length hydraulic cylinder 880 is shortest, and a fully extended position where the total length of hydraulic cylinder 880 is longest. As illustrated in FIGS. 16B, when hydraulic cylinder 880 is at the mid-point between the fully extended and retracted positions, wheels 826a, 826b, 828a, 828b of wheeled support units 822a, 822b are generally orientated in the straight-ahead position/longitudinally aligned orientation. As the piston rod is extended, the relative distance between bracket 882 of drawbar 814 and bracket 884 of track rod 824 will increase such that track rod 824 will move in the direction indicated by arrow 886a. Through rotation of arms 834a, 834b, attached to track rod 824, wheeled support units 822a, 822b will rotate/pivot about their respective steering axes 830a, 830b in the directions indicated by arrows 888a, 888b. As a result, wheels 826a, 826b, 828a, 828b will rotate/pivot to the left (as viewed in FIG. 16B).

By retracting the piston rod of hydraulic cylinder 880, the distance between bracket 882 of drawbar 814 and bracket 884 of track rod 824 may be decreased such that track rod 824 will move in the direction indicated by arrow 886b. Through rotation of arms 834a, 834b, wheeled support units 822a, 822b will rotate about their respective axes 830a, 830b in the directions indicated by arrows 890a, 890b. As a result, wheels 826a, 826b, 828a, 828b will rotate to the right (as viewed in FIG. 16B).

Thus, operation of hydraulic cylinder 880 and the distance that the piston rod is extended or contracted from the neutral—straight ahead position of the wheels—can control the steering angle θ of wheels 826a, 826b, 828a, 828b relative to drawbar 814 in either direction. The maximum permissible steering angle θₘₐₓ in each angular direction may be determined by the stroke length of hydraulic cylinder 880 the size and arrangement of components attached thereto. In an example embodiment, wheeled support units 822a, 822b, including attached wheels 826a, 826b, 828a, 828b can rotate in either direction about respective pivot axes 830b up to a maximum permissible steering angle θₘₐₓ in the range of about 30 to 45 degrees and most preferably about 40 degrees.

In other embodiments, steering cart steering assembly 820 may be configured with more than one hydraulic cylinder. For example, steering cart seeder assembly 820 may include two hydraulic cylinders, which each cylinder having a cap end interconnected to drawbar 824 and each cylinder having a rod end orientated in opposite outboard directions to the other cylinder, whereby the rod ends are interconnected connected to track rod 824. In this configuration both of the hydraulic cylinders are at their respective mid-stroke positions corresponds to the straight-ahead position/longitudinally aligned orientation of wheels 826a, 826b, 828a, 828b of wheeled support units 822a, 822b. By retracting the piston rod of one of the hydraulic cylinders and extending the piston rod of the other hydraulic cylinder, wheels 826a, 826b, 828a, 828b will rotate/pivot to the left or right depending on which piston rod is extended/retracted. This arrangement of hydraulic cylinders may result in a more even turning forces and speeds produced by the hydraulic cylinders of steering cart steering assembly 820 in both of the left and right directions.

Seed cart steering assembly 820 may also include a rotation sensor 892 (FIG. 17D) associated with drawbar 814 and track rod 824 and configured to generate a rotation signal representing the rotation of wheeled support units 822a, 822b relative to drawbar 814. Similar to as described above for steering angle sensors 354a and 354b, sensor 892 may provide a signal to a controller to identify the steering angle from the neutral straight-ahead longitudinal position over time and may also verify that a required steering angle has been achieved. In an embodiment, sensor 892 is a rotary position sensor and is configured to produce a rotation signal representing zero degrees of rotation when the mid-point 824c of track rod 824 is positioned over drawbar 814 (i.e., as shown in FIG. 17D for example). Movement of track rod 824 in the direction indicated by arrow 886a may result in a negative change in the rotation signal and movement in the direction indicated by arrow 886b may result in a positive change in the rotation signal (or vice versa). In a specific embodiment, sensor 892 may generate a rotation signal of 2.5 V in the position shown in FIG. 17D and a decrease or increase in voltage depending on the direction of movement of track rod 824.

Referring back to FIG. 17D, sensor 892 may be mounted to sensor mount 894, which in turn is affixed to the lower side of track rod 824. Sensor 892 may also be connected to bracket 882 of rear bar section 816 by rod 896. As drawbar 814 and track rod 824 move relative to each other, this relative movement will cause a change in the rotation signal produced by sensor 892.

Rotation sensors 861 and 892 may be similar to steering angle rotation sensors 354a, 354b described above and may be a hard-wired sensor with wires running through to a controller. In other embodiments, sensor 892 may be a sensor capable or wireless communication with a control system. Various other rotation sensors may be used such as inductive sensors, resistive sensors, or optical rotary encoders. In an embodiment sensor 892 is a 5-volt ratiometric angle sensor manufactured by Hella GmbH.

### Seed Cart Hydraulic and Control System

In some embodiments, the operation of hydraulic cylinder 880 and thus the steering of cart 800 may be actuated manually by an operator (such as an operator of propulsion unit 102), who may actuate a suitable manual device (such as a control lever) to actuate and control the control valve(s) in a hydraulic fluid circuit to control the flow of pressurized fluid to and from hydraulic cylinder 880.

In some embodiments/situations, the steering system may be configured to be manually operated by an operator in order to manually adjust the steering direction and angle for the steerable wheel assemblies of cart 800, with the system being configured so that an operator can manually control the operation of valve 1434 to provide suitable signals to valve 1434 to operate the steering actuator(s) in a desired manner. Thus, an operator may in effect manually steer seed cart 800 to in effect manually adjust the position of seed cart 800 relative to the propulsion unit 102 and the agricultural implement 100, such as steering seed cart 800 back into or towards a square alignment with population unit 102 and/or agricultural implement 100.

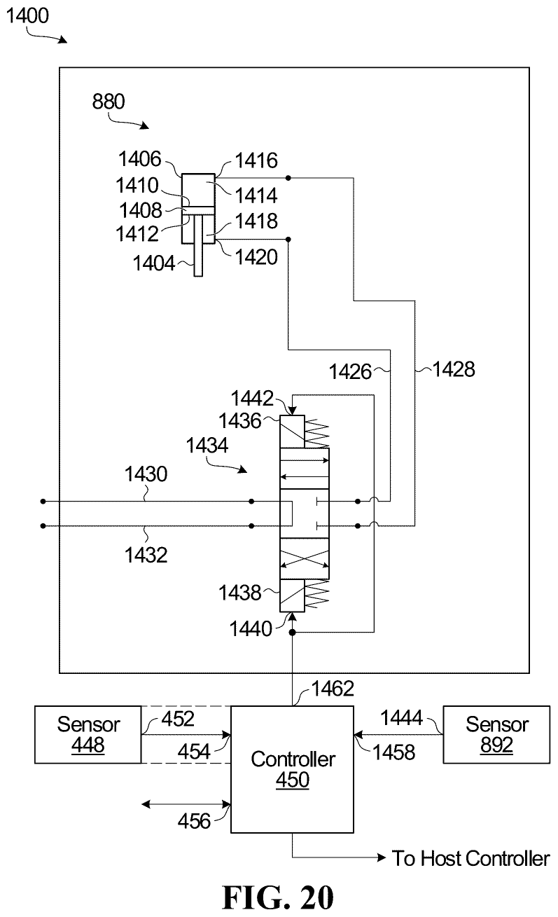

Additionally, or alternately, as will be outlined below, the operation of hydraulic cylinder 880 may be controlled at least in part, by a programmable computer controller such as a controller 450 (FIG. 20), which may be the same controller 450 and may be arranged as part of a control system, as described above in relation to FIGS. 11A-C. Controller 450 may at least in part, operate and control the control valve(s) in a hydraulic fluid circuit to control the flow of pressurized fluid to and from hydraulic cylinder 880 and thus control the position of the associated piston rod. In some embodiments controller 450 is configured to independently control both hydraulic cylinder 880 and to also control hydraulic cylinders 402a, 402b (as described above). In other embodiments the operation of hydraulic cylinder 880 may be solely controlled with a separate dedicated controller located on implement 100, propulsion apparatus 102 or cart 800.

As described herein, seed cart steering assembly 820 (along with hydraulic cylinder 880 and directional valve 1434) may comprise at least part of a side tilt counteracting mechanism.

With reference to FIG. 20, an embodiment of a control system for seed cart steering assembly 820 is shown generally at 1400. Control system 1400 (which may be part of the hydraulic fluid supply and control system of propulsion unit 102) may include a controller 450, sensors 892 and 448, and may be operable to control the operation of hydraulic cylinder 880 by controlling the flow of pressurized hydraulic fluid in various hydraulic fluid lines and valves. As described above hydraulic cylinder 880 may be configured to rotate wheels of left- and right-side wheeled support units 822a, 822b about their respective steering axes 830a, 830b through track rod 824.

Controller 450 and sensors 892, 448 may be provided with appropriate electrical power and other wires/cables to communicate with other components of control system 1400.

Hydraulic cylinder 880 may include hydraulic chamber 1406 having a reciprocally moveable piston 1408 therewithin connected to piston rod 1404. Piston 1408 may have upper and lower faces 1410, 1412 and divides hydraulic chamber 1406 into cap end chamber 1414 having cap end hydraulic fluid port 1416 and rod end chamber 1418 having rod end hydraulic port 1420. As shown in FIG. 20, hydraulic piston 1408 is at the approximate mid-point of chamber 1406 which corresponds to the straight-ahead position for wheeled support units 822a, 822b shown in FIG. 16A.

As described above, in embodiments where steering cart assembly 820 is configured with two hydraulic cylinders rather than single hydraulic cylinder 880, the supply of hydraulic fluid to each of the cylinders may be configured and operate in a similar manner to as shown in FIGS. 11A to 11C and described above for control system 400.

The cap end port 1416 of hydraulic cylinder 880 may be hydraulically connected to diverter valve 1434 by hydraulic fluid line 1428. The rod end port 1420 may be hydraulic connected to valve 1434 by hydraulic fluid line 1426. Valve 1434 (shown schematically in FIG. 20), which may be similar to valve 434 described above may selectively connect hydraulic fluid lines 1426, 1428 to a pressurized hydraulic fluid supply line 1430 and return line 1432. Valve 1434 may be coupled to a pressurized hydraulic fluid supply system (not shown) that may be mounted on propulsion unit 102—and which may include a hydraulic fluid pump and hydraulic fluid reservoir—through lines 1430 and 1432 such as by quick connection fittings (not shown).

In other embodiments, valve 1434 may be a proportionally controlled directional valve.

Through control of valve 1434, pressurized hydraulic fluid may be selectively supplied to line 1428 in order to cause cylinder 880 to expand or hydraulic fluid may be supplied to line 1426 to cause cylinder 880 to contract/retract.

Control of diverter valve 1434 may be achieved through an internal control spool that may be actuated for straight-through flow via solenoids 1436 and 1438 to selectively permit fluid flow from supply line 1430 to line 1426 and for fluid to flow back from line 1428 to return line 1432. Alternatively, diverter valve 1434 may be actuated for cross-flow to selectively permit fluid flow from supply line 1430 to line 1428 and for fluid to flow back from line 1426 to return line 1432.

When valve 1434 is actuated for straight-through flow, hydraulic fluid may flow through line 1426 to rod end port 1420 of hydraulic cylinder 880. At the same time, fluid is permitted to flow back from cap end port 1416, through line 1428 to return line 1432. This will cause hydraulic cylinder 880 to contract in length as hydraulic fluid acts upon lower face 1412 of piston 1408. As hydraulic cylinder 880 contracts, track rod 824 will move in the direction indicted by arrow 886b in FIG. 16B and wheeled support units 822a, 822b, (through rotation of arms 834a, 834b) will rotate about their respective axes 830a, 830b in the directions indicated by arrows 888a, 888ab. As a result, wheels 826a, 826b, 828a, 828b will rotate to the right (as viewed in FIG. 16B).

When valve 1434 is actuated for cross-flow, hydraulic fluid may flow through line 1428 to cap end port 1416 of hydraulic cylinder 880. At the same time fluid is permitted to flow back from rod end port 1420, through line 1426 to return line 1432. This will cause hydraulic cylinder 880 to expand in length as hydraulic fluid acts upon upper face 1410 of piston 880. As hydraulic cylinder 880 expands, track rod 824 will move in the direction indicated by arrow 886a in FIG. 16B and wheeled support units 822a, 822b (through rotation of arms 834a, 834b) will rotate about their respective axes 830a, 830b in the directions indicated by arrows 890a, 890b. As a result, wheels 826a, 826b, 828a, 828b will rotate to the left (as viewed in FIG. 16B).

The solenoids 1436, 1438 are responsive to electrical control signals provided by controller 450 at inputs 1440, 1442 to cause the internal control spool to move between the straight-through flow and cross-flow configurations. Diverter valve 1434 may be a “bang-bang” controlled valve. For example diverter valve 1434 may be configured and operable such that: (a) if zero volts are applied to the solenoids 1436, 1438 then the solenoid is not activated and valve springs ensure that the valve is positioned in the closed position (FIG. 20) and fluid is no permitted to flow through valve 1434; (b) when 12 volts is applied producing a current of about 3 amps to either of the solenoids 1436, 1438 then the respective solenoid is activated and the valve is actuated for either straight-through flow (if solenoid 1436 is activated) or cross-flow (if solenoid 1438 is activated. If zero volts are applied to solenoids 1456, 1460 then the solenoid is not activated and the valve springs ensure that the valve 1434 is in the closed position. In this scenario, hydraulic cylinder 880 (and therefore the wheels of seed cart steering assembly 820) will remain in the same orientation (which may be the straight-ahead orientation or any other orientation).

Control system 1400 also includes rotation sensor 892, as described above having an output 1444 for generating rotation signals representing the rotational position of front wheeled support units 822a, 822b about their steering axes relative to drawbar 814. In an embodiment, sensor 892 may be configured to produce a rotation signal representing a zero angular rotation when the mid-point 824c of track rod 824 is positioned over drawbar 814 (i.e, as shown in FIG. 16B for example). Movement of track rod 824 in the direction indicated by arrow 886a in FIG. 16B may result in a negative change in the rotation signal and movement in the direction indicated by arrow 886b may result in a positive change in the rotation signal from sensor 892 (or vice versa).

Control system 1400 may also utilize frame orientation sensor 448 having an output 452 for producing a frame orientation signal representative of the relative orientation of frame 108 of implement 100. In some embodiments, control system 1400 uses the same frame orientation sensor 448 as control system 400, which may be located on frame 108 of implement 100. Due to the relatively close proximity of seed cart 800 to implement 100, the relative orientation of frame 108 of implement 100 may be approximately equivalent to the orientation of seed cart 800, such that the frame orientation signal also represents the orientation of seed cart 800.

In other embodiments, the control system may include a seed cart frame orientation sensor (which may be similar to or the same as tillage frame sensor 448) located on seed cart 800 for producing a seed cart orientation signal representative of the relative orientation of frame 802 of seed cart 800. The seed cart frame orientation sensor may like sensor 448 may be mounted on a horizontally level and flat upper surface of a frame member of seed cart 800.

Control system 1400 may also include controller 450, which receives frame orientation signals from sensor 448 or a frame orientation sensor on seed cart 800, through input 454. The controller 450 also includes inputs 1458 receiving rotation signals from output 444 of rotation sensor 892. Controller 450 may be integrated as part of controller 450 described above, or may be a separate controller entirely. Controller 450 may be located on seed cart 800, agricultural implement 100 or propulsion unit 102.

As referenced above, in some embodiments, frame orientation sensor 448 may take the form of a semi-conductor chip that is operationally located on the control circuit board of controller 450. In such embodiments, controller 450, with embedded frame sensor 448, may be mounted onto may be placed on a flat upper surface of an upper flange of open member 706 (FIG. 4B) of implement 100, or on a flat upper surface of an open member of seed cart 800, and may be provided with appropriate electrical power and other wires/cables to communicate with other components of control system 1400. Controller 450 may also be in communication with a host controller on propulsion unit 102.

As described previously, tillage frame orientation sensor 448 (or the seed cart frame orientation sensor) may only measure or provide signals indicative of force/acceleration in the Z″ and Y″ directions (like as shown in FIGS. 4D and 4E) of the sensor. The acceleration measured by sensor 448 or the seed cart frame orientation sensor may be measured as a function of gravity, from which the roll/side tilt angle of frame 108 (or of the frame of the seed cart 800) can be calculated by measuring the magnitude and direction of the proper acceleration as a vector quantity and thus can be used to sense the orientation of the accelerometer (and the component of the frame it is attached thereto) because of the direction of weight changes experienced by the accelerometer. Control system 400 may be operable to calculate (such as from a vector diagram and for example using the Pythagorean Theorem and deriving an angle beta therefrom) to establish the roll/side tilt angle beta of frame 108.

Also similar to that as described above, an algorithm of controller 450 may then use the roll/side tilt angle of the relevant frame to determine a required steering direction and angle to prevent/compensate for drift of seed cart 800 based on the frame orientation signal/values received from sensor 448. The algorithm may be similar to the algorithm described above in relation to control system 400 and may determine a required steering direction and angle to prevent drift of seed cart 800 based on the frame orientation signal received from sensor 448.

In some embodiments, the required steering direction and angle may be determined using a look up table, utilizing calculated values that are stored in a database that can be accessed by the controller. In some embodiments, the required steering direction and angle values in the look up table may be optimized to maintain the alignment of seed cart 800 with implement 100 and/or to assist in maintaining the alignment of implement 100 with propulsion unit 102.

In an embodiment, as noted above, controller 450 may receive a signal from frame orientation sensor 448 relating to the tilt/roll angle of frame 108 of the implement 100. Using the frame orientation signal, controller 450 may determine the roll angle of frame 108 and thus determine a required steering direction and angle to prevent drift of seed cart 800. It should be noted that sensor 448 is not detecting whether seed cart 800 has moved out of longitudinal/transverse alignment with propulsion unit 102 and/or agricultural implement 100. Thus, sensor 448 may sense a change in the side tilt angle (and optionally the fore/aft tilt) of frame 108 before seed cart 800 side drifts/slides sideways and moves out of longitudinal/transverse alignment with propulsion unit 102 and agricultural implement 100. Generally, in some embodiments, as side tilt/roll angle of frame 108 increases in either direction, then the required steering angle determined by controller 450 will also increase. If the roll angle of frame 108 is determined to be level (i.e. zero degrees roll) then controller 450 may determine that seed cart steering assembly 820 is required to be orientated in the straight ahead position. Both the straight-ahead position of seed cart steering assembly 820 and a zero-degree roll angle of frame 108 may be set by a calibration of control system 450.

Controller 450 may then produce a valve control signal through output 1462 for driving solenoids 1436 and 1438 to control diverter valve 1434 and therefore the steering angle and direction of seed cart steering assembly 820. Rotation signals from the output 1444, rotation sensor 892 may be used to confirm that the calculated required steering angle for seed cart steering assembly 820 has been achieved.

It should be noted that if it is desired to de-activate the steering system such that the front wheeled support units 822a, 822b, are able to move somewhat freely (albeit there will be some resistance due to the movement of fluid in the system), then the valves can be operated in such a manner that the there is no pressurized hydraulic fluid supplied by the hydraulic fluid supply and control system to the hydraulic circuit of cylinder 880. Thus, fluid is able to freely flow into and out of cylinder 880 and pass freely though valve 1474.

Referring to FIG. 21, a process 1500 that can be executed for detecting the orientation of frame 802 of seed cart 800 and preventing side drift of seed cart 800 is shown. The process is initiated by a signal provided by a user or automated process at block 1502. At block 1504, controller 4150 determines if the override for the system is activated and if agricultural implement 100 and/or seed cart 800 are in the correct configuration. A correct configuration for agricultural implement 100 may include, for example, all frame sections 130, 132, 134, 136, 138, 140, 142 of frame 108 being in the deployed configuration (as shown in FIG. 1A) and/or the seed cart 800 being properly connected in a tow configuration with agricultural implement 100. The override may be a manual override operated by a user in propulsion unit 102. If the condition at block 1504 is not met, for example when agricultural implement 100 is in a transport configuration, the process proceeds to block 1506, where the required steering angle for left- and right-side wheeled support units 822a, 822b is set to 0 degrees (i.e. the position shown in FIG. 16B).

If the condition in block 1504 is met, then the process proceeds to block 1508, where a frame orientation signal (as described above) is received by controller 450 from sensor 448. Controller 450 determine the angle of roll/side tilt of the frame 108 (or the angle of side tilt of the frame of the seed cart 800). At block 1510, controller 450 may determine via an algorithm or a lookup table (like as referenced above), a required steering direction and angle for left- and right-side wheeled support units 822a, 822b to prevent side drift of seed cart 800. If controller 450 determines no side drift is likely to occur, i.e., for example if seed cart 800 is travelling on flat and level ground, the desired steering angle will be 0 degrees.

In some embodiments, the required steering direction and angle may be a predetermined value obtained from a lookup table based on the frame tilt angle that is determined by the frame orientation sensor. For example, if sensor 448 detects a roll/side tilt angle of frame 108 of −10 degrees, that roll angle may, as an example, correspond to the wheels of seed cart steering assembly 820 being orientated to 10 degrees in the left direction (as determined from the lookup table).

At block 1512, controller 450 determines the difference between the required steering angle and the real steering angle. The real steering angle is determined from rotation signals received from rotation sensor 892 as described above. If the condition in block 1512 is met, then no adjustments are necessary, and the process returns to block 1504.

If the condition in block 1512 is not met, at block 1514 the process sends a signal to solenoids 1436 and 1438 in order to control the flow of hydraulic fluid through diverter valve 1434 to adjust the position of piston 1408 within hydraulic cylinder 880 and thereby adjust the steering angle of wheeled support units 822a, 822b. This may be referred to as a “Low” setting for the solenoid pin.

The duration of the signal sent to solenoids 1436 and 1438 may vary based on the deviation between the required steering angle and the real steering angle. Generally speaking, the duration of the signal sent to solenoids 1436 and 1438 may increase as the deviation between the required steering angle and the real steering angle increases. The duration of the signal may be determined by controller 450 via an algorithm or a lookup table.

At block 1516 controller 1450 again determines the difference between the required steering angle and the real steering angle. If the condition at block 1516 is met, the process proceeds to block 1518, where a signal is sent to solenoids 1436 and 1438 to stop adjustment of solenoids 1436 and 1438 order to maintain the current steering angle. This may be referred to as a “High” setting for the solenoid pins 1436, 1438, whereby zero volts are applied to the solenoids 1436, 1438 and valve springs ensure that the valve is positioned in the closed position and no fluid is permitted to flow through valve 1434. The process then returns to block 1504.

If the condition at block 516 is not met, the process returns directly to block 504.

In some embodiments, a user in the propulsion apparatus 102 may be able to make manual adjustments to the angle and direction of the wheels of seed cart steering assembly 820, for example by operation of a manual control such as a dial or switch in communication with controller 450. For example, the user may set a required steering angle of 5 degrees in the left direction on the manual control. The controller 450 determines the difference between the required steering angle and the real steering angle. The real steering angle is determined from rotation signals received from rotation sensor 892 as described above. If the real steering angle is equal to the required steering angle, no adjustments are necessary, and the process returns to block 1504. If the real steering angle is not equal to the required steering angle, controller 450 will send a signal to solenoids 1436 and 1438 in order to control the flow of hydraulic fluid through diverter valve 1434 to adjust the position of piston 1408 within hydraulic cylinder 880 and thereby adjust the steering angle of wheeled support units 822a, 822b. Controller 1450 again determines the difference between the required steering angle and the real steering angle. If the real steering angle is equal to the required steering angle a signal is sent to solenoids 1436 and 1438 to stop adjustment of solenoids 1436 and 1438 order to maintain the current steering angle.

### Seed Cart Side Drift Prevention/Compensation

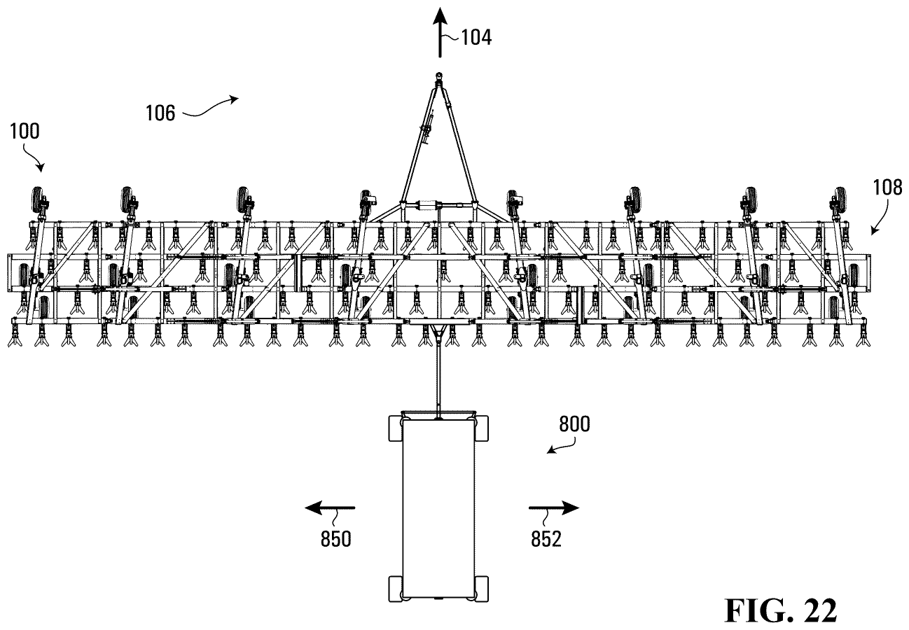

With reference to FIGS. 22-26 when seed cart 800 is attached to agricultural implement 100 and is traveling across uneven or sloped ground the weight of seed cart 800 may cause side shift of seed cart 800 occur in the general directions indicated by arrows 850, 852 in FIG. 22. For example, the weight of seed cart 800 due to gravity may result in a gravitation drift force acting upon seed cart 800 that causes seed cart 800 to drift/slide in a downhill direction relative to agricultural implement 100 and propulsion unit 102. Similar to agricultural implement 100, the angle of the slope, speed of seed cart 800 and the grip/resistance forces between ground surface 106 and the wheels 806, 826a-b and 828a-b of seed cart 800 may contribute towards the amount of side drift. The grip/resistance forces acting against the gravitational forces, that arise between ground surface 106 and seed cart 800 is determined from a number of factors such as the specific characteristics of the wheels and associated tires and the weight of seed cart 800 and the composition and moisture content of the material beneath ground surface 106.

As described above, through drawbar pivot pin 868, seed cart 800 can pivot about a generally vertical axis relative to agricultural implement 100 such that seed cart 800 is no longer in alignment with implement 100 and propulsion unit 102 (not shown in FIGS. 22-26). As a result of this, seed cart 800 may be in a skewed or skidded configuration where it is no longer be in alignment with agricultural implement 100 and/or propulsion unit 102. This is undesirable as when seed cart 800 drifts in direction 850 or 852 (FIG. 22), the weight of seed cart 800 will act upon agricultural implement 100 through drawbar 814 and rear towing hitch 56, which may cause implement 100 to also be dragged out of alignment with propulsion unit 102 and itself forced into a skewed or skidded configuration. Movement of seed cart 800 in either direction 850, 852 may result in inconsistent tracking of wheels 806, 826a-b and 828a-b of seed cart 800 across surface 106. This is undesirable, for example, when the tires of seed cart 800 skid (i.e., do not run straight) as the wheels may pass over and disturb ground that has just been treated by ground engagers 600, disrupting the seed and/or fertilizer that has been placed by implement 100. Furthermore, drift of seed cart 800 may apply additional forces to implement 100 through drawbar 814 and rear towing hitch 56 which could lead to distortion or failure of frame 108.

If the front wheels 826a-b and 828a-b of seed cart 800 were fixed in a straight-ahead direction, whilst the grip/resistive forces between the tires of the wheels and ground surface 106 would provide some resistance against the drift force, it may not be sufficient to completely negate the drift force and prevent side drift of seed cart 800. Furthermore, providing fixed wheels in the front would hinder the manoeuvrability of seed cart 800, although there would continue to be some amount of pivoting movement of the cart 800 as a result of the movement of the hitch connection 858, which is connected to the tillage frame 108, facilitated by movement of drawbar 814 via is forward hitch connection 858 and the connection at drawbar pivot pin 868. It should be noted that additional steering capability is available through the pivoting of the drawbar 815 about the vertical axis of drawbar pivot pin 868. For example, when propulsion unit 102 needs to make a sharp turn such as at the end of a field, the ground engagers on the tillage apparatus can be lifted from engagement with the ground surface, and the active steering systems for both the tillage apparatus 100 and seed cart 800 can be de-activated, while the propulsion unit 102 pulls the tillage apparatus and seed cart in a turn. It should be noted that at no time will the pivoting of drawbar 814 and the front connection 868, be locked/prevented from pivoting about the vertical axis of the drawbar pivot pin 868.

If the front wheels 826a-b and 828a-b of seed cart 800 were free to rotate, such as for example freely rotatable caster wheels, they may rotate in the downhill direction when seed cart 800 encounters sloped or uneven ground. This may undesirably steer seed cart 800 in the down-hill direction and into a skewed or skidding orientation.

Through operation of steering assembly 820, side drift of seed cart 800 may be reduced or substantially eliminated. Therefore, the alignment of seed cart 800 with agricultural implement 100 may be maintained which in turn may assist in maintaining alignment of implement 100 with propulsion unit 102 during operation.

Generally speaking, steering assembly 820 may be steered in an uphill direction when implement 100 and seed cart 800 encounter ground sloped either way in a transverse direction (i.e., in the Y-direction shown in FIG. 1). The severity of the slope of ground surface will determine the required steering angle of steering assembly 820, whereby the steering angle will generally increase with increasing slope of the ground surface due to the greater drift force that will be acting upon seed cart 800.

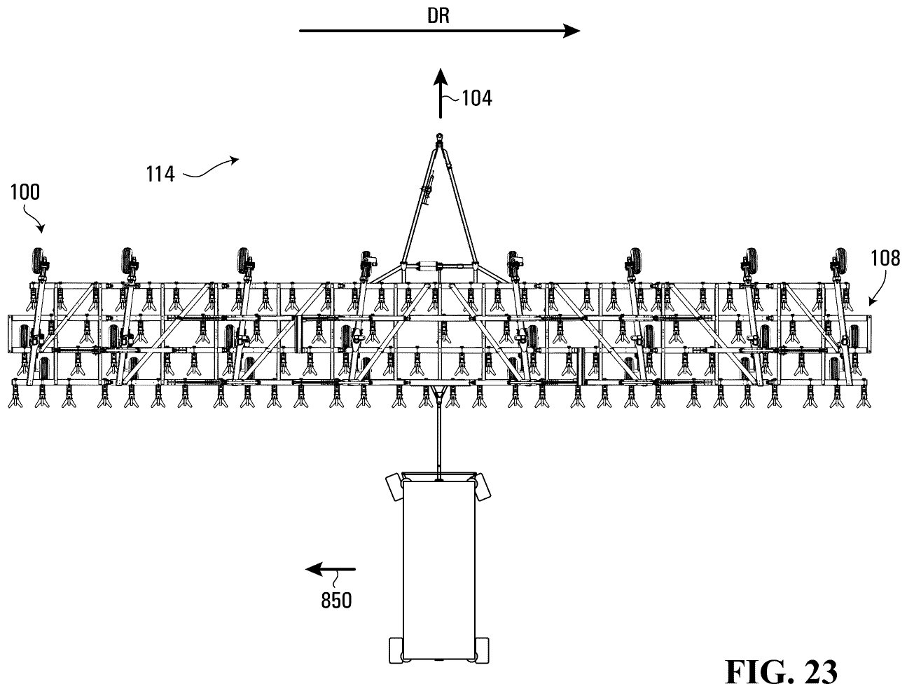

As illustrated in FIG. 22, agricultural implement 100 and seed cart 800 may be travelling across ground surface that is substantially flat and level in a direction of travel 104. In a first scenario as depicted in FIG. 23, agricultural implement 100 and seed cart 800 may encounter a transition from ground surface 106 to ground surface 114, that is sloped downwards in the direction DR. As agricultural implement 100 and seed cart 800 travel in the direction 104, the weight of seed cart 800 as a whole due to gravity will act in the direction DR, resulting in a drift force acting in the same direction that will urge seed cart 800 to drift in the direction DR.

However, as the ground surface transitions from surface 106 to surface 114, seed cart orientation sensor 448 will detect the change in the roll/side tilt angle of frame 108 of implement 100 (and associated direction and degree of slope of the ground surface 114), generating a frame orientation signal which is received by controller 450 at input 454. Controller 450 will use the frame orientation signal to determine a required steering direction and angle for steering assembly 820 to compensate for forces resulting from the downward slope and may desirably keep seed cart 800 in substantial alignment with propulsion unit 102. Through operation of hydraulic cylinder 880, assembly 820 operate such that wheels 826a-b and 828a-b are orientated in an uphill direction 850 as shown in FIG. 23, in order to steer seed cart 800 in an uphill direction to maintain alignment with agricultural implement 100.

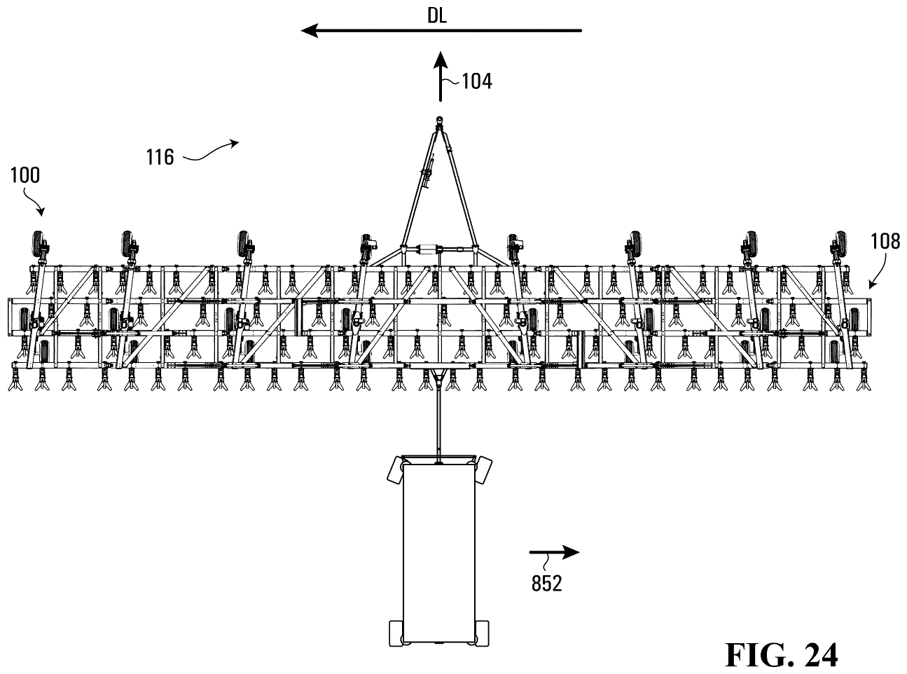

In a second scenario as depicted in FIG. 24, in operation agricultural implement 100 and seed cart 800 may encounter a transition from ground surface 106 to ground surface 116, that is sloped downwards in the direction DL. As agricultural implement 100 and seed cart 800 travel in the direction 104, the weight of seed cart 800 as a whole due to gravity, will act the direction DL, resulting in a drift force acting in the same direction that will urge seed cart 800 to drift in the direction DL.

However, as the ground surface transitions from surface 106 to surface 116, seed cart orientation sensor 448 will detect the change in the roll of frame 108 of implement 100 (and associated the direction and degree of slope of ground surface 116), generating a frame orientation signal which is received by controller 450 at input 454. Controller 450 will use the frame orientation signal to determine a required steering direction and angle for steering assembly 820 to compensate for forces resulting from the downward slope and may desirably keep seed cart 800 in substantial alignment with propulsion unit 102. Through operation of hydraulic cylinder 880, assembly 820 operate such that wheels 826a-b and 828a-b are orientated in an uphill direction, as shown in FIG. 24 in order to steer seed cart 800 in an uphill direction to maintain alignment with agricultural implement 100.

In either of the scenarios described above, as sensor 448 detects further changes in the roll of frame 108, i.e., and associated change in the slope of the ground surface, controller 450 will adjust the direction and degree of steering of steering assembly 820 in order to keep seed cart 800 in alignment with implement 100. For example, if the severity of the slope of surfaces 114 or 116 were to decrease (which would be detected through changes in the roll of frame 108 by sensor 448), controller 450 may decrease the required steering angle of steering assembly 800. Conversely, if the severity of the slope of surfaces 114, 116 were to increase controller 450 may increase the steering angle of steering assembly 820 to counteract the increase in drift force experienced by seed cart 800.

Through operation steering of steering assembly 820, side drift of seed cart 800 will be reduced or substantially eliminated. Therefore, the alignment of seed cart 800 (and attached agricultural implement 100) with propulsion unit 102 is maintained during operation.

In a similar manner to as described above for steerable rear wheeled assembly 200, in an embodiment an operator in propulsion unit 102 may be able to adjust the sensitivity of the response of controller 450 such that for the same frame orientation signal received by controller 450, a greater or lesser required steering angle for seed cart steering assembly 820 is determined. For example, if an operator observed that some side drift of seed cart 800 was occurring, an adjustment could be made to increase the sensitivity of the response on controller 450 such that for the same frame orientation signal received by controller 450, a greater required steering angle was determined for seed cart steering assembly 820. In some embodiments, the operator may use information on the voltage of drawbar rotation sensor 861 (which may be indicative of the relative position of the seed cart 800 relative to implement 100 and propulsion unit 102) which may be displayed in the cab of propulsion unit 102 to indicate if the sensitivity of the response of controller 450 needs to be adjusted.

Seed cart steering assembly 820 may be suitable for use with any type of air seed cart. In an embodiment, seed cart steering assembly 820 may be positioned at the rear of a seed cart such that the rear wheels of the seed cart 800 are steerable instead of, or in addition to the front wheels. However, it may be more desirable to position seed cart steering assembly 820 at the front of a seed cart, such that the steering assembly will have a greater influence on the orientation of the interconnected implement 100 due to the closer proximity to drawbar 814.

In an embodiment, seed cart steering assembly 820 may work cooperatively with steerable rear wheeled assembly 200 of agricultural implement 100 to reduce or eliminate side drift of both seed cart 800 and implement 100. For example, the wheels of steerable rear wheeled assembly 200 and seed cart steering assembly 820 may be operated to both steer in the same direction at approximately the same steering angle the same time (known as crab steering).

For example, the degree and direction of the required steering angle for each of steerable rear wheeled assembly 200 and seed cart steering assembly 820 may be determined by an integrated control system, or separately by more than one controller, which may be communication with each other. The controller(s) may receive frame orientation signal(s) such as from sensor 448 and calculate required steering angles for both steerable rear wheeled assembly 200 and seed cart steering assembly 820 to reduce or eliminate side drift of both seed cart 800 and implement 100. The steering assemblies may be operated as described above to achieve the required steering angle for each assembly.

In an embodiment, control system 400 of steerable rear wheeled assembly 200 may be integrated with control system 1400 of seed cart steering assembly 820 as a single control system that may share common components such as valves and hydraulic fluid lines.

In an embodiment, the rear wheels of seeder cart 800 may also be steerable, i.e., there is also a steerable rear wheeled assembly similar to steerable rear wheeled assembly 820 at the rear of seeder cart 800 such that seeder cart 800 has four-wheel steering. In this embodiment, the front and rear wheels may both be controlled by a control system such that all wheels turn in the same direction and to approximately the same rotational steering angle at the same time (which may be referred to as “crab” steering). The degree and direction of the steering the front and rear wheels may be determined and controlled in a similar manner to as described above for control system 1400.

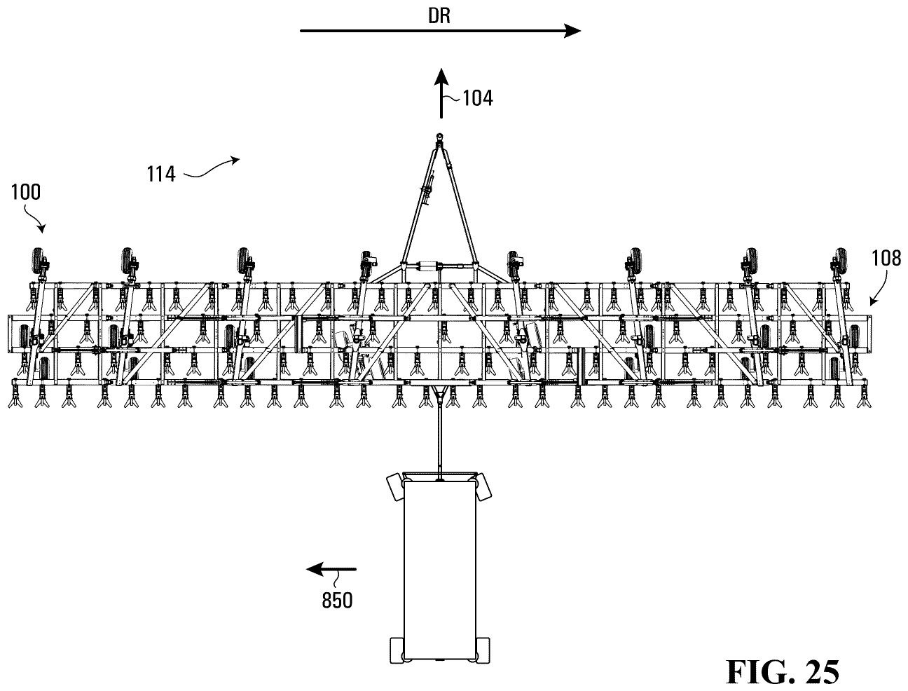

With reference to FIG. 25, agricultural implement 100 and seed cart 800 may be travelling in direction 104 across a ground surface 114 that is sloped in the direction DR. As explained above, steerable rear wheeled assembly 200 and seed cart steering assembly 820 may both rotate in an uphill direction, as shown in FIG. 25.

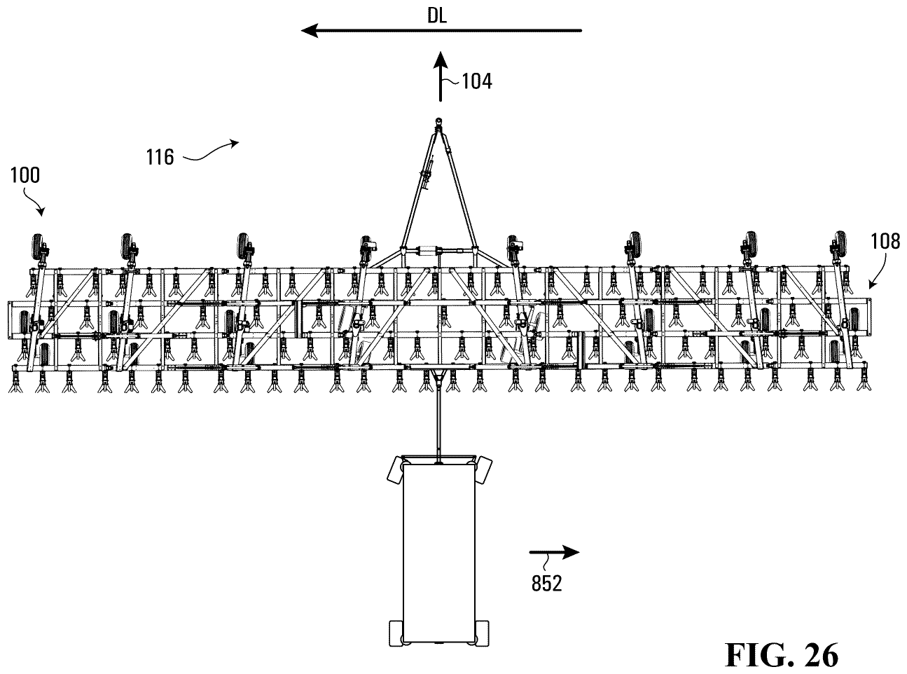

Similarly, as shown in FIG. 26, agricultural implement 100 and seed cart 800 may be travelling in direction 104 across a ground surface 116 that is sloped in the direction DL. As explained above, steerable rear wheeled assembly 200 and seed cart steering assembly 850 may both rotate in the uphill direction shown in FIG. 21.

In an embodiment, controller 450 may function to estimate the weight of seed cart 800 in real time, based on information inputted by an operator, such as starting weight of seed cart 800, starting volumes/weights of material in tanks 808 and flow rates of material from tanks 808 during operation in order to estimate changes in the weight of seed cart 800. Alternatively, controller may receive a signal from seed cart 800 corresponding to the real-time weight or volume of seed/fertilizer or other products remaining in tanks 808. As it is known, the weight of seed cart 800 will influence the magnitude of the drift force acting upon seed cart 800 and this may factor into the calculation of the required steering angle for seed cart steering assembly 820 and/or rear wheeled assembly 200. For example, as seed/fertilizer is placed by agricultural implement 100 during operation and the weight of seed cart 800 decreases, the drift force acting upon seed cart 800 may also decrease and as such less steering angle may be required for seed cart steering assembly 820 and/or rear wheeled assembly 200 in order to prevent side drift.

Variations on the foregoing are contemplated. For example, whilst the control systems described above may by substantially automated such that minimal or no input from an operator is required in an embodiment, communications ports such as port 456 on controller 450 or port 1456 on controller 450 facilitates connection of the respective controller with propulsion unit 102 such that information orientation may be displayed in propulsion unit 102. Such information may include, but is not limited to the orientation of frame 802 of seed cart 800 (such as the pitch roll or yaw of frame 802), the orientation of frame 108 of agricultural implement 100, and the steering direction and angle of left- and right-side wheeled support units 822a, 822b and the steering direction and angle of left- and right-side rear wheeled support units 300a, 300b. An operator may then manually adjust the steering direction and angle of steerable rear wheeled assembly 200 and/or seed cart steering assembly 820 through a control interface in propulsion unit 102 in order to adjust the orientation of implement 100 as required.

In an embodiment, the steerable rear wheeled assembly 200 of agricultural implement 100 and/or seed cart steering assembly 820 of seed cart 800 may be manually operated by a user such as an operation onboard in a cab of propulsion unit 102 to assist in maneuvering agricultural implement 100 and/or seed cart 800. This may be particularly helpful when executing a turn of propulsion unit 102, agricultural implement 100 and/or seed cart 800.

In some alternate embodiments, the frame support units may not be wheeled support units, but may be another type of support unit which permit the tillage frame or mobile unit to move over the ground surface, and which support unit can be actively steered by a steering system such as is described herein.

### Downhill Side Drift Counteracting/Compensation Mechanism Using Ground Engagers

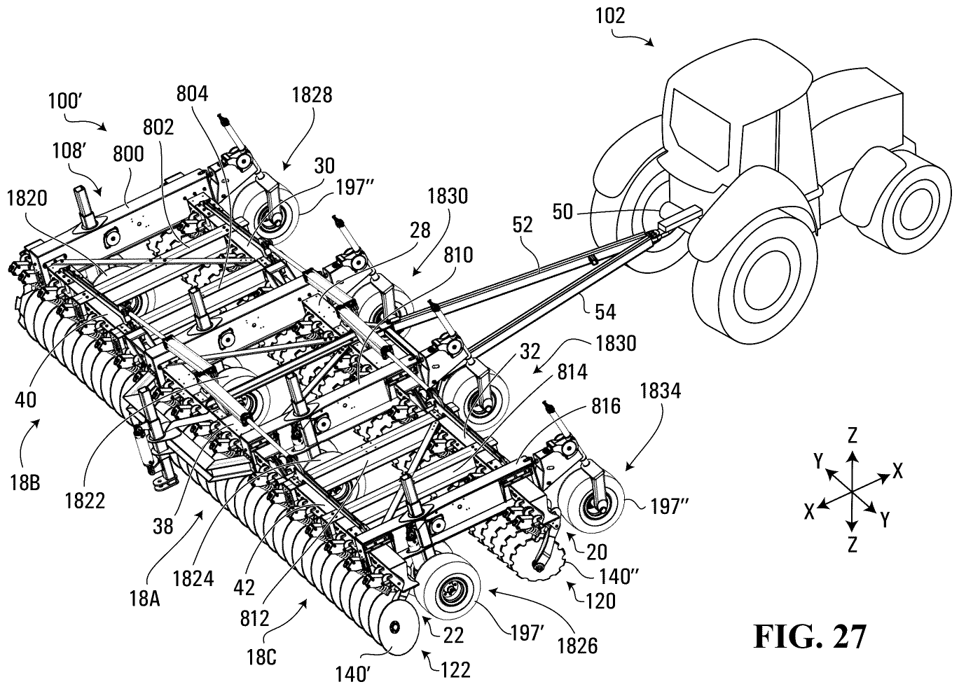

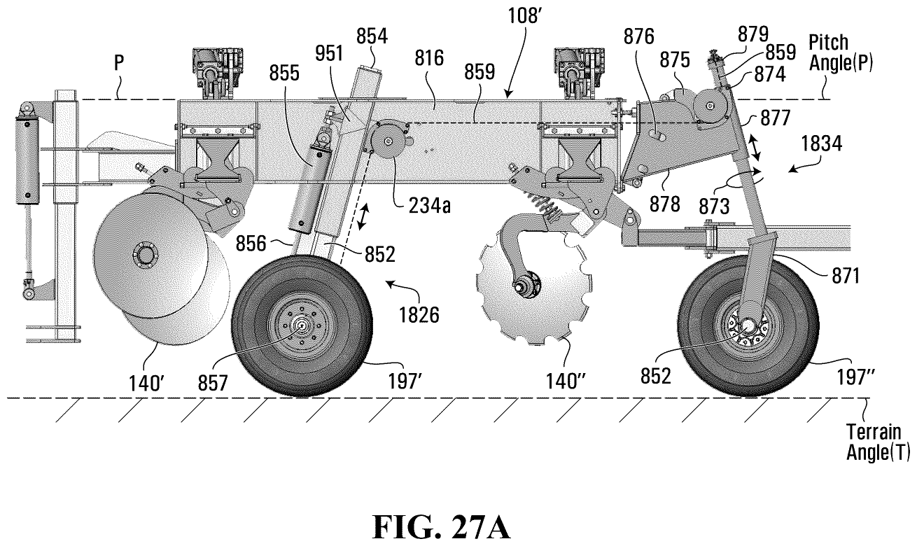

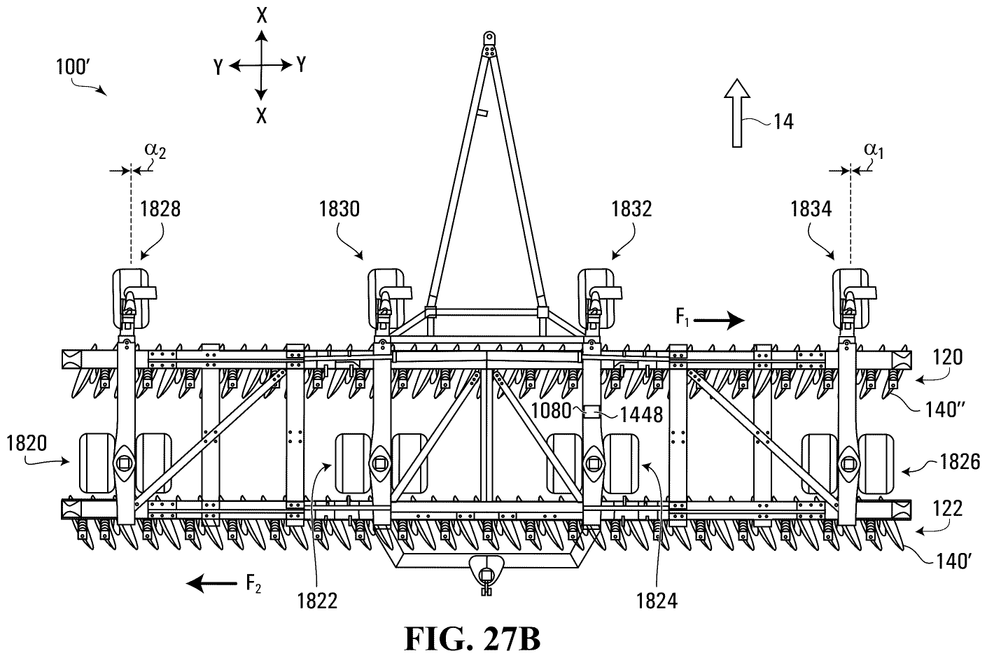

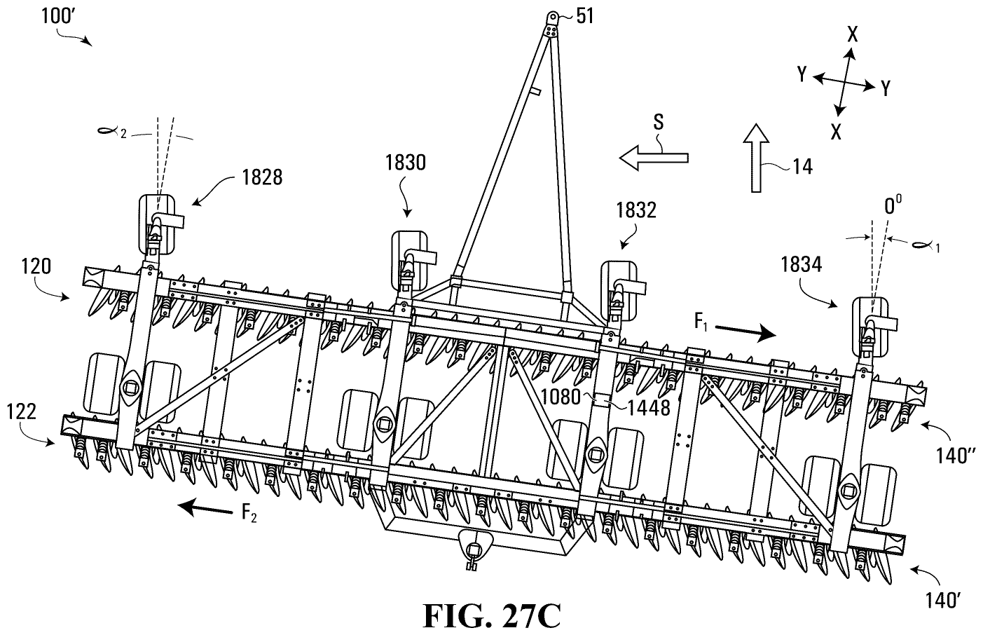

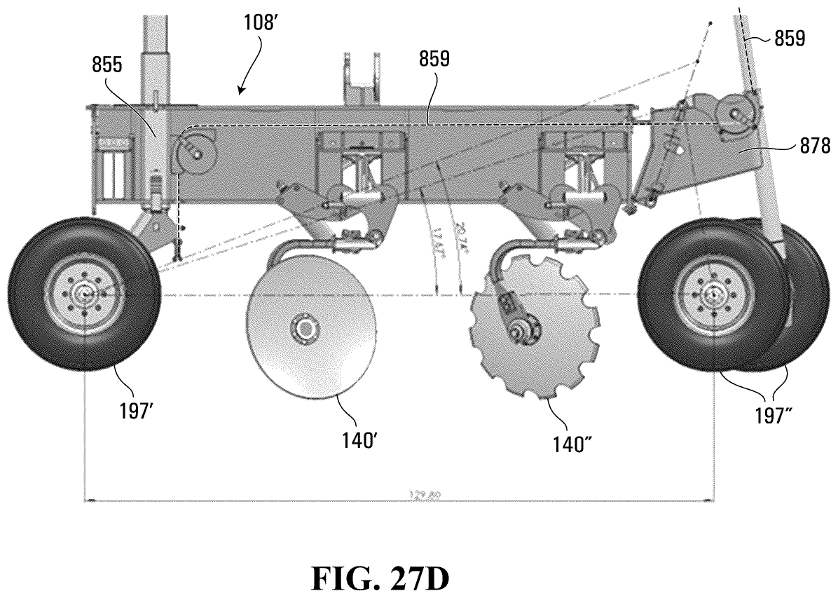

As noted previously, in some embodiments, the fore/aft pitch of the frame about a transverse axis of an agricultural implement (i.e. titling in the longitudinal X direction of FIG. 27) may be adjustable, such as for example in the manner disclosed in U.S. Pat. No. 11,122,725 B2 referenced above. In such an arrangement, adjustment of the fore/aft pitch angle of the frame of an agricultural implement relative to the ground surface on which it is positioned, and the ground engagers attached to the frame, can be utilized to vary the transverse forces applied to the angled ground engagers (angled relative to the longitudinal axis of the frame) and the frame to which they are attached, as a result of the forward movement of the agricultural implement, the angled contact of the ground engagers with the terrain, and the different amount/depth of engagement with the ground material/terrain of the ground engagers in a front row, compared to the amount/depth of angled contact and engagement with the ground material/terrain of the ground engagers in a second row.

With particular reference to FIGS. 27, 27A and 27B, in an agricultural implement 100′ in which there is a front row 120 of ground engagers 140′ and a rear row 122 of ground engagers 140″ both attached to a frame 108′ (FIG. 27), and if the discs 140′ are identical in number and in configuration including contact angle with the terrain, to discs 140″, then because the front row of discs 140″ will typically be engaging unbroken ground material, whereas the rear row of discs 140′ may encounter partially broken ground, if the depth of engagement of the front discs 140″ and rear discs 140″ is the same, then the front discs 140″ may have greater transverse force F1 exerted on them in one direction compared to the transverse force F2 exerted on the discs 140′. This imbalance may at least be partially compensated for by the fact that force F2 is acting at a greater radial distance from the hitch 51 than force F1. Nevertheless, on level terrain, it may in some embodiments and/or situations, be necessary to adjust the fore/aft pitch angle of the frame 108′ (P) [FIG. 27A] (which may be defined relative to a top surface of a longitudinal member of frame 108′) relative to the terrain surface level/angle (T) [FIG. 27A] of the terrain on which rear wheels 197′, and front caster wheels 197″ are supported, in order to find a suitable difference in depth of penetration of discs 140′ compared to discs 140″ on level ground in to the terrain surface in order to provide for a substantially balance of forces F1 and F2. This may be considered the neutral pitch angle of the frame 108′ and its value may be stored in a database accessible by host controller and/or controller 1080. In some situations, for some agricultural implements 100′, the neutral pitch angle of frame 108′ relative to level ground surface may be zero degrees. The neutral pitch angle of frame 108′ may be ascertained at least in part by controller 1080 with the assistance of rotation sensor 1042 (which may operate as described below)—so the controller 1080 can identify the neutral fore/aft pitch angle corresponding to when the ground side slope angle is zero and the front caster wheel is longitudinally aligned with the longitudinal axis of the frame 108′.

In some embodiments, the angle of side tilt/roll of the frame 108′ (relative to a level orientation) measured by a side tilt/roll angle sensor (such as a sensor 448 mounted on a flat level surface of a frame member as described above), can be utilized by a control system in order to vary the fore/aft pitch angle and orientation of the frame from its neutral pitch angle, and thereby adjust at least one of, and in some embodiments/situations both, of the transverse forces F1, F2 acting on the front and rear rows of ground engagers. The adjustment of the relative level of these transverse forces can be selected to produce a net transverse force in a particular transverse direction, which counteracts the gravitational forces acting on the agricultural implement in the opposite transverse direction resulting from the agricultural implement being positioned on side angled tilted sloping terrain. As an aside, it should be noted that in such embodiments the rear wheeled support units of the agricultural implement, may have wheels that are not pivotable about respective generally vertical steering axes.

By way of example, with reference to FIG. 27, an agricultural implement 100′ that may be towed by a propulsion unit 102, may be constructed in substantially the same manner as the agricultural implement disclosed and illustrated in U.S. Pat. No. 11,122,725. Transversely oriented structural members of a frame 108′ may include a front row of longitudinally axially aligned open members 20 and a rear row of longitudinally axially aligned open members 22. Front row open members 20 may include a center open member 28 in a central frame section 18A, a left open member 30 in a left frame section 18B, and a right open member 32 in a right frame section 18C. Similarly, the rear row members 22 may include a central open member 38 in the central frame section 18A, a left open member 40 in the left frame section 18B and a right open member 42 in the right frame section 18C. Open member 30 may be longitudinally spaced and be transversely parallel to open member 40; open member 28 may be longitudinally spaced and be transversely parallel to open member 38; and open member 32 may be longitudinally spaced and transversely parallel to open member 42.

Frame 108′ may also include a plurality of spaced structural open members 800, 802, 804, 806, 810, 812, 814, and 816 which are generally oriented in a longitudinal direction (direction X in FIG. 1) and which fixedly interconnect open members in each of the front and rear rows 20 and 22. Open members 800, 806, 810, 816 are particularly configured to be connected to and supported by rear wheeled support units having wheels that either may or may not, be rotatable/pivotable about a generally vertical axis of rotation and may be configured to connect to associated frame lift mechanisms of the type described in U.S. Pat. No. 11,122,725 and as described hereinbefore.

Agricultural implement 100′ may also comprise a front row 120 of ground engagers 140″ mounted on the front row of open members 20 (FIG. 27), and a rear row of ground engagers 140′ mounted on rear row of open members 22 and thus are secured to frame 108′ of agricultural implement 100′. Ground engagers 140′, 140″ may comprise tillage discs (FIGS. 27, 27A) as described and illustrated in U.S. Pat. No. 11,122,725 and which may be configured to engage the terrain at a contact angle of terrain engagement to the terrain relative to the longitudinal axis X-X.

Wheels 197′ of the rear wheeled support unit 1820, 1822, 1824 and 1826 and wheels 197″ of front wheeled support units front wheeled support unit 1828, 1830. 1832, 1834 may typically include round rubber compound tires (or tires made of other materials that provide a suitable frictional contact with a terrain surface) mounted on round strong metallic rims and are operable for free rotation about a generally transversely oriented wheel axis of rotation on respective wheel axles.

Agricultural implement 100′ may be constructed to allow for frame 108′ to be raised evenly upward and downward relative to the ground surface upon which it is supported, without any adjustment to its fore/aft pitch angle, and it may also be able to be independently adjusted in its fore/aft pitch (in a longitudinal direction X). This vertical upward and downward position adjustment and its fore/aft pitch adjustment can in general be facilitated by a hydraulic cylinder associated with each front wheeled support unit, and adjustment of the length of a cable 859 (FIG. 27A) that passes from a wheel hub 857 of each rear wheeled support unit 1820, 1822, 1824 and 1826, to corresponding opposed side, rearward pulley devices 234a, 234, forward to front pulley devices 874 and over an end cap 879, associated with each corresponding front wheeled support unit 1828, 1830. 1832, 1834, such as front wheeled support unit 1834 as depicted in FIG. 27A. In some embodiments pulley devices 234a, 234b may have the same outside diameter over which cable 859 passes as the outside diameter as front pulley devices 874 over which cable 859 passes. In other embodiments, a linkage mechanism can replace the cable and pulley system to achieve the same functionality as described herein.

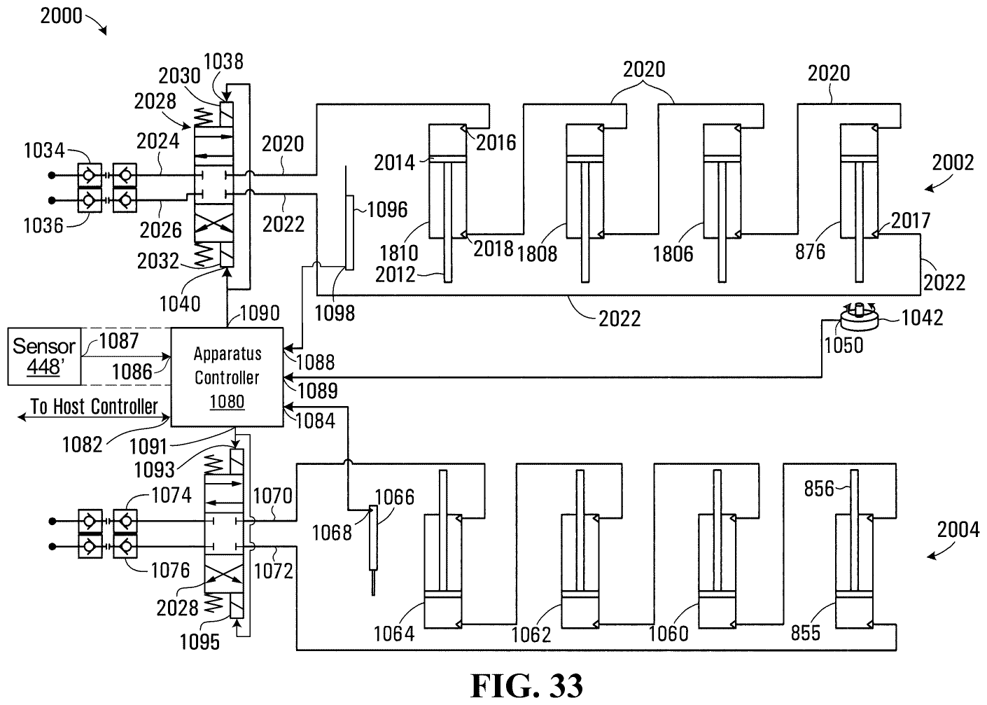

In a manner like that described above herein, each rear wheeled support unit 1820, 1822, 1824 and 1826 may have a one way (or two way) acting hydraulic cylinder (which may be like hydraulic cylinders 226 above) that may for example (with reference to FIG. 27A) be interposed between longitudinal open members (such as an open member 816) of frame 108′ and a wheel hub like wheel hub 857 of a wheel 197′. With continued reference to FIG. 27A, representative hydraulic cylinder 855 may be provided that is associated with representative rear wheeled support 1826, and which includes extendible piston rod 856. Corresponding respective hydraulic cylinders 1060, 1062, and 1064 (FIG. 33) may be associated with each of the other rear wheeled support units 1820, 1822, 1824. In some embodiments, hydraulic cylinders 855, 1060, 1062, and 1064 may have the same size chamber volumes, piston rods, same size pistons and piston rods, and have the same stroke distance. In other embodiments, it may be desirable that these cylinders may have some varying dimensions such as for example some having smaller diameter cylinders with longer stroke lengths and others with relatively larger diameter cylinders with shorter stroke lengths. With cylinders being connected in series, overall frame height control system 2004 as referenced below can be configured such that the volume of hydraulic fluid being displaced on each stroke is the same in each of the cylinders connected in series.

As shown in FIG. 33, hydraulic cylinders 855, 1060, 1062, and 1064 may be connected in series via hydraulic fluid lines 1070 and 1072. As described above, the implement 100′ may be configured and operable so that by extending or retracting the piston rods 856 of each hydraulic cylinders 855, 1060, 1062, and 1064, with the appropriate flow of pressurized hydraulic fluid, the front row 120 of ground engagers 140″ and rear row 122 of ground engagers 140′ across the entirety of frame 108′ are both evenly raised or lowered by substantially equal amounts resulting in an even upwards/downwards movement. In the embodiment as shown in FIG. 33, overall frame height control system 2004 may include hydraulic cylinders 855, 1060, 1062, 1064 along with a linear sensor 1066 having an output 1068 for producing a frame height signal representative of an overall vertical height of the frame 108′ relative to the ground surface. Linear sensor 1066 may be provided with appropriate electrical power and other wires/cables to communicate with other components of control system 2000 including controller 1080.

Representative hydraulic cylinder 855 as shown in FIG. 27A, may have an upper end interconnected to a bracket 951 which is secured to tubular support 854. Like that described above herein in relation to agricultural implement 100, the operation of hydraulic cylinders 855, 1060, 1062, and 1064 may be controlled by an actuator and/or controller which may control valves in a hydraulic fluid and control circuit to control the flow of pressurized hydraulic fluid to and from these hydraulic cylinders. By extending piston rod 856 of each hydraulic cylinder 855, 1060, 1062, and 1064, the distance between rear wheel 197′ and its corresponding open frame member (such as frame member 816) may be increased, and by retracting piston rod 856, the distance between each rear wheel 197′ and the corresponding open member may be decreased. If all piston rods of the hydraulic cylinders 855, 1060, 1062, and 1064 move the same amount transversely across frame 108′, the upward and downward movement of frame 108′ relative to the rear wheels will be the same across the frame.

Secured to opposed sides of web portion of each open member (such as open member 816) of frame 108′ may be the rearward pulley devices 234a, 234b (only 234a is visible in FIG. 27A).

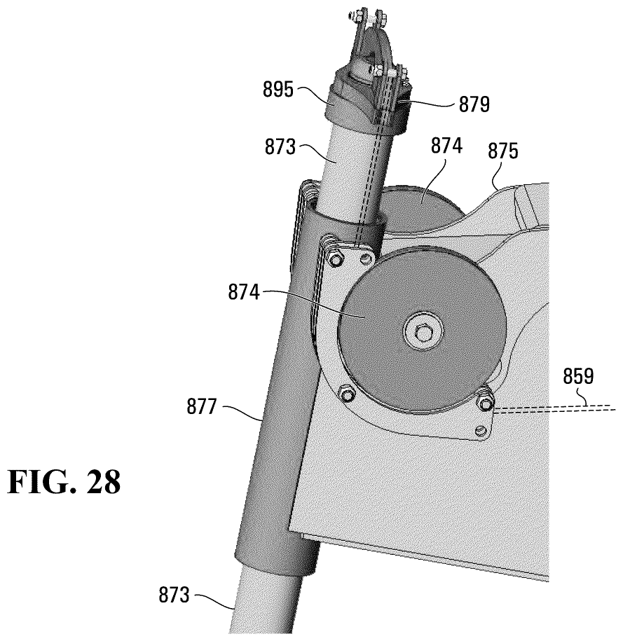

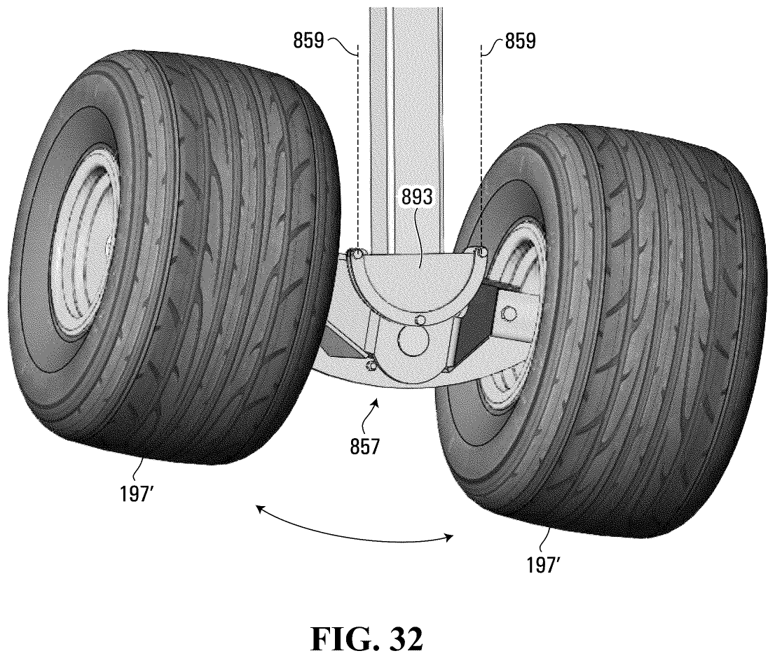

With reference to FIG. 32, an example of each of rear wheeled support units 1820, 1822, 1824 and 1826 is shown in which rear wheels 197′ may be mounted for rotation on a wheel axle about a generally transverse wheel axis of a wheel hub 857. Wheel hub 857 may be supported on leg 853 that is interconnected to a longitudinal open member (such as open member 816) and capable of generally vertical sliding movement in relation thereto. Continuous cable 859 may be secured around an arcuate guide 893 of wheel hub 857 which may be fixedly mounted to wheel hub 857 associated with the rear wheels 197′ of each rear wheeled support unit. Cable 859 may extend around the arcuate guide 893 of wheel hub 857 upwards on both sides to transversely opposed rearward pulley devices 234a, 234b and then follow curved paths around rearward pulley devices 234a, 234b on opposite sides of the web of the open member (such as open member 816) and extend to a pair of corresponding opposed forward pulley devices 874 associated with its front wheeled support unit (such as front wheeled support unit 1834) (see also FIG. 28).

With reference again to FIG. 27A, an example front wheeled support unit 1834—which is representative of each of the front wheeled support units 1828, 1830, 1832, 1834—is also illustrated and may include a single caster wheel 197″ supported at one end of a leg member 871 which may be attached to an axle/hub mechanism 852 in such a manner as to allow for free rotation of the wheel about the wheel axis of the axle/hub 852. In other embodiments, where for example loading may be of a magnitude to require it, front wheeled support unit 1834 may include two, side by side, front caster wheels. Leg member 873 may be generally rectangular in cross section and tubular and may be connected at a top end portion to a cylindrical rotatable support post 873. Post 873 may be receivable for axial movement relative to a supporting hollow cylindrical tubular support 877. Post 873 may also be rotatable about a generally vertical, longitudinal steering axis of tubular support 877. Tubular support 877 may be mounted to a forward end portion of a mounting block 878.

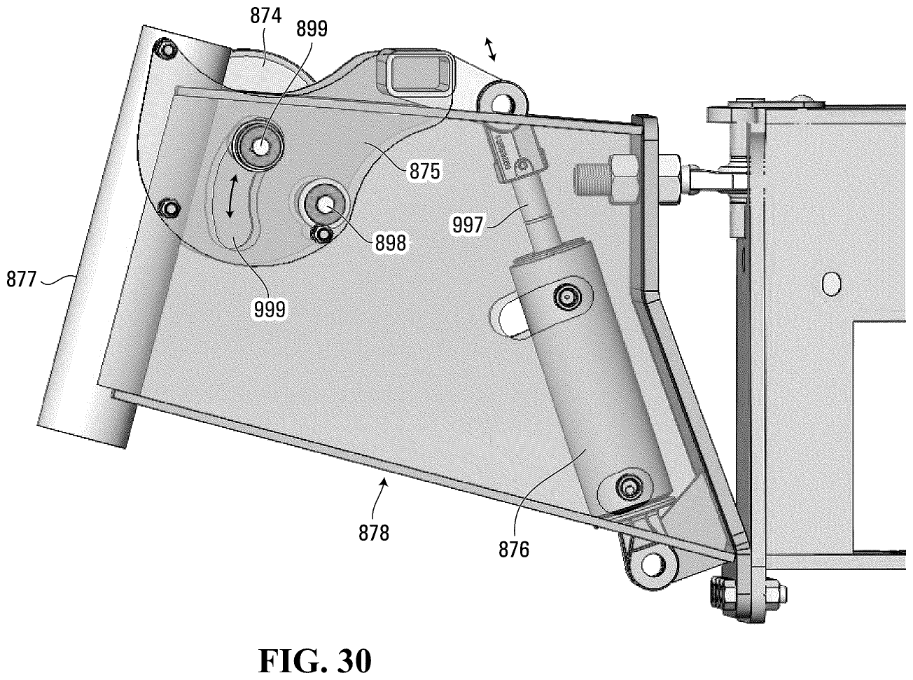

Front pulley devices 874 of each front wheeled support unit 1828, 1830, 1832, 1834, may have a common transverse axle for rotation and may be mounted on a common shaft 899 (FIG. 30). Shaft 899 may be mounted to a lever arm device 875. Lever arm device 875 may be mounted to mounting block 878 for pivoting movement about a pivot location 898. An end arm portion of lever arm device 875 may be pivotally connected to an end of a piston rod of a two-way acting hydraulic cylinder 876 that is also mounted to mounting block 878. Hydraulic cylinder 876 may have an extendible piston rod 997. The operation of hydraulic cylinder 876 may be controlled by an actuator and/or controller which may control valves in a hydraulic fluid circuit to control the flow of pressurized hydraulic fluid to and from hydraulic cylinder 876. By extending or retracting piston rod 997 of hydraulic cylinder 876, lever arm 875 may be pivoted about pivot location 898. The shaft 899 connecting pulley device 874 may move within a slot 999 in mounting block 878. By this movement, the position of pulley devices 874 can be altered. By moving the position of pulley devices 874, the path distance for cable 859 between the pulley devices 874 and trunnion device 879 can be increased or decreased.

As noted above, continuous cable 859 may extend from the wheel hub 857 of wheel 197′ upwards to rearward pulley devices 234a, 234b and then follow a curved path around rearward pulley devices 234a, 234b and extend to forward pulley devices 874. The opposite sides of cable 859 may follow a path upwards and are affixed to cable trunnion 879 located at the upper end of post 873. Opposed sides of cable 859 pass over and meet at the cable trunnion 879. Thus, a continuous path of cable 859 is completed.

Cable trunnion 879 may include an upper arcuate guide member which will be held at a fixed angle (i.e. top-down rotational angle) by the tension in cable 859 that passes over arcuate guide member has runs vertically down each side thereof. This arrangement will keep cable trunnion 879 from rotating angular about a vertical axis Trunnion 879 may be mounted on a thrust bearing device 895 (FIG. 28). Post 873, leg member 871 and front caster wheel 197″ are thus operable to rotate about a generally vertical axis, without interfering with the positioning of cable 859.

By extending piston rod 997 of hydraulic cylinder 876, the distance between pulley devices 874 and trunnion device 879 can be altered. Post 873 may be rotatable relative to end cap device 879 such that post 873 rotates about a longitudinal axis. But when post 873 rotates, the cable 859 attached around each end cap device 879 is not rotated.

For each front wheeled support unit 1828, 1830, 1832, 1834 an increase in that length of the cable 859 between pulleys 874 and trunnion 879 will cause the front wheel 197″ to be moved closer to front region of frame 108′, thus lowering the front region of the frame 108′ and causing the front row of ground engagers—which may be discs 140″—to penetrate into the ground more. A decrease in that length of the cable 859 will cause the front wheel 197″ to be moved further away from front of frame 108′, thus raising the front region frame 108′ relative to the front caster wheel 197″ and ground surface 106 and causing the front row of ground engagers 140″ to penetrate into the ground to a lesser extent. Thus, adjustment of the cable 859 can facilitate adjustment of the fore/aft pitch angle of the frame 108′ and the ground engagers 140′, 140″ attached thereto. This may also be useful for levelling the frame 108′ and ground engagers 140′, 140″ attached thereto.

The result is that each of the front caster wheels 197″ of each of the front wheeled support units 1828, 1830, 1832, 1834 can be adjusted vertically, independently of the main frame height setting [which is controlled by operation of each of the main hydraulic vertical lift cylinders 855, 1060, 1062, and 1064 (FIG. 33)].

In operation of agricultural implement 100′, for example when it is about to commence tilling of the ground material beneath ground surface, an operator in propulsion unit 102 may consider it desirable to lower frame 108′ evenly and including the front row of transverse open members and rear row of transverse open members an equal amount relative to the ground surface. This may cause front row of discs 140″ and rear row of discs 140′ to penetrate into the ground material beneath the ground surface an equal and suitable distance as assessed by the operator. It may be appreciated that in many typical operating environments, the overall weight of the frame 108′ and discs 140′, 140″ and their mounting devices, will be considerable and will typically cause the discs 140′, 140″ to penetrate into the ground to a desired depth if the frame 108′ is lowered relative to front and rear wheeled support units. In other words, within typically operating depths, the contact surface areas of the discs 140′, 140″ with the ground material beneath surface will not provide sufficient upward forces to alone counteract the force of gravity acting on frame 108′ and discs 140′, 140″ and their mounting components. The front wheeled support units 1828, 1830, 1832, 1834 and rear wheeled supports units 1820, 1822, 1824, 1826 are required to support the weight of these components above ground surface 16.

Assuming the frame 108′ starts from a generally horizontally level manner (with a zero fore/aft pitch angle), both longitudinally and transversely to lower the frame 108′ and the disc mounts and discs 140′, 140″ attached thereto, in a level manner, piston rods 856 of hydraulic cylinders 855, 1060, 1062, 1064, of each of rear wheeled support units 1820, 1822, 1824, 1826 may be appropriately retracted. This will cause corresponding pairs of wheels 197′ to move up relative to the frame 108′ including respective open members. This movement will cause in respect of each rear wheeled support unit 1828, 1830, 1832, 1834, the distance of the respective cables 859 between their respective wheel hubs 857 to shorten, with the result is that the distance between pulleys 874 on mount blocks 878 and respective trunnions 879 for each of front wheeled support units will extend. This will create a corresponding shortening of the distance between front caster wheels 197″ and mounting blocks 878 for each front wheeled support units 1828, 1830, 1832, 1834 and their respective open members. The result is that the open members will move towards their respective front caster wheels 197″ and rear wheels 197′ a substantially equal amount resulting in a level movement downwards and an equal movement of front row of ground engagers and rear row of ground engagers (discs 140, 140′) across/throughout the entirety of frame 108′.

To raise frame 108′ and discs 140 attached thereto in a level manner, an operator can cause piston rod 856 of hydraulic cylinder 855, 1060, 1062 and 1064 of each of rear wheeled support units 1820, 1822, 1824, 1826 to be extended. This will cause corresponding rear pair of wheels 197′ to move down relative to frame 108′. This movement will cause the distance of cable 859 between respective axles/hubs of each rear wheeled support units to lengthen, with the result is that the distance between pulleys 874 and trunnions 879 of each front wheeled support units will be reduced. This will create a corresponding same lengthening of the distance between front caster wheel 197″ and mounting blocks 878 for each front wheeled support units 1828, 1830, 1832, 1834 and the respective open members of frame 108′. The result is that such as open members of frame 108′ will move towards respective rear wheels 197′ and front caster wheels 197″ a substantially equal amount resulting in a level movement upwards and an equal movement of the front row of discs 140″ and rear row of discs 140′ across/throughout the entirety of frame 108′.

To lower frame 108′ and discs 140′, 140″ attached thereto in a level manner, piston rod 856 of hydraulic cylinders 855, 1060, 1062, 1064 of each of rear wheel supports 1820, 1822, 1824, 1826 may be retracted. This will cause corresponding rear pair of wheels 197′ to move upwards relative to frame 108′. This movement will cause the distance of cable 859 between respective axles/hubs 857 of each rear wheeled support units 1820, 1822, 1824, 1826 to shorten, with the result is that the distance between pulleys 874 and trunnions 879 of each front wheeled support units will be increased. This will create a corresponding same shortening of the distance between front caster wheel 197″ and mounting block 878 for each front wheeled support units 1828, 1830, 1832, 1834 and the respective open members of frame 108′. The result is that such as open members of frame 108′ will move away respective rear wheels 197′ and front caster wheels 197″ a substantially equal amount resulting in a level movement downwards and an equal movement of the front row of discs 140″ and rear row of discs 140′ across/throughout the entirety of frame 108′.

Referring again to FIG. 27 and to FIG. 27B, the forward row 120 of ground engagers/discs 140″ may be disposed at an angle to longitudinal direction X such that when the first row of ground engagers/discs 140″ engage with the ground material beneath the ground surface as implement 100′ moves forward, a force F1 acting in a direction transversely (direction Y) right to the direction of travel 14 of tillage apparatus 100′ is exerted on the ground engagers which is transmitted to frame 108′. Conversely, the rear row 122 of ground engagers 140′ may be disposed at an angle such that when the ground engagers 140′ engage the ground material beneath ground surface 16, a force F2 acting in a direction transversely (direction Y) left to the direction of travel 14 of tillage apparatus 100′ is exerted on the ground engagers which is transmitted to frame 108′. Thus, the front row 120 of ground engagers/discs 140″ and rear row 122 of ground engagers 140′ may provide at least part of the side tilt counteracting mechanism of agricultural implement 100′.

In some embodiments, if the forward and rearward set of ground engagers 140′ and 140″ engage with the surface 16 at generally the same depth, transverse forces F1, F2 exerted by the ground material on the forward and rear sets of ground engagers 140′ and 140″ may completely substantially offset each other, and the transverse forces F1 and F2 may in some circumstances be substantially the same magnitude and opposite in direction, such that the net transverse force is substantially zero and the tillage apparatus 100′ keeps the generally square orientation relative to the propulsion unit 102 shown in FIG. 27 and travels substantially in the direction 14 with propulsion unit 102 across the ground surface 16.

However, if the forward and rearward set of ground engagers 140′ and 140″ engage with the surface 16 at different depth levels, transverse forces F1, F2 exerted by the ground material on the forward row of ground engagers 140″ and the rear row of ground engagers 140′ may not offset each other, and the transverse forces F1, F2 may in be greater in one direction than the opposite transverse direction. If the agricultural implement 100′ is on a side angled sloped terrain surface (i.e. in direction Y), then an unbalanced transverse forces F1, F2 exerted on the front row of ground engagers 140″ relative to the rear row of ground engagers 140′ can be generated and selected to counteract in whole or at least in part, the transverse force associated with gravity acting on the agricultural implement 100′. Thus, agricultural implement 100′ may be adapted as partly described further below, to adjust the relative heights of the front row of ground engagers 140″ relative to the rear row of ground engagers 140′ and thereby modify the relative transverse forces F1, F2 that are acting upon the implement 100′ in opposite directions.

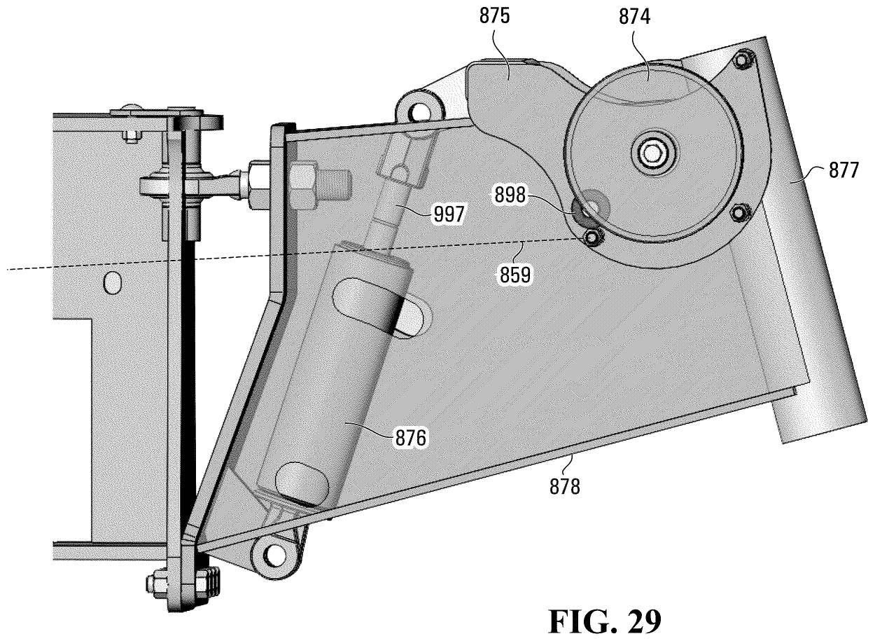

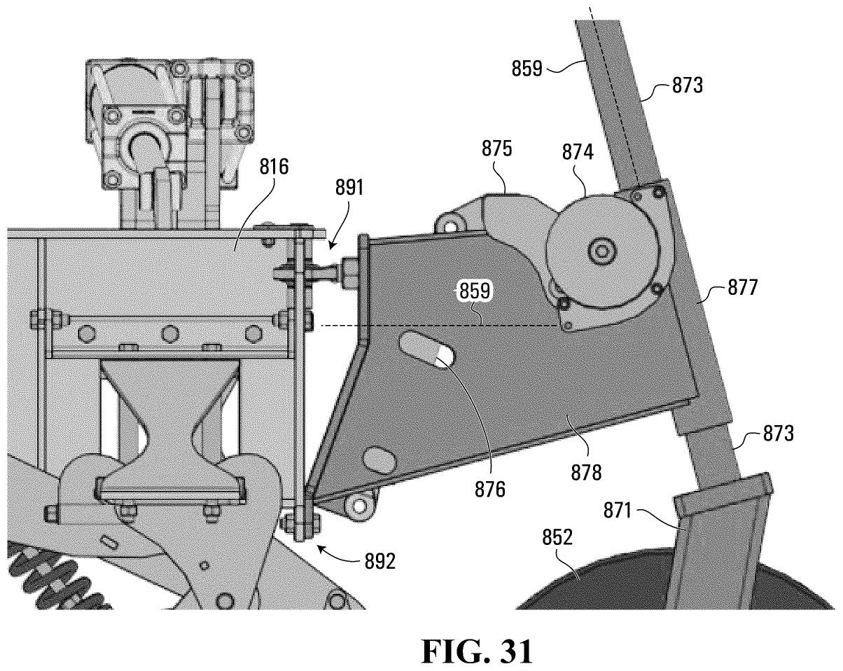

With particular reference now to FIGS. 27A, 28, 29, 30 and 31, as noted above, each of the opposed pairs of forward pulley devices 874 of front wheeled support units 1828, 1830, 1832, 1834 may be mounted to respective mounting blocks 878 (FIG. 29) and may be connected to a lever device 875. The operation of hydraulic cylinder 876 may be controlled by an actuator and/or controller which may control valves in a hydraulic fluid circuit to control the flow of pressurized hydraulic fluid to and from hydraulic cylinder 876. By extending or retracting piston rod of hydraulic cylinder 876, the position of pulley devices 874 on each mounting block of each front wheel assembly 820, 822, 824 and 826 can be altered. By altering the position of pulley device 874 by moving lever device 875, the path length of each respective cable 859 between pulley devices 874 and trunnion 879 may be lengthened or shortened independently of the main height control of the frame 108′ provided by operation of hydraulic cylinders 855. By lengthening the path length of the portion of cable 859 extending between pulley devices 874 and trunnions 879, resultant axial movement of post 873 will cause the distance between caster wheels 197″ and the respective open members such as open member 816, will be shortened, thus lowering the forward portion open members and the front side of frame 18, relative to the surface 16. This will cause front row of ground engagers 140″ to penetrate the ground material to a greater depth, thus increasing the transverse force F1 (FIG. 27B) in a right transverse direction and cause rear row of ground engagers 140′ to penetrate the ground material to a lesser depth, thus decreasing the transverse force F2 (FIG. 27B) in a left transverse direction (as the downward movement of the front portion of the frame will cause pivoting upwards of the rear portion of the frame about the rearward tires contact position with the terrain).

Similarly, by shortening the path length between pulley devices 874 and trunnion 879, axial movement of post 873 will cause the distance between front caster wheels 197″ and the respective open members such as open member 816, will be lengthened, thus raising the open members and the front side of frame 108′, relative to the surface 16. This will cause front row of ground engagers 140 to penetrate the ground material to a lesser depth, thus decreasing the transverse force F1 in a right transverse direction and cause rear row of ground engagers 140′ to penetrate the ground material to a greater depth, thus increasing the transverse force F2 (FIG. 27B) in a left transverse direction (as the upward movement of the front portion of the frame will cause pivoting downward of the rear portion of the frame about the rearward tires contact position with the terrain).

It should be noted that an alternate arrangement of the position of the rear row 22 of discs 140′ relative to the rear wheels of the rear wheeled support units is illustrated in FIG. 27D. In this embodiment, downward movement of the forward portion of the open members and the front side of frame 108′ will cause front row of ground engagers 140″ to penetrate the ground material to a greater depth, thus increasing the transverse force F1 in the upward right direction and cause rear row of ground engagers 140′ to penetrate the ground material to a greater depth (but with less change in depth penetration than the front row of engagers 140″)—as the downward movement of the front portion of the frame will also cause pivoting upwards of the rear portion of the frame about the rearward tires contact position with the terrain).

Similarly, in this alternate arrangement of FIG. 27D, upward movement of the forward portion of the open members and the front side of frame 108′ will cause front row of ground engagers 140″ to penetrate the ground material to a lesser depth, thus decreasing the transverse force F1 in the upward right direction and cause rear row of ground engagers 140′ to also penetrate the ground material to a lesser depth (but with less reduction in depth penetration than the front row of engagers 140″)—as the upward movement of the front portion of the frame will also cause pivoting downwards of the rear portion of the frame about the rearward tires contact position with the terrain).

Thus, in the embodiments of both FIGS. 27A and 27D, changing of the fore/aft pitch of the frames will adjust the net transverse force imparted onto the agricultural implements resulting from the engagement of the ground engagers with the ground material/soil.

The upward and downward movement of the front of the frame 108′ relative to the rear of the frame 108′, may be controlled by actuation of hydraulic cylinders 876, 1806, 1808, 1810 associated with the respective front wheeled support units 1828, 1830, 1832, 1834 such as hydraulic cylinder 876. This may in embodiments, be controlled manually by an operator or by a control system with a suitable sensing system that interfaces with a system controller.

With reference now to FIG. 33, an embodiment of a control system for adjusting both the overall height of frame 108′ and the fore/aft pitch angle of frame 108′ of tillage apparatus 100′, and for counteracting the sliding/drifting of apparatus 100′ due to a side slope in the ground terrain, is designated generally 2000. Control system 2000 may include a frame pitch angle control system 2002 for controlling a height of the front regions of the frame 108′ (and in particular the locations where frame 108′ is connected to the front wheel units 1828, 1830, 1832, 1834) and thus the fore/aft pitch angle of frame 108′. Control system 2000 may also include overall frame height control system 2004 for controlling an overall height of the frame 108′ relative to the ground surface.

Frame pitch angle control system 2002 (along with front row 120 of ground engagers 140″ and rear row 122 of ground engagers 140′) may be considered at least part of a side tilt counteracting apparatus. Frame pitch angle control system 2002 may include the hydraulic cylinder 876 of the front wheeled support unit 1834 (shown in FIG. 27A). The frame pitch angle control system 2002 may also include respective hydraulic cylinders 876, 1806, 1808, and 1810 associated with each of the front wheeled support units front wheeled support units 1828, 1830, 1832, 1834—all of which may be configured the same including having the same size. Each of hydraulic cylinders 876, 1806, 1808, and 1810 may have the same size chamber volumes, piston rods, same size pistons and piston rods, and have the same stroke distance. In other embodiments, it may be desirable that these cylinders may have some varying dimensions such as for example some having smaller diameter cylinders with longer stroke lengths and others with relatively larger diameter cylinders with shorter stroke lengths. With cylinders being connected in series the system 2002 can be configured such that the volume of hydraulic fluid being displaced on each stroke is the same in each of the cylinders connected in series.

The hydraulic cylinders 876, 1806, 1808, and 1810 may be disposed on respective mounting blocks (such as the mounting block 878 shown in FIG. 29) for raising or lowering the respective front wheeled support units 1834, 1832, 1830, and 1828 to cause the open members 816, 812, 806, and 800 of the frame 108′ to be raised or lowered at/proximate their forward ends, to counteract the effect of the frame 108′ being oriented on a sideways/transverse tilted sloped of ground surface. Each hydraulic cylinder 876, 1806, 1808, and 1810 has an actuator rod connected to a moveable piston (for the hydraulic cylinder 1810, the rod is shown at 2012 and the piston at 2014). The moveable piston 2014 divides the cylinder 1810 into a cap end chamber having a cap end hydraulic fluid port 2016 and rod end chamber having a rod end hydraulic fluid port 2018. The hydraulic cylinders 876, 1806, 1808, 1810 are similarly configured in the embodiment shown and are hydraulically connected in series via a hydraulic fluid line 2020, which is in fluid communication with the cap end port 2016. Hydraulic cylinders 876, 1806, 1808, 1810 may be configured the same including having the same sized pistons and piston rods, same sized hydraulic fluid chambers and same piston stroke lengths. The fluid line 2020 also couples between the rod end port 2018 and a cap end port of the cylinder 1808 and between respective rod end and cap end ports of the successive downstream cylinders 1806 and 876. A rod end port 2017 of the cylinder 876 is coupled to a hydraulic fluid line 2022.

The hydraulic fluid lines 2020 and 2022 are selectively connected to a pressurized hydraulic fluid supply line 2024 and a return line 2026 through a proportionally controlled directional valve 2028 (shown schematically in FIG. 33). The lines 2024 and 2026 may be coupled via respective quick connect fittings 1034 and 1036 to a pressurized hydraulic fluid supply (not shown) on the host propulsion unit 102. The directional valve 2028 includes an internal control spool that may be actuated for straight-through flow via solenoids 2030 and 2032 to selectively permit fluid flow from the supply line 2024 and through the line 2020 to the cap end port 2016 of the cylinder 1810 and to permit fluid to flow back from the rod end port of the cylinder 876 via the line 2020 to the return line 2026. Alternatively, the directional control valve 2028 may be actuated for cross-flow to selectively permit fluid flow from the supply line 2024 and through the line 2022 to the rod end hydraulic fluid port 2017 of the cylinder 876 and to permit fluid to flow back from the cap end port 2016 of the cylinder 1810 and via the line 2020 to the fluid return line 2026. The solenoids 2030 and 2032 are responsive to electrical control signals provided at inputs 1038 and 1040 to cause the internal control spool to move between the straight-through flow and cross-flow configurations. For example, the control signal may be a DC current that varies over a range between amperages of −I₀, 0, and +I₀, where the positive I₀ current causes the valve 2028 to be completely open in the straight-through flow configuration and a negative I₀ current causes the valve 2028 to be completely open in the cross-flow configuration. A current of 0 A causes the valve to be substantially closed. A DC current of less than positive or negative I₀ supplied to the solenoids 2030, 2032 causes the valve to be proportionally opened for flow in the respective directions.

Still with reference to FIG. 33, frame fore/aft pitch angle control system 2002 may also include at least one wheel rotation sensor 1042 associated with a freely rotatable caster wheel of at least one front wheeled support unit, such as a wheel rotation sensor 1042 being associated with the angular position of the wheel(s) of front wheeled support unit 1834. In some embodiments, a second wheel rotation sensor (or other additional wheel rotation sensors) 1042 may be provided associated with one or more of the other front freely rotatable caster wheel(s) of the front wheeled support units (such as front wheeled support unit 1828). Each wheel rotation sensor 1042 has a respective output 1050 for generating rotation signals representing the rotation of the post 873 about the generally vertical, longitudinal steering axis of tubular support 877 and thus the rotation of a respective front caster wheel 197″ of a front wheeled support unit (such as front wheeled support units 1834, 1828) about such steering axis. Referring back to FIG. 28, in one embodiment rotational sensors 1042 may be disposed within the respective end cap device 879 and may be configured to generate rotation signals at the output 1050 representing an angle of rotation of the leg member 873 with respect to the end cap, where end cap 879 is rotationally stationary relative to tubular support 877 in a rotational plane due to cable constraint. As described above, in operation, engagement of the end cap device 879 by the cable 859 effectively prevents rotation of the end cap when the leg member 873 rotates within the cylindrical tubular support 877. The one or more rotation sensors 1042 produce rotation signals representing the respective rotational position/angle of freely rotating front caster wheels 197″ of the respective front wheeled support unit 1834, 1828.

With reference to FIGS. 27B and 27C, it may be appreciated that freely rotatable (i.e. about the steering axis) caster wheels 197″ of front wheeled units 1834, 1828 (as well as of the other freely rotatable [about their steering axes] caster wheels) will generally remain aligned with the direction of travel 14/the direction of pull of propulsion unit 102 (not shown). Therefore, if frame 108′ pivots about the hitch connection point relative to the propulsion unit and the direction of pull/travel 14, the orientation of the front caster wheels 197″ relative to longitudinal orientation of the frame 108′ will change. In some embodiments, rotation sensors 1042 may be configured to produce rotation signals representing a zero angular rotation α when the respective wheels 197″ of front wheeled support units 1834, 1828 are oriented straight ahead in the direction of travel 14 as shown in FIG. 27B and such direction being aligned with the longitudinal axis of frame 108′, when frame 108′ is pulled in the same direction of travel 14 by propulsion unit 102 and which is parallel to longitudinal axis X-X of frame 108′ (FIG. 27B). However, as depicted in FIG. 27C, with agricultural implement 100′ moving in a direction of travel 14, on terrain which is side sloped transversely downwards in a direction S to the left, which may be orthogonal to the direction of travel 14, then agricultural implement 100′ may have pivoted clockwise around receiver of the hitch connection, such that the longitudinal axis X-X of frame 108′ is no longer aligned with the direction of pull/travel 14 (the frame 108′ has pivoted out of longitudinal alignment with the direction of travel 14), then a non-zero angular deviation α1 and/or α2 of the front caster wheels 197″ of wheeled support units 1834, 1828 may be recorded by the rotation sensors 1042 and corresponding signals provided to controller 1080. An angular deviation α1/α2 of the wheeled support units 1834, 1828 to one side may result in a positive angle signal (FIG. 27C).

If agricultural implement 100′ is moving in a direction of travel 14 (as shown in FIG. 27C) but on terrain which is side sloped downwards in an opposite direction (compared to direction S in FIG. 27C) to the right, then agricultural implement 100′ may have pivoted counter-clockwise around receiver 51 of the hitch connection, such that the longitudinal axis X-X of frame 108′ is no longer aligned with the direction of pull/travel 14 (the frame 108′ has pivoted out of longitudinal alignment with the direction of travel 14), and a negative angular deviation α1 and/or α2 of the front caster wheels 197″ of wheeled support units 1834, 1828 may be recorded by the rotation sensors 1042.

Rotation sensors 1042 may include an element (such as a magnet in the case of a Hall effect sensor) that moves relative to a base of the sensor and generates rotational displacement signals and this element may be mounted on or coupled to the leg member 873. Various other rotation sensors may be used such as inductive sensors, resistive sensors, or optical rotary encoders. In some embodiments, rotation sensors 1042 may be provided with appropriate electrical power and other wires/cables to communicate with other components of control system 2000 including controller 1080.

Frame pitch angle control system 2002 may also in some embodiments, include a linear sensor 1096 associated with at least one of the hydraulic cylinders 876, 1806, 1808, 1810 that is in communication with controller 1080. Linear sensor 1096 may measure the amount of extension of an actuator/piston rod 2012 of such hydraulic cylinder(s) 876, 1806, 1808, 1810 and thus can have an output 1098 for producing a signal representative of linear position of the piston rod which is a function of the fore/aft pitch angle of the frame 108′ relative to the ground surface. Thus, when the amount of extension of actuator rod 2012 changes, the fore/aft pitch angle of the entire frame 108′ will change and there will be a change in the value produced by linear sensor 1096 which is a function of a change in the fore/aft pitch angle of frame 108′. Linear sensor 1096 may also be provided with appropriate electrical power and other wires/cables to communicate with other components of control system 2000 including controller 1080.

The frame pitch angle control system 2002 may also include a frame orientation sensor 448′ that may be the same as any of frame orientation sensors 448 described above. In some embodiments, frame orientation sensor 448′ may take the form of a semi-conductor chip that is operationally located on the control circuit board of controller 1080. In such embodiments, controller 1080, with embedded frame sensor 448′, may be mounted onto a flat upper surface of an upper flange of open member of frame 108′ (FIGS. 27B, 27C) In some embodiments, frame orientation sensor 448′ may be provided with appropriate electrical power and other wires/cables to communicate with other components of control system 2000 including controller 1080. Controller 1080 may also be in communication with the host controller on propulsion unit 102.

Like frame orientation sensor 448, frame orientation sensor 448′ is indicative of, and detects, the orientation of the frame 108, which correlates with the orientation of the ground surface upon which the frame 108 and its ground engagers are supported. Frame orientation sensor 448′ may also be considered a ground surface orientation sensor. As the wheels of front and rear wheeled units of implement 100′ pass over a ground surface that changes in orientation, this results in a change in the orientation of the frame members of frame 108′ and thus a change the orientation of the sensor 448 attached to one of these frame members. Thus, frame orientation sensor 448′ may be in effect a sensor that detects the orientation of the ground surface beneath the frame 108 (and changes therein), including in particular the side tilt/slope angle of the ground surface beneath the frame as it is supported on the wheels of the front and rear wheeled support units.

In some embodiments, other types of sensors may be utilized to detect the orientation, including the side tilt of the ground surface, upon which the frame is being supported.

Frame orientation sensor 448′ may have an output for producing a frame orientation signal representative of the orientation of frame 108′ in the X-Y-Z frame of reference of FIG. 27. This correlates with the orientation of ground surface or at least part of the ground surface) beneath the frame, including the side tilt angle.

It should be noted that sensor 448′ is not typically detecting whether implement 100′ has moved out of longitudinal/transverse alignment with propulsion unit 102. Thus, sensor 448′ may at least in some situations sense a change in the side tilt angle (and optionally the fore/aft tilt) of frame 108′ before agricultural implement 100′ actually side drifts/slides sideways and moves out of the longitudinal/transverse alignment with propulsion unit 102.

In an embodiment, frame orientation sensor 448′ may include an accelerometer and/or gyroscopic sensor, configured to detect parameters such as the side tilt/roll angle, downhill angle (pitch) and yaw of frame 108′. Sensor 448′ may be manually or automatically calibrated to read a side tilt/roll angle of zero degrees when frame 108′ is on flat and level ground. In some embodiments, frame orientation sensor 448′ may be utilized instead of, or in addition to, linear sensor 1096, to provide a signal indicative of the fore/aft pitch of frame 108′.

As noted above, frame orientation sensor 448′ (which may be embedded in controller 1080) may be positioned in any suitable location on frame 108′ such as a flat upper surface of an upper flange of an open member of frame 108′ (FIG. 27B). Sensor 448′ may measure acceleration in relation to its own frame for reference that may be defined in part its upward/downward and its side to side/transverse axis and may be configured and operable to detect the changes in the direction of weight. If the magnitude of acceleration/weight is known along each of its upward/downward axis and its transverse axis, then the roll/side tilt angle of the sensor 448′, and the roll/side tilt angle of frame 108′ to which it is attached can be derived.

In embodiments, sensor 448′ may only measure or provide signals indicative of force/acceleration in its upwards (Z) and transverse (Y) directions relative to itself (like sensor 448 as described above). The acceleration measured by sensor 448′ may be measured as a function of gravity, from which the roll/side tilt angle of frame 108′ can be calculated by measuring the magnitude and direction of the proper acceleration as a vector quantity and thus can be used to sense the orientation of the accelerometer (and the component of the frame it is attached thereto) because of the direction of weight changes experienced by the accelerometer.

Thus, an accelerometer 448′ may be operable to report values of the acceleration/force along its upwards/downwards axis and its transverse axis. As will be apparent, and like in a manner described above, the orientation of its transverse axis relative to the direction of gravity may be derived from the value readings provided by the accelerometer.

In some embodiments, an accelerometer 448′ may also be operable to report values of the acceleration/force along its upwards/downwards axis and its longitudinal axis. As will be apparent, the orientation of its longitudinal axis relative to the direction of gravity may be derived from the value readings provided by the accelerometer. Thus, an accelerometer 448′ may also be used to measure the fore/aft tilt pitch angle of frame 108′ relative to the direction of gravity.

The overall frame height control system 2004 may also include the hydraulic cylinder 855 associated with the rear wheeled support 826, which includes the extendible piston rod 856. The frame height control system 2004 also includes respective hydraulic cylinders 1060, 1062, and 1064 and their own extendible piston rods, associated with each of the other rear wheeled support units 824, 822, and 820. The cylinders 855, 1060, 1062, and 1064 may be connected in series via hydraulic fluid lines 1070 and 1072. As described above, by extending or retracting the piston rods 856 of the cylinders 855, 1060, 1062, and 1064, the front row 120 of ground engagers and rear row 122 of ground engagers across the entirety of frame 18 are both raised or lowered by substantially equal amounts resulting in a level upwards or downwards movement. In embodiments such as shown in FIG. 33, as noted above, the frame height control system 2004 may also include linear sensor 1066 having an output 1068 for producing a frame height signal representative of an overall vertical height of the entire frame 108′.

In embodiments, the frame overall frame height control system 2004 is hydraulically actuated by hydraulic fluid pressure provided via hydraulic the fluid line 1070 and return line 1072, which the flow of pressurized hydraulic fluid may be generated and controlled at the host propulsion unit 102. The lines 1070 and 1072 may be coupled via respective quick connect fittings 1074 and 1076 to a pressurized hydraulic fluid supply on the host propulsion unit 102. A directional control valve 2028 like the proportionally controlled directional valve 2028 of the frame pitch angle control system 2002 may be provided for controlling overall frame height. Valve 2028 may be controlled by controller 1080 which may, upon receiving instructions such as from an operator on propulsion unit 102, produce an appropriate valve control signal through output 1091 for driving solenoids 1093, 1095 to cause directional valve 2028 to be completely open in the straight-through flow or cross-flow configuration to vary the overall vertical height of frame 108′ as may be required in the particular situation.

The group of hydraulic cylinders 876, 1806, 1808, and 1810 of the frame pitch angle control system 2002, and the group of hydraulic cylinders 855, 1060, 1062, and 1064 of the frame height control system 2004 are thus respectively driven in unison by fluid pressure flowing via the respective lines 1020, 1022, and 1070 and 1072. In operation, leakage around the pistons of the cylinders may cause a phasing difference between motion of the respective piston rods over time. In embodiments, the cylinders 876, 1806, 1808, 1810, and cylinders 855, 1060, 1062, and 1064 may be implemented using phased cylinders. Phased cylinders are configured to permit hydraulic fluid to bypass the piston and flow through the cylinder when the piston is in a re-phasing position. Re-phasing may be required from time to time to prevent one of the cylinders in series (typically the downstream cylinder) from reaching a fully extended or fully retracted position before the upstream cylinders and thus blocking further extension or retraction of these upstream cylinders.

Control system 2000 may also include tillage apparatus controller 1080, which in the embodiment shown receives sensor signals and produces control signals for controlling the frame fore/aft pitch angle control system 2002 to at least partially and may substantially counteract/compensate for the sideways acting gravitational forces associated with the side angled slope of the terrain.

In embodiments, the controller 1080 has an input 1084 for receiving the frame height signal from the output 1068 of the frame height linear sensor 1066. The controller 1080 may process the signal and transmit data at the communications port 1082 to the host propulsion unit controller to facilitate display of frame height information to an operator of the host. In embodiments where the frame height signal at the output 1068 is an analog signal, the controller 1080 may include analog to digital converters for converting the signal into a digital representation for transmission to the host controller on the CAN bus.

Controller 1080 also includes inputs 1086 for receiving the signals from the respective outputs 1087 of the frame orientation sensor 448′ and may in embodiments also receive inputs 1088 for receiving the respective outputs 1098 from linear sensor 1096.

Controller also includes inputs 1089 for receiving the outputs 1050 from the one or more wheel rotation sensors 1042 which represent the rotation of the post 873 about the generally vertical, longitudinal caster steering axis of tubular support 877 and thus the rotation of the respective front caster wheel(s) 197″ about such respective steering axis.

The controller 1080 further includes an output 1090 for producing a valve control signal for driving the solenoids 2030 and 2032 to control the directional valve 2028.

The controller 1080 further includes an output 1091 for producing a valve control signal for driving the solenoids 2030, 2032 to control the directional valve 2028.

Like that described above, controller 1080 may be implemented using a low-cost microprocessor-based controller such as the Eaton HFX Family of programmable controllers or the JCA electronics Oriole controller. These controllers may implement a Controller Area Network bus (CAN bus) that also may act as a communications port 1082 for receiving commands from the host controller and also provide inputs and outputs that may be configured to act as the outputs 1090, 1091 and inputs 1084, 1086, 1088, 1089. In embodiments, the communications port 1082 of the controller 1080 facilitates connection to a control bus of the host propulsion unit 102 for receiving and sending control signals between the host and the agricultural implement 100′. The host propulsion unit 102 may include a host controller (not shown) that operates via a data bus (such as a CAN bus) for controlling the propulsion unit 102 and connected farm implements such as the agricultural implement 100′. Command signals may be received from the host controller at the communications port 1082 for controlling operations of the frame fore/aft pitch angle control system 2002 and overall frame height control system 2004.

In an embodiment, control system 2000 includes frame orientation sensor 448′ having an output 1087 for producing a frame orientation signal representative of the orientation of frame 108′ in the X-Y-Z frame of reference of FIG. 1. The frame orientation signal may also be a ground surface orientation signal indicative of the orientation of the orientation (including the side tilt angle) of the ground surface upon which the frame is being supported at the relevant time.

In operation, once a roll/side tilt angle of frame 108′ has been detected by frame orientation sensor 448′ and established by controller 1080, a desired fore/aft tilt angle of frame 108′ can be determined/established such that an appropriate net force in a transverse direction Y associated with the relative difference in transverse forces of the front row of ground engagers 140′ compared to the rear row of ground engagers 140′ is created.

The desired fore/aft tilt angle of frame 108′ may be a function of the side tilt angle of frame 108′ when located on a side tilted slope. For example, in embodiments, the greater the side tilt angle that is determined, then the greater the fore/aft tilt of the frame 108′ that may be set in one direction than the other, and thus the greater the corresponding desired net transverse force that is desired and sought to be established, to counteract the side tilt angle of the terrain and the gravitational related forces acting on the frame 108′ and the components supported thereon.

An algorithm of controller 1080 may be based on a side tilt angle of frame 108′ that is detected and then: (i) determine if an adjustment is to be made to the fore/aft pitch angle of frame 108′; (ii) if so, determine a required fore/aft direction (i.e. tilt the frame 108′ pitch forward or backward) and (iii) possibly also determine and/or establish the magnitude of the desired fore/aft tilt angle for the frame; that will in combination create a desired difference in transverse forces F1, F2 (FIG. 27B) acting on the ground engagers 140′, 140″ to prevent sideways movement, and/or fully or at least partially counteract/compensate for, the sideways gravitational related forces acting of agricultural implement 100′. This may be accomplished based on the frame orientation signals received from sensor 448′ and the side tilt/roll angle derived therefrom.

In some embodiments, the direction to alter the fore/aft pitch angle, and also a desired target angle of the fore/aft pitch angle of frame 108′, may be determined, using a look up table, utilizing calculated values that are stored in a database that can be accessed by the controller 1080.

### Ground Engagement for Steering Effect

Referring to FIGS. 27B and 27C, an example process for counteracting the forces acting on agricultural implement 100′ when encountering a downward angled side slope in the direction S (FIG. 27C) of the ground terrain during tilling operations is as follows. First with reference to FIG. 27B, and with agricultural implement 100′ on transversely and longitudinally level terrain surface, and with the propulsion unit 102 (not shown) pulling implement 100′ in a direction of travel 14, the agricultural implement 100′ is transversely and longitudinally aligned behind the propulsion unit. The operator may, by operation of the host controller, operate overall frame height control system 2004 to select an appropriate overall frame height and thus an appropriate general depth of penetration into the ground surface of the rear row 122 of discs 140′ and the front row 120 of discs 140″. The operator may also, when the propulsion unit 102 pulling agricultural implement 100′ forward through a field on longitudinally and transversely level terrain, make an operator-based adjustment to the frame fore/aft angle pitch of frame 108′ to locate a neutral fore/aft pitch angle of frame 108′ (which may not be zero degrees relative to a transversely and longitudinally level ground surface). The adjustment of the fore/aft pitch of the frame 108′ may then alter the relative depth of penetration into the ground surface of the rear row 122 of discs 140′ and the front row 120 of discs 140″. This neutral fore/aft pitch angle of frame 108′ corresponds to the net transverse differential force from forces F1, F2, being approximately zero. Depending for example upon several factors in including the nature of the ground material being tilled and the configuration of discs 140′, 140″, the neutral fore/aft pitch angle of frame 108′ may not be zero (the frame 108′ may not be longitudinally oriented parallel to the longitudinal level of the terrain surface). Once the desired level ground operating settings of overall frame height and frame neutral fore/aft pitch angle are achieved, the operator may then operate frame pitch angle control system 2002. Controller 1080 may be configured and operable (including having or being connected to a memory device) to store the value of the neutral/aft pitch angle of frame 108′ when frame 108′ is positioned on longitudinally and transversely level ground.

With frame pitch angle control system 2002 activated, in some embodiments, when controller 1080 receives signals from frame orientation sensor 448′, it or the host controller may determine the transverse side slope tilt angle of the terrain as referenced above. If that determined transverse side slope angle is not zero (or is greater in magnitude than a threshold side slope angle)—host controller and/or controller 1080 may send signals to frame pitch angle control system 2002 to cause valve 2028 to be activated to cause the fore/aft pitch angle of frame 108′ to be changed either to pitch longitudinally forwards or pitch longitudinally rearwards, in order to increase one of the transverse forces F1, F2 (and typically also decrease the other of the transverse forces F1, F2) in order to create an increase in net transverse differential force in a particular transverse direction to counter/compensate for the side slope gravitational forces associated with slop S, and thus may maintain or re-establish alignment of propulsion unit 102 and agricultural implement 100′, or at least minimize the side drifting of agricultural implement 100′ and/or prevent further side drifting relative to the propulsion unit. For example, controller 1080 may be configured to send a signal to operate valve 2028 by driving solenoids 2030 and 2032 to cause directional valve 2028 to be completely open either in the straight-through flow or in the cross-flow configuration. This will cause valve 2028 to deliver pressurized hydraulic fluid to the hydraulic cylinders 876, 1806, 1808, 1810 in order to either raise the front end/region of frame 108′ or lower the front end/region of frame 108′.

In some embodiments, host controller and/or controller 1080 may be configured such that control of the fore/aft pitch angle of frame 108′ is only dependent upon the signal received from frame orientation sensor 448′; so long as frame orientation sensor 448′ provides a signal indicating that agricultural implement is located on terrain with transverse side slope angle that is not zero (or is at least greater in magnitude than a threshold side slope angle), then a modified fore/aft pitch angle of frame 108′ will be sought and may be maintained by pitch angle control system 2002.

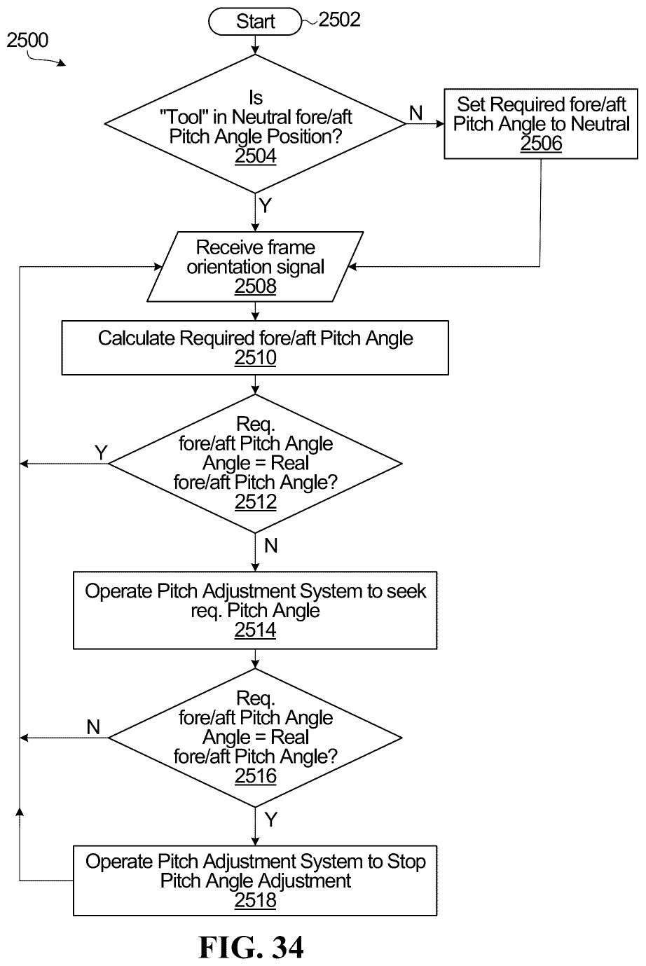

With reference to FIG. 34, example process 2500 that can be executed for detecting the orientation of frame 108′ and preventing side drift of agricultural implement 100′ is shown. The process is initiated by a signal provided by a user or automated process at block 2502. At block 2504, controller may first determine if the override for the system is activated and if agricultural implement 100′ is in the correct fore/aft neutral pitch angle position as referenced herein. A correct configuration for agricultural implement 100 may include frame 108′ being in the neutral fore/aft pitch angle position and being properly connected to the propulsion unit. The override may be a manual override operated by a user in propulsion unit 102. If the condition at block 2504 is not met, then at block 2506 an operator and/or controller 1080 may adjust the pitch angle of the frame 108′ to locate the frame 108′ at the neutral fore/aft pitch angle position.

Once the condition in blocks 2504 or 2506 is met, then the process proceeds to block 2508, where a frame orientation signal (as described above) is received by controller 1080 from sensor 448′. Controller 1080 may then at block 2510 calculate the required fore/aft pitch angle of frame 108′ such as with a look up table.

At block 2512, controller 1080 may be configured to determine the difference if any between the required fore/aft pitch angle and the real fore/aft steering angle. The real fore/aft angle may be determined from a sensor as described herein, such as a sensor 1096. If the condition in block 2512 is met, then no adjustments are necessary, and the process returns to block 2506.

If the condition in block 2512 is not met, at block 2514 the process sends a signal to activate pitch angle control system 2002 by activating solenoids 2030, 2032 in order to control the flow of hydraulic fluid through diverter valve 2028 to adjust the position of pistons of hydraulic cylinders 876, 1806, 1808, 1810, to adjust the fore/aft pitch angle of the frame 108′.

The duration of the signal sent to solenoids 2030, 2032 may vary based on the deviation between the required fore/aft pitch angle and the real fore/aft angle. The duration of the signal sent to solenoids 2030, 2032 may increase as the deviation increases. The duration of the signal may be determined by controller 1080 via an algorithm or a lookup table.

At block 2516 controller 1080 may again determines the difference between the required fore/aft pitch angle and the real fore/aft pitch angle. If the condition at block 2516 is met, the process proceeds to block 2518, where a signal is sent to solenoids 2030, 2032 to operate valve 2028 to maintain the current fore/aft pitch angle. The valve springs ensure that the valve 2028 is positioned in the closed position and no fluid is permitted to flow through valve 2028. The process then returns to block 2508.

If the condition at block 2516 is not met, the process returns directly to block 2508.

Host controller and/or controller 1080 may also be configured such that once the modified fore/aft pitch angle is established, and when thereafter, frame orientation sensor 448′ provides a signal indicating that agricultural implement is again located on terrain with a transverse side slope angle that is zero (or is less in magnitude than a threshold side slope angle), then the host controller/controller 1080 will then cause pitch angle control system 2002 to return the fore/aft pitch angle of frame 108′ towards the neutral fore/aft pitch angle and may establish once again the neutral fore/aft pitch angle.

In some embodiments, although host controller or controller 1080 may have determined that the side slope tilt angle is not zero (or is greater in magnitude than a threshold amount) and is such that an adjustment of the fore/aft pitch of frame 108′ from the neutral fore/aft pitch angle is desired, controller 1080 may also receive rotational signals from the outputs 1050 of the rotation sensors 1042 representing the current angle of rotation α₁ of the leg member 873 of front wheeled support unit 1834 with respect to its end cap, and outputs 1050 representing the current angle of rotation α₂ of a leg member of the front wheeled support unit 1828 with respect to its end cap. If at least one (or in some case if both) of the wheeled support units 1828 and 1834 are aligned in a straight-ahead orientation relative to the X-X axis of frame 108′ (i.e. at an angle of 0° for α₁ and α₂ as shown in FIG. 27B) the sensors 1042 may be configured to each produce signals corresponding to angles α₁ and α₂ having a zero value. In such situations, and in some embodiments, host controller and/or controller 1080 may be configured so that if it/they receive at least one zero value (or it receives both zero values) for angles α₁ and α₂, then it will not send any signal to directional valve 2028 to cause the fore/aft pitch angle of frame 108′ to be adjusted.

It should be noted that if at least one (or in some cases, if both) of the wheeled support units 1828 and 1834 are aligned in a straight-ahead orientation relative to the frame axis X-X, then this likely means that the agricultural implement 100′ is longitudinally and transversely aligned with the propulsion unit (it has not pivoted out of alignment with the propulsion unit).

However, in some embodiments, outputs 1050 of the rotation sensors 1042 representing the current angle of rotation α₁ of the leg member 873 of front wheeled support unit 1834 with respect to its end cap, and outputs 1050 representing the current angle of rotation α₂ of a leg member of the front wheeled support unit 1828 with respect to its end cap, may only be used in order to determine if the frame 108′ is moving in a direction of travel, if the frame 108′ is being turned by a turning propulsion unit 102, or if frame 108′ and the wheels are skidding sideways and may not be used in connection with the host controller/controller 1080 controlling the fore/aft pitch angle of frame 108′.

In some embodiments, host controller and/or controller 1080 may be configured to respond to both: (i) signals from frame orientation sensor 448′ that indicate that the transverse side slope tilt angle of the terrain is not zero (or is greater in magnitude than a threshold side slope angle) and (ii) both (or at least one) signals received from sensors 1042 for angles α₁ and α₂ are non-zero numbers. If so, then controller 1080 may be configured to send a signal to operate valve 2028 by driving solenoids 2030 and 2032 to cause directional valve 2028 to be completely open either in the straight-through flow or in the cross-flow configuration. This will cause valve 2028 to deliver pressurized hydraulic fluid to the hydraulic cylinders 876, 1806, 1808, 1810 in order to either raise the front end of frame 108′ or lower the front end of frame 108′—in order to alter the balance of forces F1, F2, in order to counter the sideways tilting of frame 108′. Host controller and/or controller 1080 may then seek a desired change in direction of the fore/aft pitch angle and may also seek a target/desired fore/aft frame pitch angle.

As the front of frame 108′ is being raised (or lowered), front wheel rotation sensors 1042 may continue to provide signals, and when the wheeled support units 1828 and 1834 are again aligned in a straight-ahead aligned condition (i.e. at angles of 0° as shown in FIG. 27B) the sensors 1042 on both front wheels may produce angles α₁ and α₂ having a zero value. In response to these zero values, controller 1080 may be configured to send a signal to valve 2028 to shut off the supply of pressurized fluid flow to hydraulic cylinders 876, 1806, 1808, 1810 and then close the valve to hold the frame 108′ in a particular fore/aft tilt angle. Valve springs will ensure that valve 2028 returns to its closed positions and the frame 108′ will be held in that established fore/aft tilt angle. At this time host controller and/or controller 1080 may in some embodiments, be configured to then seek to return fore/aft pitch angle of the frame 108′ towards the stored level terrain neutral pitch angle of frame 100′ to the neutral pitch by operation of pitch angle control system 2002 and thus again alter the balance of forces F1, F2, towards the level terrain neutral fore/aft pitch angle of frame 108′ as referenced above. Also as noted above, this neutral fore/aft pitch angle of frame 108′ corresponds to the net transverse differential force from forces F1, F2, being approximately zero. If the neutral pitch angle is reached, and optionally also if wheel rotation sensors 1042 determine that the direction of the wheels is now aligned with the longitudinal axis X-X of frame 108′, controller 1080 may then send a signal to valve 2028 to shut off the supply of pressurized fluid flow to hydraulic cylinders 876, 1806, 1808, 1810 and then close the valve to hold the frame 108′ in a particular fore/aft tilt angle. Valve springs will ensure that valve 2028 returns to its closed positions and the frame 108′ will be held in the neutral fore/aft tilt angle.

Host controller/controller 1080 may be configured to continue to then continue to monitor the side tilt angle of frame 108′ via orientation sensor 448′ and optionally, also the orientation of wheels via wheel rotation sensors 1042. If the conditions are met such that frame 108′ is on a side tilt angle (or if a side tilt angle determined to exceed a threshold value) as detected by signals provided from frame orientation sensor 448′, and also optionally, if wheel rotation sensors 1042 determine that the direction of the wheels is not aligned with the longitudinal axis X-X of frame 108′, then the host controller and/or controller 1080 will again send appropriate signals to re-activate directional valve 2028, in the manner described above to alter the fore/aft pitch of frame 108′ to provide appropriate net counteracting forces F1, F2, and this may continue until such time as the agricultural implement is re-aligned with the propulsion unit as reflected in the signals received from wheel rotation sensors 1042.

In general, host controller and/or controller 1080 may be configured to operate frame fore/aft pitch control system 2002 in such a manner that the fore/aft pitch angle of frame 108′ is adjusted in order to counteract the side tilt angle as reflected by frame orientation sensor 448′ and optionally to additionally seek an orientation of wheels as reflected by the signals from wheel rotation sensors 1042 on both front wheels where angles α₁ and α₂ have a zero value.

It should also be noted that if as a result of the operation of frame pitch angle control system 2002 in countering a side slope such as slope S in FIG. 27C, frame 108′ is caused to pivot counter-clockwise/upwards and overshoot past the frame aligned position/orientation (FIG. 27B), the operator on propulsion unit 102 can intervene to manually take control of the frame fore/aft pitch angle in order to re-establish the aligned orientation of frame 108′.

It should be noted that when during active use of frame pitch angle control system 2002, it is generally not a concern that when host controller/controller 1080 is controlling the fore/aft pitch angle of frame 108′, that the frame 108′ might when moving from the position shown in FIG. 27C towards the position shown in FIG. 27B, that the frame 108′ might overshoot/pass by, the longitudinally and transversely aligned position of FIG. 27B. However, if it did happen, an operator in the cab of propulsion unit 102 could manually intervene in order to adjust the fore/aft pitch of frame 108′ by manually controlling the operation of frame pitch angle control system 2002 by manually controlling valve 2028 (FIG. 33).

With reference again to FIG. 27D, in some example embodiments:
the length of each of the longitudinal open members 800 to 816 may be about 9.5 ft. in length; the centers of front wheels 197″ and rear wheels 197′ may be longitudinally spaced apart by about 10¾ ft;
the front row and rear row of ground engagers may be roughly spaced apart by about 3.5 ft. and may both be positioned—approximately equally spaced—between the wheels 197′ of the rear wheeled units and the wheels 197″ of the front wheeled units;
the front row 120 of engagers 140″ may be angled forward and to the right (as in FIG. 27B) in the range of +1 to +25 degrees from the X axis [0.0 degrees];
the rear row 122 of engagers 140′ may be angled forward and to the left (as in FIG. 27B) in the range of −1 to −25 degrees from the X axis [0.0 degrees];
the ground engagers 140′, 140″ may be discs with a constant circular outer diameter of about 24 to 36 inches;
if the frame 108′ is level relative to the ground surface, and the discs 140′ and 140″ penetrate into the ground material below the ground surface in the range of about 0.5 to 15 inches, then the range of adjustment of the fore/aft tilt angle from the frame level orientation may be 0.0 to 1.5 degrees forwards and downwards orientation, and may be 0.0 to 1.5 degrees in the backwards and downwards orientation [approx. 3 degrees total in this embodiment].

As noted above, in use of agricultural implement 100′, an operator who wishes to till a field with discs 140′, 140″ may first manually use controls to set an appropriate overall vertical height frame height using frame height control system 2004, to allow discs 140′, 140″ to penetrate the ground surface to an appropriate depth for tilling of the field. Frame pitch angle control system 2002 can be utilized to initially manually set the fore/aft pitch angle of frame 108′ to a neutral fore/aft pitch angle (which may or may not be a zero fore/aft tilt angle) on transversely and longitudinally level terrain, thereby adjusting to some extent the relative depths of penetration of the front row 120 of ground engagers 140″ and the rear row 122 of ground engagers 140′. Frame pitch angle control system 2002 may then be activated to operate. As agricultural implement 100′ is towed forward in a field by propulsion unit 102, the frame may pass over terrain surface that is tilted in a transverse sideways angled direction. With the force of gravity acting sideways on frame 108′ and the components attached thereto, there will be a tendency for the frame 108′ and the components attached thereto, to drift/slide sideways downwards on the slide slope (like as described above in relation to FIGS. 27B and 27C). When frame orientation sensor 448′ detects that the frame 108′ is oriented sideways, frame pitch angle control system 2002, which will be active, will respond as described above and may operate the hydraulic cylinders 876, 1806, 1808, 1810 in order to adjust the fore/aft angle of pitch of frame 108′. This adjustment in the pitch angle of frame 108′ will then cause one of the rows of discs to penetrate further into the ground terrain and the other row to penetrate less into the ground. In this way the relative amount of ground penetration of the front row of ground engagers relative to the rear row of engagers is adjusted.

As the implement 100′ is towed forward, there will be a change in the transverse forces F1 acting on discs 140′ compared to the transverse force F2 acting on discs 140″. The result will be that a net differential transverse force will be created that counteracts, at least to some significant extent, the gravitational force component acting on the frame 108′ in the opposite transverse direction due to the side tilt associated with the side slope of the terrain. The front wheel rotation sensors 1042 will provide feedback signals to host controller/controller 1080 to indicate if and when the adjustment of the fore/aft pitch angle has achieved the re-alignment of the axis X-X of frame 108′ with the direction of travel 14, and thereafter host controller/controller 1080 can then cease making adjustments to the fore/aft pitch angle of frame 108′. The host controller/controller 1080 can then continue to monitor the signals received from frame orientation sensor 448′ and the at least one of the wheel rotation sensors 1042 and can then make ongoing adjustments to the pitch angle of frame 108′ in order to seek the zero steering angle orientation of the front wheels relative to the frame 108′, as referenced above.

In some embodiments, the depth of engagement of the front row of ground engagers compared to the rearward row of ground engagers may be provided by a different mechanism to that described above—not by altering the fore/aft pitch of the frame 108′. For example, a mechanism may be provided that allows the depth of the front row of engagers and/or the depth of the rearward row of ground engagers to be altered independent of the movement/position/angle of the frame on which they are supported. Nevertheless, the relative amount of penetration of the front and rear rows of ground engagers can be adjusted to vary the net transverse forces acting on the ground engagers during use, to a level that is appropriate to counter the force of gravity acting on the agricultural implement due to a sideways angled tilt of the terrain and the implement supported thereon. Thus, in some embodiments only one of the front or rear rows of ground engagers may be adjustable, while still being able to vary the net transverse forces acting on all the ground engagers during use,

In some embodiments, the net difference in transverse forces F1 and F2, created by difference in the contact force mechanism between the front row of ground engagers and the rear row of engagers might possibly be varied by another mechanism than altering the depth of penetration of the at least one of front and rear plurality of ground engagers. For example, in some embodiments it might be possible to vary the angle of contact of the front row of ground engagers relative to the longitudinal axis of the frame, compared to the angle of contact of the rear row of ground engagers relative to the longitudinal axis of the frame,

In some embodiments, a seeder cart such as is described above can also be inter-connected to agricultural implement 100′ and a propulsion 102, in one of the same ways as described above in relation to agricultural implement 100 and a propulsion unit 102.

It should be noted that the steering mechanisms, fore/aft pitch adjustment systems and other force compensation mechanisms disclosed herein, may not operate in such manner as to provide for complete maintenance of alignment of the agricultural implements/seed carts relative to a propulsion unit. However, these mechanisms/systems can be utilized to at least compensate and counteract to a significant extent, for the effects of a side tilted slope acting thereon during use and may improve an operator's performance during agricultural operations, such as when operating in a field where the ground terrain has side tilted sloped regions.

While specific embodiments of the invention have been described and illustrated, such embodiments should be considered illustrative of the invention only and not as limiting the invention as construed in accordance with the accompanying claims.

The above-described embodiments are intended to be illustrative only and in no way limiting. The described embodiments of carrying out the invention are susceptible to many modifications of form, arrangement of parts, details and order of operation. Other variations are possible.

When introducing elements of the present invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

1. A method for counteracting a sideways force acting of an agricultural apparatus moving on a sideways sloped ground surface, the agricultural apparatus comprising a frame and a plurality of support units supporting said frame for movement on said ground surface, wherein the method comprises:
(a) receiving at a control system, orientation signals from a ground surface orientation sensor, said orientation signals indicative of a side tilt angle of said sideways sloped ground surface;
(b) based on the orientation signals received by the control system, causing the control system to determine whether to cause a side tilt counteracting mechanism to operate to counteract the sideways acting force acting on the agricultural apparatus associated with the side tilt angle.

2. A method for counteracting a sideways force acting of an agricultural apparatus moving on a sideways sloped ground surface, the agricultural apparatus comprising a frame and a plurality of support units supporting said frame for movement on said ground surface, wherein the method comprises:
(a) receiving at a control system, orientation signals from a ground surface orientation sensor, said orientation signals indicative of a side tilt angle of said sideways sloped ground surface;
(b) based on the orientation signals received by the control system, causing the control system to cause a side tilt counteracting mechanism to operate to counteract the sideways acting force acting on the agricultural apparatus associated with the side tilt angle.

3. A method as claimed in claim 1, wherein upon receiving the orientation signals, the control system causes the side tilt counteracting mechanism to operate to counteract the sideways force acting on the agricultural apparatus associated with the side tilt angle of the ground surface.

4. A method as claimed in claim 2, wherein the orientation sensor is located on said frame and said orientation sensor sends said orientation signals to the control system indicative of a side tilt angle of the frame which are also indicative of the side tilt angle of the ground surface upon which said frame is supported.

5. A method as claimed in claim 1, wherein the control system causes the side tilt counteracting mechanism to generate a sideways force that counteracts the sideways force acting on the agricultural apparatus associated with the side tilt angle.

6. A method as claimed in claim 1, wherein (a) and (b) are repeated as the agricultural implement is propelled in a direction of travel on the ground surface.

7. A method as claimed in claim 4, wherein:
based on the orientation signals, the control system determines at least one of the side tilt angle of the frame and the side tilt angle of the ground surface upon which the frame is supported; and
in response to the determination by the control system of at least one of the side tilt angle of the frame and the side tilt angle of the ground surface upon which the frame its supported, the control system generates control signals which causes the side tilt counteracting mechanism to generate a sideways force to counteract the sideways force acting on the agricultural apparatus associated with the side tilt angle of the ground surface.

8. A method as claimed in claim 1, wherein:
said plurality of support units comprises at least one wheeled support unit comprising at least one wheel mounted for rotation about a wheel axis, said at least one wheel operable to contact the ground surface;
said wheel of at least one wheeled support unit of the plurality of wheeled support units is a wheel that is rotatable and about a generally vertical steering axis;
wherein the method further comprises:
the control system receiving a wheel steering angle rotation signal from a wheel steering angle rotation sensor, said wheel rotation signal representative of a rotational angle of the wheel about said steering axis;
based on both the frame orientation signal and the wheel steering angle rotation signal received by the control system, the control system determines whether to cause said side tilt counteracting system to operate to counteract the sideways force acting on the agricultural apparatus associated with the side tilt angle.

9. A method as claimed in claim 2, wherein:
said plurality of support units comprises at least one wheeled support unit comprising at least one wheel mounted for rotation about a wheel axis, said at least one wheel operable to contact the ground surface;
said wheel of at least one wheeled support unit of the plurality of wheeled support units being a steerable wheel that is rotatable and about a generally vertical steering axis;
based on the orientation signal, causing the control system to cause said side tilt counteracting mechanism to adjust a steering angle of said steerable wheel about said steering axis, such that said steerable wheel is oriented in an angled direction that is generally in an uphill direction that is generally in an opposite direction to a sideways downhill slope direction of the ground surface.

10. A method as claimed in claim 2, wherein:
said plurality of support units comprises at least one wheeled support unit comprising at least one steerable wheel mounted for rotation about a wheel axis, said at least one steerable wheel operable to contact the ground surface,
said steerable wheel of said at least one wheeled support unit of the plurality of wheeled support units being rotatable and steerable about a generally vertical steering axis;
wherein the method further comprises:
the control system receiving a wheel steering angle signal from a steering angle rotation sensor, said wheel steering angle signal representing an actual wheel steering angle of the steerable wheel of the at least one wheeled support unit;
based on the orientation signal, causing the control system to calculate a target wheel steering angle;
based on the wheel steering angle signal, causing the control system to identify the actual wheel steering angle of the steerable wheel;
the control system causing the side tilt counteracting mechanism to operate to adjust the actual wheel steering angle of the steerable wheel towards the target wheel steering angle.

11. A method as claimed in claim 10, further comprising: causing the control system to maintain the actual wheel steering angle when the control system determines the actual wheel steering angle of the steerable wheel is substantially the same as the target wheel steering angle.

12. A method as claimed in claim 10, wherein: based on the orientation signal, the control system calculates said target wheel steering angle and causes said side tilt counteracting mechanism to rotate said steerable wheel about said steering axis and alter the wheel steering angle of the steerable wheel so that the wheel steering angle moves towards the target wheel steering angle, to steer the steerable wheel to counteract the sideways force acting on the agricultural apparatus associated with the side tilt angle.

13. A method as claimed in claim 12, wherein the control system causes said side tilt counteracting mechanism to adjust the actual wheel steering angle of the steerable wheel until the actual wheel steering angle reaches either a maximum wheel steering angle or the target wheel steering angle, as verified by the control system from the wheel steering angle signal.

14. A method as claimed in claim 13, further comprising: when the actual wheel steering angle of the steerable wheel reaches either the maximum wheel steering angle or the target wheel steering angle, the control system causes the side tilt counteracting mechanism to maintain that actual wheel steering angle of the steerable wheel.

15. A method as claimed in claim 11, further comprising wherein the control system causes the maintenance of the actual wheel steering angle of the steerable wheel substantially at the target steering angle.

16. A method as claimed in claim 2, wherein said plurality of support units supporting said frame for movement on said ground surface comprises: a plurality of front wheeled support units and a plurality of rearward wheeled support units, each of said front wheeled support units and said plurality of rearward wheeled support units comprising at least one wheel operable for rotation about a respective wheel axis.

17. A method as claimed in claim 16, wherein at least one of the plurality of rear wheeled support units comprises said steerable wheel that is rotatable and steerable about said steering axis.

18. The method of claim 8, wherein:
said plurality of support units supporting said frame for movement on said ground surface comprises a plurality of front wheeled support units and a plurality of rearward wheeled support units;
said side tilt counteracting system comprises at least one of said front wheeled support units and said rear wheeled support units comprising a steerable wheel that is pivotable about a steering axis, and said side tilt counteracting system further comprises an actuation system operable to adjust a steering angle of the steerable wheel about said steering axis of said steerable wheel;
and wherein upon the control system determining the target steering angle, the control system causes the actuation system to pivot the steerable wheel to adjust the steering angle of the steerable wheel to produce a steering direction of said steerable wheel that counteracts the side force acting on the tillage apparatus associated with the side tilt angle.

19. A method as claimed in claim 18, wherein said plurality of front wheeled support units and said plurality of rear wheeled support units each comprises at least one wheel mounted for rotation about a respective wheel axis.

20. A method as claimed in claim 18, wherein said plurality of rear wheeled support units comprises first and second transversely spaced rear wheeled support units, and wherein each of said first and second rear wheeled support units comprises a steerable wheel that is pivotable about a respective steering axis, and said side tilt counteracting system comprises a first actuator operable to adjust a steering angle of the steerable wheel of the first rear wheeled support unit and wherein said side tilt counteracting system further comprises a second actuator operable to adjust a steering angle of the steerable wheel of the second rear wheeled support unit;
and wherein in in response to the control system determining the target steering angle, the control system generates and sends one or more control signals to: cause the first actuator to adjust the steering angle of the steerable wheel of the first rear wheeled support unit to produce a steering direction of said steerable wheel of the first rear wheeled support unit; and cause the second actuator to adjust the steering angle of the steerable wheel of the second rear wheeled support unit to produce a steering direction of said steerable wheel of the second rear wheeled support unit, to thereby counteract the side force acting on the agricultural apparatus associated with the side tilt angle.

21. (canceled)

22. A method as claimed in claim 20, wherein the steering direction of said steerable wheel of the first rear wheeled support unit, and the steering direction of said steerable wheel of the second rear wheeled support unit, are approximately the same.

23. A method as claimed in claim 22, wherein the first and second wheeled support units are mechanically inter-connected by a track rod, to assist with the adjustment of the steering direction of said steerable wheel of the first rear wheeled support unit, and of the steering direction of said steerable wheel of the second rear wheeled support unit, to provide both with substantially the same steering direction.

24. A method as claimed in claim 18, wherein said plurality of rear wheeled support units comprises first and second transversely spaced rear wheeled support units, and wherein each of said first and second rear wheeled support units comprises a first and second steerable wheel that are pivotable together about a respective steering axis, and said side tilt counteracting system comprises an actuation system operable to adjust a steering angle of the first and second steerable wheels of the first rear wheeled support unit and adjust a steering angle of the first and second steerable wheels of the second rear wheeled support unit;
and wherein in in response to the control system determining the target steering angle, the control system generates and sends one or more control signals to cause said actuation system to adjust the steering angle of the first and second steerable wheels of the first rear wheeled support unit to produce a steering direction of said first and second steerable wheels of the first rear wheeled support unit, and to adjust the steering angle of the first and second steerable wheels of the second rear wheeled support unit to produce a steering direction of said first and second steerable wheels of the second rear wheeled support unit, to thereby counteract the side force acting on the agricultural apparatus associated with the side tilt angle.

25. A method as claimed in claim 24, wherein the steering direction of said first and second steerable wheels of the first rear wheeled support unit, and the steering direction of said first and second steerable wheels of the second rear wheeled support unit, are approximately the same.

26. A method as claimed in claim 24, wherein the first and second wheeled support units are mechanically inter-connected by a track rod, to assist with the adjustment of the steering direction of said first and second steerable wheels of the first rear wheeled support unit, and of the steering direction of said first and second steerable wheels of the second rear wheeled support unit, to provide both with substantially the same steering direction.

27. A method as claimed in claim 1, wherein the frame supports a plurality of ground engagers, operable for engaging the ground surface.

28. A method as claimed in claim 27, wherein said ground engagers comprises one or more of chisel plows, seed drills and harrow tines.

29. A method as claimed in claim 1, wherein the frame supports a plurality of ground engagers, operable for engaging the ground surface, and wherein said ground engagers comprise discs.

30. A method as claimed in claim 18, wherein said plurality of rear wheeled support units comprises first and second transversely spaced rear wheeled support units, and wherein each of said first and second rear wheeled support units comprises a steerable wheel that is pivotable about a respective steering axis, and said side tilt counteracting system comprises an actuation system, said actuation system comprising a first actuator operable to adjust a steering angle of the steerable wheel of the first rear wheeled support unit, and wherein said actuation system further comprises a second actuator operable to adjust a steering angle of the steerable wheel of the second rear wheeled support unit;
and wherein in in response to the control system determining the target steering angle, the control system generates and sends one or more control signals to: cause the first actuator to adjust the steering angle of the steerable wheel of the first rear wheeled support unit to produce a steering direction of said steerable wheel of the first rear wheeled support unit; and cause the second actuator to adjust the steering angle of the steerable wheel of the second rear wheeled support unit to produce a steering direction of said steerable wheel of the second rear wheeled support unit, to thereby counteract the side force acting on the agricultural apparatus associated with the side tilt angle.

31. A method as claimed in claim 18, wherein said plurality of rear wheeled support units comprises first and second transversely spaced rear wheeled support units, and wherein each of said first and second front wheeled support units comprises a steerable wheel that is pivotable about a respective steering axis, and said side tilt counteracting system comprises an actuation system operable to adjust a steering angle of the steerable wheel of the first front wheeled support unit and operable to adjust a steering angle of the steerable wheel of the second front wheeled support unit;
and wherein in in response to the control system determining the target steering angle, the control system generates and sends one or more control signals to: cause the actuation system to adjust the steering angle of the steerable wheel of the first rear wheeled support unit to produce a steering direction of said steerable wheel of the first rear wheeled support unit; and cause the actuation system to adjust the steering angle of the steerable wheel of the second rear wheeled support unit to produce a steering direction of said steerable wheel of the second rear wheeled support unit, to thereby counteract the side force acting on the agricultural apparatus associated with the side tilt angle.

32. A method as claimed in claim 31, wherein said agricultural apparatus is a seeding cart, comprising at least one tank operable for holding a plurality of seeds, said tank being supported on said frame.

33. A method as claimed in claim 1, wherein said agricultural apparatus is propelled in a direction of travel by a propulsion unit.

34. A method as claimed in claim 33, wherein said side tilt counteracting mechanism is in operation while said agricultural apparatus is propelled in said direction of travel by said propulsion unit.

35. A method as claimed in claim 34, wherein said agricultural apparatus is inter-connected to said propulsion unit by a pivotable hitch connection mechanism.

36. (canceled)

37. A method as claimed in claim 1, wherein:
said side tilt counteracting system comprises a plurality of ground engagers, and said plurality of ground engagers comprises a plurality of front ground engagers and a plurality of rear ground engagers, each of said plurality of front and rear ground engagers operable for engaging below the ground surface; and
at least one of a depth of engagement below the ground surface of the front ground engagers and (ii) a depth of engagement below the ground surface of the rear ground engagers can be adjusted;
the control system is operable to cause the side tilt counteracting system to change at least one of a depth of engagement of the front ground engagers below the ground surface and a depth of engagement of the rear ground engagers beneath the ground surface;
and wherein said method further comprises:
propelling said agricultural implement in a direction of travel and said control system causes the side tilt counteracting system to adjust at least one of: (i) a depth of engagement below the ground surface of the front ground engagers and (ii) a depth of engagement below the ground surface of the rear ground engagers, to produce a ground engagers sideways force operable to counteract the side force acting on the tillage apparatus associated with the side tilt angle of the ground surface.

38. A method as claimed in claim 37, wherein said ground engagers sideways force is produced by a frame pitch angle control system changing a fore/aft pitch angle of the frame relative to the ground surface to adjust at least one of: (i) said depth of engagement below the ground surface of the front ground engagers and (ii) said depth of engagement below the ground surface of the rear ground engagers.

39. A method as claimed in claim 38, wherein changing the fore/aft angle of tilt of the frame relative to the ground surface is achieved by lowering or raising the frame at an end region of the frame.

40. A method as claimed in claim 39, wherein changing the fore/aft angle of tilt of the frame relative to the ground surface is achieved by the pitch angle control system lowering or raising the frame at a forward region relative to the wheels of a plurality of front wheeled support units of the plurality of wheeled support units that are located proximate a front region of the frame.

41. A method as claimed in claim 40, wherein based on the orientation signals, said control system determines a desired frame pitch angle and then sends signals to cause the pitch angle control system to adjust at least one of: (i) a depth of engagement below the ground surface of the front ground engagers and (ii) a depth of engagement below the ground surface of the rear ground engagers.

42. A method as claimed in claim 41, wherein:
said pitch angle control system comprises an actuation system operable to adjust the fore/aft pitch angle of the frame to increase and decrease the depth of engagement beneath the ground surface of at least one of the front ground engagers and the rear ground engagers with respect to the ground surface; and
wherein causing the control system to generate control signals comprises causing the control system to generate control signals for controlling said actuation system to increase and/or decrease the depth of engagement of at least one of the front ground engagers and the rear ground engagers with respect to the ground surface.

43. A method as claimed in any claim 42:
wherein said actuation system comprises a hydraulic valve operable to control flow of pressurized hydraulic fluid from a source of pressurized hydraulic fluid to at least one hydraulic cylinder, the at least one hydraulic cylinder being operable to adjust the fore/aft pitch angle of the frame to increase and decrease the depth of engagement beneath the ground surface of at least one of the ground engagers and the rear ground engagers with respect to the ground surface;
wherein causing the control system to generate control signals comprises causing the control system to generate control signals for controlling said hydraulic valve to control flow of pressurized hydraulic fluid to said at least one hydraulic cylinder to increase and decrease the depth of engagement of at least one of the front ground engagers and the rear ground engagers with respect to the ground surface.

44. A method as claimed in any claim 42:
wherein said actuation system comprises a hydraulic valve device operable to control flow of pressurized hydraulic fluid from a source of pressurized hydraulic fluid to a plurality of hydraulic cylinders, the plurality of hydraulic cylinder being operable to adjust the fore/aft pitch angle of the frame to increase and decrease the depth of engagement beneath the ground surface of at least one of the ground engagers and the rear ground engagers with respect to the ground surface;
wherein causing the control system to generate control signals comprises causing the control system to generate control signals for controlling said hydraulic valve device to control flow of pressurized hydraulic fluid to said plurality of hydraulic cylinders to increase and decrease the depth of engagement of at least one of the front ground engagers and the rear ground engagers with respect to the ground surface.

45. A method as claimed in claim 37, wherein:
said plurality of support units comprises at least one front wheeled support unit comprising at least one caster wheel mounted for free rotation about a wheel axis, said at least one caster wheel operable to contact the ground surface and operable to freely rotate to a direction of travel of said frame;
said caster wheel of said at least one wheeled support unit of the plurality of wheeled support units being freely rotatable and steerable about a generally vertical caster wheel steering axis;
wherein said method comprises:
receiving at said control system, said orientation signals from said orientation sensor, said orientation signals indicative of a side tilt angle of said sideways sloped ground surface;
receiving at said control system a caster wheel steering angle signal from a caster wheel angle rotation sensor, said at caster wheel steering angle signal indicative of an actual rotational angle of the caster wheel;
based on the caster wheel angle signal, the control system determines whether to sends signals to cause the pitch angle control system to adjust at least one of: (i) a depth of engagement below the ground surface of the front ground engagers and (ii) a depth of engagement below the ground surface of the rear ground engagers.

46. A method as claimed in claim 37, wherein the plurality of ground engagers comprises a plurality of discs.

47. A method as claimed in claim 46, wherein a plurality of front discs are oriented at an angle to a first side of a longitudinal axis of said frame.

48. A method as claimed in claim 47, wherein a plurality of rear discs are oriented at an angle to a second side of said longitudinal axis of said frame, said second side being an opposite side to said first side.

49. A method as claimed in claim 37, wherein the agricultural apparatus is coupled to a propulsion unit and wherein the method is performed while the propulsion unit pulls the agricultural apparatus in a direction of travel.

50. A method as claimed in claim 37, wherein the agricultural apparatus is pivotally connected to a propulsion unit and wherein the method is performed while the propulsion unit pulls the agricultural apparatus in a direction of travel.

51. A method as claimed in claim 37 wherein said plurality of support units comprises at least one wheeled support unit comprising at least one wheel mounted for rotation about a wheel axis, said at least one wheel operable to contact the ground surface.

52. A method for compensating for sideways force acting of an agricultural apparatus moving on a sideways sloped ground surface, the agricultural apparatus comprising:
a frame and a plurality of support units supporting said frame for movement on said ground surface, said plurality of support units comprising at least one wheeled support unit comprising at least one steerable wheel mounted for rotation about a wheel axis, said steerable wheel operable to contact the ground surface, said steerable wheel being rotatable and steerable about a generally vertical steering axis;
a steering angle adjustment system operable to adjust a steering angle of the at least one steerable wheel about said steering axis;
wherein the method comprises operating the steering angle adjustment system to adjust the steering angle of said steerable wheel about said steering axis, such that said steerable wheel is oriented in an angled direction that is generally in an uphill direction that is generally in an opposite direction to a sideways downhill slope direction of the ground surface.

53. A method for compensating for a sideways force acting of an agricultural apparatus moving on a sideways sloped ground surface, the agricultural apparatus comprising:
a frame and a plurality of support units supporting said frame for movement on said ground surface, said plurality of support units comprising at least one wheeled support unit comprising at least one steerable wheel mounted for rotation about a wheel axis, said at least one steerable wheel operable to contact the ground surface;
said steerable wheel of said at least one wheeled support unit of the plurality of wheeled support units being rotatable and steerable about a generally vertical steering axis;
a steering angle adjustment system operable to adjust the angular position of the steerable wheel about the steering axis;
wherein the method comprises:
receiving at a control system, at least one orientation signal from a ground surface orientation sensor, said at least one orientation signal indicative of a side tilt angle of said sideways sloped ground surface;
receiving at said control system a wheel steering angle signal from a steering angle rotation sensor, said at steering angle signal indicative of an actual steering angle of the steerable wheel;
based on the orientation signal, causing the control system to calculate a target steering angle;
based on the wheel steering angle signal, causing the control system to identify the actual steering angle of the steerable wheel;
causing the control system to generate signals to the steering angle adjustment system to adjust the actual steering angle of the steerable wheel towards the target steering angle.

54. A method as claimed in claim 53, further comprising:
causing the control system to maintain the actual steering angle when the control system determines the actual steering angle has either reached a maximum steering angle or the actual steering angle is substantially the same as the target steering angle.

55. A method for compensating for sideways force acting of an agricultural apparatus moving on a sideways sloped ground surface, the agricultural apparatus comprising:
(a) a frame and a plurality of support units supporting said frame for movement on said ground surface, said plurality of support units;
(b) a plurality of front ground engagers and a plurality of rear ground engagers mounted on said frame, each of said plurality of front and rear ground engagers operable for engaging beneath the ground surface, wherein at least one of a depth of engagement beneath the ground surface of the front ground engagers and (ii) a depth of engagement below the ground surface of the rear ground engagers can be adjusted;
(c) a depth adjustment system that is operable to adjust at least one of a depth of engagement of the front ground engagers below the ground surface and a depth of engagement of the rear ground engagers beneath the ground surface;
and wherein said method comprises:
(i) propelling said agricultural implement in a direction of travel;
(ii) receiving at a control system, orientation signals from a ground surface orientation sensor, said orientation signals indicative of a side tilt angle of said sideways sloped ground surface;
(iii) based on the orientation signals received by the control system, causing the control system to operate the depth adjustment system to cause the side tilt counteracting system to adjust at least one of: (i) a depth of engagement below the ground surface of the front ground engagers and (ii) a depth of engagement below the ground surface of the rear ground engagers, to produce a side force operable to counteract the side force acting on the tillage apparatus associated with the side tilt angle.

56. A method for compensating for sideways force acting of an agricultural apparatus located on a transversely side sloped ground surface, the agricultural apparatus comprising a frame and a plurality of wheeled support units, each of said plurality of wheeled support units having at least one wheel mounted for rotation about a wheel axis and said at least one wheel operable to contact the ground surface, the wheel of at least one wheeled support unit of the plurality of wheeled support units being rotatable about a generally vertical steering axis;
wherein the method comprises:
receiving at a control system at least one wheel steering angle rotation signal from a wheel steering angle rotational sensor, said at least one wheel steering angle rotation signal representative of a steering angle of the wheel about the steering axis;
receiving at said control system, at least one frame orientation signal from a frame orientation sensor, said at least one frame orientation signal representative of a side tilt angle of the frame;
based on the frame orientation signal and the at least one wheel steering angle rotation signal received by the control system, causing the control system to determine whether to activate a side tilt counteracting mechanism to counteract the sideways force acting on the agricultural apparatus associated with the side tilt angle;
based on the frame orientation signal and the at least one wheel rotational signal received by the control system, the control system determines whether to activate said side tilt counteracting system to generate said side force operable to counteract the sideways force acting on the agricultural apparatus associated with the side tilt angle.

57. A system comprising:
an agricultural apparatus comprising a frame supported by a plurality of support units operable to support said frame for movement on a ground surface;
a control system;
an orientation sensor operable to provide to said control system an orientation signal indicative of a side tilt angle of said ground surface upon which the frame is supported;
wherein the control system is operable is operable to determine if the side tilt angle is above a threshold angle, and in response to determining that the side tilt angle is above the threshold angle, to generate and send control signals to operate a side tilt counteracting system to counteract the sideways force on the agricultural apparatus associated with the side tilt angle.

58.-76. (canceled)

77. A system as claimed in claim 57, wherein said plurality of support units comprises at least one wheeled support unit supporting the frame, said at least one wheeled support unit comprising at least one wheel mounted for rotation about a wheel axis, said at least one wheel operable to contact the ground surface, said at least one wheel operable to rotate about a generally vertical steering axis, said at least one wheeled support unit operable to support said frame on a ground surface; and wherein said system further comprises an actuation system operable to adjust a steering angle of the at least one wheel about the steering axis.

78.-79. (canceled)

80. A system as claimed in claim 77, wherein at least one wheeled support unit further comprises:
a support leg member connected at an upper region thereof, to a frame member of said frame;
a steering hub fixedly connected to a lower region of said support leg member;
a pivot pin assembly connected to said steering hub, said pivot pin assembly comprising a king pin shaft aligned with and defining the steering axis;
a wheel assembly comprising said at least one wheel, said wheel assembly mounted on said king pin shaft such that in operation, said at least one wheel can pivot about said steering axis.

81. A system as claimed in claim 80, wherein said at least one wheel of said wheel assembly comprises a first wheel and a second wheel, and said wheel assembly further comprises a walking beam, said walking beam having an opening for receiving said king pin shaft therein, such that said walking beam is operable to rotate about said steering axis, and wherein said first wheel is mounted on a first side of said walking beam spaced from said opening, and said second wheel is mounted on a second side of said walking beam, such that said first and second wheel are operable to rotate with said walking beam about said king pin shaft and said steering axis.

82. An apparatus as claimed in claim 81, further comprising a generally horizontally oriented hub shaft having a longitudinal hub axis, said hub shaft being that is mounted to said steering hub, and wherein said pivot pin assembly has an upper region mounted for rotation on and about said hub shaft, such that pivot pin assembly, and the walking beam and the first and second wheels mounted on said walking beam, are operable to rotate about said hub shaft and said hub axis.

83. A system as claimed in claim 82, wherein said actuation system comprises at least one hydraulic cylinder in fluid communication with a supply of pressurized hydraulic fluid.

84. A system as claimed in claim 83, wherein the first and second wheels are mounted on a first axle and a second wheel axle respectively, said first and second wheel axles being mounted on said walking beam, and wherein said at least one hydraulic cylinder has a first end region pivotally interconnected to said steering hub and a second opposite end region pivotally connected to said wheel axel of said first wheel.

85.-97. (canceled)

98. An agricultural apparatus comprising:
a frame;
at least one wheeled support unit supporting the frame, said at least one wheeled support unit comprising at least one wheel mounted for rotation about a wheel axis, said at least one wheel operable to contact the ground surface, said at least one wheel operable to rotate about a generally vertical steering axis, said at least one wheeled support unit operable to support said frame on a ground surface;
an actuation system operable to adjust a steering angle of the at least one wheel about the steering axis.

99.-114. (canceled)

115. An agricultural system comprising:
(1) a tillage apparatus comprising
a frame;
at least one wheeled support unit connected to the frame, said at least one wheeled support unit comprising at least one wheel operable to rotate about a steering axis;
a tillage apparatus actuation system operable to adjust a steering angle of the at least one wheel about the steering axis.
(2) a seed cart interconnected to said tillage apparatus, said seed cart comprising
a frame;
at least plurality of wheeled support units connected to the frame, each of said plurality of wheeled support units comprising at least one wheel operable to rotate about a steering axis;
a seed cart actuation system operable to adjust a steering angle of at least one wheeled support unit of said plurality of wheeled support units about its respective steering axis.

116. A system as claimed in claim 115, further comprising:
a control system;
an orientation sensor operable to provide to said control system an orientation signal indicative of a side tilt angle of said ground surface upon which the frame of said tillage apparatus and/or the frame of the said seed cart is supported;
wherein the control system is operable is operable to determine if the side tilt angle is above a threshold angle, and in response to determining that the side tilt angle is above the threshold angle, to generate and send control signals to operate said tillage apparatus actuation system to adjust the steering angle of the at least one wheeled support unit of the tillage apparatus to counteract the sideways force on the tillage apparatus associated with the side tilt angle, and said control system also operable to generate and send control signals to operate said seed cart actuation system to adjust the steering angle of the at least one wheeled support unit of the seed cart to counteract the sideways force on the seed cart.

117. A system as claimed in claim 116, wherein said orientation sensor is mounted on said frame of said tillage apparatus or said seeder cart.

118. A system as claimed in claim 117, further comprising:
a propulsion unit interconnected to said tillage apparatus, and operable to pull both said tillage apparatus and said seed cart on a ground surface in a direction of travel.

119. A system as claimed in claim 118, wherein said tillage apparatus is positioned between said propulsion unit and said seed cart.
